(19) United States
(12) Patent Application Publication
(10) Pub. No.: US 2004/0137389 A1
(43) Pub. Date: Jul. 15, 2004

(54) Heat-developable light-sensitive material

(76) Inventors: Kouta Fukui, Kanagawa (JP); Toyohisa Oya, Kanagawa (JP)

Correspondence Address: MS. YUMI YERKS, 2111 JEFFERSON DAVIS HIGHWAY, APARTMENT #412, NORTH, ARLINGTON, VA, 22202, US

(21) Appl. No.: 10/736,320

(22) Filed: Dec. 16, 2003

(30) Foreign Application Priority Data
Dec. 19, 2002 (JP) 2002-367661
Dec. 19, 2002 (JP) 2002-367662
Jan. 16, 2003 (JP) 2003-8014

(51) Int. Cl. G03C 1/498; G03C 1/34

(52) U.S. Cl. 430/619; 430/567; 430/600; 430/611; 430/613

(57) ABSTRACT

The invention is a heat-developable light-sensitive material having, on a face of a support thereof, a photosensitive silver halide, a non-photosensitive organic silver salt, a reducing agent and a binder. In first and second aspects, the silver iodide content of the silver halide is from 5 mol % to 100 mol %, and the material contains a compound (eg. silver iodide complex-forming agent) capable of substantially lowering through heat development a spectral absorption intensity derived from the silver halide in visible and ultraviolet regions. In the first aspect, the silver halide is photosensitive silver halide grains having a mean diameter of 0.001 to 0.08 μm. In its second aspect, the material is exposed to light shorter than 700 nm. In its third aspect, (a) the silver iodide content of the silver halide is from 40 to 100 mol %, and (b) the material contains a compound of formula (14):

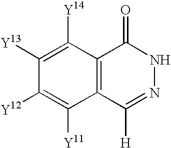

### CROSS-REFERENCE TO RELATED APPLICATION

This application claims priority under 35 USC 119 from Japanese Patent Application Nos. 2002-367661, 2002-367662, and 2003-8014, the disclosures of which are incoporated by reference herein.

### BACKGROUND OF THE INVENTION

1. Field of the Invention

The present invention relates to a heat-developable light-sensitive material. More precisely, the invention relates to a novel heat-developable light-sensitive material that has improved image storability, and especially improved image storability in conditions of light after heat development.

2. Description of the Related Art

From the viewpoints of environmental protection and space saving, a priority in the field of medical treatment in recent years has been a reduction in the volume of waste processing solutions. In these circumstances, techniques are required to produce heat-developable light-sensitive materials for medical diagnosis and photomechanical processes capable of being exposed efficiently with laser image setters or laser imagers to form sharp and clear monochromatic images of high resolution. Such heat-developable light-sensitive materials would provide users with more simple heat development systems, dispensing with the need for solution-type processing chemicals, which would therefore not pollute the environment.

The same requirement applies in the field of ordinary photo-imaging materials, but with somewhat different characteristics to those in the field of medical treatment. Specifically, photo-images for medical treatment must illustrate minute details and therefore the images must be sharp and have good image quality with fine graininess. An additional characteristic is that, for purpose of easy diagnosis, cold black images are preferred in the field of medical treatment. At present, various types of hard copy systems using pigments and dyes, for example, ink jet printers and electrophotographic systems, are available for ordinary imaging systems. However, no satisfactory system has yet been developed for forming photo-images suitable for used in the area of medical treatment.

On the other hand, photothermographic systems in which organic silver salts are used are known (for example, see U.S. Pat. Nos. 3,152,904 and 3,457,075, and D. Klosterboer's “Thermally Processed Silver Systems” (Imaging Processes and Materials), Neblette, 8th Edition, compiled by J. Sturge, V. Walworth & A. Shepp, Chapter 9, page 279, 1989). In particular, heat-developable light-sensitive materials in general have a photosensitive layer with a catalytically active amount of a photocatalyst (e.g., silver halide), a reducing agent, a reducible silver salt (e.g., organic silver salt), and optionally a color toning agent for controlling silver tones, all being dispersed in a binder matrix in the layer. After imagewise exposure, heat-developable light-sensitive materials of this type are heated at a high temperature (for example, at 80° C. or higher) to form black silver images through a redox reaction between the silver halide, or the reducible silver salt (serving as an oxidizer), and the reducing agent therein. In heat-developable light-sensitive materials of this type, the redox reaction is accelerated by a catalytic action of the latent image of the exposed silver halide. Therefore, black silver images are formed in the area of the materials exposed (for example, see U.S. Pat. No. 2,910,377 and JP-B No. 43-4924). As an imaging system for medical treatment based on a heat-developable light-sensitive material, the Fuji Medical Dry Imager FM-DPL has already been put on the market.

In the production of thermal imaging systems using organic silver salts, a prodution method based on the use of a solvent for forming a photosensitive layer is known, as well as a method comprising coating a support with a coating liquid containing an aqueous dispersion of polymer particles serving as an essential binder, and then drying it. The latter method does not entail solvent recovery and therefore the equipment required for it is simple. For these reasons, the latter method is advantageous in the area of industrial scale mass-production of thermal imaging systems.

Heat-developable light-sensitive materials in general have an image-forming layer with a catalytically active amount of a photocatalyst (e.g., silver halide), a reducing agent, and a reducible silver salt (e.g., an organic silver salt), all being dispersed in a binder matrix in the layer.

One serious problem with such heat-developable light-sensitive materials is that no process for removing compounds is included and in consequence the unreacted compounds remain in their existing state within the developed materials. Therefore, when, after image formation, the materials are either exposed to room light, or exposed to high temperatures during storage, silver ions therein are further reduced and in consequence fogging occurs. Accordingly, a demand has grown for a technique which would improve the image storability of heat-developable light-sensitive materials.

It is, for example, known that a polyhalogen compound capable of oxidatively decomposing unnecessary fog silver formed during the processing and storing of heat-developable light-sensitive materials is effective as a measure for improving the image storability of heat-developable light-sensitive materials (for example, see JP-A No. 2001-33911). JP-A No. 2002-156727 and Japanese Patent Application No. 2001-124796 also disclose a complex-forming agent capable of forming a complex with a developing agent to control undesirable reduction during storage of developed heat-developable light-sensitive materials. However, there are limits to the capacities of such conventional techniques for improving image storability under conditions of light, and further novel techniques have been sought.

Another serious problem with heat-developable light-sensitive materials is the fact that the photosensitive silver halide remaining in developed materials makes the materials cloudy. Silver halide grains have a high refractive index, and when they are dispersed in the binder and exist within developed materials, the materials become cloudy as the silver halide grains therein scatter light, and, as a result, image quality is there damaged. To reduce film cloudiness, a ruse hitherto adopted in the art has been to reduce the mean grain size of silver halides used, thereby lowering the overall quantity of silver halide in the heat-developable light-sensitive material to a degree that does not substantially damage image quality. However, as a result, sensitivity of heat-developable light-sensitive materials has inevitably remained at a low level. Strenuous efforts have hitherto been made to increase the sensitivity of heat-decelopable light-sensitive materials by improving chemical sensitization of the heat-developable light-sensitive materials and by improving the quality of color sensitizers. However, none of these attempts have so far attained a satisfactory level of success.

Silver iodide is known as a type of photosensitive silver halides (for example, see U.S. Pat. No. 6,143,488). However, the sensitivity of silver iodide, or high-iodide (iodide-rich) silver iodobromide, is much lower than that of silver bromide or low-iodide (at most 3.5 mol % iodide) silver iodobromide. In addition, the former has so far not been found to be superior to the latter in any specific aspect, and silver iodide has almost never attracted attention from a practical point of view. In fact, all heat-developable light-sensitive materials now sold on the market by various manufacturers comprise silver bromide or low-iodide silver iodobromide.

Phthalazone and phthalazine are known as color toning agents used in heat-developable light-sensitive materials (for example, see U.S. Pat. No. 4,123,282). However, when a phthalazone color toning agent is used in heat-developable light-sensitive materials containing silver bromide or low-iodide silver iodobromide, properties such as sensitivity and image storability of the materials are often inferior to those of materials containing a phthalazine derivative as a color toning agent. In heat-developable light-sensitive materials containing phthalazone, this difference in properties is often more pronounced in materials containing silver iodide than in materials containing silver bromide or low-iodide silver iodobromide. In addition, when a thermal developing machine is used over a long period of time for processing heat-developable light-sensitive materials containing phthalazone, sublimed phthalazone deposits inside the machine and on occasions has caused problems in that it has had a negative influence on the finished materials.

On the other hand, a number of techniques have been developed for solving the problem of film cloudiness caused by silver halide grains remaining in processed heat-developable light-sensitive materials. For example, a technique has been proposed for incorporating in a heat-developable light-sensitive material a compound that can form a complex with a silver ion (sometimes referred to hereafter as a silver halide solvent), and the silver halide in the material is made soluble through heat development (generally referred to as fixation) (see U.S. Pat. No. 4,123,282, and JP-A No. 8-76317). A technique has also been proposed for preparing a different type of sheet (fixation sheet) containing a compound capable of forming a complex with a silver ion, thermally developing a heat-developable light-sensitive material to form an image thereon, putting the material thus developed on a fixation sheet and then heating them to dissolve and remove the remaining silver halide from the developed material (see JP-B No. 43-4924, and JP-A No. 9-166845). However, the former technique entials serious problems in that the image-forming layer becomes extremely unstable, and image density is therefore easily saturated at a low level, and reduction in sensitivity during storage is spectacular. In addition, the former technique relates to silver bromide or silver chlorobromide, and requires post-heating for fixation. This post-heating requires a high temperature of 155° C. to 160° C., and the system has been difficult to fix. Further, the latter technique requires additional treatment with the fixation sheet and the process becomes complicated. In addition, the processing machine for the latter technique becomes extremely large and it becomes difficult to ensure operational stability. The fixation sheet which has been used must also be disposed of, and the waste creates an environmental problem.

Apart from the above, another method which has been proposed for fixation in the process of heat development is of incorporating a silver halide fixing agent in microcapsules and then releasing the fixing agent by means of heat development (see JP-A No. 8-82886). However, it is difficult to design a system for releasing the fixing agent effectively. Another proposal is a method for fixing a material with a fixer after is has been developed (see JP-A Nos. 51-104826 and 62-133454). However, this method requires wet treatment and is therefore unsuitable for the full-dry treatment required.

As has been described in the above, methods hitherto proposed for reducing film cloudiness of heat-developable light-sensitive materials have all entailen serious problems, and it has been extremely difficult to put such methods into practical use.

Therefore, a novel heat-developable light-sensitive material of improved image storability, especially improved image storability under conditions of light is desired. Also desired is a novel heat-developable light-sensitive material which would facilitate improved raw stock storability.

### SUMMARY OF THE INVENTION

The first aspect of the present invention is to provide a heat-developable light-sensitive material comprising, on a face of a support thereof, a photosensitive silver halide, a non-photosensitive organic silver salt, a reducing agent and a binder, wherein (a) the silver iodide content of the photosensitive silver halide is from 5 mol % to 100 mol %, (b) the photosensitive silver halide is photosensitive silver halide grains having a mean diameter of 0.001 μm to 0.08 μm, and (c) the material contains a silver iodide complex-forming agent capable of substantially lowering through heat development a spectral absorption intensity derived from the photosensitive silver halide in visible and ultraviolet ranges.

The second aspect of the invention is to provide a heat-developable light-sensitive material comprising, on a face of a support thereof, a photosensitive silver halide, a non-photosensitive organic silver salt, a reducing agent and a binder, wherein (a) the silver iodide content of the photosensitive silver halide is from 5 mol % to 100 mol %, (b) the material contains a compound capable of substantially lowering through heat development a spectral absorption intensity derived from the photosensitive silver halide in visible and ultraviolet ranges, and (c) the material is exposed to light shorter than 700 nm.

The third aspect of the invention is to provide a heat-developable light-sensitive material comprising, on a face of a support thereof, a photosensitive silver halide, a non-photosensitive organic silver salt, a reducing agent and a binder, wherein (a) the silver iodide content of the photosensitive silver halide is from 40 mol % to 100 mol %, and (b) the material contains a compound of the following formula (14):

Formula (14):

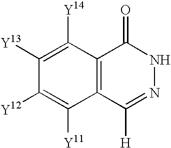

wherein Y¹¹ to Y¹⁴ each independently represent a hydrogen atom, or a substituent which can bond to the benzene ring; at least one of Y¹¹ to Y¹⁴ is a substituent; and Y¹¹ to Y¹⁴ may bond to each other to form a saturated or unsaturated ring.

### BRIEF DESCRIPTION OF THE DRAWING

FIG. 1 is a spectral absorption pattern of silver iodide grains for use in the present invention. The horizontal axis indicates the spectral wavelength of from 350 nm to 500 nm; and the vertical axis indicates the absorbance of any scale. The maximum absorption at around 410 nm is the direct transition absorption that is derived from high silver iodide content crystals.

### DETAILED DESCRIPTION OF THE INVENTION

The present invention is described in detail hereinafter.

Description of Silver Iodide Complex-Forming Agent:

In the invention, a silver iodide complex-forming agent is preferred for the compound that may substantially lower the photosensitive silver halide-derived, UV to visible spectral absorption intensity through heat development of the heat-developable light-sensitive material.

In the compound of the silver iodide complex-forming agent for use in the invention, at least one of the nitrogen atom or the sulfur atom serves as a coordination atom (electron donor; Lewis base), and therefore can contribute to the Lewis acid-base reaction for electron donation to silver ions. The complex stability is defined by the successive stability constant or the total stability constant, but depends on the combination of the three, silver ion, iodide ion and silver complex-forming agent. As a general guide to it, the chelate effect through intramolecular chelate ring formation or the increase in the acid-base dissociation constant of the ligand may increase the stability constant.

The mechanism of the silver iodide complex-forming agent in the invention is not completely clarified, but it may be presumed that silver iodide may be solubilized through formation of a stable complex of at least three components including iodide ion and silver ion. The silver iodide complex-forming agent for use in the invention is characterized in that its ability to solubilize silver bromide or silver chloride is poor but it specifically acts on silver iodide, and this differs from ordinary silver halide solvent in that characteristic point thereof.

The mechanisms of the silver iodide complex-forming agent to improve the image storability of heat-developable light-sensitive materials is not clarified in detail, but it may be presumed that the silver iodide complex-forming agent will react with at least a part of photosensitive silver halide to form a complex, whereby the silver halide may lower or lose its photosensitivity. As a result, the image storability of heat-developable light-sensitive materials under exposure to light may be significantly improved. In addition, the silver iodide complex-forming agent may reduce film cloudiness to be caused by silver halide and is therefore effective for giving clear high-quality images. This is still another significant advantage of the silver iodide complex-forming agent. The film cloudiness may be confirmed by the reduction in the UV to visible absorbance in absorption spectra.

In the invention, the UV to visible absorption spectrum of photosensitive silver halide may be measured in a transmission method or a reflection method. When the absorption derived from any other compound in the heat-developable light-sensitive material of the invention overlaps with that from the photosensitive silver halide therein, spectral differential or removal of the other compound with a solvent may be employed either alone or in combination to analyze the UV to visible absorption spectrum of the photosensitive silver halide alone.

Definite difference between the silver iodide complex-forming agent in the invention and ordinary silver ion complex-forming agent is indispensable for forming a stable iodide complex in the invention. Ordinary silver ion complex-forming agent does not have specific selectivity to halide ions, or that is, it may form a complex with any silver salt such as silver bromide, silver chloride or even with any organic silver salt such as silver behenate, to thereby dissolve such silver salt. Different from it, the silver iodide complex-forming agent in the invention is significantly characterized in that it is ineffective in the absence of silver iodide.

For the silver iodide complex-forming agent for use in the invention, preferred are compounds of the following formula (1) or (2).

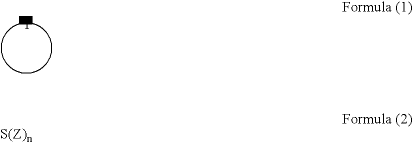

In formula (1), Y represents a non-metallic atomic group necessary for forming a 5- to 7-membered heterocyclic ring that contains at least one of a nitrogen and sulfur atom, and the heterocyclic ring which Y forms may be saturated or unsaturated, and may be substituted. The substituents on the heterocyclic ring which Y forms may bond to each other to form a ring.

Examples of the 5- to 7-membered heterocyclic ring containing at least one of a nitrogen and sulfur atom which is formed by Y are thiophene, pyrrole, pyridine, oxazole, isoxazole, thiazole, isothiazole, imidazole, pyrazole, pyrazine, pyrimidine, pyridazine, indole, isoindole, indolidine, quinoline, isoquinoline, benzimidazole, 1H-imidazole, quinoxaline, quinazoline, cinnoline, phthalazine, 1,8-naphthyridine, purine, pteridine, carbazole, acridine, phenanthridine, 1,10-phenanthroline, phenazine, phenoxazine, phenothiazine, benzothiazole, benzoxazole, benzimidazole, 1,2,4-triazine, 1,3,5-triazine, pyrrolidine, imidazolidine, pyrazolidine, piperidine, piperazine, morpholine, indoline, and isoindoline.

These rings may have a substituent. Preferred examples of the substituent are a halogen atom (fluorine atom, chlorine atom, bromine atom, or iodine atom), an alkyl group (linear, branched or cyclic alkyl group including bicycloalkyl group and active methine group), an alkenyl group, an alkynyl group, an aryl group, a heterocyclic group (its substituting position is not defined), an acyl group, an alkoxycarbonyl group, an aryloxycarbonyl group, a heterocyclic-oxycarbonyl group, a carbamoyl group, an N-acylcarbamoyl group, an N-sulfonylcarbamoyl group, an N-carbamoylcarbamoyl group, a thiocarbamoyl group, an N-sulfamoylcarbamoyl group, a carbazoyl group, a carboxy group and its salts, an oxalyl group, an oxamoyl group, a cyano group, a carbonimidoyl group, a formyl group, a hydroxyl group, an alkoxy group (including one that contains repetitive units of ethyleneoxy or propyleneoxy group), an aryloxy group, a heterocyclic-oxy group, an acyloxy group, an (alkoxy or aryloxy) carbonyloxy group, a carbamoyloxy group, a sulfonyloxy group, an amino group, an (alkyl, aryl or heterocyclic)amino group, an acylamino group, a sulfonamido group, an ureido group, a thioureido group, an imido group, an (alkoxy or aryloxy) carbonylamino group, a sulfamoylamino group, a semicarbazido group, a thiosemicarbazido group, an ammonio group, an oxamoylamino group, an N-(alkyl or aryl)sulfonylureido group, an N-acylureido group, an N-acylsulfamoylamino group, a nitro group, a quaternary nitrogen atom-containing heterocyclic group (e.g., pyridinio, imidazolio, quinolinio, isoquinolinio group), an isocyano group, an imino group, a mercapto group, an (alkyl, aryl or heterocyclic)thio group, an (alkyl, aryl or heterocyclic)dithio group, an (alkyl or aryl)sulfonyl group, an (alkyl or aryl)sulfinyl group, a sulfo group and its salts, a sulfamoyl group, an N-acylsulfamoyl group, an N-sulfonylsulfamoyl group and its salts, a phosphino group, a phosphinyl group, a phosphinyloxy group, a phosphinylamino group, and a silyl group. The active methine group as referred to herein means a methine group substituted with two electron attractive groups, in which the electron attractive group includes an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group and a carbonimidoyl group, and in which the two electron attractive groups may bond to each other to form a cyclic structure. The salt includes those with a cation of alkali metals, alkaline earth metals or heavy metals, and those with an organic cation such as ammonium or phosphonium ion. These substituents may be further substituted with any of these substituents. The heterocyclic ring which Y forms may be condensed with any other ring.

Preferably, the compound of formula (1) is a nitrogen-containing heterocyclic compound. More preferably, the acid dissociation constant (pKa) of its conjugate acid in a mixed solution of tetrahydrofuran/water (3/2) falls between 3 and 8 at 25° C. Even more preferably, the acid dissociation constant (pKa) is from 4 to 7.

Also preferably, the compound of formula (1) contains a pyridine ring, a pyrimidine ring, or a pyridazine ring (including condensed pyridazine such as phthalazine). Also preferably, it has at least one mercapto group as the substituent. Even more preferably the compound of formula (1) contains a pyridine ring or a phthalazine ring.

In formula (2), Z represents a hydrogen atom or a substituent. n indicates an integer of 1 or 2, and when n is 1, it means that S bonds to Z via a double bond. When n is 2, it means that S bonds to two Zs each via a single bond. When n is 1, Z must not be a hydrogen atom. When n is 2, two Zs may be the same or different, but both two Zs must not be hydrogen atoms. Preferably, Z bonds to S via a single bond or a double bond at its carbon atom.

When n is 1, examples of Z are methylene, ethylidene and vinylidene. These groups may be further substituted. For the examples of the substituent, referred to are those mentioned hereinabove for the substituent for the heterocyclic ring which Y forms in formula (1). Examples of the substituted Z that is combined with S are thiourea, tetramethylthiourea, N-ethyl-N′-propylthiourea, N,N′-dimethylthiourea. When n is 2, the substituent of Z includes an alkyl group (including a cycloalky group such as a bicycloalkyl group), an alkenyl group (including cycloalkenyl group such as bicycloalkenyl group), an alkynyl group, an aryl group, a heterocyclic group, an acyl group, an aryloxycarbonyl group, an alkoxycarbonyl group, a carbamoyl group, and an imido group.

More precisely, the substituent includes an alkyl group (preferably having from 1 to 30 carbon atoms, such as methyl, ethyl, n-propyl, isopropyl, t-butyl, n-octyl, eicosyl, 2-chloroethyl, 2-cyanoethyl, 2-ethylhexyl), a cycloalkyl group (substituted or unsubstituted cycloalkyl group preferably having from 3 to 30 carbon atoms, such as cyclohexyl, cyclopentyl, 4-n-dodecylcyclohexyl), a bicycloalkyl group (substituted or unsubstituted bicycloalkyl group preferably having from 5 to 30 carbon atoms, such as bicyclo[1,2,2]heptan-2-yl, bicyclo[2,2,2]octan-3-yl), an alkenyl group (substituted or unsubstituted alkenyl group preferably having from 2 to 30 carbon atoms, such as vinyl, allyl, prenyl, geranyl, oleyl), an alkynyl group (substituted or unsubstituted alkynyl group preferably having from 2 to 30 carbon atoms, such as ethynyl, propargyl, trimethylsilylethynyl), an aryl group (substituted or unsubstituted aryl group preferably having from 6 to 30 carbon atoms, such as phenyl, p-tolyl, naphthyl, m-chlorophenyl, o-hexadecanoylaminophenyl), a heterocyclic group (preferably monovalent group derived from a 5- or 6-membered, substituted or unsubstituted, aromatic or non-aromatic heterocyclic compound by removing one hydrogen atom from the compound, more preferably 5- or 6-membered aromatic heterocyclic group having from 3 to 30 carbon atoms, such as 2-furyl, 2-thienyl, 2-pyrimidinyl, 2-benzothiazolyl), an acyl group (preferably formyl group, or substituted or unsubstituted alkylcarbonyl group having from 2 to 30 carbon atoms, or substituted or unsubstituted arylcarbonyl group having from 7 to 30 carbon atoms, or substituted or unsubstituted heterocyclic-carbonyl group having from 4 to 30 carbon atoms in which a heterocycle bonds to a carbonyl group via a carbon atom, such as acetyl, pivaloyl, 2-chloroacetyl, stearoyl, benzoyl, p-n-octyloxyphenylcarbonyl, 2-pyridylcarbonyl, 2-furylcarbonyl), an aryloxycarbonyl group (substituted or unsubstituted aryloxycarbonyl group preferably having from 7 to 30 carbon atoms, such as phenoxycarbonyl, o-chlorophenoxycarbonyl, m-nitrophenoxycarbonyl, p-t-butylphenoxycarbonyl), an alkoxycarbonyl group (substituted or unsubstituted alkoxycarbonyl group preferably having from 2 to 30 carbon atoms, such as methoxycarbonyl, ethoxycarbonyl, t-butoxycarbonyl, n-octadecyloxycarbonyl), a carbamoyl group (substituted or unsubstituted carbamoyl group preferably having from 1 to 30 carbon atoms, such as carbamoyl, N-methylcarbamoyl, N,N-dimethylcarbamoyl, N,N-di-n-octylcarbamoyl, N-(methylsulfonyl)carbamoyl), an imido group (preferably N-succinimido or N-phthalimido). Of the substituents, those having a hydrogen atom may be further substituted by removing the hydrogen atom therein. Examples of such composite substituents are a hydroxyethoxyethyl group, a hydroxyethylthioethyl group, and a dimethylaminocarbonyl group.

More preferably, the silver iodide complex-forming agent for use in the invention is a 5- to 7-membered heterocyclic compound that has at least one nitrogen atom. When the 5- to 7-membered heterocyclic compound does not have a substituent of mercapto group, sulfido group or thione group, it may be saturated or unsaturated and may have any other substituent. The substituents on the heterocyclic ring may bond to each other to form a ring.

Preferred examples of the 5- to 7-membered heterocyclic compound are pyrrole, pyridine, oxazole, isoxazole, thiazole, isothiazole, imidazole, pyrazole, pyrazine, pyrimidine, pyridazine, indole, isoindole, indolidine, quinoline, isoquinoline, benzimidazole, 1H-imidazole, quinoxaline, quinazoline, cinnoline, phthalazine, naphthyridine, purine, pteridine, carbazole, acridine, phenanthridine, phenanthroline, phenazine, phenoxazine, phenothiazine benzothiazole, benzoxazole, benzimidazole, 1,2,4-triazine, 1,3,5-triazine, pyrrolidine, imidazolidine, pyrazolidine, piperidine, piperazine, morpholine, indoline, and isoindoline. More preferred are pyridine, imidazole, pyrazole, pyrazine, pyrimidine, pyridazine, indole, isoindole, indolidine, quinoline, isoquinoline, benzimidazole, 1H-imidazole, quinoxaline, quinazoline, cinnoline, phthalazine, 1,8-naphthyridine, 1,10-phenanthroline, benzimidazole, benzotriazole, 1,2,4-triazine, and 1,3,5-triazine. Even more preferred are pyridine, imidazole, pyrazine, pyrimidine, pyridazine, phthalazine, triazine, 1,8-naphthyridine, and 1,10-phenanthroline.

These rings may have a substituent. Preferred examples of the substituent are a halogen atom (fluorine atom, chlorine atom, bromine atom, or iodine atom), an alkyl group (linear, branched or cyclic alkyl group including bicycloalkyl group and active methine group), an alkenyl group, an alkynyl group, an aryl group, a heterocyclic group (its substituting position is not defined), an acyl group, an alkoxycarbonyl group, an aryloxycarbonyl group, a heterocyclic-oxycarbonyl group, a carbamoyl group, an N-acylcarbamoyl group, an N-sulfonylcarbamoyl group, an N-carbamoylcarbamoyl group, an N-sulfamoylcarbamoyl group, a carbazoyl group, a carboxy group and its salts, an oxalyl group, an oxamoyl group, a cyano group, a carbonimidoyl group, a formyl group, a hydroxyl group, an alkoxy group (including one that contains repetitive units of ethyleneoxy or propyleneoxy group), an aryloxy group, a heterocyclic-oxy group, an acyloxy group, an (alkoxy or aryloxy) carbonyloxy group, a carbamoyloxy group, a sulfonyloxy group, an amino group, an (alkyl, aryl or heterocyclic)amino group, an acylamino group, a sulfonamido group, an ureido group, a thioureido group, an imido group, an (alkoxy or aryloxy)carbonylamino group, a sulfamoylamino group, a semicarbazido group, an ammonio group, an oxamoylamino group, an N-(alkyl or aryl)sulfonylureido group, an N-acylureido group, an N-acylsulfamoylamino group, a nitro group, a quaternary nitrogen atom-containing heterocyclic group (e.g., pyridinio, imidazolio, quinolinio, isoquinolinio group), an isocyano group, an imino group, an (alkyl or aryl)sulfonyl group, an (alkyl or aryl)sulfinyl group, a sulfo group and its salts, a sulfamoyl group, an N-acylsulfamoyl group, an N-sulfonylsulfamoyl group and its salts, a phosphino group, a phosphinyl group, a phosphinyloxy group, a phosphinylamino group, and a silyl group. The active methine group as referred to herein means a methine group substituted with two electron attractive groups, in which the electron attractive group includes an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group and a carbonimidoyl group, and in which the two electron attractive groups may bond to each other to form a cyclic structure. The salt includes those with a cation of alkali metals, alkaline earth metals or heavy metals, and those with an organic cation such as ammonium or phosphonium ion. These substituents may be further substituted with any of these substituents. The heterocyclic ring may be condensed with any other ring. When the substituent is an anionic group (e.g., —CO₂⁻, —SO₃⁻, —S⁻), the nitrogen-containing heterocyclic ring in the invention may be a cation (e.g., pyridinium, 1,2,4-triazolium) to form an internal salt.

When the heterocyclic compound is any of pyrazine, pyrimidine, pyridazine, phthalazine, triazine, naphthyridine or phenanthroline derivatives, the acid dissociation constant (pKa) at acid dissociation equilibrium of the conjugate acid of the nitrogen-containing heterocyclic ring moiety of the compound in a mixed solution of tetrahydrofuran/water (3/2) is more preferably from 3 to 8 at 25° C., even more preferably from 4 to 7.

For the heterocyclic compound of the type, especially preferred are pyridine, pyridazine and phthalazine derivatives, and more preferred are pyridine and phthalazine derivatives.

When the heterocyclic compound has a substituent of mercapto group, sulfido group or thione group, it is preferably any of pyridine, thiazole, isothiazole, oxazole, isoxazole, imidazole, pyrazole, pyrazine, pyrimidine, pyridazine, triazine, triazole, thiadiazole or oxadiazole derivatives, more preferably any of thiazole, imidazole, pyrazole, pyrazine, pyrimidine, pyridazine, triazine or triazole derivatives.

The compounds of formula (1) are preferably those of the following formulae (5) to (7).

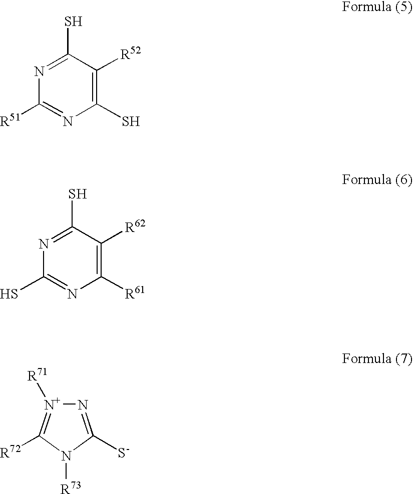

In formulae (5) to (7), R⁵¹, R⁵², R⁶¹, R⁶² and R⁷¹ to R⁷³ each independently represent a hydrogen atom or a substituent. For the examples of the substituent for R⁵¹, R⁵², R⁶¹, R⁶² and R⁷², referred to are those mentioned hereinabove for the heterocyclic ring which Y in formula (1) forms. Examples of the substituent for R⁷¹ and R⁷² are an alkyl group (including cycloalkyl group such as bicycloalkyl group), an alkenyl group (including cycloalkenyl group such as bicycloalkenyl group), an alkynyl group, an aryl group, and a heterocyclic group. R⁵¹, R⁵², R⁶¹, R⁶² and R⁷¹ to R⁷³ may bond to each other to form a saturated or unsaturated ring.

Preferred compounds for the silver iodide complex-forming agent for use in the invention are those of the following formula (10) or (11).

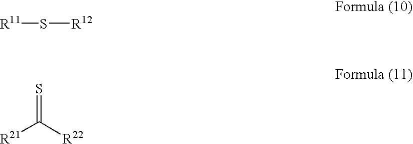

In formula (10), R¹¹ and R¹² each represent a hydrogen atom or a substituent. In formula (11), R²¹ and R²² each represent a hydrogen atom or a substituent. However, both R¹¹ and R¹² are not hydrogen atoms, and both R²¹ and R²² are not hydrogen atoms.

Formula (10) is described.

Examples of R¹¹ and R¹² are an alkyl group (preferably having from 1 to 30 carbon atoms, such as methyl, ethyl, n-propyl, isopropyl, t-butyl, n-octyl, eicosyl, 2-chloroethyl, 2-cyanoethyl, 2-ethylhexyl), a cycloalkyl group (substituted or unsubstituted cycloalkyl group preferably having from 3 to 30 carbon atoms, such as cyclohexyl, cyclopentyl, 4-n-dodecylcyclohexyl), a bicycloalkyl group (substituted or unsubstituted bicycloalkyl group preferably having from 5 to 30 carbon atoms, such as bicyclo[1,2,2]heptan-2-yl, bicyclo[2,2,2]octan-3-yl), an alkenyl group (substituted or unsubstituted alkenyl group preferably having from 2 to 30 carbon atoms, such as vinyl, allyl, prenyl, geranyl, oleyl), an alkynyl group (substituted or unsubstituted alkynyl group preferably having from 2 to 30 carbon atoms, such as ethynyl, propargyl, trimethylsilylethynyl), an aryl group (substituted or unsubstituted aryl group preferably having from 6 to 30 carbon atoms, such as phenyl, p-tolyl, naphthyl, m-chlorophenyl, o-hexadecanoylaminophenyl), a heterocyclic group (preferably monovalent group derived from a 5- or 6-membered, substituted or unsubstituted, aromatic or non-aromatic heterocyclic compound by removing one hydrogen atom from the compound, more preferably 5- or 6-membered aromatic heterocyclic group having from 3 to 30 carbon atoms, such as pyridyl, thiazolyl, isothiazolyl, oxazolyl, isoxazolyl, imidazolyl, pyrazolyl, pyrazyl, pyrimidyl, pyridazinyl, triazinyl, triazolyl, thiadiazolyl, oxadiazolyl, 2-furyl, 2-thienyl, 2-benzothiazolyl), an acyl group (preferably formyl group, or substituted or unsubstituted alkylcarbonyl group having from 2 to 30 carbon atoms, or substituted or unsubstituted arylcarbonyl group having from 7 to 30 carbon atoms, or substituted or unsubstituted heterocyclic-carbonyl group having from 4 to 30 carbon atoms in which a heterocycle bonds to a carbonyl group via a carbon atom, such as acetyl, pivaloyl, 2-chloroacetyl, stearoyl, benzoyl, p-n-octyloxyphenylcarbonyl, 2-pyridylcarbonyl, 2-furylcarbonyl), an aryloxycarbonyl group (substituted or unsubstituted aryloxycarbonyl group preferably having from 7 to 30 carbon atoms, such as phenoxycarbonyl, o-chlorophenoxycarbonyl, m-nitrophenoxycarbonyl, p-t-butylphenoxycarbonyl), an alkoxycarbonyl group (substituted or unsubstituted alkoxycarbonyl group preferably having from 2 to 30 carbon atoms, such as methoxycarbonyl, ethoxycarbonyl, t-butoxycarbonyl, n-octadecyloxycarbonyl), a carbamoyl group (substituted or unsubstituted carbamoyl group preferably having from 1 to 30 carbon atoms, such as carbamoyl, N-methylcarbamoyl, N,N-dimethylcarbamoyl, N,N-di-n-octylcarbamoyl, N-(methylsulfonyl)carbamoyl), an alkylthio group, and an arylthio group. Of the substituents, those having a hydrogen atom may be further substituted by removing the hydrogen atom therein to form composite substituents. Examples of such composite substituents are a hydroxyethoxyethyl group, a hydroxyethylthioethyl group, and a dimethylaminocarbonyl group. R¹¹ and R¹² may bond to each other to form a saturated or unsaturated ring.

Preferably, the substituents each are an alkyl group, an aryl group, an alkylthio group, an arylthio group or a composite substituent including any of them, more preferably an alkyl group, an alkylthio group or a composite substituent including any of them (hydroxyalkoxyalkyl group, hydroxyalkylthioalkyl group).

Formula (11) is described.

In formula (11), R² and R²² each represent a hydrogen atom or a substituent. However, both R²¹ and R²² are not hydrogen atoms.

Examples of R²¹ and R²² are an alkyl group (linear, branched or cyclic alkyl group including bicycloalkyl group and active methine group), an alkenyl group, an alkynyl group, an aryl group, a heterocyclic group (its substituting position is not defined), an acyl group, an alkoxycarbonyl group, an aryloxycarbonyl group, a heterocyclic-oxycarbonyl group, a carbamoyl group, an N-acylcarbamoyl group, an N-sulfonylcarbamoyl group, an N-carbamoylcarbamoyl group, an N-sulfamoylcarbamoyl group, a carbazoyl group, a carboxy group and its salts, an oxalyl group, an oxamoyl group, a cyano group, a carbonimidoyl group, a formyl group, a hydroxyl group, an alkoxy group (including one that contains repetitive units of ethyleneoxy or propyleneoxy group), an aryloxy group, a heterocyclic-oxy group, an acyloxy group, an (alkoxy or aryloxy)carbonyloxy group, a carbamoyloxy group, a sulfonyloxy group, an amino group, an (alkyl, aryl or heterocyclic)amino group, an acylamino group, a sulfonamido group, an ureido group, a thioureido group, an imido group, an (alkoxy or aryloxy)carbonylamino group, a sulfamoylamino group, a semicarbazido group, an ammonio group, an oxamoylamino group, an N-(alkyl or aryl)sulfonylureido group, an N-acylureido group, an N-acylsulfamoylamino group, a nitro group, a quaternary nitrogen atom-containing heterocyclic group (e.g., pyridinio, imidazolio, quinolinio, isoquinolinio group), an isocyano group, an imino group, an (alkyl or aryl)sulfonyl group, an (alkyl or aryl)sulfinyl group, a sulfo group and its salts, a sulfamoyl group, an N-acylsulfamoyl group, an N-sulfonylsulfamoyl group and its salts, a phosphino group, a phosphinyl group, a phosphinyloxy group, a phosphinylamino group, a silyl group, an alkylthio group, an arylthio group, and a mercapto group. The active methine group as referred to herein means a methine group substituted with two electron attractive groups, in which the electron attractive group includes an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group and a carbonimidoyl group, and in which the two electron attractive groups may bond to each other to form a cyclic structure. The salt includes those with a cation of alkali metals, alkaline earth metals or heavy metals, and those with an organic cation such as ammonium or phosphonium ion. R²¹ and R²² may bond to each other to form saturated or unsaturated a ring.

Preferably, R²¹ and R²² each are an alkyl group, an aryl group or a substituted amino group, more preferably an aryl group or a substituted amino group.

The heterocyclic compounds that may be used as the silver iodide complex-forming agent in the invention are described.

One preferred example of the heterocyclic compounds is a compound of the following formula (3):

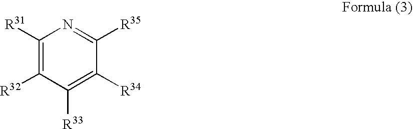

In formula (3), R³¹ to R³⁵ each independently represent a hydrogen atom or a substituent. Examples of the substituent for R³¹ to R³⁵ are those mentioned hereinabove for the heterocyclic ring which Y in formula (1) forms. When the compound of formula (3) has a substituent, the preferred positions for the substituents are R³² to R³⁴. R³¹ to R³⁵ may bond to each other to form a saturated or unsaturated ring.

Preferably, the substituents are an alkyl group, an aryl group, an alkoxy group, an aryloxy group, an amino group (including substituted amino group), and a carbamoyl group; and more preferred are an alkyl group, an alkoxy group, and an aryloxy group.

Preferably, the acid dissociation constant (pKa) of the conjugate acid of the pyridine ring moiety of the compound of formula (3), measured in a mixed solution of tetrahydrofuran/water (3/2) at 25° C., is from 3 to 8, more preferably from 4 to 7.

Another preferred example of the heterocyclic compound for use in the invention is a compound of the following formula (4):

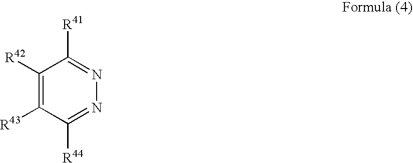

In formula (4), R⁴¹ to R⁴⁴ each independently represent a hydrogen atom or a substituent. R⁴¹ to R⁴⁴ may bond to each other to form a saturated or unsaturated ring. For the examples of the substituent for R⁴¹ to R⁴⁴, referred to are those mentioned hereinabove for the substituent in formula (3). Preferably, the substituent is an alkyl group, an alkenyl group, an alkynyl group, an aryl group, a hydroxyl group, an alkoxy group, an aryloxy group, a heterocyclic-oxy group or a phthalazine ring formed by benzo-condensation. When the carbon atom adjacent to the ring-forming nitrogen atom in the compound of formula (4) is substituted with a hydroxyl group, the compound may form equilibrium to pyridazinone.

More preferably, the compound of formula (4) forms a phthalazine ring of the following formula (12). Even more preferably, the phthalazine ring has at least one substituent.

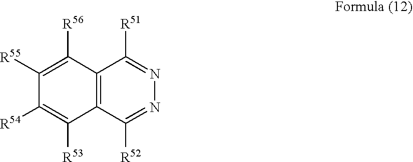

For the examples of R⁵ to R⁵⁶ in formula (12), referred to are those mentioned hereinabove for the substituent in formula (3). Preferably, they are any of an alkyl group, an alkenyl group, an alkynyl group, an aryl group, a hydroxyl group, an alkoxy group, and an aryloxy group.

More preferably, they are any of an alkyl group, an alkenyl group, an aryl group, an alkoxy group and an aryloxy group, even more preferably any of an alkyl group, an alkoxy group and an aryloxy group.

Still another preferred example of the heterocyclic compound for use herein is a compound of the following formula (13):

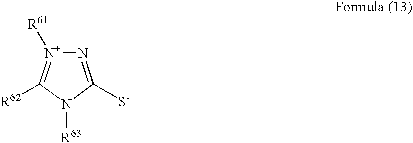

In formula (13), R⁶¹ to R⁶³ each independently represent a hydrogen atom or a substituent. For the examples of the substituent for R⁶², referred to are those mentioned hereinabove for the substituent in formula (3). Examples of the substituent for R⁶¹ and R⁶³ are an alkyl group (including cycloalkyl group), an alkenyl group (including cycloalkenyl group), an alkynyl group, an aryl group, and a heterocyclic group.

Preferably, the substituent is an alkyl group, an alkynyl group, an aryl group or a heterocyclic group, more preferably an alkyl group or an aryl group.

Still another preferred example of the compound for use herein is a compound of the following formula (9):

R⁷¹ —S-(L)ₙ-S—R⁷² Formula (9)

In formula (9), R⁷¹ and R⁷² each independently represent a hydrogen atom or a substituent. L represents a divalent linking group. n indicates 0 or 1. The substituent for R⁷¹ and R⁷² may be any of an alkyl group (including cycloalkyl group), an alkenyl group (including cycloalkenyl group), an alkynyl group, an aryl group, a heterocyclic group, an acyl group, an aryloxycarbonyl group, an alkoxycarbonyl group, a carbamoyl group, an imido group, and a composite substituent comprising any of these. The divalent linking group for L preferably has a length corresponding to from 1 to 6 atoms, more preferably from 1 to 3 atoms, and it maybe further substituted. Preferred examples of the linking group are —CH₂—, —CH₂CH₂—, —CH(CH₃)—, —CH(OH)CH₂—, and —CH(CH₂CH₃) CH₂—.

Preferably, R⁷¹ and R⁷² each are an alkyl group, a hydroxyalkyl group, a mercaptoalkyl group, or a hydroxyalkoxyalkyl group, and L is —CH₂CH₂—, —CH(CH₃)—CH(OH)CH₂—, —CH(CH₂CH₃)CH₂—, or-CH₂CH₂SCH₂CH₂—. More preferably, R⁷¹ and R⁷² each are an alkyl group, a hydroxyalkyl group, or a hydroxyalkoxyalkyl group, and L is —CH₂CH₂—, —CH(OH)CH₂—, —CH(CH₂CH₃)CH₂—, or —CH₂CH₂SCH₂CH₂—.

Still another preferred example of the compound for use in the invention is a compound of the following formula (8):

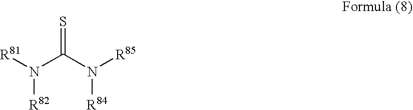

In formula (8), R¹¹ to R¹⁴ each independently represent a hydrogen atom or a substituent. Examples of the substituent for R⁸¹ to R⁸⁴ are an alkyl group (including cycloalkyl group), an alkenyl group (including cycloalkenyl group), an alkynyl group, an aryl group, a heterocyclic group, an acyl group, an aryloxycarbonyl group, an alkoxycarbonyl group, a carbamoyl group, and an imido group.

Preferably, R⁸¹ to R⁸⁴ each are an alkyl group, an alkenyl group, an alkynyl group, an aryl group, or a heterocyclic group, more preferably an alkyl group, an aryl group or a heterocyclic group.

Of the silver iodide complex-forming agents mentioned above, more preferred are the compounds of formulae (3), (4), (12), (13) and (9), and even more preferred are the compounds of formulae (3) and (12).

Preferred examples of the silver iodide complex-forming agents for use in the invention are mentioned below, however, the invention is not limited thereto.

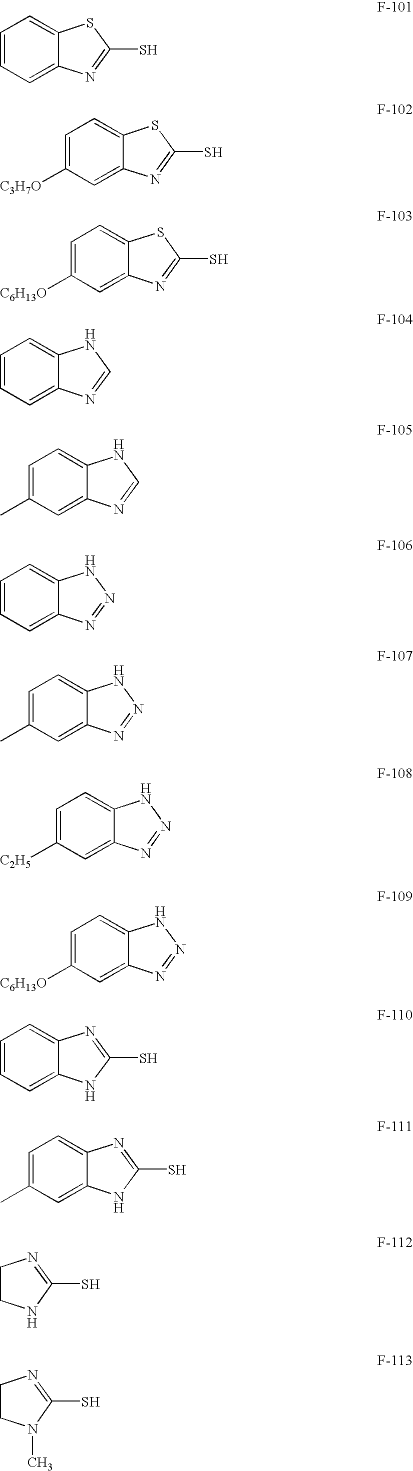

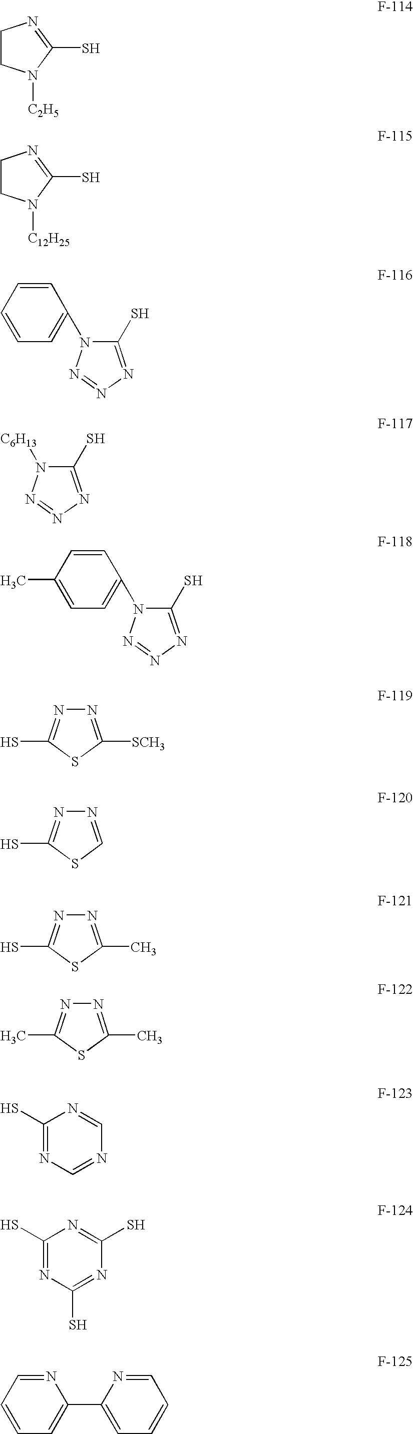

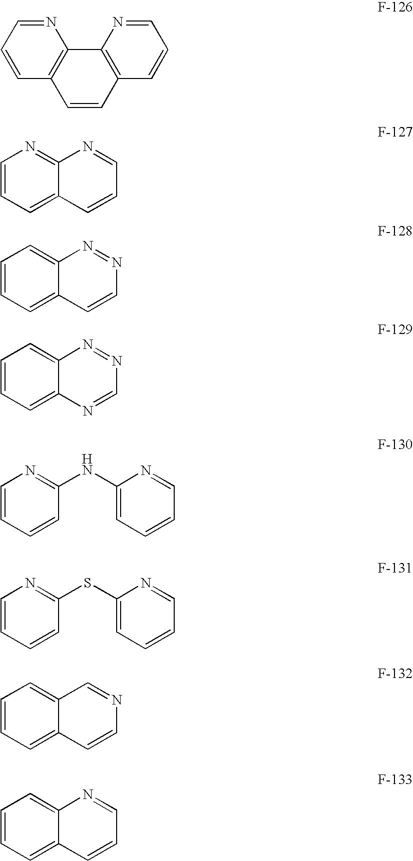

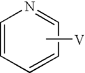

| Compound Code | V |
|---|---|
| F-301 | H |
| F-302 | 4-methyl |
| F-303 | 4-ethyl |
| F-304 | 4-propyl |
| F-305 | 2-methyl |
| F-306 | 2,6-dimethyl |
| F-307 | 3,4-dimethyl |
| F-308 | 2,4-dimethyl |
| F-309 | 3,5-dimethyl |
| F-310 | 2,4,6-trimethyl |
| F-311 | 4-phenyl |
| F-312 | 4-benzyl |
| F-313 | 4-phenethyl |
| F-314 | 4-methoxy |
| F-315 | 4-benzyloxy |
| F-316 | 4-phenoxy |
| F-317 | 4-(4-chlorophenyl)oxy |
| F-318 | 4-(4-chlorobenzyl)oxy |
| F-319 | 4-(4-methylbenzyl)oxy |
| F-320 | 4-(4-methoxybenzyl)oxy |
| F-321 | 4-amino |
| F-322 | 4-dimethylamino |
| F-323 | 2-dimethylamino |
| F-324 | 4-acetylamino |
| F-325 | 4-benzoylamino |
| F-326 | 4-(4-pyridyl) |
| F-327 | 4-phenoxycarbonyl |

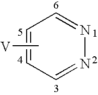

| Compound Code | V |
|---|---|
| F-401 | H |
| F-402 | 4-methyl |
| F-403 | 4,5-dimethyl |
| F-404 | 3,4,5,6-tetramethyl |
| F-405 | 4-phenyl |
| F-406 | 4-nitro |
| F-407 | 4-chloro |
| F-408 | 4-amino |
| F-409 | 4-benzoylamino |
| F-410 | 4-acetylamino |
| F-411 | 4-hydroxy |
| F-412 | 4-methoxy |
| F-413 | 4,5-dimethoxy |
| F-414 | 3-hydroxy |
| F-415 | 3-chloro |
| F-416 | 3-methyl |
| F-417 | 3-methoxy |
| F-418 | 3,6-dihydroxy |
| F-419 | 4-dimethylamino |
| F-420 | 4-acetyl |
| F-421 | the following compound |

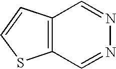

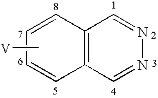

| Compound Code | V |
|---|---|
| F-431 | H |
| F-432 | 1-phenyl |
| F-433 | 1-(4-isopropylphenyl) |
| F-434 | 5-methyl |
| F-435 | 6-methyl |
| F-436 | 5,7-dimethyl |
| F-437 | 6,7-dimethyl |
| F-438 | 5,6,8-trimethyl |
| F-439 | 6-ethyl |
| F-440 | 6-isopropyl |
| F-441 | 6-isobutyl |
| F-442 | 6-propyl |
| F-443 | 6-t-butyl |
| F-444 | 6-sec-butyl |
| F-445 | 6-cyclohexyl |
| F-446 | 6-phenyl |
| F-447 | 6-benzyl |
| F-448 | 6-thienyl |
| F-449 | 6-chloro |
| F-450 | 6-bromo |
| F-451 | 6,7-dichloro |
| F-452 | 5,6,7,8-tetrachloro |
| F-453 | 1-chloro |
| F-454 | 1-methyl |
| F-455 | 6-acetyl |
| F-456 | 6-benzoyl |
| F-457 | 6-carboxy |
| F-458 | 6-methoxycarbonyl |
| F-459 | 6-sulfo |
| F-460 | 6-hydroxy |
| F-461 | 6,7-dihydroxy |
| F-462 | 6-methoxy |
| F-463 | 6,7-dimethoxy |
| F-464 | 6,7-methylenedioxy |
| F-465 | 6-acetoxy |
| F-466 | 5-nitro |
| F-467 | 6-nitro |
| F-468 | 5-amino |
| F-469 | 6-amino |
| F-470 | 5-dimethylamino |
| F-471 | 6-dimethylamino |
| F-472 | 4-(4-isopropylphenyl)-6-isopropyl |
| F-473 | 4-(4-methylphenyl)-6-methyl |
| F-474 | 1,4-dicarboxy |
| F-475 | 1,4-dichloro |
| F-476 | 1,4-di(methoxycarbonyl) |
| F-477 | 1,4-dimethyl |

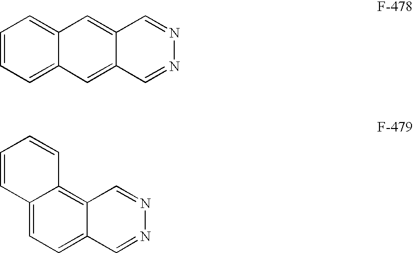

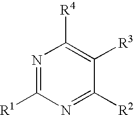

| Compound | R¹ | R² | R³ | R⁴ |
|---|---|---|---|---|
| F-501 | SH | SH | H | H |
| F-502 | SH | SH | H | OH |
| F-503 | SH | SH | H | SH |
| F-504 | SH | SH | H | CO₂H |
| F-505 | SH | SH | NH₂ | CH₃ |
| F-506 | SH | SH | H | CH₂CO₂CH₃ |
| F-507 | SH | SH | H | NCH₃(CH₂CO₂H) |
| F-508 | NCH₃(CH₂CO₂H) | SH | H | SH |
| F-509 | NCH₃(CH₂CO₂Na) | SH | H | SH |
| F-510 | SH | SH | H | NCH₃(CH₂CO₂H) |
| F-511 | SH | SH | H | NH(CH₂)₂CO₂H |
| F-512 | SH | SH | H | CONHCH₂CO₂H |
| F-513 | SH | SH | H | CON(CH₃)CH₂CO₂H |
| F-514 | SH | SH | H | N(CH₃)CH₂CO₂C₂H₅ |
| F-515 | SH | SH | H | NHC₆H₅ |
| F-516 | SH | SH | H | 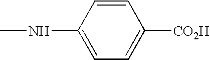 |
| F-517 | SH | SH | H | 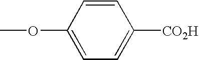 |
| F-518 | SH | SH | H | —OC₆H₁₃ |
| F-519 | SH | SH | H | —N(CH₂CO₂H)₂ |
| F-520 | SH | SH | H | —N(CH₂CO₂C₂H₅)₂ |
| F-521 | SH | SH | H | CONH(CH₂)₃CH₃ |
| F-522 | SH | SH | H | CH₂CO₂C₆H₅ |
| F-523 | SH | SH | H | 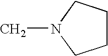 |
| F-524 | SH | SH | H | N(CH₃)CH₂CH₂SO₃Na |

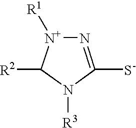

| Compound | R¹ | R² | R³ |
|---|---|---|---|
| F-701 | CH₃ | H | C₂H₅ |
| F-702 | CH₃ | CH₃ | CH₃ |
| F-703 | CH₃ | H | C₃H₇ |
| F-704 | CH₃ | CH₃ | i-C₃H₇ |
| F-705 | CH₃ | H | C₄H₉ |
| F-706 | CH₃ | CH₃ | CH₂SO₃H |
| F-707 | CH₃ | CH₃ | CH₂CO₂H |
| F-708 | CH₃ | CH₃ | NHCO₂C₂H₅ |
| F-709 | CH₃ | CH₃ | NHCO₂C₆H₁₃ |
| F-710 | CH₃ | CH₃ | C₁₂H₂₅ |
| F-711 | CH₃ | CH₂CH₂CO₂CH₃ | CH₃ |
| F-712 | C₆H₅ | CH₃ | CH₃ |
| F-713 | C₆H₅ | H | CH₃ |
| F-714 | t-C₄H₉ | CH₃ | CH₃ |
| F-715 | i-C₃H₇ | CH₃ | CH₃ |
| F-716 | t-C₄H₉ | C₆H₅ | CH₃ |
| F-717 | t-C₄H₉ | CH₃ | C₆H₅ |
| F-718 | CH₃ | CH₃ | C₆H₅ |
| F-719 | CH₃ | H | C₆H₁₃ |
| F-720 | CH₃ | H | C₆H₁₃ |

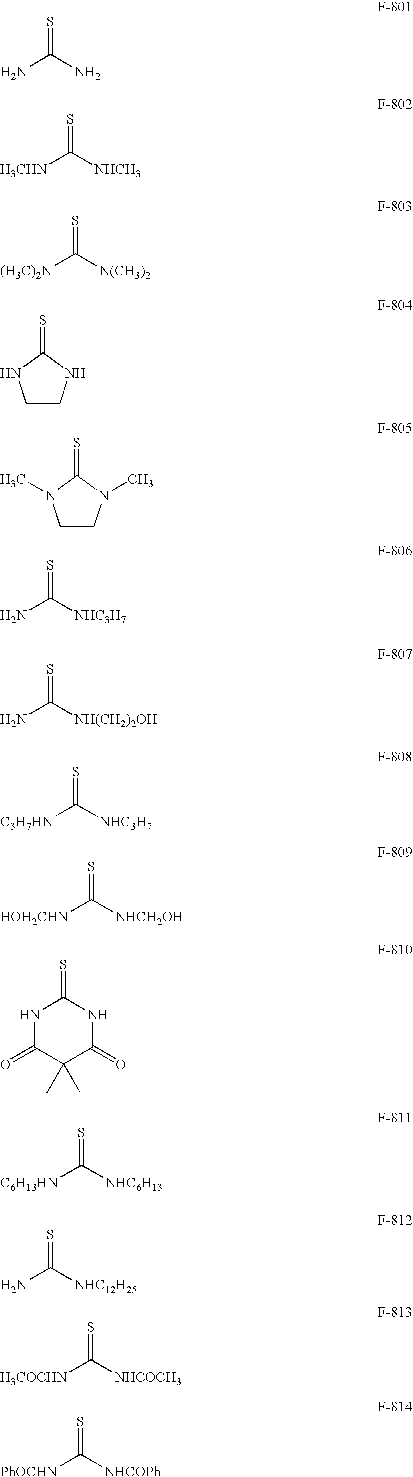

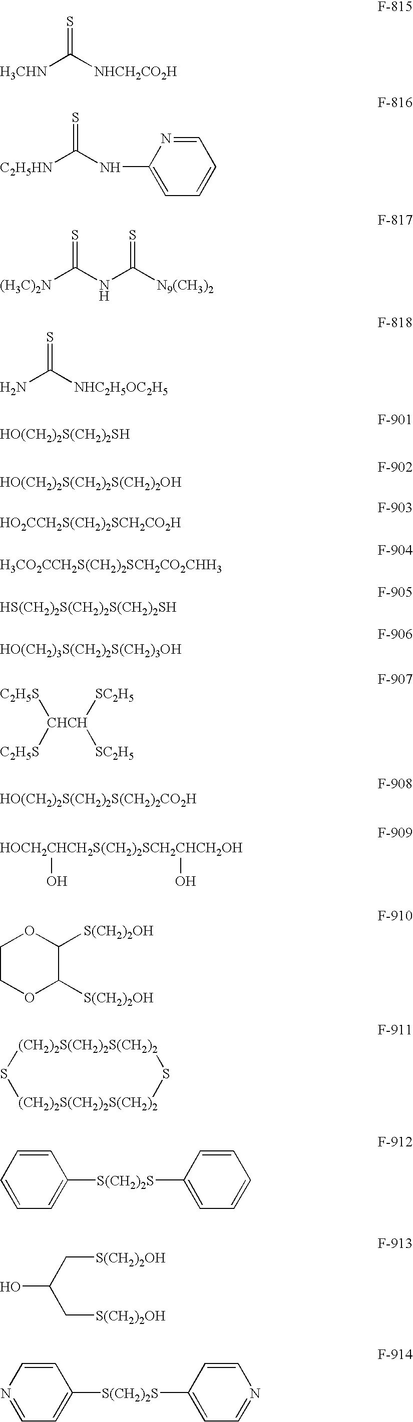

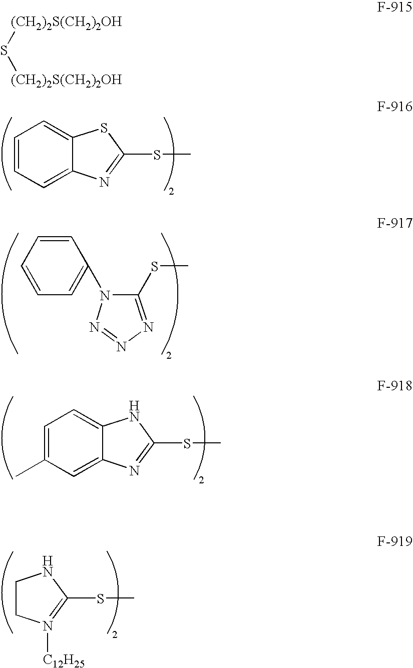

When the silver iodide complex-forming agent for use in the invention has the function as an ordinary color toning agent, it may serve also as a color toning agent. The silver iodide complex-forming agent may be combined with an additional color toning agent. For example, some pyridazine derivatives of formula (4) (e.g., phthalazine) serves as a color toning agent. Though it is known that phthalazine compounds are effective as a color toning agent in heat-developable light-sensitive materials, it is quite unknown that they may function as a silver iodide complex-forming agent as in the present invention. Presence of compounds having the function as a silver iodide complex-forming agent is not recognized at all in the art, and therefore, no compound has heretofore been expected to have the function. When phthalazine compounds are used as a color toning agent, they may be used alone or may be combined with the silver iodide complex-forming agent in the invention to further enhance the advantages of the invention. Of phthalazine compounds, when those having a better function as the silver iodide complex-forming agent in the invention are selected and used herein, it further enhances the advantages of the invention.

In order that the silver iodide complex-forming agent does not have any adverse influence on the raw stock storability of the heat-developable light-sensitive material of the invention and that it is effective without interfering with the image forming reaction in the material, it is desirable that the agent does not react with photosensitive silver halide until it is heated for heat development, but that, after heating, it stepwise reacts with the photosensitive silver halide so that it does not have substantially any influence on the thermal developability of the material. For that purpose, it is desirable that the silver iodide complex-forming agent is separated from photosensitive silver halide in the material, for example, it is present therein as a solid. Also preferably, the agent may be added to separate layers adjacent to photosensitive silver halide-containing layers. Preferably, the melting point of the silver iodide complex-forming agent for use in the invention is so controlled that the agent is solid and does not melt at room temperature or lower but melts when heated at the heat development temperature, or a melting point controlling agent may be added to the silver iodide complex-forming agent to thereby suitably control the melting point of the complex-forming agent.

In the invention, the UV to visible absorption spectrum to be caused by the photosensitive silver halide in the heat-developable light-sensitive material may be measured in a transmission method or a reflection method. When the absorption derived from any other compound in the heat-developable light-sensitive material overlaps with that from the photosensitive silver halide therein, spectral differential or removal of the other compound with a solvent may be employed either alone or in combination to analyze the UV to visible absorption spectrum of the photosensitive silver halide alone.

In the invention, it is desirable that the UV to visible absorption spectrum intensity of the photosensitive silver halide in the thermally-developed heat-developable light-sensitive material is at most 80%, more preferably at most 40%, even more preferably at most 20%, most preferably at most 10% of that of the undeveloped material, in order that the image storability, especially that under exposure to light, of the material may be significantly improved.

The silver iodide complex-forming agent may be in the coating liquids for the material in any form of a solution, an emulsified dispersion or a solid particle dispersion, to add it to the heat-developable light-sensitive material of the invention.

An emulsification and dispersion method is well known in the art for adding the agent to the material, and it comprises dissolving the agent in oil such as dibutyl phthalate, tricresyl phosphate, glyceryl triacetate or diethyl phthalate or in any other auxiliary solvent such as ethyl acetate or cyclohexanone, and mechanically processing it into an emulsified dispersion.

For preparing a solid particle dispersion of the silver iodide complex-forming agent, for example, a powder of the agent is dispersed in a suitable solvent such as water by the use of a ball mill, a colloid mill, a vibration ball mill, a sand mill, a jet mill, a roller mill, or an ultrasonic device to make it into a solid dispersion. In the method, if desired, a protective colloid (e.g., polyvinyl alcohol) or a surfactant (e.g., an anionic surfactant such as sodium triisopropylnaphthalenesulfonate, a mixture of isomers that differ in point of the substituting positions of the three isopropyl groups) may be used. In the above-mentioned mills, generally used are beads of zirconia or the like serving as a dispersion medium, and Zr and the like may dissolve out from the beads into the dispersion produced. Though depending on the dispersion condition, the contaminant concentration may fall between 1 ppm and 1000 ppm. When the Zr content of the heat-developable light-sensitive material of the invention is not larger than 0.5 mg per gram of Ag in the material, it causes no problem for practical use of the material.

The aqueous dispersion of the silver iodide complex-forming agent preferably contains a preservative (e.g., benzoisothiazolinone sodium salt).

More preferably, the silver iodide complex-forming agent is used as a solid dispersion thereof in the invention.

Preferably, the amount of the silver iodide complex-forming agent to be in the heat-developable light-sensitive material of the invention is from 1 to 5000 mol %, more preferably from 10 to 1000 mol %, even more preferably from 50 to 300 mol % relative to the photosensitive silver halide in the material.

Description of Compound of Formula (14):

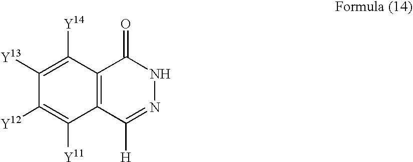

wherein Y¹¹ to Y¹⁴ each independently represent a hydrogen atom, or a substituent which can bond to the benzene ring; at least one of Y¹¹ to Y¹⁴ is the substituent; and Y¹¹ to Y¹⁴ may bond to each other to form a saturated or unsaturated ring.

Examples of the substituent which can bond to the benzene ring are a halogen atom (fluorine atom, chlorine atom, bromine atom, or iodine atom), an alkyl group (linear, branched or cyclic alkyl group including bicycloalkyl group and active methine group), an alkenyl group, an alkynyl group, an aryl group, a heterocyclic group (its substituting position is not defined), an acyl group, an alkoxycarbonyl group, an aryloxycarbonyl group, a heterocyclic-oxycarbonyl group, a carbamoyl group, an N-acylcarbamoyl group, an N-sulfonylcarbamoyl group, an N-carbamoylcarbamoyl group, an N-sulfamoylcarbamoyl group, a carbazoyl group, a carboxy group and its salts, an oxalyl group, an oxamoyl group, a cyano group, a carbonimidoyl group, a formyl group, a hydroxyl group, an alkoxy group (including one that contains repetitive units of ethyleneoxy or propyleneoxy group), an aryloxy group, a heterocyclic-oxy group, an acyloxy group, an (alkoxy or aryloxy)carbonyloxy group, a carbamoyloxy group, a sulfonyloxy group, an amino group, an (alkyl, aryl or heterocyclic)amino group, an acylamino group, a sulfonamido group, an ureido group, a thioureido group, an imido group, an (alkoxy or aryloxy)carbonylamino group, a sulfamoylamino group, a semicarbazido group, an ammonio group, an oxamoylamino group, an N-(alkyl or aryl)sulfonylureido group, an N-acylureido group, an N-acylsulfamoylamino group, a nitro group, a quaternary nitrogen atom-containing heterocyclic group (e.g., pyridinio, imidazolio, quinolinio, isoquinolinio group), an isocyano group, an imino group, an (alkyl or aryl)sulfonyl group, an (alkyl or aryl)sulfinyl group, a sulfo group and its salts, a sulfamoyl group, an N-acylsulfamoyl group, an N-sulfonylsulfamoyl group and its salts, a phosphino group, a phosphinyl group, a phosphinyloxy group, a phosphinylamino group, and a silyl group. The active methine group as referred to herein means a methine group having two electron attractive groups, and in which the electron attractive group includes an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group and a carbonimidoyl group, and in which the two electron attractive groups may bond to each other to form a cyclic structure. The salt includes those with a cation of alkali metals, alkaline earth metals or heavy metals, and those with an organic cation such as ammonium or phosphonium ion. These substituents may further have any of these substituents. The heterocyclic ring may be condensed with any other ring. When the substituent is an anionic group (e.g., —CO₂⁻, —SO₃⁻, —S⁻), the nitrogen-containing heterocyclic ring in the invention may be a cation (e.g., pyridinium, 1,2,4-triazolium) to form an internal salt.

More preferred examples of the substituent are an alkyl group (linear, branched or cyclic alkyl group including bicycloalkyl group and active methine group), an alkenyl group, an alkynyl group, an aryl group, a heterocyclic group (its substituting position is not defined), a hydroxyl group, an alkoxy group (including one that contains repetitive units of ethyleneoxy or propyleneoxy group), an aryloxy group, a heterocyclic-oxy group, an acyloxy group, an (alkoxy or aryloxy)carbonyloxy group, a carbamoyloxy group, a sulfonyloxy group, an amino group, an (alkyl, aryl or heterocyclic)amino group, an acylamino group, a sulfonamido group, an ureido group, a thioureido group, an (alkoxy or aryloxy)carbonylamino group, a sulfamoylamino group, a semicarbazido group, an ammonio group, an oxamoylamino group, an N-(alkyl or aryl)sulfonylureido group, an N-acylureido group, and an N-acylsulfamoylamino group.

Even more preferred examples of the substituent are an alkyl group having from 1 to 10 carbon atoms (e.g., methyl, ethyl, propyl, isopropyl, butyl, isobutyl, s-butyl, t-butyl, pentyl, hexyl, cyclohexyl, octyl, 2-ethylhexyl, benzyl, ethoxyethyl, ethoxyethoxyethyl, hydroxyethoxyethyl), an alkenyl group having from 2 to 10 carbon atoms (e.g., vinyl, allyl, isopropenyl, styryl), an alkynyl group having from 2 to 8 carbon atoms (e.g., ethynyl, propynyl), an aryl group having from 6 to 12 carbon atoms (e.g., phenyl, o-tolyl, m-tolyl, p-tolyl, 2,3-xylyl, 2,4-xylyl, p-cumenyl, mesityl, 4-dimethylaminophenyl, 4-methoxyphenyl), a heterocyclic group having from 1 to 8 carbon atoms (e.g., 2-pyridyl, 3-pyridyl, 4-pyridyl, thienyl, furyl, morpholyl), a hydroxyl group, an alkoxy group having from 1 to 10 carbon atoms (e.g., methoxy, ethoxy, propoxy, butoxy, pentyloxy, hexyloxy, cyclohexyloxy, octyloxyethyleneoxy, ethoxyethoxy, ethoxyethoxyethoxy, hydroxyethoxyethoxy, 2-phenylethoxy), an aryloxy group having from 6 to 12 carbon atoms (e.g., phenoxy, naphthaleneoxy), an amino group having from 0 to 12 carbon atoms (e.g., amino, ethylamino, diethylamino, methylamino, dimethylamino, diisopropylamino), an alkenyloxy group having from 2 to 10 carbon atoms (e.g., vinyloxy, allyloxy, isopropenyloxy), an acylamino group having from 1 to 10 carbon atoms (e.g., acetylamino, propionylamino, benzamido), a sulfonamino group having from 0 to 10 carbon atoms (e.g., benzenesulfonamino, methanesulfonamino, p-toluenesulfonamino), and an acyloxy group (e.g., acetoxy, propionyloxy, benzoxy).

In the invention, the Hammett's rule is preferably employed for the index that indicates the electronic property of the substituent of Y¹¹ to Y¹⁴. The substituent of Y¹¹ to Y¹⁴ is preferably an electron-donating group, and its Hammett's substituent constant up is preferably from −2 to 0. When the compound has multiple substituents, the total sum of the Hammett's substituent constants up of the substituents of Y¹¹ to Y¹⁴ is preferably from −5 to 0. So far as the total sum of up is from −5 to 0, the compound may have a substituent whose up is equal to or more than 0. The Hammett's rule and the definition of the Hammett's substituent constant up are described, for example, in Chemical Review, 1991, Vol. 91, No. 2, pp. 165-195; and concrete data of the constant up are described in Table 1 in that reference.

Preferred examples of compounds of formula (14) for use in the invention are described below, however, the invention is not limited thereto.

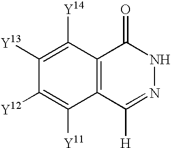

| | | | | | Total Sum |
|---|---|---|---|---|---|
| Compound | Y¹¹ | Y¹² | Y¹³ | Y¹⁴ | of σ p |
| I-1 | CH₃ | H | H | H | −0.17 |
| I-2 | H | CH₃ | H | H | −0.17 |
| I-3 | H | H | CH₃ | H | −0.17 |
| I-4 | H | H | H | CH₃ | −0.17 |
| I-5 | C₂H₅ | H | H | H | −0.15 |
| I-6 | H | C₂H₅ | H | H | −0.15 |
| I-7 | H | H | C₂H₅ | H | −0.15 |
| I-8 | H | H | H | C₂H₅ | −0.15 |
| I-9 | H | C₃H₇ | H | H | −0.13 |
| I-10 | C₃H₇ | H | H | H | −0.13 |
| I-11 | H | H | C₃H₇ | H | −0.13 |
| I-12 | H | H | H | C₃H₇ | −0.13 |
| I-13 | H | i-C₃H₇ | H | H | −0.15 |
| I-14 | H | n-C₄H₉ | H | H | −0.16 |
| I-15 | H | C₆H₅ | H | H | −0.01 |
| I-16 | H | i-C₄H₉ | H | H | −0.12 |
| I-17 | H | t-C₄H₉ | H | H | −0.20 |
| I-18 | H | CH₃ | CH₃ | H | −0.34 |
| I-19 | CH₃ | CH₃ | H | H | −0.34 |
| I-20 | CH₃ | CH₃ | CH₃ | H | −0.51 |
| I-21 | H | C₂H₅ | CH₃ | H | −0.32 |
| I-22 | H | H | i-C₃H₇ | H | −0.15 |
| I-23 | H | H | n-C₄H₉ | H | −0.16 |
| I-24 | H | H | s-C₄H₉ | H | −0.12 |
| I-25 | H | H | i-C₄H₉ | H | −0.12 |
| I-26 | CH₃O | H | H | H | −0.27 |
| I-27 | H | CH₃O | H | H | −0.27 |
| I-28 | H | H | CH₃O | H | −0.27 |
| I-29 | H | H | H | CH₃O | −0.27 |

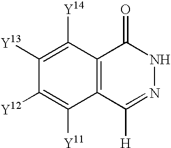

| | | | | | Total Sum |
|---|---|---|---|---|---|
| Compound | Y¹¹ | Y¹² | Y¹³ | Y¹⁴ | of σ p |
| I-30 | C₂H₅O | H | H | H | −0.24 |
| I-31 | H | C₂H₅O | H | H | −0.24 |
| I-32 | H | H | C₂H₅O | H | −0.24 |
| I-33 | H | H | H | C₂H₅O | −0.24 |
| I-34 | C₃H₇O | H | H | H | −0.32 |
| I-35 | H | C₃H₇O | H | H | −0.32 |
| I-36 | H | H | C₃H₇O | H | −0.32 |
| I-37 | H | H | H | C₃H₇O | −0.32 |
| I-38 | H | i-C₃H₇O | H | H | −0.33 |
| I-39 | H | n-C₄H₉O | H | H | −0.34 |
| I-40 | H | CH₃O | CH₃O | H | −0.54 |
| I-41 | CH₃O | CH₃O | H | H | −0.54 |
| I-42 | CH₃O | CH₃O | CH₃O | H | −0.81 |
| I-43 | H | (methylenedioxy) | | H | |
| I-44 | H | n-C₆H₁₃O | H | H | |
| I-45 | H | c-C₆H₁₁O | H | H | |
| I-46 | H | C₄H₉(C₂H₅)CHCH₂O | H | H | |
| I-47 | H | C₆H₅O | H | H | −0.03 |
| I-48 | H | H | C₆H₅O | H | −0.03 |
| I-49 | H | 1-naththoxy | H | H | |
| I-50 | H | 4-chlorophenoxy | H | H | |
| I-51 | H | 4-Methylphenoxy | H | H | |
| I-52 | H | 4-Methoxyphenoxy | H | H | |
| I-53 | H | C₃H₇CO₂— | H | H | |
| I-54 | H | CH₃OC═O— | H | H | |
| I-55 | H | CH₃CO₂— | H | H | |
| I-56 | H | C₆H₅CH═CH— | H | H | |
| I-57 | H | C₆H₅CH₂O— | H | H | |

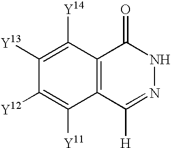

| | | | | | Total Sum |
|---|---|---|---|---|---|
| Compound | Y¹¹ | Y¹² | Y¹³ | Y¹⁴ | of σ p |
| I-58 | H | 4-CH₃—C₆H₅C═ONH— | H | H | |
| I-59 | H | (C₂H₅)₂N— | H | H | −0.72 |
| I-60 | H | NH₂ | H | H | −0.66 |
| I-61 | H | CH₃C═ONH— | H | H | 0.00 |
| I-62 | H | C₆H₅C═ONH— | H | H | −0.19 |
| I-63 | H | n-C₈H₁₇CONH— | H | H | |
| I-64 | H | n-C₈H₁₇SO₂NH— | H | H | |
| I-65 | H | C₆H₅SO₂NH— | H | H | 0.01 |
| I-66 | H | p-CH₃C₆H₄NHCONH— | H | H | |
| I-67 | H | C₆H₅OCONH— | H | H | |
| I-68 | H | H | CH₃OC═O— | H | |
| I-69 | H | H | CH₃CO₂— | H | 0.31 |
| I-70 | H | H | C₆H₅CH═CH— | H | |
| I-71 | H | H | C₆H₅CH₂O— | H | |
| I-72 | H | H | C₆H₅C═ONH— | H | |
| I-73 | H | H | (C₂H₅)₂NC═O— | H | |
| I-74 | H | H | (CH₃)₂N— | H | −0.83 |
| I-75 | H | H | n-C₈H₁₇SO₂NH— | H | |

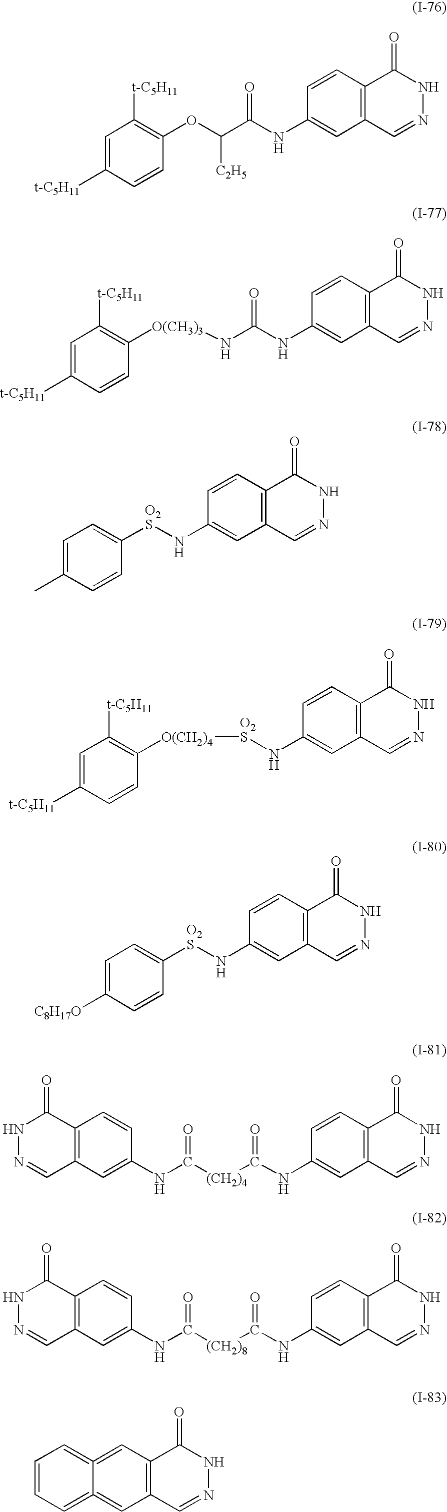

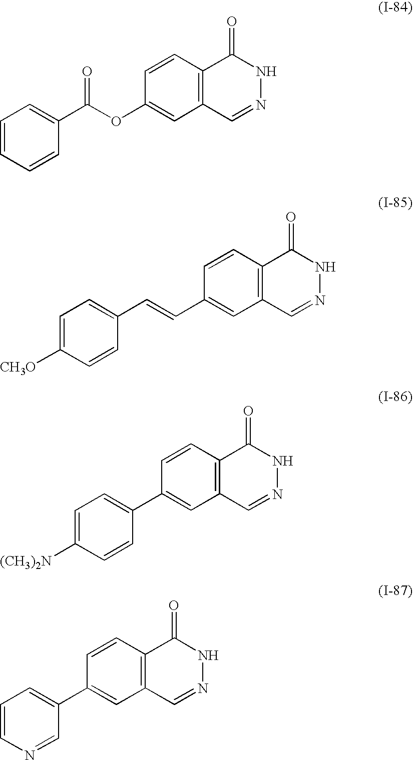

Description of Organic Silver Salt:

1) Composition:

The organic silver salt for use in the invention is relatively stable to light, but, when heated at 80° C. or higher in the presence of an exposed photosensitive silver halide and a reducing agent, it serves as a silver ion donor and forms a silver image. The organic silver salt may be any and every organic substance capable of donating a silver ion that may be reduced by a reducing agent. Some non-photosensitive organic silver salts of that type are described, for example, in JP-A No. 10-62899, paragraphs [0048] to [0049]; EP-A No. 0803764A1, from page 18, line 24 to page 19, line 37; EP-A No. 0962812A1; JP-A Nos. 11-349591, 2000-7683 and 2000-72711. Preferred for use herein are silver salts of organic acids, especially silver salts of long-chain (C10 to C30, preferably C15 to C28) aliphatic carboxylic acids. Preferred examples of silver salts of fatty acids are silver lignocerate, silver behenate, silver arachidate, silver stearate, silver oleate, silver laurate, silver caproate, silver myristate, silver palmitate, silver erucate, and their mixtures. Of the silver salts of fatty acids, especially preferred are those having a silver behenate content of from 30 mol % to 100 mol %, more preferably from 40 mol % to 100 mol %, even more preferably from 50 mol % to 100 mol %, still more preferably from 85 mol % to 100 mol %, further more preferably from 95 mol % to 100 mol %. Also preferred are silver salts of fatty acids having a silver erucate content of at most 2 mol %, more preferably at most 1 mol %, even more preferably at most 0.1 mol %.

Also preferably, the silver stearate content of the organic silver salts is at most 1 mol %. The silver salts of organic acids of the type having a silver stearate content of at most 1 mol % enable the heat-developable light-sensitive material of the invention to have low Dmin, high sensitivity and good image storability. The silver stearate content is more preferably at most 0.5 mol %, even more preferably substantially zero.

When the silver salts of organic acids contains silver arachidate, it is desirable that the silver arachidate content thereof is at most 6 mol %, more preferably at most 3 mol % in order that the heat-developable light-sensitive material may have lower Dmin and better image storability.

2) Shape:

The organic silver salt for use in the invention is not specifically defined for its shape, and may be in any form of acicular, rod-like, tabular or scaly grains.

Scaly organic silver salts are preferred for use in the invention. Also preferred are those having the ratio of major axis/minor axis of 5 or less, including short acicular, rectangular-parallelepiped or cubic grains, and irregular grains such as potato-like grains. These organic silver salt grains are characterized in that they are more effective for preventing fog in heat development of heat-developable light-sensitive materials than long acicular grains having a ratio of major axis/minor axis of 5 or more. In particular, the grains having a ratio of major axis/minor axis of at most 3 are preferred since the mechanical stability of the coated films is good. The scaly organic silver salt is defined as follows: A sample of an organic acid silver salt to be analyzed is observed with an electronic microscope, and the grains of the salt seen in the field are approximated to rectangular parallelopipedons. The three different edges of the thus-approximated, one rectangular parallelopipedone are represented by a, b and c. a is the shortest, c is the longest, and c and b may be the same. From the shorter edges a and b, x is obtained according to the following equation:

x=b/a.

About 200 grains seen in the field are analyzed to obtain the value x, and the data of x are averaged. Samples that satisfy the requirement of x (average)≧1.5 are scaly. For scaly grains, preferably, 30≧x (average)≧1.5, more preferably 15≧x (average)≧1.5. In this connection, the value x of acicular grains falls within a range of 1≦x (average)<1.5.

In the scaly grains, it is understood that a corresponds to the thickness of tabular grains of which the main plane is represented by b×c. In the scaly organic silver salt grains for use herein, a (average) preferably falls between 0.01 μm and 0.3 μm, more preferably between 0.1 μm and 0.23 μm; and c/b (average) preferably falls between 1 and 9, more preferably between 1 and 6, even more preferably between 1 and 4, most preferably between 1 and 3.

When the sphere-corresponding diameter of the organic silver salt grains for use in the invention is from 0.05 μm to 1 μm, then the grains hardly aggregate in the heat-developable light-sensitive material and the image storability of the material is therefore good. The sphere-corresponding diameter is more preferably from 0.1 μm to 1 μm. The sphere-corresponding diameter of the grains may be determined as follows: Using an electronic microscope, a sample of an organic silver salt to be analyzed is directly photographed, and the resulting negative picture is processed and analyzed.

A ratio of sphere-corresponding diameter/a of the scaly grains is defined as an aspect ratio. The aspect ratio of the scaly grains preferably falls between 1.1 and 30, more preferably between 1.1 and 15, since the grains of the type hardly aggregate in the heat-developable light-sensitive material and the image storability of the material is therefore good.

Regarding its grain size distribution, the organic silver salt is preferably a mono-dispersed one. Mono-dispersion of grains referred to herein is such that the value (in terms of percentage) obtained by dividing the standard deviation of the minor axis and the major axis of each grain by the minor axis and the major axis thereof, respectively, is preferably at most 100%, more preferably at most 80%, even more preferably at most 50%. To determine its shape, a dispersion of the organic silver salt may be analyzed on its image taken by the use of a transmission electronic microscope. Another method for analyzing the organic silver salt for mono-dispersion morphology comprises determining the standard deviation of the volume weighted mean diameter of the salt grains. In the method, the value in terms of percentage (coefficient of variation) obtained by dividing the standard deviation by the volume weighted mean diameter of the salt grains is preferably at most 100%, more preferably at most 80%, even more preferably at most 50%. Concretely, for example, a sample of the organic silver salt is dispersed in a liquid, the resulting dispersion is exposed to a laser ray, and the self-correlation coefficient of the salt grains relative to the time-dependent change of the degree of fluctuation of the scattered ray is obtained. Based on this, the grain size (volume weighted mean diameter) of the salt grains is obtained. For the measurement, usable is any commercially-available laser scattering grain size analyzer.

3) Preparation:

For preparing and dispersing the organic acid silver salts for use in the invention, employable is any known method. For it, for example, referred to are JP-A No. 10-62899; EP-A Nos. 0803763A1 and 0962812A1; JP-A Nos. 11-349591, 2000-7683, 2000-72711,2001-163889, 2001-163890, 2001-163827,2001-33907, 2001-188313, 2001-83652, 2002-6442, 2002-49117, 2002-31870, and 2002-107868.

It is desirable that the organic silver salt is dispersed substantially in the absence of a photosensitive silver salt, since the photosensitive silver salt, if any in the dispersing system, will be fogged and its sensitivity will be significantly lowered. For the heat-developable light-sensitive material of the invention, the amount of the photosensitive silver salt that may be in the aqueous dispersion of the organic silver salt is preferably at most 1 mol %, more preferably at most 0.1 mol % relative to one mol of the organic acid silver salt therein, and even more preferably, any photosensitive silver salt is not positively added to the aqueous dispersion.

An aqueous, organic silver salt dispersion may be mixed with an aqueous, photosensitive silver salt dispersion to prepare a coating liquid for the heat-developable light-sensitive material of the invention. The blend ratio of the organic silver salt to the photosensitive silver salt in the mixture may be suitably determined depending on the object of the invention. Preferably, the blend ratio of the photosensitive silver salt to the organic silver salt in the mixture falls between 1 and 30 mol %, more preferably between 2 and 20 mol %, even more preferably between 3 and 15 mol %. Mixing two or more different types of aqueous, organic silver salt dispersions with two or more different types of aqueous, photosensitive silver salt dispersions is preferred for controlling the photographic properties of the resulting mixture.

4) Addition Amount:

The amount of the organic silver salt to be in the heat-developable light-sensitive material of the invention is not specifically defined, and may be any desired one. Preferably, the total amount of all salts including silver halide that may be in the material falls between 0.1 and 5 g/m², more preferably between 0.3 and 3.0 g/m², even more preferably between 0.5 and 2.0 g/m² in terms of the amount of silver in the salts. For better image storability of the heat-developable light-sensitive material, the overall silver amount is preferably at most 1.8 g/m², more preferably at most 1.6 g/m². Using the preferred reducing agent in the invention makes it possible to obtain sufficient image density even though the silver amount in the material falls within such a low range.

Description of Reducing Agent:

The heat-developable light-sensitive material of the invention preferably contains a reducing agent that acts as a heat-developing agent for the organic silver salt therein. The reducing agent for the organic silver salt may be any and every substance capable of reducing silver ions into metal silver, but is preferably an organic substance. Some examples of the reducing agent are described in JP-A No. 11-65021, paragraphs [0043] to [0045] and in EP-A No. 0803764A1, from page 7, line 34 to page 18, line 12.

Preferred for the reducing agent for use in the invention are hindered phenols having an ortho-substituent relative to the phenolic hydroxyl group therein, or bisphenols; and more preferred are compounds of the following formula (R):

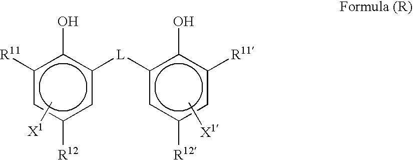

In formula (R), R¹¹ and R^{11′} each independently represent an alkyl group having from 1 to 20 carbon atoms; R¹² and R^{12′} each independently represent a hydrogen atom, or a substituent which can bond to the benzene ring; L represents a group of —S— or —CHR¹³—; R¹³ represents a hydrogen atom or an alkyl group having from 1 to 20 carbon atoms; X¹ and X^{1′} each independently represent a hydrogen atom, or a substituent which can bond to the benzene ring.

Compounds of formula (R) are described in detail.

1) R¹¹ and R^{11′}:

R¹¹ and R¹¹′ each independently represent a substituted or unsubstituted alkyl group having from 1 to 20 carbon atoms. The substituent for the alkyl group is not specifically defined, but preferably includes, for example, an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, an ureido group, an urethane group, and a halogen atom.

2) R¹² and R^{12′}, X¹ and X^{1′}:

R¹² and R^{12′} each independently represent a hydrogen atom, or a substituent which can bond to the benzene ring; and X¹ and X¹ each independently represent a hydrogen atom, or a substituent which can bond to the benzene ring. Preferred examples of the substituent which can bond to the benzene ring are an alkyl group, an aryl group, a halogen atom, an alkoxy group, and an acylamino group.

3) L:

L represents a group of —S— or —CHR¹³—. R¹³ represents a hydrogen atom or an alkyl group having from 1 to 20 carbon atoms. The alkyl group may be substituted. Examples of the unsubstituted alkyl group for R¹³ are methyl, ethyl, propyl, butyl, heptyl, undecyl, isopropyl, 1-ethylpentyl and 2,4,4-trimethylpentyl groups. Examples of the substituent for the alkyl group may be the same as those for R¹¹, including, for example, a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group, and a sulfamoyl group.

4) Preferred Substituents:

For R¹ and R¹¹, preferred is a secondary or tertiary alkyl group having from 3 to 15 carbon atoms, including, for example, isopropyl, isobutyl, t-butyl, t-amyl, t-octyl, cyclohexyl, cyclopentyl, 1-methylcyclohexyl and 1-methylcyclopropyl groups. For R¹¹ and R^{11′}, more preferred is a tertiary alkyl group having from 4 to 12 carbon atoms; even more preferred are t-butyl, t-amyl and 1-methylcyclohexyl groups; and most preferred is a t-butyl group.

For R¹² and R^{12′}, preferred is an alkyl group having from 1 to 20 carbon atoms, including, for example, methyl, ethyl, propyl, butyl, isopropyl, t-butyl, t-amyl, cyclohexyl, 1-methylcyclohexyl, benzyl, methoxymethyl and methoxyethyl groups. More preferred are methyl, ethyl, propyl, isopropyl and t-butyl groups.

For X¹ and X^{1′}, preferred are a hydrogen atom, a halogen atom and an alkyl group; and more preferred is a hydrogen atom.

L is preferably —CHR¹³—.

R¹³ is preferably a hydrogen atom or an alkyl group having from 1 to 15 carbon atoms. For the alkyl group, preferred are methyl, ethyl, propyl, isopropyl and 2,4,4-trimethylpentyl groups. More preferably, R¹³ is a hydrogen atom, a methyl group, a ethyl group, a propyl group or an isopropyl group.

When R¹³ is a hydrogen atom, R¹² and R¹² each are preferably an alkyl group having from 2 to 5 carbon atoms, more preferably an ethyl or propyl group, most preferably an ethyl group. When R¹³ is a primary or secondary alkyl group having from 1 to 8 carbon atoms, R¹² and R¹²′ are preferably both methyl groups. For the primary or secondary alkyl group having from 1 to 8 carbon atoms for R¹³, preferred are methyl, ethyl, propyl and isopropyl groups; and more preferred are methyl, ethyl and propyl groups.

When R¹¹, R^{11′}, R¹² and R^{12′} are all methyl groups, R¹³ is preferably a secondary alkyl group. The secondary alkyl group for R¹³ is preferably any of isopropyl, isobutyl or 1-ethylpentyl group, and more preferably an isopropyl group.

Depending on the combination of the groups R¹¹, R^{11′}, R¹² R^{12′} and R¹³ therein, the reducing agents exhibit different heat-developability and produce different silver tone. Combining two or more different types of the reducing agents makes it possible to control the heat-developability to produce a controlled silver tone. Therefore, combining two or more different types of the reducing agents in the heat-developable light-sensitive material is preferred, depending on the object of the material.

Specific examples of the compounds of formula (R) and other reducing agents for use in the invention are shown below, however, the invention is not limited thereto.

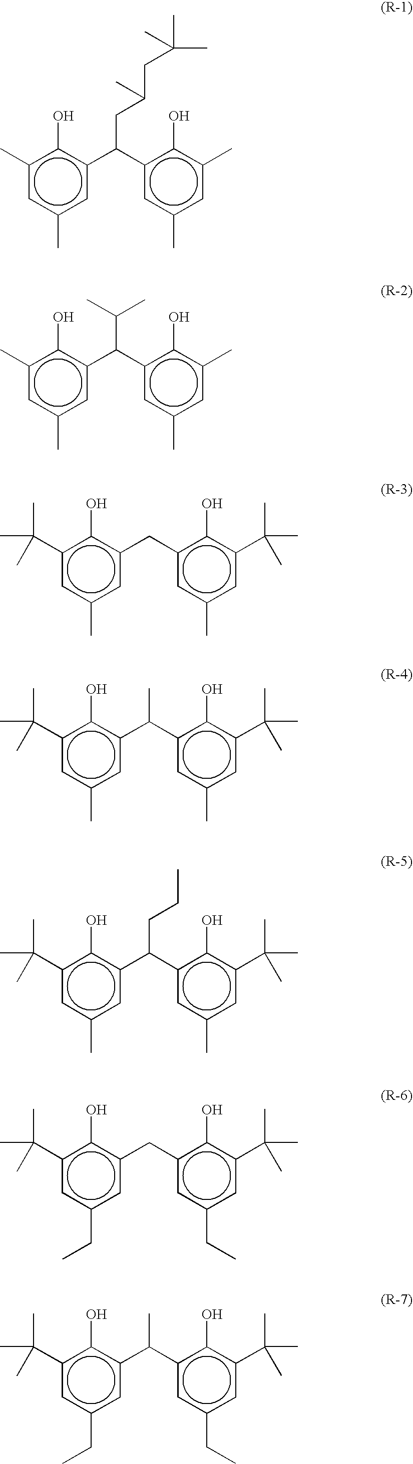

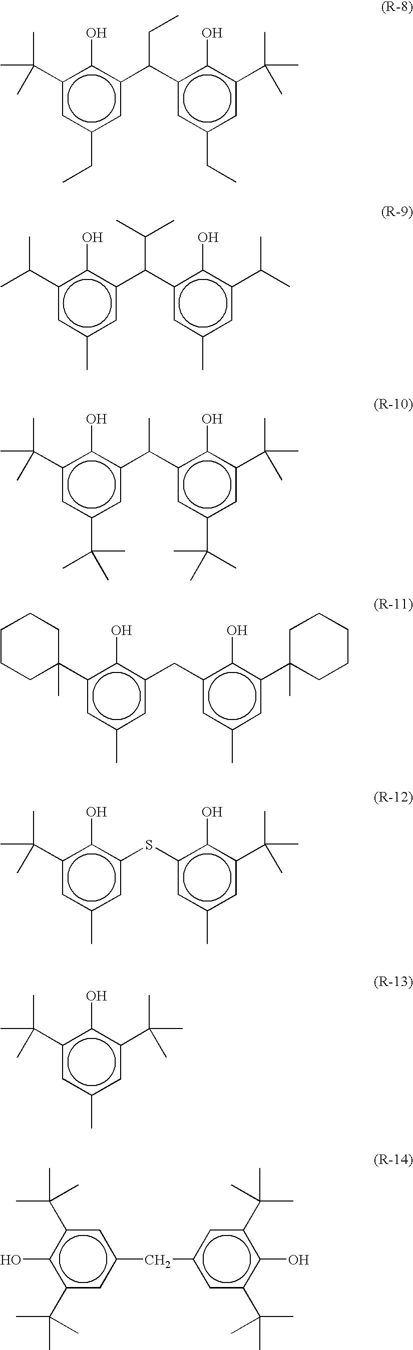

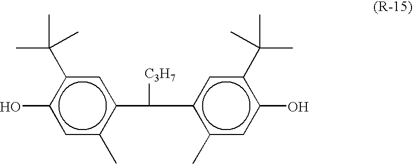

In addition to the above, compounds described in JP-A Nos. 2001-188314, 2001-209145, 2001-350235 and 2002-156727 are also preferred examples of the reducing agent for use in the invention.

In the heat-developable light-sensitive material of the invention, the amount of the reducing agent preferably falls between 0.1 and 3.0 g/m², more preferably between 0.2 and 1.5 g/m², even more preferably between 0.3 and 1.0 g/m². Also preferably, the amount of the reducing agent to be therein falls between 5 and 50 mol %, more preferably between 8 and 30 mol %, even more preferably between 10 and 20 mol %, per mol of silver existing in the face of the image-forming layer of the material. Still preferably, the reducing agent is present in the image-forming layer of the material.

The reducing agent may be in any form of a solution, an emulsified dispersion or a fine solid particle dispersion, and may be added to the coating liquid in any known method so as to be incorporated into the heat-developable light-sensitive material of the invention.

One well known method of emulsifying the reducing agent to prepare its dispersion comprises dissolving the reducing agent in an oily solvent such as dibutyl phthalate, tricresyl phosphate, glyceryl triacetate, diethyl phthalate or the like, or in an auxiliary solvent such as ethyl acetate or cyclohexanone, then mechanically emulsifying the resultant into a dispersion.

For preparing a fine solid particle dispersion of the reducing agent, for example, employable is a method that comprises dispersing a powder of the reducing agent in water or in any other suitable solvent by the use of a ball mill, a colloid mill, a vibration ball mill, a sand mill, a jet mill or a roller mill, or ultrasonic wave to thereby prepare the intended solid dispersion of the reducing agent. In this method, optionally used is a protective colloid (e.g., polyvinyl alcohol), and a surfactant (e.g., an anionic surfactant such as sodium triisopropylnaphthalenesulfonate, a mixture of isomers that differ in point of the substituting positions of the three isopropyl groups). In these mills, generally used are beads of zirconia or the like that serve as a dispersion medium. Zr or the like may dissolve out of the beads and often contaminates the dispersion formed. Depending on dispersion conditions, the contaminant content of the dispersion formed may generally fall between 1 ppm and 1000 ppm. So far as the Zr content of the heat-developable light-sensitive material is not larger than 0.5 mg per gram of silver in the material, the contaminant will cause no practical problem.

Preferably, the aqueous dispersion contains a preservative (e.g., sodium benzoisothiazolinone).

Especially preferred in the invention is preparing a solid particle dispersion of the reducing agent, in which the mean particle size of the reducing agent particles is preferably from 0.01 μm to 10 μm, more preferably from 0.05 μm to 5 μm, even more preferably from 0.1 μm to 2 μm. In the invention, it is desirable that the particle sizes of the other solid dispersions also fall within the range.

Description of Development Promoter:

Preferably, the heat-developable light-sensitive material of the invention contains a development promoter. Preferred examples of the development promoter are sulfonamidophenol compounds in JP-A Nos. 2000-267222 and 2000-330234 (formula (A)); hindered phenol compounds of formula (II) in JP-A No. 2001-92075; hydrazine compounds in JP-A Nos. 10-62895 and 11-15116 (compounds of formula (I)), JP-A No. 2002-156727 (formula (D)) and Japanese Patent Application No. 2001-074278 (formula (1)); and phenol or naphthol compounds of formula (2) in JP-A No. 2001-264929. The amount of the development promoter to be in the material may fall between 0.1 and 20 mol %, preferably between 0.5 and 10 mol %, more preferably between 1 and 5 mol % relative to the reducing agent therein. The development promoter may be introduced into the material in the same manner as the method used for introducing the reducing agent thereinto. Preferably, however, it is added to the material in the form of its solid dispersion or emulsified dispersion. When it is added to the material in the form of its emulsified dispersion, the emulsified dispersion thereof is preferably prepared by emulsifying and dispersing the development promoter in a mixed solvent of a high-boiling point solvent that is solid at room temperature and an auxiliary solvent having a low boiling point; or the emulsified dispersion is preferably an oilless dispersion with no high-boiling-point solvent therein.

For the development promoter for use in the invention, especially preferred are hydrazine compounds of formula (D) in JP-A No. 2002-156727, and phenol or naphthol compounds of formula (2) in JP-A No. 2001-264929.

Preferred examples of the development promoter for use in the invention are compounds of the following formulae (A-1) and (A-2):

Q₁-NHNH-Q₂ (A-1)

wherein Q₁ represents an aromatic or heterocyclic group bonding to NHNH-Q₂ via its carbon atom; Q₂ represents a carbamoyl group, an acyl group, an alkoxycarbonyl group, an aryloxycarbonyl group, a sulfonyl group, or a sulfamoyl group.

In formula (A-1), the aromatic or heterocyclic group for Q₁ is preferably a 5- to 7-membered unsaturated cyclic group. Preferred examples for it are benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isoxazole ring, and thiophene ring; and also preferred are condensed rings of any of those rings.

These rings may be substituted, and when they have 2 or more substituents, the substituents may be the same or different. Examples of the substituents are a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. When these substituents are substitutable ones, they may have further substituents. Preferred examples of the substituents are a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group, and an acyloxy group.

The carbamoyl group for Q₂ preferably has from 1 to 50 carbon atoms, more preferably from 6 to 40 carbon atoms. Examples thereof include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl, and N-benzylcarbamoyl.

The acyl group for Q₂ preferably has from 1 to 50 carbon atoms, more preferably from 6 to 40 carbon atoms. Examples thereof include formyl, acetyl, 2-methylpropanoyl, cyclohexylcarbonyl, octanoyl, 2-hexyldacanoyl, dodecanoyl, chloroacetyl, trifluoroacetyl, benzoyl, 4-dodecyloxybenzoyl, and 2-hydroxymethylbenzoyl. The alkoxycarbonyl group for Q₂ preferably has from 2 to 50 carbon atoms, more preferably from 6 to 40 carbon atoms. Examples thereof include methoxycarbonyl, ethoxycarbonyl, isobutyloxycarbonyl, cyclohexyloxycarbonyl, dodecyloxycarbonyl, and benzyloxycarbonyl.

The aryloxycarbonyl group for Q₂ preferably has from 7 to 50 carbon atoms, more preferably from 7 to 40 carbon atoms. Examples thereof include phenoxycarbonyl, 4-octyloxyphenoxycarbonyl, 2-hydroxymethylphenoxycarbonyl, and 4-dodecyloxyphenoxycarbonyl.

The sulfonyl group for Q₂ preferably has from 1 to 50 carbon atoms, more preferably from 6 to 40 carbon atoms. Examples thereof include methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

The sulfamoyl group for Q₂ preferably has from 0 to 50 carbon atoms, more preferably from 6 to 40 carbon atoms. Examples thereof include unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl.

The groups for Q₂ may be optionally substituted at their substitutable position with any of those mentioned hereinabove for the substituents for the 5- to 7-membered unsaturated rings for Q₁. When they have 2 or more such substituents, the substituents may be the same or different.

Preferred embodiments of the compounds of formula (A-1) are mentioned below. Q₁ is preferably a 5- or 6-membered unsaturated cyclic group, for which more preferred are benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thiazole ring, oxazole ring, isothiazole ring, isoxazole ring, and condensed rings of any of those rings with a benzene ring or an unsaturated heterocyclic ring. Also preferably, Q² is a carbamoyl group, more preferably a carbamoyl group having a hydrogen atom on the nitrogen atom.

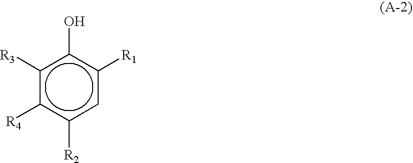

In formula (A-2), R₁ represents an alkyl group, an acyl group, an acylamino group, a sulfonamido group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group, or a carbonate group. R₃ and R₄ each represent a group which can bond to the benzene ring such as those mentioned hereinabove for the substituents in formula (A-1). R₃ and R₄ may bond to each other to form a condensed ring.

R₁ is preferably an alkyl group having from 1 to 20 carbon atoms (e.g., methyl, ethyl, isopropyl, butyl, tert-octyl, cyclohexyl), an acylamino group (e.g., acetylamino, benzoylamino, methylureido, 4-cyanophenylureido), or a carbamoyl group (e.g., n-butylcarbamoyl, N,N-diethylcarbamoyl, phenylcarbamoyl, 2-chlorophenylcarbamoyl, 2,4-dichlorophenylcarbamoyl), and is more preferably an acylamino group (including an ureido group and an urethane group). R₂ is preferably a halogen atom (more preferably, chlorine atom, bromine atom), an alkoxy group (e.g., methoxy, butoxy, n-hexyloxy, n-decyloxy, cyclohexyloxy, benzyloxy), or an aryloxy group (e.g., phenoxy, naphthoxy).

R₃ is preferably a hydrogen atom, a halogen atom, an alkyl group having from 1 to 20 carbon atoms, and is most preferably a halogen atom. R₄ is preferably a hydrogen atom, an alkyl group, or an acylamino group, more preferably an alkyl group or an acylamino group. Examples of these preferred substituents may be the same as those for R₁. When R₄ is an acylamino group, it is also desirable that R₄ bonds to R₃ to form a carbostyryl ring.

In formula (A-2), when R₃ and R₄ bond to each other to form a condensed ring, the condensed ring is especially preferably a naphthalene ring. The naphthalene ring may be substituted with any substituents of those mentioned hereinabove for formula (A-1). When the compound of formula (A-2) is a naphthol compound, R₁ is preferably a carbamoyl group, more preferably a benzoyl group. R₂ is preferably an alkoxy group, or an aryloxy group, more preferably an alkoxy group.

Preferred examples of the development promoter for use in the invention are mentioned below, however, the invention is not limited thereto.

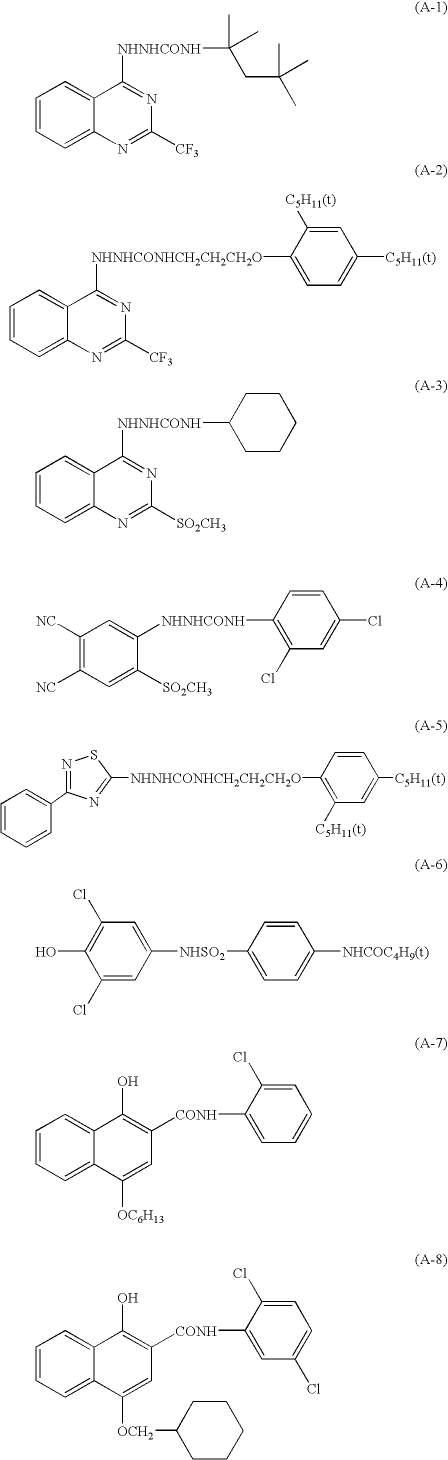

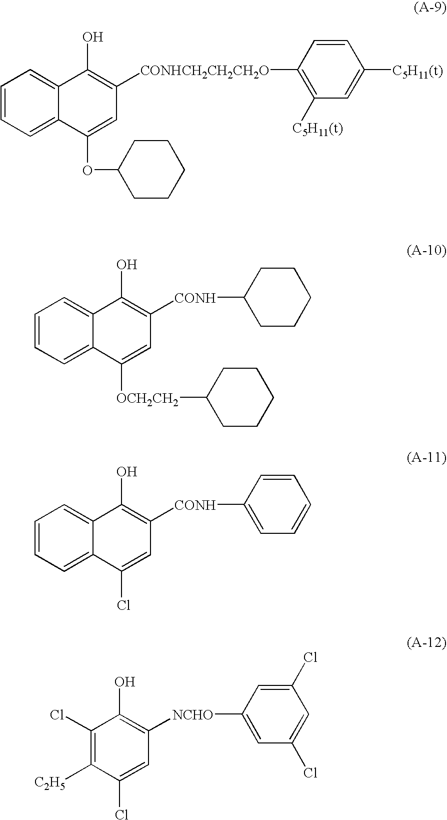

Description of Hydrogen-Bonding Compound:

When the reducing agent for use in the invention has an aromatic hydroxyl group (—OH) or an amino group, especially when it is any of the above-mentioned bisphenols, the reducing agent is preferably combined with a non-reducing compound that has a group capable of forming a hydrogen bond with the group in the reducing agent. The group capable of forming a hydrogen bond with the hydroxyl group or the amino group in the reducing agent includes, for example, a phosphoryl group, a sulfoxide group, a sulfonyl group, a carbonyl group, an amido group, an ester group, an urethane group, an ureido group, a tertiary amino group, and a nitrogen-containing aromatic group. Of those, preferred are a phosphoryl group, a sulfoxide group, an amido group (not having a group of >N—H but is blocked to form >N-Ra, in which Ra is a substituent except hydrogen), an urethane group (not having a group of >N—H but is blocked to form >N-Ra, in which Ra is a substituent except hydrogen), and an ureido group (not having a group of >N—H but is blocked to form >N-Ra, in which Ra is a substituent except hydrogen).

Especially preferred examples of the hydrogen-bonding compound for use in the invention are those of the following formula (D):

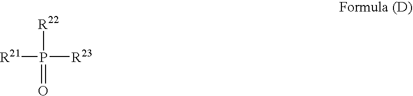

In formula (D), R²¹ to R²³ each independently represent an alkyl group, an aryl group, an alkoxy group, an aryloxy group, an amino group or a heterocyclic group, and these may be unsubstituted or substituted. The substituents for the substituted groups for R²¹ to R²³ are, for example, a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group. Of the substituents, preferred are an alkyl group and an aryl group including, for example, methyl, ethyl, isopropyl, t-butyl, t-octyl, phenyl, 4-alkoxyphenyl and 4-acyloxyphenyl groups.

The alkyl group for R²¹ to R²³ includes, for example, methyl, ethyl, butyl, octyl, dodecyl, isopropyl, t-butyl, t-amyl, t-octyl, cyclohexyl, 1-methylcyclohexyl, benzyl, phenethyl and 2-phenoxypropyl groups. The aryl group includes, for example, phenyl, cresyl, xylyl, naphthyl, 4-t-butylphenyl, 4-t-octylphenyl, 4-anisidyl and 3,5-dichlorophenyl groups. The alkoxy group includes, for example, methoxy, ethoxy, butoxy, octyloxy, 2-ethylhexyloxy, 3,5,5-trimethylhexyloxy, dodecyloxy, cyclohexyloxy, 4-methylcyclohexyloxy and benzyloxy groups. The aryloxy group includes, for example, phenoxy, cresyloxy, isopropylphenoxy, 4-t-butylphenoxy, naphthoxy and biphenyloxy groups. The amino group includes, for example, dimethylamino, diethylamino, dibutylamino, dioctylamino, N-methyl-N-hexylamino, dicyclohexylamino, diphenylamino and N-methyl-N-phenylamino groups.

For R²¹ to R²³, preferred are an alkyl group, an aryl group, an alkoxy group and an aryloxy group. From the viewpoint of the advantages of the invention, it is preferable that at least one of R²¹ to R²³ is an alkyl group or an aryl group, and it is more desirable that at least two of them are any of an alkyl group and an aryl group. Even more preferably, R²¹ to R²³ are the same as the compounds of the type are inexpensive.

Specific examples of the compounds of formula (D) and other hydrogen-bonding compounds usable in the invention are shown below, however, the invention is not limited thereto.)

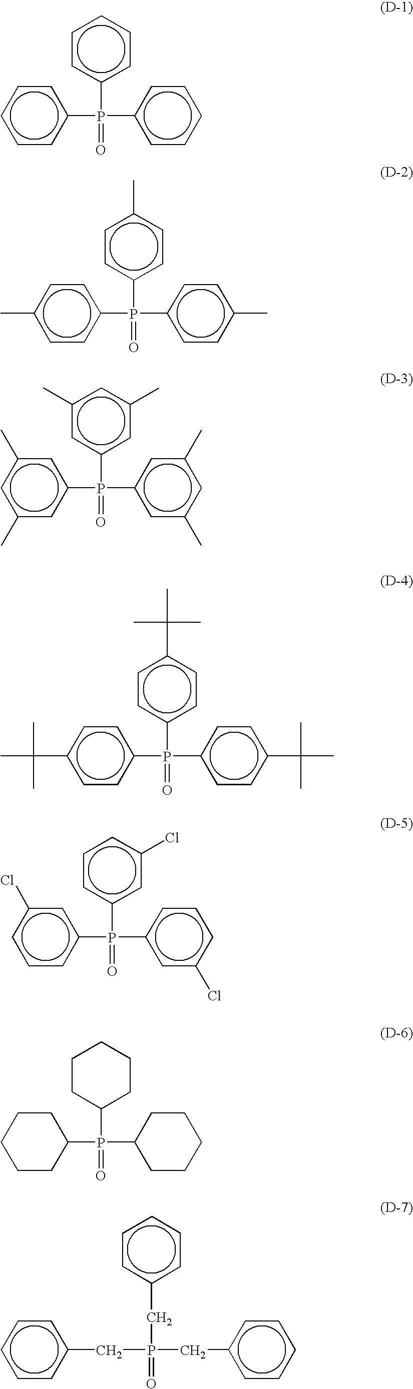

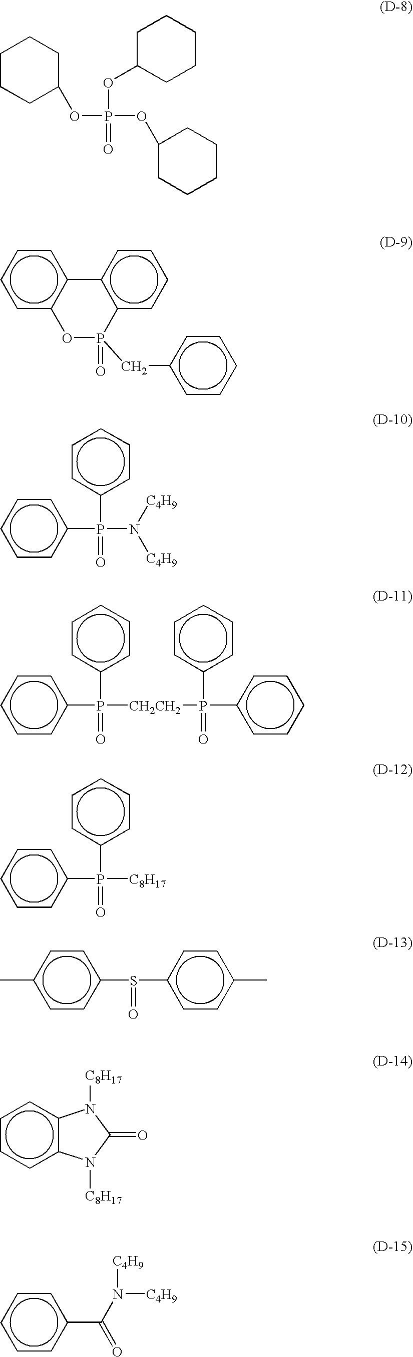

Apart from the above, other hydrogen-bonding compounds such as those described in EP No. 1,096,310, JP-A No. 2002- 156727 and Japanese Patent Application No. 2001-124796 are also usable herein.

Like the reducing agent mentioned above, the compound of formula (D) may be added to the coating liquid for the heat-developable light-sensitive material of the invention, for example, in the form of a solution, an emulsified dispersion or a solid particle dispersion, but preferably it is in the form of a solid particle dispersion. In its solution, the compound of formula (D) may form a hydrogen-bonding complex with a compound having a phenolic hydroxyl group or an amino group. Depending on the combination of the reducing agent and the compound of formula (D) for use herein, the complex may be isolated as its crystal. The isolated crystal powder may be formed into its solid particle dispersion, and the dispersion is especially preferred for use in the invention for stabilizing the heat-developable light-sensitive material of the invention. Also, powders of the reducing agent and the compound of formula (D) may be mixed optionally along with a suitable dispersant added thereto in a sand grinder mill or the like to thereby form the intended complex in the resulting dispersion. The method is also preferred in the invention.

Preferably, the amount of the compound of formula (D) to be added to the reducing agent falls between 1 and 200 mol %, more preferably between 10 and 150 mol %, even more preferably between 20 and 100 mol % relative to the reducing agent.

Description of Silver Halide:

1) Halogen Composition:

The photosensitive silver halide for use in the invention may be silver iodobromide or silver iodochlorobromide having a silver iodide content of at least 5 mol %, or silver iodide. The silver iodide content of the silver halide is preferably from 40 mol % to 100 mol %, more preferably from 90 mol % to 100 mol %. The components other than silver iodide is not specifically defined, and may be selected from silver chloride, silver bromide, silver thiocyanate or silver phosphate. Preferably, it is silver bromide or silver chloride.

Regarding the halogen composition distribution in each silver halide grain, the composition may be uniform throughout the grain, or may stepwise vary, or may continuously vary. Core/shell structured silver halide grains are preferred for use herein. Preferably, the core/shell structure of the grains has from 2 to 5 layers, more preferably from 2 to 4 layers. A technique of localizing silver bromide or silver iodide in the surfaces of silver chloride, silver bromide or silver chlorobromide grains is also preferably employed herein.

2) Method of Grain Formation:

Methods of forming the photosensitive silver halides are well known in the art, and, for example, methods in Research Disclosure 17029 (June 1978), and U.S. Pat. No. 3,700,458 are employable in the invention. Concretely, a silver source compound and a halogen source compound are added to gelatin or any other polymer solution to prepare a photosensitive silver halide, and the photosensitive silver halide is then mixed with an organic silver salt. This method is preferred for the invention. Also preferred are the method described in JP-A No. 11-119374, paragraphs [0217] to [0244]; and the methods described in JP-A Nos. 11-352627 and 2000-347335.

3) Mean Grain Size:

In the first aspect of the invention, the grain size of the photosensitive silver halide must be small in order to prevent the formed images from becoming cloudy. Concretely, it is preferably from 0.001 μm to 0.08 μm, more preferably from 0.005 μm to 0.06 μm, even more preferably from 0.01 μm to 0.04 μm, still more preferably from 0.01 μm to 0.03 μm. The grain size as referred to herein is the diameter of the circular image having the same area as the projected area of each silver halide grain (for tabular grains, the main face of each grain is projected to determine the projected area of the grain).

In the second aspect of the invention, the grain size of the photosensitive silver halide is not specifically defined and may be any one depending on the object of the invention. Especially in this aspect of the invention, the light absorption to be caused by the silver halide in the heat-developable light-sensitive material reduces after heat development of the material, and therefore the grain size of the silver halide grains may be larger than that in the related art.

Concretely, the mean grain size of the photosensitive silver halide in this aspect may fall between 0.001 μm and 5.0 μm, preferably between 0.01 μm and 2.0 μm, more preferably between 0.01 μm and 0.3 μm, even more preferably between 0.01 μm and 0.08 μm. The grain size as referred to herein is the diameter of a sphere having the same volume as that of one silver halide grain. To determine the size thereof, the silver halide grains are observed with an electronic microscope and the grain volume is obtained from the projected area and the thickness of each grain. From the grain volume thus measured, a sphere having the same volume as the measured grain volume is derived, and the diameter thereof is obtained.

In the third aspect of the invention, the grain size of the photosensitive silver halide is not also specifically defined and may be any one depending on the object of the invention. Especially in this aspect of the invention, the light absorption to be caused by the silver halide in the heat-developable light-sensitive material reduces after heat development of the material, and therefore the grain size of the silver halide grains may be larger than that in the related art.

Concretely, the mean grain size of the photosensitive silver halide in this aspect may be up to 5.0 μm, preferably falling between 0.001 μm and 5.0 μm, more preferably between 0.01 μm and 0.3 μm, even more preferably between 0.01 μm and 0.8 μm. The grain size as referred to herein is the diameter of the circular image having the same area as the projected area of each silver halide grain (for tabular grains, the main face of each grain is projected to determine the projected area of the grain).

4) Grain Shape:

The shape of the silver halide grains maybe, for example, cubic grains, octahedral grains, tabular grains, spherical grains, rod-like grains, and potato-like grains. Cubic grains are especially preferred for use in the invention. Also preferred are corner-rounded silver halide grains. The surface index (Miller index) of the outer surface of the photosensitive silver halide grains for use in the invention is not specifically defined, but is desirably such that the proportion of [100] plane, which ensures higher spectral sensitization when it has adsorbed a spectral sensitizing dye, in the outer surface is larger. Preferably, the proportion of [100] plane in the outer surface is at least 50%, more preferably at least 65%, even more preferably at least 80%. The Miller index indicated by the proportion of [100] plane can be obtained according to the method described by T. Tani in J. Imaging Sci., 29, 165 (1985), based on the adsorption dependency of sensitizing dye onto [111] plane and [100] plane.

5) Heavy Metal:

The photosensitive silver halide grains for use in the invention may contain a metal or a metal complex of Groups 8 to 10 of the Periodic Table (including Groups 1 to 18). The metal, or the center metal of the metal complex, which belongs to Groups 8 to 10, is preferably rhodium, ruthenium or iridium. In the invention, one metal complex may be used alone, or two or more metal complexes of the same type of metal or different types of metals may also be used herein in combination. The metal or metal complex content of the grains preferably falls between 1×10⁻⁹ mols and 1×10⁻³ mols per mol of silver. Such heavy metals and metal complexes, and methods of adding them to silver halide grains are described in, for example, JP-A No. 7-225449; JP-A No. 11-65021, paragraphs [0018] to [0024]; and JP-A No. 11-119374, paragraphs [0227] to [0240].

Silver halide grains having a hexacyano-metal complex in their outermost surfaces are preferred for use in the invention. The hexacyano-metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. The hexacyano-Fe complexes are preferred for the grains for use in the invention.

As hexacyano-metal complexes exist in the form of ions in their aqueous solutions, their counter cations are of no importance. Preferably, however, the counter cations for the complexes are any of alkali metal ions such as sodium, potassium, rubidium, cesium and lithium ions; ammonium ions, and alkylammonium ions (e.g., tetramethylammonium, tetraethylammonium, tetrapropylammonium and tetra(n-butyl)ammonium ions), as they are well miscible with water and are favorable to the operation of precipitating silver halide emulsions.

The hexacyano-metal complex may be added to silver halide grains in the form of a solution thereof including water or a mixed solvent of water and an organic solvent miscible with water (for example, alcohols, ethers, glycols, ketones, esters, amides), or in the form of a mixture thereof with gelatin.

The amount of the hexacyano-metal complex to be added to the silver halide grains preferably falls between 1×10₋₅ mols and 1×10⁻² mols, per mol of silver of the grains, more preferably between 1×10⁻⁴ mols and 1×10⁻³ mols.

In order to make the hexacyano-metal complex exist in the outermost surface of the silver halide grains, the complex is directly added to a reaction system after an aqueous silver nitrate solution for forming the silver halide grains is added to the reaction system but before the grains formed are subjected to chemical sensitization such as chalcogen sensitization with sulfur, selenium or tellurium or noble metal sensitization with gold or the like. More specifically, it is directly added to the system before completion of addition of raw materials, during a rinsing step, during a dispersing step, or before the chemical sensitization step. To prevent the silver halide grains formed from growing too much, it is desirable that the hexacyano-metal complex is added to the system immediately after grains are formed. Preferably, the complex is added thereto before completion of addition of raw materials.

Adding the hexacyano-metal complex to the system may be started after 96% by mass of the total of silver nitrate for forming the grains has been added to the reaction system, but is preferably started after 98% by mass of silver nitride has been added thereto, more preferably after 99% by mass thereof has been added thereto.

The hexacyano-metal complex added to the system after an aqueous solution of silver nitrate to be added to the system just before completion of grain formation has been added to the reaction system is well adsorbed by the grains formed, and may well exist in the outermost surfaces of the grains. Most of the complex added in that manner forms a hardly-soluble salt with the silver ions existing in the surfaces of the grains. The silver salt of hexacyano-iron(II) is more hardly soluble than AgI, and the fine grains formed are prevented from re-dissolving. Accordingly, the intended fine silver halide grains having a small grain size can be formed.

The metal atoms (e.g., in [Fe(CN)₆]⁴⁻) that may be contained in the silver halide grains for use in the invention, as well as the methods of desalting or chemical sensitization of the silver halide emulsions are described, for example, in JP-A No. 11-84574, paragraphs [0046] to [0050], JP-A No. 11-65021, paragraphs [0025] to [0031], and JP-A No. 11-119374, paragraphs [0242] to [0250].

6) Gelatin:

Any gelatin may be used in preparing the photosensitive silver halide emulsions for use in the invention. For better dispersion of the photosensitive silver halide emulsion in an organic silver salt-containing coating liquid in producing the heat-developable light-sensitive material of the invention, preferred is gelatin having a molecular weight of from 10,000 to 1,000,000. Also preferably, the substituent in gelatin is phthalated. Gelatin may be used in forming the silver halide grains or in dispersing the grains after the grains have been desalted. Preferably, it is used in forming the grains.

7) Sensitizing Dye:

Sensitizing dyes usable in the invention are those which, after adsorbed by silver halide grains, can spectrally sensitize the grains within a desired wavelength range. Depending on the spectral characteristics of the light source to be used for exposure, favorable sensitizing dyes having good spectral sensitivity are selected for use in the heat-developable light-sensitive material of the invention. For the details of sensitizing dyes usable herein and methods for adding them to the heat-developable light-sensitive material of the invention, referred to are paragraphs [0103] to [0109] in JP-A No. 11-65021; compounds of formula (II) in JP-A No. 10-186572; dyes of formula (I) and paragraph [0106] in JP-A No. 11-119374; dyes described in U.S. Pat. Nos. 5,510,236, 3,871,887 (Example 5); dyes described in JP-A Nos. 2-96131 and 59-48753; from page 19, line 38 to page 20, line 35 of EP-A No. 0803764A1; JP-A Nos. 2001-272747, 2001-290238 and 2002-23306. One or more such sensitizing dyes may be used herein either alone or in combination. Regarding the time at which the sensitizing dye is added to the silver halide emulsion in the invention, it is desirable that the sensitizing dye is added thereto after the desalting step but before the coating step, more preferably after the desalting step but before completion of a chemical ripening step.

The amount of the sensitizing dye to be in the heat-developable light-sensitive material of the invention varies, depending on the sensitivity and the fogging preventive property of the material. In general, it preferably falls between 106 and 1 mol, more preferably between 10⁻⁴ and 101 mols, per mol of the silver halide in the photosensitive layer of the material.

For better spectral sensitization, the heat-developable light-sensitive material of the invention may contain a supersensitizer. For the supersensitizer, for example, usable are the compounds described in EP-A No. 587,338, U.S. Pat. Nos. 3,877,943 and 4,873,184, and JP-A Nos. 5-341432, 11-109547 and 10-111543.

8) Chemical Sensitization:

Preferably, the photosensitive silver halide grains for use in the invention are chemically sensitized with, for example, sulfur, selenium or tellurium. For such sulfur, selenium or tellurium sensitization, any known compounds are usable. For example, preferred are the compounds described in JP-A No. 7-128768. The grains for use in the invention are especially preferably sensitized with tellurium, and more preferably sensitized with the compounds described in JP-A No. 11-65021, paragraph [0030], and the compounds of formulae (II), (III) and (IV) in JP-A No. 5-313284.

Preferably, the photosensitive silver halide grains for use in the invention are chemically sensitized with gold alone or with gold combined with chalcogen. Gold in the gold sensitizer for them preferably has a valence of +1 or +3. Any ordinary gold compounds for gold sensitization are usable herein. Preferred examples of the gold sensitizer for use herein are chloroauric acid, bromoauric acid, potassium chloroaurate, potassium bromoaurate, auric trichloride, potassium auric thiocyanate, potassium iodoaurate, tetracyanoauric acid, ammonium aurothiocyanate, pyridyltrichlorogold. Also preferred for use herein are the gold sensitizers described in U.S. Pat. No. 5,858,637, and Japanese Patent Application No. 2001-79450.

In the invention, the photosensitive silver halides may be chemically sensitized in any stage after their formation but before their coating. For example, they may be chemically sensitized after desalted, but (1) before spectral sensitization, or (2) along with spectral sensitization, or (3) after spectral sensitization, or (4) just before coating.

The amount of the sulfur, selenium or tellurium sensitizer for such chemical sensitization in the invention varies, depending on the type of the photosensitive silver halide grains to be sensitized therewith and the conditions for chemically ripening the grains, but may fall generally between 10⁻⁸ and 10⁻² mols, preferably between 10⁻⁷ and 10⁻³ mols, per mol of the silver halide.

The amount of the gold sensitizer to be added to the silver halide grains also varies depending on various conditions. In general, it may fall between 10⁻⁷ and 10⁻³ mols, preferably between 10⁻⁵ and 5×10⁻⁴ mols, per mol of the silver halide.

Though not specifically defined, the conditions for chemical sensitization in the invention may be such that the pH falls between 5 and 8, the pAg falls between 6 and 11, and the temperature falls between 40 and 95° C.

If desired, a thiosulfonic acid compound may be added to the silver halide emulsions for use in the invention, according to the method described in EP-A No. 293,917.

Preferably, the photosensitive silver halide grains in the invention are processed with a reduction sensitizer. Concretely, preferred examples of the compounds for such reduction sensitization are ascorbic acid, thiourea dioxide, as well as stannous chloride, aminoimimomethanesulfinic acid, hydrazine derivatives, borane compounds, silane compounds and polyamine compounds. The reduction sensitizer may be added to the grains in any stage of preparing the photosensitive emulsions including the stage of grain growth to just before coating the emulsions. Preferably, the emulsions are subjected to such reduction sensitization while they are kept ripened at a pH of 7 or more and at a pAg of 8.3 or less. Also preferably, they may be subjected to reduction sensitization while the grains are formed with a single addition part of silver ions being introduced thereinto.

9) Compound Whose One-Electron Oxidant Formed Through One-Electron Oxidation Can Release One or More Electrons:

Preferably, the heat-developable light-sensitive material of the invention contains a compound whose one-electron oxidant formed through one-electron oxidation can release one or more electrons. The compound may be used alone or in combination with any other various chemical sensitizer such as those mentioned above, and it increases the sensitivity of silver halides.

The compound whose one-electron oxidant formed through one-electron oxidation can release one or more electrons and which may be in the heat-developable light-sensitive material of the invention may be selected from those of the following type 1 to type 5.

Type 1:

Compound whose one-electron oxidant formed through one-electron oxidation may release further 2 or more electrons through subsequent bond cleavage reaction.

Type 2:

Compound whose one-electron oxidant formed through one-electron oxidation may release still another electron through subsequent bond cleavage reaction and which has at least two groups which the silver halide can adsorb in the same molecule.

Type 3:

Compound whose one-electron oxidant formed through one-electron oxidation may release further one or more electrons after subsequent bond formation.

Type 4:

Compound whose one-electron oxidant formed through one-electron oxidation may release further one or more electrons after subsequent intramolecular ring cleavage reaction.

Type 5:

Compound of X-Y in which X indicates a reducing group and Y indicates a leaving group. Its one-electron oxidant formed through one-electron oxidation at the reducing group of X thereof forms a radical X after releasing Y through subsequent X-Y bond cleavage reaction, and releases still another electron from it.

Of the compounds of type 1 and types 3 to 5 mentioned above, preferred are “compounds having in the molecule a group which the silver halide can adsorb” or “compounds having a partial structure of spectral sensitizer in the molecule”. More preferred are “compounds having in the molecule a group which the silver halide can adsorb”. Of the compounds of types 1 to 4, more preferred are “compounds having, as the adsorptive group, a nitrogen-containing heterocyclic group substituted with at least 2 mercapto groups”.

Compounds of types 1 to 5 are described in more detail.

With the compounds of type 1, the “bond cleavage reaction” concretely means carbon-carbon, carbon-silicon, carbon-hydrogen, carbon-boron, carbon-tin or carbon-germanium bond cleavage, which may be accompanied by additional carbon-hydrogen bond cleavage. The compound of type 1 undergoes bond cleavage to release further 2 or more electrons (preferably 3 or more electrons) only after it forms a one-electron oxidant through one-electron oxidation.

Preferred compounds of type 1 are represented by the following formula (A), (B), (15), (16) or (17):

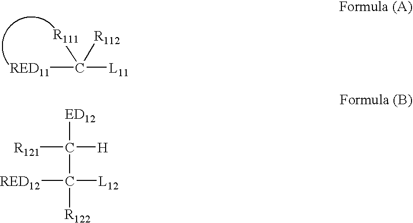

In formula (A), RED₁₁ represents a reducing group capable of undergoing one-electron oxidation, and L₁₁ represents a leaving group. R₁₁₂ represents a hydrogen atom or a substituent. R₁₁₁ represents a non-metallic atomic group capable of forming, along with the carbon atom (C) and RED₁₁, a cyclic structure that corresponds to a tetrahydro, hexahydro or octahydro form of a 5-membered or 6-membered aromatic ring (including aromatic heterocyclic ring).

In formula (B), RED₁₂ represents a reducing group capable of undergoing one-electron oxidation, and L₁₂ represents a leaving group. R₁₂₁ and R₁₂₂ each represent a hydrogen atom or a substituent. ED₁₂ represents an electron-donating group. In formula (B), R₁₂₁ and RED₁₂, R₁₂₁ and R₁₂₂, or ED₁₂ and RED₁₂ may bond to each other to form a cyclic structure.

After one-electron oxidation at the reducing group of RED₁, or RED₁₂ therein, the compound of formula (A) or (B) undergoes bond cleavage reaction to spontaneously release L₁₁ or L₁₂ from it. With that, the compound further releases at least 2, preferably at least 3 electrons.

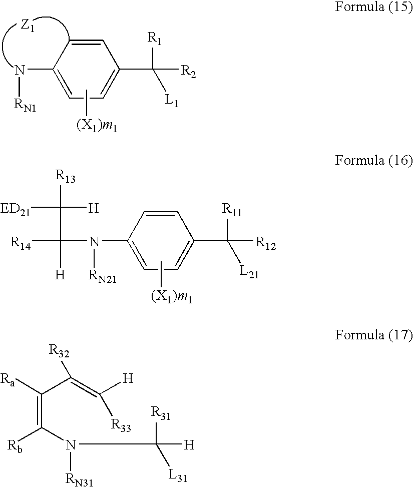

In formula (15), Z₁ represents an atomic group capable of forming a 6-membered ring along with the nitrogen atom and two carbon atoms of the benzene ring; R₁, R₂ and R_{N1} each represent a hydrogen atom or a substituent; X₁ represents a substituent which can bond to the benzene ring; m₁ indicates an integer of from 0 to 3; and L₁ represents a leaving group. In formula (16), ED₂₁ represents an electron-donating group; R₁₁, R₁₂, R_{N21}, R₁₃ and R₁₄ each represent a hydrogen atom or a substituent; X₂₁ represents a substituent which can bond to the benzene ring; m₂₁ indicates an integer of from 0 to 3; and L₂₁ represents a leaving group. R_{N21}, R₁₃, R₁₄, X₂₁ and ED₂₁ may bond to each other to form a cyclic structure. In formula (17), R₃₂, R₃₃, R_{N31}, Rₐ and R_{b} each represent a hydrogen atom or a substituent; and L₃₁ represents a leaving group. However, when R_{N3}1 is a group except an aryl group, Rₐ and R_{b} bond to each other to form an aromatic ring.

After under going one-electron oxidation, these compounds spontaneously release L₁, L₂₁ or L₃₁ through bond cleavage reaction therein, and therefore further release at least 2, preferably at least 3 electrons.

The compounds of formula (A) are described in detail.

In formula (A), the reducing group RED₁₁ capable of undergoing one-electron oxidation is a group bonding to R₁₁₁ to form a specific ring. R₁₁₁ will be described hereinunder. Concretely, the reducing group may be a divalent group that is derived from any of the following monovalent groups by removing one hydrogen atom at a suitable position to form a cyclic structure. For example, the monovalent group includes an alkylamino group, an arylamino group (e.g., anilino, naphthylamino), a heterocyclic amino group (e.g., benzthiazolylamino, pyrrolylamino), an alkylthio group, an arylthio group (e.g., phenylthio), a heterocyclic-thio group, an alkoxy group, an aryloxy group (e.g., phenoxy), a heterocyclic-oxy group, an aryl group (e.g., phenyl, naphthyl, anthranyl), and an aromatic or non-aromatic heterocyclic group (5-membered to 7-membered, monocyclic or condensed-cyclic heterocyclic ring that contains at least one hetero atom of nitrogen, sulfur, oxygen and selenium atoms, and its specific examples are tetrahydroquinoline ring, tetrahydroisoquinoline ring, tetrahydroquinoxaline ring, tetrahydroquinazoline ring, indoline ring, indole ring, indazole ring, carbazole ring, phenoxazine ring, phenothiazine ring, benzothiazoline ring, pyrrole ring, imidazole ring, thiazoline ring, piperidine ring, pyrrolidine ring, morpholine ring, benzimidazole ring, benzimidazoline ring, benzoxazoline ring, methylenedioxyphenyl ring). For convenience sake, RED₁₁ is hereinunder described by the name of the monovalent group that corresponds to it. RED₁₁ may be substituted.

Unless otherwise specifically indicated, the substituent referred to herein is selected from the groups mentioned below. They are a halogen atom, an alkyl group (including aralkyl group, cycloalkyl group, active methine group), an alkenyl group, an alkynyl group, an aryl group, a heterocyclic group (not specifically indicated in point of its substituting position), a quaternary nitrogen atom-containing heterocyclic group (e.g., pyridinio, imidazolio, quinolinio, isoquinolinio), an acyl group, an alkoxycarbonyl group, an aryloxycarbonyl group, a carbamoyl group, a carboxyl group and its salts, a sulfonylcarbamoyl group, an acylcarbamoyl group, a sulfamoylcarbamoyl group, a carbazoyl group, an oxalyl group, an oxamoyl group, a cyano group, a carbonimidoyl group, a thiocarbamoyl group, a hydroxyl group, an alkoxy group (including those that contain repetitive ethyleneoxy or propylene oxy units), an aryloxy group, a heterocyclic-oxy group, an acyloxy group, an (alkoxyoraryloxy)cabonyloxy group, a carbamoyloxy group, a sulfonyloxy group, an amino group, an (alkyl, aryl or heterocyclic)amino group, an acylamino group, a sulfonamido group, an ureido group, a thioureido group, an imido group, an (alkoxy or aryloxy)carbonylamino group, a sulfamoylamino group, a semicarbazido group, a thiosemicarbazido group, a hydrazino group, an ammonio group, an oxamoylamino group, an (alkyl or aryl)sulfonylureido group, an acylureido group, an acylsulfamoylamino group, a nitro group, a mercapto group, an (alkyl, aryl or heterocyclic)thio group, an (alkyl or aryl)sulfonyl group, an (alkyl or aryl)sulfinyl group, a sulfo group and its salts, a sulfamoyl group, an acylsulfamoyl group, a sulfonylsulfamoyl group and its salts, and a phosphoramido or phosphate structure-containing group. These substituents may be further substituted.

RED₁₁ is preferably an alkylamino group, an arylamino group, a heterocyclic amino group, an aryl group, or an aromatic or non-aromatic heterocyclic group, more preferably an arylamino group (especially anilino group) or an aryl group (especially phenyl group). When these groups are substituted, their substituents are preferably any of a halogen atom, an alkyl group, an alkoxy group, a carbamoyl group, a sulfamoyl group, an acylamino group, and a sulfonamido group.

When RED₁₁ is an aryl group, the aryl group preferably has at least one “electron-donating group”. The “electron-donating group” as referred to herein includes a hydroxyl group, an alkoxy group, a mercapto group, a sulfonamido group, an acylamino group, an alkylamino group, an arylamino group, a heterocyclic amino group, an active methine group, a 5-membered, monocyclic or condensed cyclic, electron-rich aromatic heterocyclic group having at least one nitrogen atom in its ring (e.g., indolyl, pyrrolyl, imidazolyl, benzimidazolyl, thiazolyl, benzthiazolyl, indazolyl), and a non-aromatic nitrogen-containing heterocyclic group that bonds to the aryl group via its nitrogen atom (that is referred to as a cyclic amino group such as pyrrolidinyl, indolinyl, piperidinyl, piperazinyl, morpholino). The active methine group also as referred to herein means a methine group substituted with two “electron attractive groups”, and the “electron attractive group” includes an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, an a carbonimidoyl group. The two electron attractive groups may bond to each other to form a cyclic structure.

In formula (A), L₁₁ is concretely a carboxyl group or its salt, a silyl group, a hydrogen atom, a triarylborate anion, trialkylstannyl group, a trialkylgermyl group, or —CR_{C1}R_{C2}R_{C3}. The silyl group is concretely a trialkylsilyl group, an aryldialkylsilyl group or a triarylsilyl group, which may have any desired substituent.

When L₁₁ is a salt of carboxyl group, the counter ion of the salt includes an alkali metal ion, an alkaline earth metal ion, a heavy metal ion, an ammonium ion, and a phosphonium ion, and is preferably an alkali metal ion or an ammonium ion, most preferably an alkali metal ion (especially Li⁺, Na⁺, K⁺).

When L₁₁ is —CR_{C1}R_{C2}R_{C3}, R_{C1}, R_{C2} and R_{C3} each independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group, or a hydroxyl group. They may bond to each other to form a cyclic structure, and may have any desired substituent. However, when one of R_{C1}, R_{C2} and R_{C3} is a hydrogen atom or an alkyl group, the remaining two of them are neither hydrogen atoms nor alkyl groups. Preferably, R_{C1}, R_{C2} and R_{C3} each independently represent an alkyl group, an aryl group (especially phenyl group), an alkylthio group, an arylthio group, an alkylamino group, an arylamino group, a heterocyclic group, an alkoxy group, or a hydroxyl group. Their concrete examples are a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, an N-methylanilino group, a diphenylamino group, a morpholino group, a thiomorpholino group, and a hydroxyl group. Examples of the groups that bond to each other to form a cyclic structure are a 1,3-dithiolan-2-yl group, a 1,3-dithian-2-yl group, an N-methyl-1,3-thiazolidin-2-yl group, and an N-benzyl-benzothiazolidin-2-yl group.

Also preferably, the group —CR_{C1}R_{C2}R_{C3} in which R_{C1}, R_{C2} and R_{C3} are within the preferred range mentioned above may be the same as the residue that is derived from formula (A) by removing L₁₁ from it.

In formula (A), L₁₁ is preferably a carboxyl group or its salt, or a hydrogen atom, more preferably a carboxyl group or its salt.

When L₁₁ is a hydrogen atom, the compound of formula (A) preferably has an inner base moiety. Owing to the action of the inner base moiety therein, the compound of formula (A) is, after oxidized, deprotonated at the hydrogen atom of L₁₁ to release an additional electron from it.

The base is concretely a conjugated base of an acid having a pKa of from about 1 to about 10. For example, it includes nitrogen-containing heterocyclic compounds (e.g., pyridines, imidazoles, benzimidazoles, thiazoles), anilines, trialkylamines, amino groups, carbon acids (e.g., active methylene anion), thioacetate anion, carboxylate (—COO⁻), sulfate (—SO₃⁻), and amine oxide (>N⁺(O⁻)—). Preferably, it is a conjugated base of an acid having a pKa of from about 1 to about 8, more preferably a carboxylate, a sulfate, or an amine oxide, even more preferably a carboxylate. When the base has an anion, it may have a counter cation. Examples of the counter cation are alkali metal ions, alkaline earth metal ions, heavy metal ions, ammonium ions, and phosphonium ions. The base may bond to the compound of formula (A) at any desired position. The base moiety bonding site may be any of RED₁₁, R₁₁₁ and R₁₁₂ of formula (A), or the moiety may bond to the substituent of these group.

In formula (A), R₁₁₂ represents a hydrogen atom or a substituent which can bond to the carbon atom. However, R₁₁₂ must not be the same as L₁₁.

R₁₁₂ is preferably a hydrogen atom, an alkyl group, an aryl group (e.g., phenyl group), an alkoxy group (e.g., methoxy group, ethoxy group, benzyloxy group), a hydroxyl group, an alkylthio group (e.g., methylthio group, butylthio group), an amino group, an alkylamino group, an arylamino group, or a heterocyclic amino group, more preferably a hydrogen atom, an alkyl group, an alkoxy group, a hydroxyl group, a phenyl group, or an alkylamino group.

In formula (A), the cyclic structure which R₁₁₁ forms is a cyclic structure that corresponds to a tetrahydro form, a hexahydro form or an octahydro form of a 5-membered or 6-membered aromatic ring (including aromatic heterocyclic ring). The “hydro form” as referred to herein means a partly-hydrogenated cyclic structure of an aromatic ring (including aromatic heterocyclic ring) in which the carbon-carbon double bond (or carbon-nitrogen double bond) inside it is partly hydrogenated. Two, three or four carbon-carbon double bonds (or carbon-nitrogen double bonds) are hydrogenated to give the corresponding tetrahydro, hexahydro or octahydro form, respectively. The hydrogenated aromatic ring has a partly-hydrogenated non-aromatic cyclic structure.

Concretely, it includes pyrrolidine ring, imidazolidine ring, thiazolidine ring, pyrazolidine ring, oxazolidine ring, piperidine ring, tetrahydropyridine ring, tetrahydropyrimidine ring, piperazine ring, tetralin ring, tetrahydroquinoline ring, tetrahydroisoquinoline ring, tetrahydroquinazoline ring, tetrahydroquinoxaline ring, tetrahydrocarbazole ring, and octahydrophenanthridine ring. These cyclic structure may have any desired substituent.

The cyclic structure which R₁₁₁ forms is more preferably pyrrolidine ring, imidazolidine ring, piperidine ring, tetrahydropyridine ring, tetrahydropyrimidine ring, piperazine ring, tetrahydroquinoline ring, tetrahydroisoquinoline ring, tetrahydroquinazoline ring, tetrahydroquinoxaline ring, or tetrahydrocarbazole ring, even more preferably pyrrolidine ring, piperidine ring, piperazine ring, tetrahydropyridine ring, tetrahydroquinoline ring, tetrahydroisoquinoline ring, tetrahydroquinazoline ring, or tetrahydroquinoxaline ring, most preferably pyrrolidine ring, piperidine ring, tetrahydropyridine ring, tetrahydroquinoline ring, or tetrahydroisoquinoline ring.

In formula (B), RED₁₂ and L₁₂ have the same meanings as RED₁₁ and L₁₁ in formula (A), respectively, and their preferred ranges may also be the same as those of the latter. However, RED₁₂ is a monovalent group except that it forms the cyclic structure mentioned below, concretely including the monovalent groups mentioned hereinabove for RED₁₁. R₁₂₁ and R₁₂₂ have the same meanings as R₁₁₂ in formula (A), and their preferred ranges may also be the same as those of the latter. ED₁₂ represents an electron-donating group. R₁₂₁ and RED₁₂, R₁₂₁ and R₁₂₂, or ED₁₂ and RED₁₂ may bond to each other to form a cyclic structure.

In formula (B), the electron-donating group for ED₁₂ may be the same as that mentioned hereinabove for the substituent for the aryl group for RED₁₁. ED₁₂ is preferably a hydroxyl group, an alkoxy group, a mercapto group, a sulfonamido group, an alkylamino group, an arylamino group, an active methine group, a 5-membered, monocyclic or condensed cyclic, electron-rich aromatic heterocyclic group having at least one nitrogen atom in its ring, a non-aromatic nitrogen-containing heterocyclic group that bonds to the compound via its nitrogen atom, or a phenyl group substituted with such an electron-donating group, more preferably a hydroxyl group, a mercapto group, a sulfonamido group, an alkylamino group, an arylamino group, an active methine group, a non-aromatic nitrogen-containing heterocyclic group that bonds to the compound via its nitrogen atom, or a phenyl group substituted with such an electron-donating group (e.g., p-hydroxyphenyl, p-dialkylaminophenyl, o,p-dialkoxyphenyl).

In formula (B), R₁₂₁ and RED₁₂, R₁₂₂ and R₁₂₁, or ED₁₂ and RED₁₂ may bond to each other to form a cyclic structure. The cyclic structure to be formed herein is a non-aromatic, carbocyclic or heterocyclic, 5-membered to 7-membered, monocyclic or condensed cyclic, substituted or unsubstituted ring structure. When R₁₂₁ and RED₁₂ form a cyclic structure, its specific examples include the above-mentioned examples of the cyclic structure which R₁₁₁ forms in formula (A) and, in addition to these, pyrroline ring, imidazoline ring, thiazoline ring, pyrazoline ring, oxazoline ring, indane ring, morpholine ring, indoline ring, tetrahydro-1,4-oxazine ring, 2,3-dihydrobenzo-1,4-oxazine ring, tetrahydro-1,4-thiazine ring, 2,3-dihydrobenzo-1,4-thiazine ring, 2,3-dihydrobenzofuran ring, and 2,3-dihydrobenzothiophene ring. When ED₁₂ and RED₁₂ form a cyclic structure, ED₁₂ is preferably an amino group, an alkylamino group, or an arylamino group, and the specific examples of the cyclic structure to be formed are tetrahydropyrazine ring, piperazine ring, tetrahydroquinoxaline ring, and tetrahydroisoquinoline ring. When R₁₂₂ and R₁₂₁ form a cyclic structure, its specific examples are cyclohexane ring and cyclopentane ring.

Next described are formulae (15) to (17).

In formulae (15) to (17), R₁, R₂, R₁₁, R₁₂ and R₃₁ have the same meanings as R₁₁₂ in formula (A), and their preferred range may also be the same as that of the latter. L₁, L₂₁ and L₃₁ indicate the same leaving group as that mentioned hereinabove for the specific examples for L₁₁ in formula (A), and their preferred range may also be the same as that of the latter. The substituents for X₁ and X₂₁ are the same as the examples of the substituent of the substituted RED₁₁ in formula (A), and their preferred range may also be the same as that of the latter. m₁ and m₂₁ are preferably an integer of from 0 to 2, more preferably 0 or 1.

When R_{N1}, R_{N21} and R_{N31} are substituents, they are preferably any of an alkyl group, an aryl group and a heterocyclic group, and these may further have any desired substituent. Preferably, R_{N1}, R_{N21} and R_{N31} are any of a hydrogen atom, an alkyl group and an aryl group, more preferably a hydrogen atom or an alkyl group.

When R₁₃, R₁₄, R₃₃, Rₐ and R_{b} are substituents, they are preferably any of an alkyl group, an aryl group, an acyl group, an alkoxycarbonyl group, a carbamoyl group, a cyano group, an alkoxy group, an acylamino group, a sulfonamido group, an ureido group, a thioureido group, an alkylthio group, an arylthio group, an alkylsulfonyl group, an arylsulfonyl group, and a sulfamoyl group.

In formula (15), the 6-membered ring which Z₁ forms is a non-aromatic heterocyclic ring condensed with the benzene ring in formula (15). The concrete ring structure in which Z1 is condensed with the benzene ring includes tetrahydroquinoline ring, tetrahydroquinoxaline ring and tetrahydroquinazoline ring. Preferably, it is tetrahydroquinoline ring or tetrahydroquinoxaline ring. The ring structure may have any substituent.

In formula (16), ED₂₁ has the same meaning as ED₁₂ in formula (B), and its preferred range may also be the same as that of the latter.

In formula (16), any two of R_{N21}, R₁₃, R₁₄, X₂₁ and ED₂₁ may bond to each other to form a cyclic structure. The cyclic structure which R_{N21} and X₂₁ bonding to each other form is preferably a 5-membered to 7-membered, non-aromatic, carbocyclic or heterocyclic ring condensed with the benzene ring, and its specific examples are tetrahydroquinoline ring, tetrahydroquinoxaline ring, indoline ring, and 2,3-dihydro-5,6-benzo-1,4-thiazine ring. Preferably, it is tetrahydroquinoline ring, tetrahydroquinoxaline ring, or indoline ring.

In formula (17), when R_{N31} is a group except an aryl group, Rₐ and R_{b} bond to each other to form an aromatic ring. The aromatic ring includes an aryl group (e.g., phenyl group, naphthyl group), and an aromatic heterocyclic group (e.g., pyridine ring, pyrrole ring, quinoline ring, indole ring), and is preferably an aryl group. The aromatic group may have any desired substituent.

Preferably in formula (17), Rₐ and R_{b} bond to each other to form an aromatic ring (especially phenyl group).

In formula (17), R₃₂ is preferably a hydrogen atom, an alkyl group, an aryl group, a hydroxyl group, an alkoxy group, a mercapto group, or an amino group. When R₃₂ is a hydroxyl group, R₃₃ is preferably an electron attractive group, and this is one preferred embodiment of the invention. The “electron attractive group” is the same as that mentioned hereinabove, and is preferably an acyl group, an alkoxycarbonyl group, a carbamoyl group or a cyano group.

Next described are the compounds of type 2.

In the compounds of type 2, the “bond cleavage resction” means interelemental cleavage of carbon-carbon bond, carbon-silicon bond, carbon-hydrogen bond, carbon-boron bond, carbon-tin bond or carbon-germanium bond, which may be accompanied by carbon-hydrogen bond cleavage.

The compound of type 2 has at least two (preferably from 2 to 6, more preferably from 2 to 4) groups adsorptive to silver halide. More preferably, it has at least two, mercapto-substituted nitrogen-containing heterocyclic groups as such groups. The number of the groups adsorptive to silver halide is preferably from 2 to 6, more preferably from 2 to 4. The groups adsorptive to silver halide will be described later.

Preferred compounds of type 2 are represented by the following formula (C):

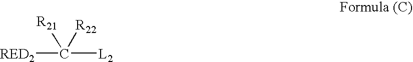

In the compounds of formula (C), the reducing group of RED₂ undergoes one-electron oxidation, and then spontaneously releases L₂ through bond cleavage reaction and further releases another electron.

In formula (C), RED₂ has the same meaning as RED₁₂ in formula (B), and its preferred range may also be the same as that of the latter. L₂ has the same meaning as L₁₁ in formula (A), and its preferred range may also be the same as that of the latter. When L₂ is a silyl group, the compound has in its molecule at least two, mercapto-substituted nitrogen-containing heterocyclic groups as the groups adsorptive to silver halide. R₂₁ and R₂₂ each represent a hydrogen atom or a substituent, and they have the same meaning as R₁₁₂ in formula (A). Their preferred range may also be the same as that of the latter. RED₂ and R₂₁ may bond to each other to form a cyclic structure.

The cyclic structure to be formed herein is a 5-membered to 7-membered, monocyclic or condensed cyclic, non-aromatic carbocyclic or heterocyclic structure which may be optionally substituted. However, the cyclic structure does not correspond to a tetrahydro, hexahydro or octahydro form of an aromatic ring or an aromatic heterocyclic ring. Preferably, the cyclic structure corresponds to a dihydro form of an aromatic ring or an aromatic heterocyclic ring. Its specific examples are 2-pyrroline ring, 2-imidazoline ring, 2-thiazoline ring, 1,2-dihydropyridine ring, 1,4-dihydropyridine ring, indoline ring, benzimidazoline ring, benzothiazoline ring, benzoxazoline ring, 2,3-dihydrobenzothiophene ring, 2,3-dihydrobenzofuran ring, benzo-α-pyran ring, 1,2-dihydroquinoline ring, 1,2-dihydroquinazoline ring, and 1,2-dihydroquinoxaline ring. Preferred are 2-imidazoline ring, 2-thiazoline ring, indoline ring, benzimidazoline ring, benzothiazoline ring, benzoxazoline ring, 1,2-dihydropyridine ring, 1,2-dihydroquinoline ring, 1,2-dihydroquinazoline ring, and 1,2-dihydroquinoxaline ring; and more preferred are indoline ring, benzimidazoline ring, benzothiazoline ring, and 1,2-dihydroquinoline ring; and even more preferred is indoline ring.

Next described are the compounds of type 3.

In the compounds of type 3, the step of “bond formation” means interatomic bond formation of, for example, carbon-carbon bond, carbon-nitrogen bond, carbon-sulfur bond or carbon-oxygen bond.

Preferably, the compound of type 3 is as follows: Its one-electron oxidant formed through one-electron oxidation of the compound reacts with the reactive group site existing inside the same molecule (carbon-carbon double bond site, carbon-carbon triple bond site, aromatic group site, or benzo-condensed non-aromatic heterocyclic group site) to form a bond, and then the resultant further releases one or more electrons.

More precisely, the compound of type 3 is characterized in that its one-electron oxidant formed through one-electron oxidation of the compound (cationic radical species, or neutral radical species that is formed through proton release from the cationic radical species) reacts with the above-mentioned reactive group existing inside the same molecule to thereby form a bond, and a cyclic structure-having radical species is newly formed in the molecule. From this radical species, a second electron is released directly or along with proton release.

Some compounds of type 3 are as follows: The resulting two-electron oxidant may be hydrolyzed or may cause a tautomerization reaction that is accompanied by direct proton movement to thereby further release one or more, generally at least two electrons. Some other compounds of type 3 do not cause such tautomerization. Concretely, the two-electron oxidant of the type has the ability to directly release one or more, generally at least two electrons.

Preferably, the compounds of type 3 are represented by the following formula (D-1).

RED₃-L₃-Y₃ Formula (D-1)

In formula (D-1), RED₃ represents a one-electron oxidizable reducing group; and Y₃ represents a reactive group site that reacts with a reactant after one-electron oxidation of RED₃. Concretely, Y₃ is an organic group that contains a carbon-carbon double bond site, a carbon-carbon triple bond site, an aromatic group site, or a benzo-condensed non-aromatic heterocyclic group site. L₃ represents a linking group that links RED₃ and Y₃.

RED₃ has the same meaning as RED₁₂ in formula (B), and is preferably an arylamino group, a heterocyclic amino group, an aryloxy group, an arylthio group, an aryl group, or an aromatic or non-aromatic heterocyclic group (especially preferably nitrogen-containing heterocyclic group), more preferably an arylamino group, a heterocyclic amino group, an aryl group, or an aromatic or non-aromatic heterocyclic group. The heterocyclic group is preferably a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a pyrrole ring group, an imidazole ring group, a thiazole ring group, a benzimidazole ring group, a benzimidazoline ring group, a benzothiazoline ring group, or a 3,4-methylenedioxyphenyl-1-yl group.

RED₃ is more preferably an arylamino group (especially anilino group), an aryl group (especially phenyl group), or an aromatic or non-aromatic heterocyclic group.

When RED₃ is an aryl group, the aryl group preferably has at least one “electron-donating group”. The “electron-donating group” is the same as that mentioned hereinabove.

When RED₃ is an aryl group, the substituent for the aryl group is more preferably an alkylamino group, a hydroxyl group, an alkoxy group, a mercapto group, a sulfonamido group, an active methine group, or a non-aromatic nitrogen-containing heterocyclic group that bonds to the aryl group at the nitrogen atom thereof, more preferably an alkylamino group, a hydroxyl group, an active methine group, or a non-aromatic nitrogen-containing heterocyclic group that bonds to the aryl group at the nitrogen atom thereof, most preferably an alkylamino group, or a non-aromatic nitrogen-containing heterocyclic group that bonds to the aryl group at the nitrogen atom thereof.

When the organic group for Y₃ that contains a carbon-carbon double bond site (e.g., vinyl group) is substituted, its substituent is preferably any of an alkyl group, a phenyl group, an acyl group, a cyano group, an alkoxycarbonyl group, a carbamoyl group, and an electron-donating group. The electron-donating group is preferably an alkoxy group, a hydroxyl group (optionally protected with a silyl group, for example, trimethylsilyloxy, t-butyldimethylsilyloxy, triphenylsilyloxy, triethylsilyloxy, phenyldimethylsilyloxy group), an amino group, an alkylamino group, an arylamino group, a sulfonamido group, an active methine group, a mercapto group, an alkylthio group, and a phenyl group substituted with any of these electron-donating groups.

When the carbon-carbon double bond site-containing organic group has a hydroxyl group as the substituent thereof, Y₃ contains a partial structure of >C₁═C₂(—OH)—, and it may be tautomerized into a partial structure of >C₁H—C₂(═O)—. In this embodiment, it is also desirable that the substituent bonding to the C₁ carbon is an electron attractive group. In this case, Y₃ has a partial structure of “active methylene group” or “active methine group”. The electron attractive group capable of giving the partial structure of active methylene group or active methine group may be the same as that mentioned hereinabove for the above “active methine group”.

When the carbon-carbon triple bond site-containing organic group (e.g., ethynyl group) for Y₃ is substituted, its substituent is preferably any of an alkyl group, a phenyl group, an alkoxycarbonyl group, a carbamoyl group and an electron-donating group.

When Y₃ is an organic group that contains an aromatic group site, the aromatic group is preferably an indole ring group or an aryl group (especially preferably phenyl group) substituted with an electron-donating group. The electron-donating group is preferably a hydroxyl group (optionally protected with a silyl group), an alkoxy group, an amino group, an alkylamino group, an active methine group, a sulfonamido group or a mercapto group.

When Y₃ is an organic group that contains a benzo-condensed non-aromatic heterocyclic group site, the benzo-condensed non-aromatic heterocyclic group preferably has an aniline structure as its inner partial structure. For example, it includes an indoline ring group, a 1,2,3,4-tetrahydroquinoline ring group, a 1,2,3,4-tetrahydroquinoxaline ring group, and a 4-quinolone ring group.

More preferably, the reactive group for Y₃ is an organic group that contains a carbon-carbon double bond site, an aromatic group site or a benzo-condensed non-aromatic heterocyclic group site. Even more preferably, the organic group contains a carbon-carbon double bond site, a phenyl group substituted with an electron-donating group, an indole ring group, or a benzo-condensed non-aromatic heterocyclic group having an aniline structure as the inner partial structure thereof. Still preferably, the carbon-carbon double bond site has at least one electron-donating substituent.

As a result that the reactive group for Y₃ is selected from the range described hereinabove, the case where Y₃ has the same partial structure as that of the reducing group for RED₃ is also one preferred embodiment of the compound of formula (D-1).

L₃ represents a linking group that links RED₃ and Y₃. Concretely, it may be a single bond, an alkylene group, an arylene group, a heterocyclic group, —O—, —S—, —NR_{N}—, —C(═O)—, —SO₂—, —SO— or —P(═O)— alone, or a combination of any of these groups. R_{N} represents a hydrogen atom, an alkyl group, an aryl group, or a heterocyclic group. The liking group for L₃ may have any desired substituent. The liking group for L₃ bonds to RED₃ and to Y₃ at any desired position thereof in such a manner that any desired one hydrogen atom of each of RED₃ and Y₃ is substituted with the linking group.

Preferably, for example, L₃ is a linking group of a single bond, an alkylene group (especially methylene, ethylene, propylene), an arylene group (especially phenylene), —C(═O)—, —O—, —NH—, or —N(alkyl)- group alone, or a combination of any of these group.

Regarding the group L₃, it is desirable that, when the cation radical species (X⁺.) formed through oxidation of RED₃, or the radical species (X⁺.) formed through proton release from that cation radical species reacts with the reactive group of Y₃ to form a bond, the atomic group relating to the reaction may form a 3-membered to 7-membered cyclic structure including L₃. For this, it is desirable that the radical species (X⁺. or X.), the reactive group of Y₃, and L are bonded to each other via from 3 to 7 atomic groups.

Next described are the compounds of type 4.

The compounds of type 4 have a cyclic structure substituted with a reducing group, in which the reducing group, after having undergone one-electron oxidation, releases another one or more electrons through subsequent ring cleavage. The ring cleavage as referred to herein means the following reaction.

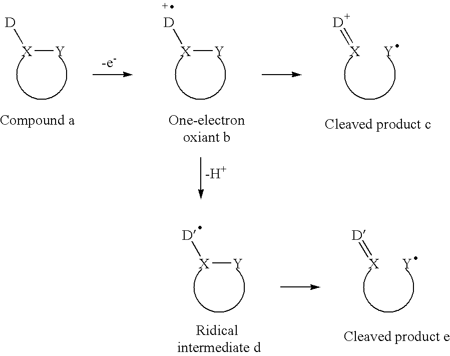

In the above formula, compound a is the compound of type 4. In compound a, D indicates a reducing group, and X and Y indicate the atoms of the cyclic structure that form a bond capable of being cleaved after one-electron oxidation of the compound. Compound a first undergoes one-electron oxidation to form one-electron oxidant b. Thereafter, the D-X single bond becomes a double bond and, at the same time, the bond X-Y is cleaved to form cleaved product c. Alternatively, one-electron oxidant b may form radical intermediate d through proton elimination, and then cleaved product e may form in the same manner as above. Thus formed, cleaved product c or e further releases at least one electron. The reaction route characterizes the compounds of type 4 for use in the invention.

The cyclic structure of the compound of type 4 is a 3- to 7-membered, carbocyclic or heterocyclic, monocyclic or condensed cyclic, saturated or unsaturated non-aromatic ring structure. Preferably, it is a saturated cyclic structure, more preferably a 3- or 4-membered one. Preferred examples of the cyclic structure are cyclopropane ring, cyclobutane ring, oxirane ring, oxetane ring, aziridine ring, azetidine ring, episulfide ring, and thietane ring. More preferred are cyclopropane ring, cyclobutane ring, oxirane ring, oxetane ring, and azetidine ring; and even more preferred are cyclopropane ring, cyclobutane ring, and azetidine ring. The cyclic structure may have any desired substituent.

Preferably, the compounds of type 4 are represented by the following formula (E) or (F):

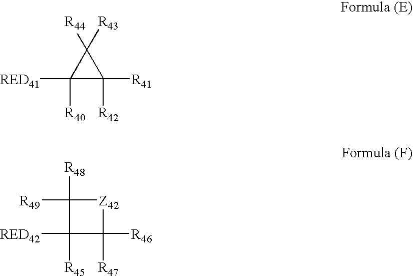

In formulae (E) and (F), RED₄₁ and RED₄₂ have the same meanings as RED₁₂ in formula (B), and their preferred range may also be the same as that of the latter. R₄₀ to R₄₄ and R₄₅ to R₄₉ each represent a hydrogen atom or a substituent. In formula (F), Z₄₂ represents —CR₄₂₀R₄₂₁—, —NR₄₂₃—, or —O—. R₄₂₀ and R₄₂₁ each represent a hydrogen atom or a substituent; and R₄₂₃ represents a hydrogen atom, an alkyl group, an aryl group or a heterocyclic group.

In formulae (E) and (F), R₄₀ and R₄₅ each are preferably a hydrogen atom, an alkyl group, an aryl group or a heterocyclic group, more preferably a hydrogen atom, an alkyl group, or an aryl group. Also preferably, R₄₁ to R₄₄ and R₄₆ to R₄₉ each are a hydrogen atom, an alkyl group, an alkenyl group, an aryl group, a heterocyclic group, an arylthio group, an alkylthio group, an acylamino group or a sulfonamido group, more preferably a hydrogen atom, an alkyl group, an aryl group or a heterocyclic group.

Also preferably, at least one of R₄₁ to R₄₄ is a donor group, or R₄₁ and R₄₂, or R₄₃ and R₄₄ are both electron attractive groups. More preferably, at least one of R₄₁ to R₄₄ is a donor group. Even more preferably, at least one of R₄₁ to R₄₄ is a donor group, and the group or groups other than the donor group of R₄₁ to R₄₄ are a hydrogen atom or an alkyl group.

The donor group as referred to herein is an “electron-donating group”, or an aryl group substituted with at least one “electron-donating group”. The donor group is preferably an alkylamino group, an arylamino group, a heterocyclic amino group, a 5-membered, monocyclic or condensed cyclic, electron-rich aromatic heterocyclic group having at least one nitrogen atom in its ring, a non-aromatic nitrogen-containing heterocyclic group bonding to the compound via its nitrogen atom, or a phenyl group substituted with at least one electron-donating group. More preferably, it is an alkylamino group, an arylamino group, a 5-membered, monocyclic or condensed cyclic, electron-rich aromatic heterocyclic group having at least one nitrogen atom in its ring (e.g., indole ring, pyrrole ring, carbazole ring), or an electron-donating group-substituted phenyl group (e.g., phenyl group substituted with at least three alkoxy groups, or phenyl group substituted with hydroxy group, alkylamino group or arylamino group). Even more preferred are an arylamino group, a 5-membered, monocyclic or condensed cyclic, electron-rich aromatic heterocyclic group having at least one nitrogen atom in its ring (especially 3-indolyl group), and an electron-donating group-substituted phenyl group (especially trialkoxyphenyl group, or phenyl group substituted with alkylamino group or arylamino group).

Z₄₂ is preferably —CR₄₂₀R₄₂₁ or —NR₄₂₃—, more preferably —NR₄₂₃—. Preferably, R₄₂₀ and R₄₂₁ each are a hydrogen atom, an alkyl group, an aryl group, a heterocyclic group, an acylamino group or a sulfonamino group, more preferably a hydrogen atom, an alkyl group, an aryl group or a heterocyclic group. R₄₂₃ is preferably a hydrogen atom, an alkyl group, an aryl group or an aromatic heterocyclic group, more preferably a hydrogen atom, an alkyl group or an aryl group.

When each group of R₄₀ to R₄₉, R₄₂₀, R₄₂₁ and R₄₂₃ is a substituent, the substituent preferably has at most 40 carbon atoms, more preferably at most 30 carbon atoms, even more preferably at most 15 carbon atoms in total. These substituents may bond to each other or may bond to any other site (RED₄₁, RED₄₂ or Z₄₂) of the molecule to form a ring.

In the compounds of types 1 to 4 for use in the invention, the group adsorptive to silver halide is a group that may be directly adsorbed by silver halide, or a group that promotes the adsorption of the compound to silver halide. Concretely, for example, it includes a mercapto group (or its salts), a thione group (—C(═S)—), a heterocyclic group that contains at lest one atom selected from nitrogen, sulfur, selenium and tellurium atoms, a sulfido group, a cationic group, and an ethynyl group. In the compounds of type 2, however, the group adsorptive to silver halide does not include a sulfido group.

The mercapto group (or its salt) for the group adsorptive to silver halide may be a mercapto group (or its salt) itself, but is more preferably a heterocyclic, aryl or alkyl group substituted with at least one mercapto group (or its salt). The heterocyclic group is a 5-membered to 7-membered, monocyclic or condensed cyclic, aromatic or non-aromatic heterocyclic group, including, for example, an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, and a triazine ring group. It may also be a quaternary nitrogen-containing heterocyclic group, in which the substituting mercapto group may dissociate to form a meso ion. Examples of the heterocyclic group of the type are an imidazolium ring group, a pyrazolium ring group, a thiazolium ring group, a triazolium ring group, a tetrazolium ring group, a thiadiazolium ring group, a pyridinium ring group, a pyrimidinium ring group, and a triazinium ring group. Among those, preferred is a triazolium ring group (e.g., 1,2,4-triazolium-3-thiolate ring group). The aryl group may be a phenyl group or a naphthyl group. The alkyl group may be a linear, branched or cyclic alkyl group having from 1 to 30 carbon atoms. When the mercapto group forms a salt, its counter ion may be a cation of alkali metals, alkaline earth metals or heavy metals (e.g., Li⁺, Na⁺, K⁺, Mg²⁺, Ag⁺, Zn²⁺), an ammonium ion, a quaternary nitrogen-containing heterocyclic group, or a phosphonium ion.

The mercapto group acting as the group adsorptive to silver halide may also be in the form of its tautomer, thione group. Concretely, it may be a thioamido group (—C(═S)—NH—) or a group that contains a partial structure of the thioamido group, more concretely a linear or cyclic thioamido group, or a thioureido group, a thiourethane group, or a dithiocarbamate group. Examples of the cyclic group are a thiazolidine-2-thione group, an oxazolidine-2-thione group, a 2-thiohydantoin group, a rhodanine group, an isorhodanine group, a thiobarbituric acid group, and a 2-thioxo-oxazolidin-4-one group.

In addition to the mercapto-tautomerized thione group as above, the thione group acting as the group adsorptive to silver halide further includes any others that cannot be tautomerized into mercapto group (that do not have a hydrogen atom at the a-position of the thione group), such as a linear or cyclic thioamido group, a thioureido group, a thiourethane group, and a dithiocarbamate group.

The heterocyclic group that contains at least one atom selected from nitrogen, sulfur, selenium and tellurium atoms and that acts as the group adsorptive to silver halide is a nitrogen-containing heterocyclic group that has a group of —NH— capable of forming imino silver (>NAg) as the partial structure of the heterocyclic ring thereof, or a heterocyclic group that has a group of “—S—”, “—Se—”, “—Te—” or “═N—” capable of coordinating with a silver ion via a coordination bond, as the partial structure of the heterocyclic ring thereof. Examples of the former are a benzotriazole group, a triazole group, an indazole group, a pyrazole group, a tetrazole group, a benzimidazole group, an imidazole group, and a purine group; and examples of the latter are a thiophene group, a thiazole group, an oxazole group, a benzothiazole group, a benzoxazole group, a thiadiazole group, an oxadiazole group, a triazine group, a selenazole group, a benzoselenazole group, a tellurazole group, and a benzotellurazole group. Preferred are the former.

The sulfido group acting as the group adsorptive to silver halide is any and every group that has a partial structure of “—S—”. Preferably, it has a partial structure of alkyl (or alkylene)-S-alkyl (or alkylene), aryl (or arylene)-S-alkyl (or alkylene), or aryl (or arylene)-S-aryl (or arylene). The sulfido group may form a cyclic structure, or may have a structure of —S—S—. Specific examples of the cyclic structure-forming group are those containing any of thiolane ring, 1,3-dithiolane ring, 1,2-dithiolane ring, thiane ring, dithiane ring, and tetrahydro-1,4-thiazine ring (thiomorpholine ring). More preferably, the sulfido group has a partial structure of alkyl (or alkylene)-S-alkyl (or alkylene).

The cationic group acting as the group adsorptive to silver halide means a group that contains a quaternary nitrogen atom, and is concretely an ammonio group or a quaternary nitrogen-containing heterocyclic group. However, the cationic group should not be a part of a dye structure-forming atomic group (e.g., cyanine chromophore). The ammonio group is a trialkylammonio group, a dialkylarylammonio group, or an alkyldiarylammonio group, including, for example, a benzyldimethylammonio group, a trihexylammonio group, and a phenyldiethylammonio group. The quaternary nitrogen-containing heterocyclic group includes, for example, a pyridinio group, a quinolinio group, an isoquinolinio group, and an imidazolio group. Preferred are a pyridinio group and an imidazolio group; and more preferred is a pyridinio group. The quaternary nitrogen-containing heterocyclic group may have any desired substituent. For pyridinio group and imidazolio group, the substituent is preferably any of an alkyl group, an aryl group, an acylamino group, a chlorine atom, an alkoxycarbonyl group, and a carbamoyl group. Especially for pyridino group, the substituent is more preferably a phenyl group.

The ethynyl group acting as the group adsorptive to silver halide means a group of —C═CH, in which the hydrogen atom may be substituted.

The above-mentioned groups adsorptive to silver halide may have any desired substituent.

Other examples of the groups adsorptive to silver halide are described, for example, in JP-A No. 11-95355, pp. 4-7.

Preferred for the groups adsorptive to silver halide in the invention are a mercapto-substituted nitrogen-containing heterocyclic group (e.g., 2-mercaptothiadiazole group, 3-mercapto-1,2,4-triazole group, 5-mercaptotetrazole group, 2-mercapto-1,3,4-oxadiazole group, 2-mercaptobenzoxazole group, 2-mercaptobenzothiazole group, 1,5-dimethyl-1,2,4-triazolium-3-thiolate group), and a nitrogen-containing heterocyclic group that has, as the partial structure of the heterocyclic ring thereof, a group —NH— capable of forming imino silver (>NAg) (e.g., benzotriazole group, benzimidazole group, imidazole group). More preferred are 5-mercaptotetrazole group, 3-mercapto-1,2,4-triazole group, and benzotriazole group; and most preferred are 3-mercapto-1,2,4-triazole group, and 5-mercaptotetrazole group.

Also preferred for use in the invention are compounds that have at least two mercapto groups as the partial structure in the molecule thereof. The mercapto group (—SH) may become a thione group when it is tautomerizable. Examples of the compounds of the type are those that have, in the molecule thereof, at least two groups adsorptive to silver halide each having the above-mentioned mercapto group or a thione group as the partial structure thereof (e.g., ring-forming thioamido group, alkylmercapto group, arylmercapto group, heterocyclic-mercapto group), or those with at least one group adsorptive to silver halide that has at least two mercapto or thione groups as the partial structure thereof (e.g., dimercapto-substituted nitrogen-containing heterocyclic group).

Examples of the group adsorptive to silver halide that has at least two mercapto groups as the partial structure thereof (e.g., dimercapto-substituted nitrogen-containing heterocyclic group) are a 2,4-dimercaptopyrimidine group, a 2,4-dimercaptotriazine group, a 3,5-dimercapto-1,2,4-triazole group, a 2,5-dimercapto-1,3-thiazole group, a 2,5-dimercapto-1,3-oxazole group, a 2,7-dimercapto-5-methyl-s-triazolo(1,5-A)pyrimidine group, a 2,6,8-trimercaptopurine group, a 6,8-dimercaptopurine group, a 3,5,7-trimercapto-s-triazolotriazine group, a 4,6-dimercaptopyrazolopyrimidine group, and a 2,5-dimercaptoimidazole group. Especially preferred are a 2,4-dimercaptopyrimidine group, a 2,4-dimercaptotriazine group, and a 3,5-dimercapto-1,2,4-triazole group.

The group adsorptive to silver halide may bond to any site in formulae (A) to (F) and formulae (15) to (17). Preferably, however, the group bonds to RED₁₁, RED₁₂₁ RED₂ or RED₃ in formulae (A) to (D-1), to any of RED₄₁, R₄₁, RED₄₂ or R₄₆ to R₄₈ in formulae (E) and (F), and to any site other than R₁, R₂₁ R₁₁, R₁₂, R₃₁, L₁, L₂₁ and L₃₁ in formulae (15) to (17). More preferably, the group bonds to RED₁₁ to RED₄₂ in all of formulae (A) to (F).

The partial structure of spectral sensitizer dye is a group that contains the chromophore of the dye, and it is a residue derived from a spectral sensitizer dye compound by removing an arbitrary hydrogen atom or substituent from the compound. The partial structure of spectral sensitizer dye may be in any site in formulae (A) to (F) and formulae (15) to (17). Preferably, however, it bonds to RED₁₁, RED₁₂, RED₂ or RED₃ in formulae (A) to (D-1), to any of RED₄₁, R₄₁, RED₄₂ or R₄₆ to R₄₈ in formulae (E) and (F), and to any site other than R₁, R₂, R₁₁, R₁₂, R₃₁, L₁, L₂₁ and L₃₁ in formulae (15) to (17). More preferably, it bonds to RED₁₁ to RED₄₁ in all of formulae (A) to (F). Preferred spectral sensitizer dyes for use in the invention are those typically used in the technique of color sensitization, including, for example, cyanine dyes, complex cyanine dyes, merocyanine dyes, complex merocyanine dyes, homopolar cyanine dyes, styryl dyes, hemicyanine dyes. Typical spectral sensitizer dyes usable herein are disclosed in Research Disclosure, Item 36544 of September 1994. Anyone skilled in the art can produce the dyes in accordance with the process described in the above Research Disclosure or in F. M. Hamer, The Cyanine Dyes and Related Compounds (Interscience Publishers, New York, 1964). In addition, all the dyes described in JP-A No. 11-95355 (U.S. Pat. No. 6,054,260), pp. 7-14 may directly apply to the invention.

Preferably, the compounds of types 1 to 4 for use in the invention each have from 10 to 60 carbon atoms, more preferably from 15 to 50 carbon atoms, even more preferably from 18 to 40 carbon atoms, still more preferably from 18 to 30 carbon atoms in total.

In the silver halide heat-developable light-sensitive material that contains any of the compounds of types 1 to 4 of the invention, the compound undergoes one-electron oxidation after the material has been exposed to light, and thereafter it undergoes subsequent reaction to release one electron, or as the case may be, to release two or more electrons depending on the type of the compound, and the compound is after all oxidized. The oxidation potential in the first electron oxidation of the compound is preferably at most about 1.4 V, more preferably at most 1.0 V. Also preferably, the oxidation potential is higher than 0 V, more preferably higher than 0.3 V. Accordingly, the oxidation potential is preferably from about 0 to about 1.4 V, more preferably from about 0.3 to about 1.0 V.

The oxidation potential may be determined through cyclic voltammetry. Concretely, the sample is dissolved in a mixed solution of acetonitrile and water (containing 0.1 M lithium perchlorate) at a volume ratio of 80%/20%, and nitrogen gas is introduced to the resultant for 10 minutes. A glassy carbon disc is used as a working electrode, and a platinum wire is used as a counter electrode, and a saturated calomel electrode (SCE) is used as a reference electrode. At 25° C. and at a potential scanning speed of 0.1 V/sec, the sample solution is analyzed. At the peak potential on the cyclic voltammetric wave, the oxidation potential to SCE is read.

When the compounds of types 1 to 4 for use in the invention are those that undergo one-electron oxidation and release one electron through subsequent reaction, the oxidation potential in the latter reaction is preferably from −0.5 V to −2 V, more preferably from −0.7 V to −2 V, even more preferably from −0.9 V to −1.6 V.

When the compounds of types 1 to 4 for use in the invention are those that undergo one-electron oxidation and release two or more electrons through subsequent reaction, and are thereby oxidized, the oxidation potential in the latter reaction is not specifically defined. The oxidation potential in the second electron oxidation and the oxidation potential in the third and later electron oxidation could not be clearly differentiated from each other in the reaction process, and in many cases, therefore, it is actually difficult to accurately measure the oxidation potential values to differentiate them from each other.

Next described are the compounds of type 5.

The compounds of type 5 are represented by X-Y, in which X indicates a reducing group and Y indicates a leaving group. One-electron oxidant of the compound, which is formed through one-electron oxidation at the reducing group X of the compound, releases the group Y through subsequent cleavage of the X-Y bond to give a radical X, and the radical releases another one electron. The oxidation reaction of the compound of type 5 is represented by the following chemical formula:

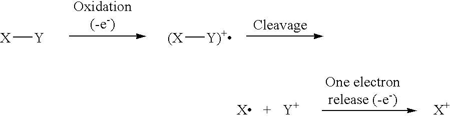

Preferably, the compound of type 5 has an oxidation potential of from 0 to 1.4 V, more preferably from 0.3 V to 1.0 V. In the above reaction formula, the oxidation potential of the formed radical X is preferably from −0.7 V to −2.0 V, more preferably from −0.9 V to −1.6 V.

The compounds of type 5 are preferably represented by the following formula (G):

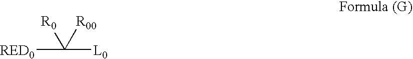

In formula (G), RED₀ represents a reducing group; L₀ represents a leaving group; and R₀ and R₀₀ each represent a hydrogen atom or a substituent. RED₀ and R₀, and R₀ and R₀₀ may bond to each other to form a cyclic structure. RED₀ has the same meaning as RED₂ in formula (C), and its preferred range may also be the same as that of the latter. R₀ and R₀₀ have the same meanings as R₂ land R₂₂ in formula (C), and their preferred range may also be the same as that of the latter. Except for a hydrogen atom, R₀ and R₀₀ are not the same as L₀. RED₀ and R₀ may bond to each other to form a cyclic structure. For the examples of the cyclic structure, referred to are those mentioned hereinabove for the cyclic structure to be formed by RED₂ and R₂₁ bonding to each other in formula (C). Their preferred range may also be the same as that of the latter. Examples of the cyclic structure which R₀ and R₀₀ bonding to each other form are cyclopentane ring and tetrahydrofuran ring. In formula (G), L₀ has the same meaning as L₂ in formula (C), and its preferred range may also be the same as that of the latter.

Preferably, the compounds of formula (G) have, in the molecule thereof, a group adsorptive to silver halide or a partial structure of spectral sensitizer dye. However, when L₀ therein is any group other than a silyl group, the compound does not have two or more groups adsorptive to silver halide in the molecule thereof. Irrespective of L₀ therein, however, the compound may have two or more sulfide groups acting as the group adsorptive to silver halide.

For the examples of the group adsorptive to silver halide which the compound of formula (G) may have, referred to are those mentioned hereinabove for the adsorptive group which the compounds of types 1 to 4 may have. In addition, all the “groups adsorptive to silver halide” mentioned in JP-A No. 11-95355, pp. 4-7 may apply to the compound of formula (G), and their preferred range mentioned therein may also apply to it.

The partial structure of spectral sensitizer dye which the compound of formula (G) may have may be the same as the partial structure of spectral sensitizer dye which the compounds of types 1 to 4 may have. In addition, all the “light-absorbing groups” mentioned in JP-A No. 11-95355, pp. 7-14 may apply to the compound of formula (G), and their preferred range mentioned therein may also apply to it.

Specific examples of the compounds of types 1 to 5 for use herein are mentioned below, however, the invention is not limited thereto.

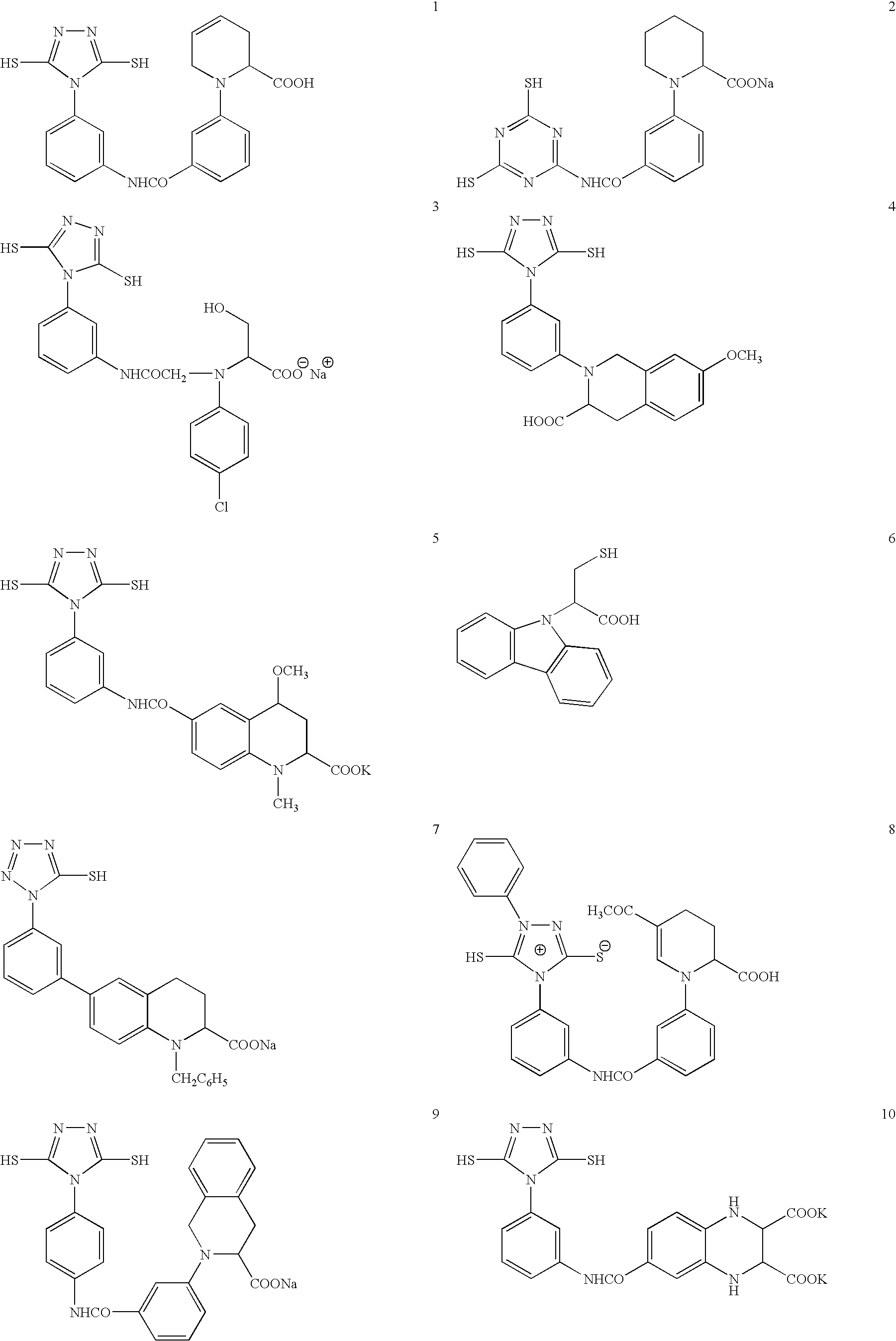

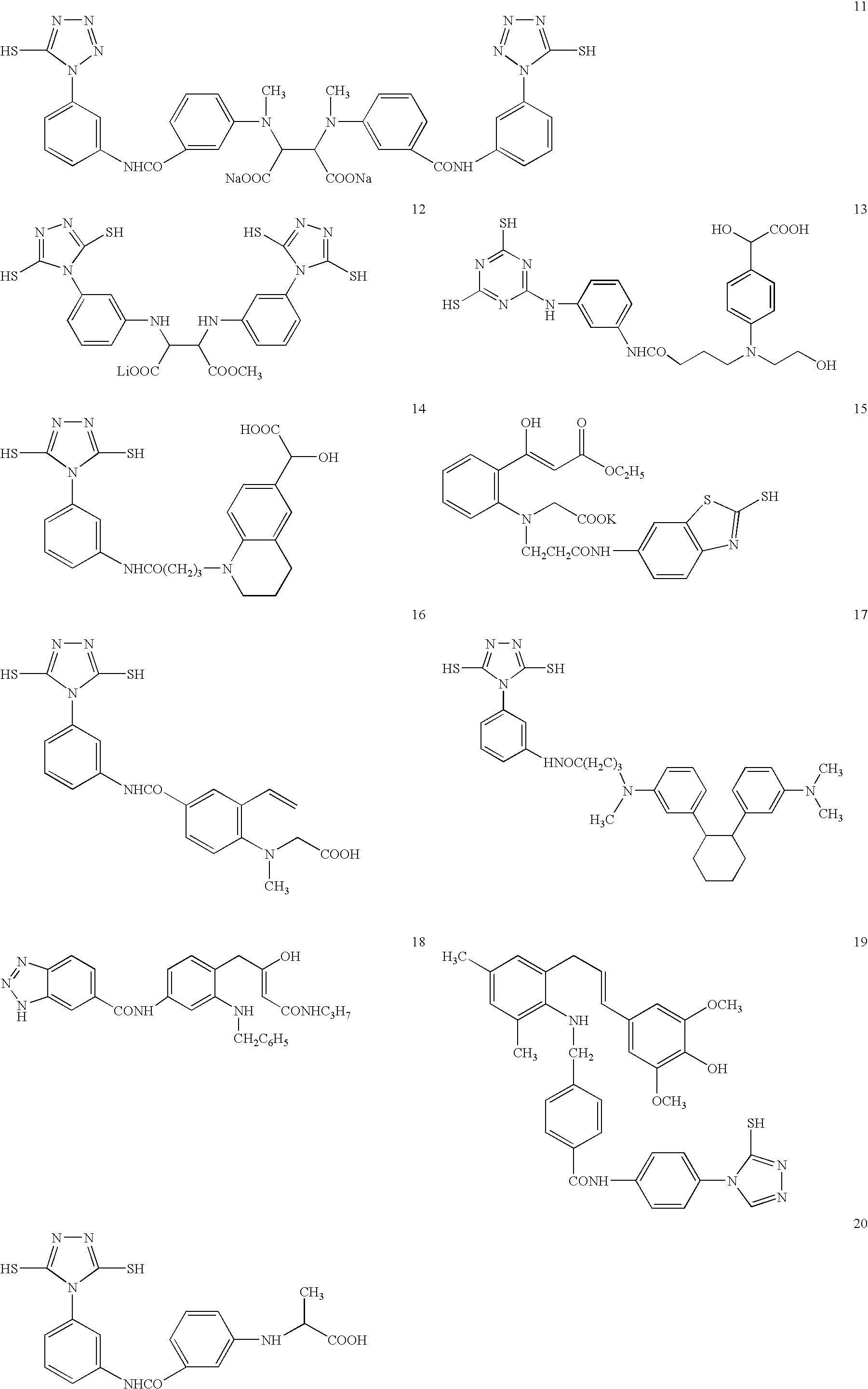

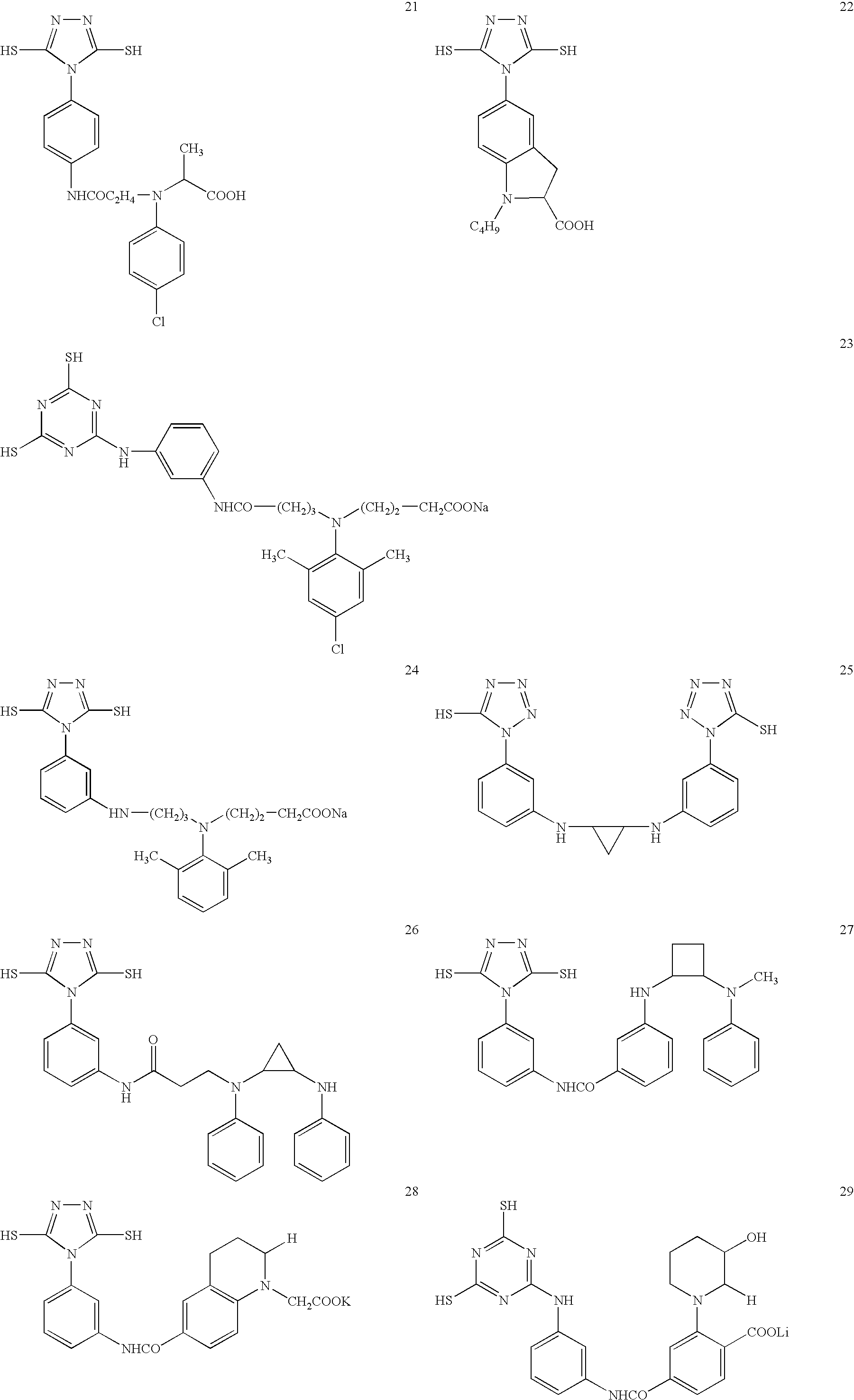

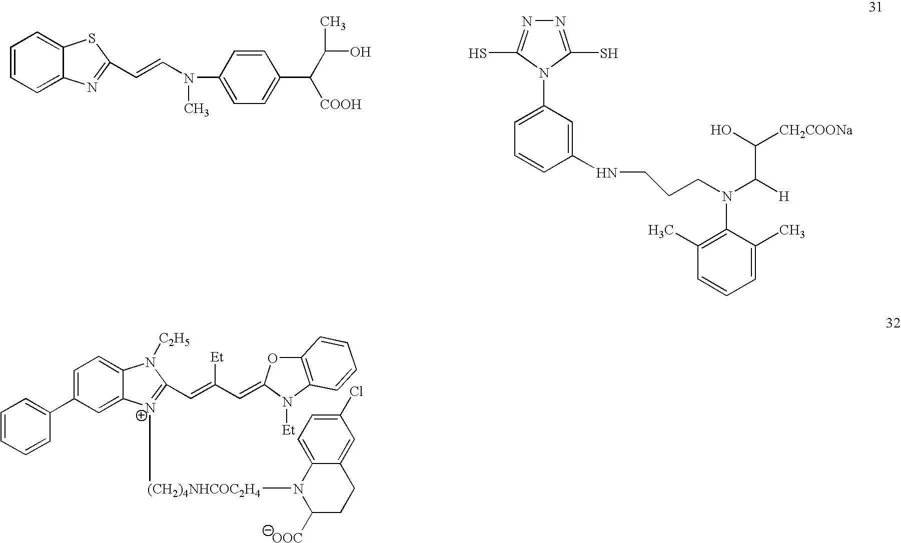

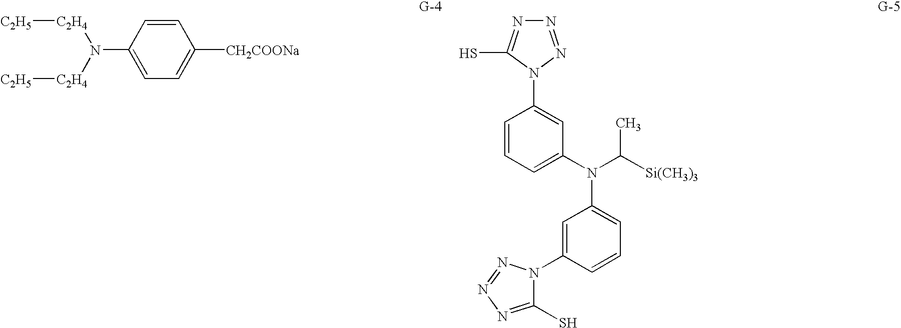

The compounds of types 1 to 4 for use in the invention are the same as those described in detail in Japanese Patent Application Nos. 2002-192373, 2002-188537. 2002-188536, 2001-272137 and 2002-192374. Specific examples of the compounds described in the specifications of these patent applications may also apply to the present invention for the specific examples of the compounds of types 1 to 4. In addition, the descriptions of these patent references are referred to for production examples for the compounds of types 1 to 4 for the invention For additional specific examples of the compounds of type 5 for use in the invention, further referred to are JP-A No. 9-211769 (compounds PMT-1 to S-37 described in Table E and Table F on pp. 28-32); JP-A No. 9-211774; JP-A No. 11-95355 (compounds INV1 to 56); JP-A No. 2001-500996 (compounds 1 to 74, 80 to 87, 92 to 122); U.S. Pat. Nos. 5,747,235 and 5,747,236; EP-A No. 786,692,A1 (compounds INV1 to 35); EP-A No. 893,732A1; U.S. Pat. Nos. 6,054,260 and 5,994,051. The compounds that are referred to as “one-photon two-electron sensitizers” or “de-protonating electron-donating sensitizers” in these patent references may directly apply to the invention.

The compounds of types 1 to 5 mentioned herein may be added to photosensitive silver halide emulsions in any stage of preparing the emulsions or producing heat-developable light-sensitive materials. For example, the compound may be added to the emulsion while photosensitive silver halide grains are formed, or desalted or chemically sensitized, or just before the emulsion is applied to a support. If desired, the compound may be divided into some portions and they may be separately added to the emulsion in these steps. Regarding the time at which the compound is added to the emulsion, it is desirable that the compound is added thereto after photosensitive silver halide grains have been formed but before they are desalted, or while the grains are chemically sensitized (precisely, just before the start of chemical sensitization and just after the finish thereof), or just before the emulsion is applied to a support. More preferably, the compound is added to the emulsion while the grains are chemically sensitized and before they are mixed with a non-photosensitive organic silver salt.

Preferably, the compounds of types 1 to 5 are added to the emulsion after dissolved in water or a water-soluble solvent such as methanol or ethanol or in a mixed solvent of these. When the compound is dissolved in water, its pH may be increased or decreased if the compound is more soluble therein at an increased or decreased pH.

Preferably, the compounds of types 1 to 5 are added to the emulsion layer that contains a photosensitive silver halide and a non-photosensitive organic silver salt. However, it may also be added to a protective layer or an interlayer that is adjacent to an emulsion layer containing a photosensitive silver halide and a non-photosensitive organic silver salt, so that the compound may diffuse into the emulsion layer. The time when the compound is added to the layer is not specifically defined and may be any time before or after the addition of sensitizer dye thereto. Preferably, the amount of the compound to be added to the silver halide emulsion layer is from 1×10⁻⁹ to 5×10⁻¹ mols, more preferably from 1×10⁻⁸ to 5×10⁻² mols per mol of silver halide in the layer.

10) Adsorptive Redox Compound:

Preferably, the heat-developable light-sensitive material of the invention contains an adsorptive redox compound having a group adsorptive to silver and a reducing group in the molecule.

Also preferably, the adsorptive redox compound for use herein is represented by the following formula (I). The compound may be used alone or in combination with any other chemical sensitizer, and it has the ability to increase the sensitivity of silver halide.

A-(W)ₙ-B (I)

wherein A represents a group adsorptive to silver halide (hereinafter this is referred to as “adsorptive group”); W represents a divalent linking group; n indicates 0 or 1; and B represents a reducing group.

Formula (I) is described in detail.

In formula (I), the adsorptive group of A is a group that may be directly adsorbed by silver halide, or a group that promotes the adsorption of the compound to silver halide. Concretely, for example, it includes a mercapto group (or its salts), a thione group (—C(═S)—), a heterocyclic group that contains at lest one atom selected from nitrogen, sulfur, selenium and tellurium atoms, a sulfido group, a disulfide group, a cationic group, and an ethynyl group.

The mercapto group (or its salt) serving as the adsorptive group may be a mercapto group (or its salt) itself, but is more preferably a heterocyclic, aryl or alkyl group substituted with at least one mercapto group (or its salt). The heterocyclic group is a 5-membered to 7-membered, monocyclic or condensed cyclic, aromatic or non-aromatic heterocyclic group, including, for example, an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, and a triazine ring group. It may also be a quaternary nitrogen-containing heterocyclic group, in which the substituting mercapto group may dissociate to give a meso ion. Examples of the heterocyclic group of the type are an imidazolium ring group, a pyrazolium ring group, a thiazolium ring group, a triazolium ring group, a tetrazolium ring group, a thiadiazolium ring group, a pyridinium ring group, a pyrimidinium ring group, and a triazinium ring group. Among those, preferred is a triazolium ring group (e.g., 1,2,4-triazolium-3-thiolate ring group). The aryl group may be a phenyl group or a naphthyl group. The alkyl group may be a linear, branched or cyclic alkyl group having from 1 to 30 carbon atoms. When the mercapto group forms a salt, its counter ion may be a cation of alkali metals, alkaline earth metals or heavy metals (e.g., Li⁺, Na⁺, K⁺, Mg²⁺, Ag⁺, Zn²⁺), an ammonium ion, a quaternary nitrogen-containing heterocyclic group, or a phosphonium ion.

The mercapto group acting as the adsorptive group may also be in the form of its tautomer, thione group. Concretely, it may be a thioamido group (—C(═S)—NH—) or a group that contains a partial structure of the thioamido group, more concretely a linear or cyclic thioamido group, or a thioureido group, a thiourethane group, or a dithiocarbamate group. Examples of the cyclic group are a thiazolidine-2-thione group, an oxazolidine-2-thione group, a 2-thiohydantoin group, a rhodanine group, an isorhodanine group, a thiobarbituric acid group, and a 2-thioxo-oxazolidin-4-one group.

In addition to the mercapto-tautomerized thione group as above, the thione group acting as the adsorptive group further includes any others that cannot be tautomerized into mercapto group (that do not have a hydrogen atom at the α-position of the thione group), such as a linear or cyclic thioamido group, a thioureido group, a thiourethane group, and a dithiocarbamate group.

The heterocyclic group that contains at least one atom selected from nitrogen, sulfur, selenium and tellurium atoms and that acts as the adsorptive group is a nitrogen-containing heterocyclic group that has a group of —NH— capable of forming imino silver (>NAg) as the partial structure of the heterocyclic ring thereof, or a heterocyclic group that has a group of “—S—”, “—Se—”, “—Te—” or “═N—” capable of coordinating with a silver ion via a coordination bond, as the partial structure of the heterocyclic ring thereof. Examples of the former are a benzotriazole group, a triazole group, an indazole group, a pyrazole group, a tetrazole group, a benzimidazole group, an imidazole group, and a purine group; and examples of the latter are a thiophene group, a thiazole group, an oxazole group, a benzothiophene group, a benzothiazole group, a benzoxazole group, a thiadiazole group, an oxadiazole group, a triazine group, a selenazole group, a benzoselenazole group, a tellurazole group, and a benzotellurazole group. Preferred are the former.

The sulfido or disulfide group acting as the adsorptive group is any and every group that has a partial structure of “—S—” or “—S—S—”. Preferably, it has a partial structure of alkyl (or alkylene)-X-alkyl (or alkylene), aryl (or arylene)-X-alkyl (or alkylene), or aryl (or arylene)-X-aryl (or arylene). X indicates —S— or —S—S—. The sulfido or disulfido group may form a cyclic structure. Specific examples of the cyclic structure-forming group are those containing any of thiolane ring, 1,3-dithiolane ring, 1,2-dithiolane ring, thiane ring, dithiane ring, or thiomorpholine ring. More preferably, the sulfido group has a partial structure of alkyl (or alkylene)-S-alkyl (or alkylene). Also more preferably, the disulfido group is a 1,2-dithiolane ring group.

The cationic group acting as the adsorptive group means a group that contains a quaternary nitrogen atom, and is concretely an ammonio group or a quaternary nitrogen-containing heterocyclic group. The ammonio group is a trialkylammonio group, a dialkylarylammonio group, or an alkyldiarylammonio group, including, for example, a benzyldimethylammonio group, a trihexylammonio group, and a phenyldiethylammonio group. The quaternary nitrogen-containing heterocyclic group includes, for example, a pyridinio group, a quinolinio group, an isoquinolinio group, and an imidazolio group. Preferred are a pyridinio group and an imidazolio group; and more preferred is a pyridinio group. The quaternary nitrogen-containing heterocyclic group may have any desired substituent. For pyridinio group and imidazolio group, the substituent is preferably any of an alkyl group, an aryl group, an acylamino group, a chlorine atom, an alkoxycarbonyl group, and a carbamoyl group. Especially for pyridino group, the substituent is more preferably a phenyl group.

The ethynyl group acting as the adsorptive group means a group of —C═CH, in which the hydrogen atom may be substituted.

The above-mentioned adsorptive groups may have any desired substituent. The substituent includes, for example, a halogen atom (fluorine atom, chlorine atom, bromine atom, or iodine atom), an alkyl group (linear, branched or cyclic alkyl group including bicycloalkyl group and active methine group), an alkenyl group, an alkynyl group, an aryl group, a heterocyclic group (its substituting position is not defined), an acyl group, an alkoxycarbonyl group, an aryloxycarbonyl group, a heterocyclic-oxycarbonyl group, a carbamoyl group, an N-hydroxycarbamoyl group, an N-acylcarbamoyl group, an N-sulfonylcarbamoyl group, an N-carbamoylcarbamoyl group, a thiocarbamoyl group, an N-sulfamoylcarbamoyl group, a carbazoyl group, a carboxy group and its salts, an oxalyl group, an oxamoyl group, a cyano group, a carbonimidoyl group, a formyl group, a hydroxyl group, an alkoxy group (including one that contains repetitive units of ethyleneoxy or propyleneoxy group) an aryloxy group, a heterocyclic-oxy group, an acyloxy group, an (alkoxy or aryloxy) carbonyloxy group, a carbamoyloxy group, a sulfonyloxy group, an amino group, an (alkyl, aryl or heterocyclic)amino group, an acylamino group, a sulfonamido group, an ureido group, a thioureido group, an N-hydroxyureido group, an imido group, an (alkoxy or aryloxy)carbonylamino group, a sulfamoylamino group, a semicarbazido group, a thiosemicarbazido group, a hydrazino group, an ammonio group, an oxamoylamino group, an N-(alkyl or aryl)sulfonylureido group, an N-acylureido group, an N-acylsulfamoylamino group, a hydroxyamino group, a nitro group, a quaternary nitrogen atom-containing heterocyclic group (e.g., pyridinio, imidazolio, quinolinio, isoquinolinio group), an isocyano group, an imino group, a mercapto group, an (alkyl, aryl or heterocyclic) thio group, an (alkyl, aryl or heterocyclic)dithio group, an (alkyl or aryl)sulfonyl group, an (alkyl or aryl) sulfinyl group, a sulfo group and its salts, a sulfamoyl group, an N-acylsulfamoyl group, an N-sulfonylsulfamoyl group and its salts, a phosphino group, a phosphinyl group, a phosphinyloxy group, a phosphinylamino group, and a silyl group. The active methine group means a methine group substituted with two electron attractive groups, in which the electron attractive group includes an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group and a carbonimidoyl group, and in which the two electron attractive groups may bond to each other to form a cyclic structure. The salt includes those with a cation of alkali metals, alkaline earth metals or heavy metals, and those with an organic cation such as ammonium or phosphonium ion.

Other examples of the adsorptive groups are described, for example, in JP-A No. 11-95355, pp. 4-7.

Preferred for the adsorptive group of A in formula (I) are a mercapto-substituted heterocyclic group (e.g., 2-mercaptothiadiazole group, 3-mercapto-1,2,4-triazole group, 5-mercaptotetrazole group, 2-mercapto-1,3,4-oxadiazole group, 2-mercaptobenzothiazole group, 2-mercaptobenzimidazole group, 1,5-dimethyl-1,2,4-triazolium-3-thiolate group), a dimercapto-substituted heterocyclic group (e.g., 2,4-dimercaptopyrimidine group, 2,4-dimercaptotriazine group, 3,5-dimercapto-1,2,4-triazole group, 2,5-dimercapto-1,3-thiazole group), and a nitrogen-containing heterocyclic group that has, as the partial structure of the heterocyclic ring thereof, a group —NH— capable of forming imino silver (>NAg) (e.g., benzotriazole group, benzimidazole group, imidazole group). More preferred are dimercapto-substituted heterocyclic groups.

In formula (I), W represents a divalent linking group. The linking group may be any one not having any negative influence of the photographic properties of the heat-developable light-sensitive material. For example, it may be a divalent linking group that comprise carbon, hydrogen, oxygen, nitrogen and/or sulfur atoms. Concretely, it includes an alkylene group having from 1 to 20 carbon atoms (e.g., methylene, ethylene, trimethylene, tetramethylene, hexamethylene), an alkenylene group having from 2 to 20 carbon atoms, an alkynylene group having from 2 to 20 carbon atoms, an arylene group having from 6 to 20 carbon atoms (e.g., phenylene, naphthylene), —CO—, —SO₂—, —O—, —S—, —NR₁—, and combinations of these linking groups. R₁ represents a hydrogen atom, an aliphatic group or an aryl group. The aliphatic group for R₁ preferably has from 1 to 30 carbon atoms, and is more preferably a linear, branched or cyclic alkyl group having from 1 to 20 carbon atoms, or alkenyl, alkynyl or aralkyl groups (e.g., methyl, ethyl, isopropyl, t-butyl, n-octyl, n-decyl, n-hexadecyl, cyclopropyl, cyclopentyl, cyclohexyl, allyl, 2-butenyl, 3-pentenyl, propargyl, 3-pentynyl, benzyl). The aryl group for R₁ is preferably a monocyclic or condensed cyclic aryl group having from 6 to 30 carbon atoms, more preferably from 6 to 20 carbon atoms. For example, it includes phenyl group and naphthyl group. The linking group of W may have any desired substituent. For the substituent, referred to are those mentioned hereinabove for the substituent for the adsorptive group.

In formula (I), the reducing group of B is a group that has the ability to reduce silver ions. For example, it includes a formyl group, an amino group, a triple bond group such as acetylene or propargyl group, a mercapto group, as well as residues that are derived from compounds selected from hydroxylamines, hydroxamic acids, hydroxyureas, hydroxyurethanes, hydroxysemicarbazides, reductones (including reductone derivatives), anilines, phenols (including chroman-6-ols, 2,3-dihydrobenzofuran-5-ols, aminophenols, sulfonamidophenols, and polyphenols such as hydroquinones, catechols, resorcinols, benzenetriols, bisphenols), hydrazines, hydrazides and phenidones.

Preferred examples of the reducing group B in formula (I) are residues derived from the compounds of the following formulae (B₁) to (B₁₃).

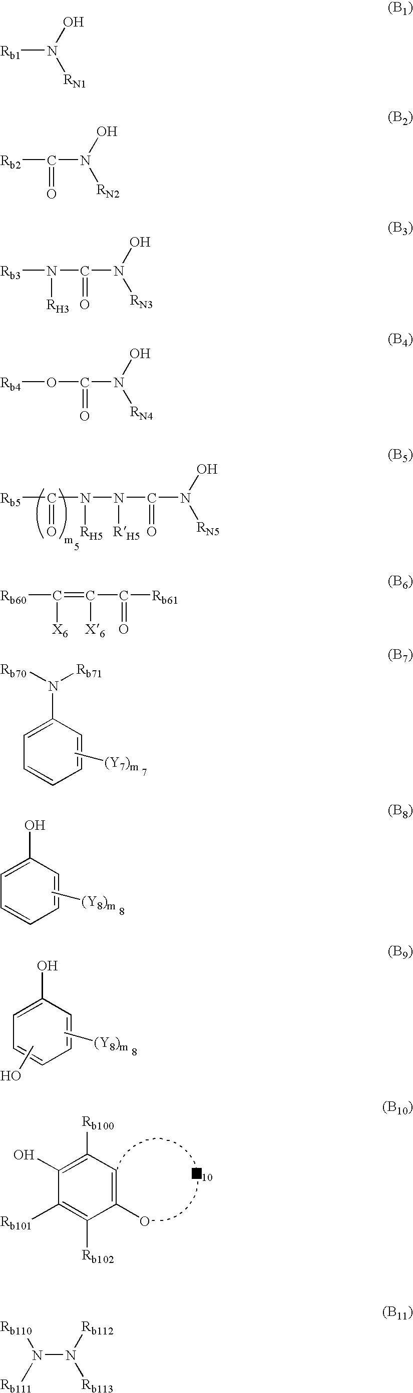

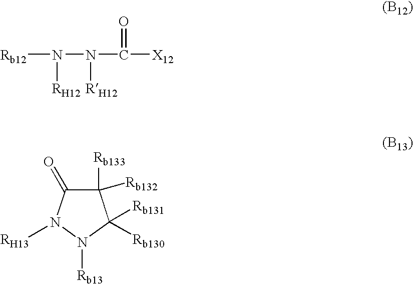

In formulae (B₁) to (B₁₃), R_{b1}, R_{b2}, R_{b3}, R_{b4}, R_{b5}, R_{b70}, R_{b71}, R_{b110}, R_{b111}, R_{b112}, R_{b113}, R_{b12}, R_{b13}, R_{N1}, R_{N2}, R_{N3}, R_{N4} and R_{N5} each represent a hydrogen atom, an alkyl group, an aryl group or a heterocyclic group; R_{H3}, R_{H5}, R′_{H5}, R_{H12}, R′_{H12} and R_{H13} each represent a hydrogen atom, an alkyl group, an aryl group, an acyl group, an alkylsulfonyl group or an arylsulfonyl group, and of these, R_{H3} may further be a hydroxyl group. R_{b100}, R_{b101}, R_{b102}, R_{b130} to R_{b133} each represent a hydrogen atom or a substituent. Y₇ and Y₈ each represent a substituent except hydroxyl group. Y₉ represents a substituent, m₅ indicates 0 or 1, m₇ indicates an integer of from 0 to 5, m₈ indicates an integer of from 1 to 5, m₉ indicates an integer of from 0 to 4. Y₇, Y₈ and Y₉ may further be an aryl group condensed with the benzene ring (e.g., benzene-condensed ring), which maybe further substituted. Z₁₀ represents a non-metallic atomic group capable of forming a ring; X₁₂ represents a hydrogen atom, an alkyl group, an aryl group, a heterocyclic group, an alkoxy group, an amino group (including alkylamino group, arylamino group, heterocyclic amino group and cyclic amino group), or a carbamoyl group.

In formula (B₆), X₆ and X′₆ each represent a hydroxyl group, an alkoxy group, a mercapto group, an alkylthio group, an amino group (including alkylamino group, arylamino group, heterocyclic amino group and cyclic amino group), an acylamino group, a sulfonamido group, an alkoxycarbonylamino group, an ureido group, an acyloxy group, an acylthio group, an alkylaminocabonyloxy group, or an arylaminocarbonyloxy group. R_{b60} and R_{b61} each represent an alkyl group, an aryl group, an amino group, an alkoxy group, or an aryloxy group, and R_{b60} and R_{b61} may bond to each other to form a cyclic structure.

In the description of the groups in formulae (B₁) to (B₁₃), the alkyl group means a linear, branched or cyclic, substituted or unsubstituted alkyl group having from 1 to 30 carbon atoms; the aryl group means a monocyclic or condensed cyclic, substituted or unsubstituted aromatic hydrocarbon group such as phenyl or naphthyl group; and the heterocyclic group means an aromatic or non-aromatic, monocyclic or condensed cyclic, substituted or unsubstituted heterocyclic group that has at least one hetero atom.

The substituent that is referred to in the description of the groups in formulae (B₁) to (B₁₃) may have the same meaning as that of the substituent for the above-mentioned adsorptive group. The substituents may be further substituted with any other substituent.

In formulae (B₁) to (B₅), R_{N1}, R_{N2}, R_{N3}, R_{N4} and R_{N5} each are preferably a hydrogen atom or an alkyl group. The alkyl group is preferably a linear, branched or cyclic, substituted or unsubstituted alkyl group having from 1 to 12 carbon atoms, more preferably a linear or branched, substituted or unsubstituted alkyl group having from 1 to 6 carbon atoms, such as methyl, ethyl, propyl or benzyl group.

In formula (B₁), R_{b1} is preferably an alkyl group or a heterocyclic group. The alkyl group is a linear, branched or cyclic, substituted or unsubstituted alkyl group preferably having from 1 to 30 carbon atoms, more preferably from 1 to 18 carbon atoms. The heterocyclic group is a 5-membered or 6-membered, monocyclic or condensed cyclic, aromatic or non-aromatic heterocyclic group, which may be substituted. The heterocyclic group is preferably an aromatic heterocyclic group, including, for example, a pyridine ring group, a pyrimidine ring group, a triazine ring group, a thiazole ring group, a benzothiazole ring group, an oxazole ring group, a benzoxazole ring group, an imidazole ring group, a benzimidazole ring group, a pyrazole ring group, an indazole ring group, an indole ring group, a purine ring group, a quinoline ring group, an isoquinoline ring group, and a quinazoline ring group. Especially preferred are a triazine ring group and a benzothiazole ring group. Also preferred are compounds of formula (B₁) in which the alkyl or heterocyclic group of R_{b1} has one or more substituents —N(R_{N1})OH.

In formula (B₂), R_{b2} is preferably an alkyl group, an aryl group or a heterocyclic group, more preferably an alkyl group or an aryl group. The preferred range of the alkyl group may be the same as that mentioned hereinabove for R_{b1}The aryl group is preferably a phenyl or naphthyl group, more preferably a phenyl group, which may be substituted. Also preferred are compounds of formula (B₂) in which the group of R_{b2} has one or more substituents —CON(R_{N2})OH.

In formula (B₃), R_{b3} is preferably an alkyl group or an aryl group. Their preferred range may be the same as that mentioned hereinabove for R_{b1} and R_{b2}. R_{H3} is preferably a hydrogen atom, an alkyl group or a hydroxyl group, more preferably a hydrogen atom. Also preferred are compounds of formula (B₃) in which the group of R_{b3} has one or more substituents —N(R_{H3})CON(R_{H3})OH. R_{b3} and R_{N3} may bond to each other to form a cyclic structure (preferably a 5-membered or 6-membered saturated heterocyclic ring).

In formula (B₄), R_{b1} is preferably an alkyl group, and its preferred range may be the same as that mentioned hereinabove for R_{b1}. Also preferred are compounds of formula (B₄) in which the group of R_{b4} has one or more substituents —OCON(R_{N4})OH.

In formula (B₅), R_{b1} is preferably an alkyl group or an aryl group, more preferably an aryl group. Their preferred range may be the same as that mentioned hereinabove for R_{b1} and R_{b2}. R_{H5} and R′_{H5} each are preferably a hydrogen atom or an alkyl group, more preferably a hydrogen atom.

In formula (B₆), R_{b60} preferably bonds to R_{b61} to form a cyclic structure. The cyclic structure may be a 5-membered to 7-membered, non-aromatic carbocyclic or heterocyclic, monocyclic or condensed cyclic group. Preferred examples of the cyclic structure are 2-cyclopenten-1-one ring, 2,5-dihydrofuran-2-one ring, 3-pyrrolin-2-one ring, 4-pyrazolin-3-one ring, 2-cyclohexen-1-one ring, 5,6-dihydro-2H-pyran-2-one ring, 5,6-dihydro-2-pyridone ring, 1,2-dihydronaphthalen-2-one ring, coumarin ring (benzo-α-pyran-2-one ring), 2-quinolone ring, 1,4-dihydronaphthalen-1-one ring, chromone ring (benzo-γ-pyran-4-one ring), 4-quinolone ring, inden-1-one ring, 3-pyrroline-2,4-dione ring, uracil ring, thiouracil ring, and dithiouracil ring. More preferred are 2-cyclopenten-1-one ring, 2,5-dihydrofuran-2-one ring, 3-pyrrolin-2-one ring, 4-pyrazolin-3-one ring, 1,2-dihydronaphthalen-2-one ring, coumarin ring (benzo-α-pyran-2-one ring), 2-quinolone ring, 1,4-dihydronaphthalen-1-one ring, chromone ring (benzo-γ-pyran-4-one ring), 4-quinolone ring, inden-1-one ring, and dithiouracil ring; and even more preferred are 2-cyclopenten-1-one ring, 2,5-dihydrofuran-2-one ring, 3-pyrrolin-2-one ring, inden-1-one ring, and 4-pyrazolin-3-one ring.

When X₆ and X′₆ each are a cyclic amino group, the cyclic amino group is a non-aromatic nitrogen-containing heterocyclic group that bonds to the compound via its nitrogen atom. For example, it includes a pyrrolidino group, a piperidino group, a piperazino group, a morpholino group, a 1,4-thiazin-4-yl group, a 2,3,5,6-tetrahydro-1,4-thiazin-4-yl group, and an indolyl group.

X₆ and X′₆ each are preferably a hydroxyl group, a mercapto group, an amino group (including alkylamino group, arylamino group and cyclic amino group), an acylamino group, a sulfonamido group, an acyloxy group or an acylthio group, more preferably a hydroxyl group, a mercapto group, an amino group, an alkylamino group, a cyclic amino group, a sulfonamido group, an acylamino group or an acyloxy group, even more preferably a hydroxyl group, an amino group, an alkylamino group, or a cyclic amino group. Still preferably, at least one of X₆ and X′₆ is a hydroxyl group.

In formula (B₇), R_{b70} and R_{b71} each are preferably a hydrogen atom, an alkyl group or an aryl group, more preferably an alkyl group. The preferred range of the alkyl group may be the same as that mentioned hereinabove for R_{b1}R_{b70} and R_{b71} may bond to each other to form a cyclic structure (e.g., pyrrolidine ring, piperidine ring, morpholine ring, thiomorpholine ring). The substituent of Y₇ is preferably an alkyl group (its preferred range may be the same as that mentioned hereinabove for R_{b1}), an alkoxy group, an amino group, an acylamino group, a sulfonamido group, an ureido group, an acyl group, an alkoxycarbonyl group, a carbamoyl group, a sulfamoyl group, a chlorine atom, a sulfo group or its salt, or a carboxyl group or its salt; and m₇ is preferably from 0 to 2.

In formula (B₈), m₈ is preferably from 1 to 4, and Y₈s may be the same or different. Y₈ when m₈ is 1, or at least one of Y₈s when m₈ is 2 or more is preferably an amino group (including alkylamino group and arylamino group), a sulfonamido group or an acylamino group. When m₈ is 2 or more, the remaining Y₈s are preferably any of a sulfonamido group, an acylamino group, an ureido group, an alkyl group, an alkylthio group, an acyl group, an alkoxycarbonyl group, a carbamoyl group, a sulfo group or its salt, a carboxyl group or its salt, or a chlorine atom. When the substituent of Y₈ is further substituted at the ortho or para-position of the hydroxyl group, with an o′- (or p′-)hydroxyphenylmethyl group (that may be optionally substituted), the compounds are bisphenols and they are preferred examples of formula (B₈). Also preferred are naphthols of formula (B₈) in which Y₈ is a benzene-condensed ring.

In formula (B₉), the hydroxy substituents may be ortho-positioned (catechols) or meta-positioned (resorcinols) or para-positioned (hydroquinones) relative to each other. m₉ is preferably 1 or 2, and Y₉s may be the same or different. The substituent of Y₉ is preferably a chlorine atom, an acylamino group, an ureido group, a sulfonamido group, an alkyl group, an alkylthio group, an alkoxy group, an acyl group, an alkoxycarbonyl group, a carbamoyl group, a sulfo group or its salt, a carboxyl group or its salt, a hydroxyl group, an alkylsulfonyl group, or an arylsulfonyl group. Preferred are 1,4-naphthohydroquinones of formula (B₉) in which Y₉ is a benzene-condensed ring. When formula (B₉) represents catechols, Y₉ is especially preferably a sulfo group or its salt, or a hydroxyl group.

When R_{b100}, R_{b101} and R_{b102} in formula (B₁₀) each are a substituent, preferred examples of the substituent may be the same as those mentioned hereinabove for Y₉. The substituent is specially preferably is an alkyl group (more preferably, methyl group). The cyclic structure which Z₁ forms is preferably a chroman ring or a 2,3-dihydrobenzofuran ring, which may be substituted. In addition, the cyclic structure may form a spiro ring.

In formula (B₁₁), R_{b110}, R_{b111}, R_{b112} and R_{b113} each are preferably an alkyl group, an aryl group or a heterocyclic group, and their preferred range may be the same as that mentioned hereinabove for R_{b1} and R_{b2}. Especially preferred is an alkyl group. Two alkyl groups of R_{b110} to R_{b113} may bond to each other to form a cyclic structure. The cyclic structure may be a 5-membered or 6-membered non-aromatic heterocyclic ring, including, for example, a pyrrolidine ring, a piperidine ring, a morpholine ring, a thiomorpholine ring, and a hexahydropyridazine ring.

In formula (B₁₂), R_{b12} is preferably an alkyl group, an aryl group or a heterocyclic group, and its preferred range may be the same as that mentioned hereinabove for R_{b1} and R_{b2}. X₁₂ is preferably an alkyl group, aryl group (especially phenyl group), a heterocyclic group, an alkoxy group, an amino group (including alkylamino group, arylamino group, heterocyclic amino group and cyclic amino group), or a carbamoyl group, more preferably an alkyl group (even more preferably having from 1 to 8 carbon atoms, an aryl group (even more preferably phenyl group), or an amino group (including alkylamino group, arylamino group and cyclic amino group). R_{H12} and R′_{H12} each are preferably a hydrogen atom or an alkyl group, more preferably a hydrogen atom.

In formula (B₁₃), R_{b13}is preferably an alkyl group or an aryl group, and its preferred range may be the same as that mentioned hereinabove for R_{b1} and R_{b2}. R_{b130}, R_{b131}, R_{b132} and R_{b133} each are preferably a hydrogen atom, an alkyl group (more preferably having from 1 to 8 carbon atoms), or an aryl group (more preferably phenyl group). R_{H13} is preferably a hydrogen atom or an acyl group, more preferably a hydrogen atom.

In formula (I), the reducing group of B is preferably hydroxylamines, hydroxamic acids, hydroxyureas, hydroxysemicarbazides, phenols, hydrazines, hydrazides or phenidones, more preferably hydroxyureas, hydroxysemicarbazides, phenols, hydrazides or phenidones.

In formula (I), the oxidation potential of the reducing group of B may be measured according to the process described in Akira Fujishima, Electrochemically Measuring MEthod, pp. 150-208 (by Gihodo Publishing) or in Lecture of Experimental Chemistry, 4th Ed., Vol. 9, pp. 282-344 by the Chemical Society of Japan (by Maruzen). For example, it may be measured through rotary disc voltammetry. Concretely, the sample is dissolved in a mixed solution of methanol and a Britton-Robinson buffer having a pH of 6.5 at a voume ratio of 10%/90%, and nitrogen gas is introduced to the resultant for 10 minutes. A rotary disc electrode of glassy carbon is used as a working electrode, and a platinum wire is used as a counter electrode, and a saturated calomel electrode is used as a reference electrode. At 25° C., at a revolution of 1000 rpm and at a sweeping rate of 20 mV/sec, the sample solution is analyzed. From the voltamograph thus obtained, the half-wave potential (E1/2) of the sample is obtained.

When measured according to the method mentioned above, the oxidation potential of the reducing group B in the invention is preferably from about −0.3 V to about 1.0 V, more preferably from about −0.1 V to about 0.8 V, even more preferably from about 0 to about 0.7 V.

Most compounds having the reducing group B are known in the art of photography. Their examples are described in many patent references, for example, JP-A Nos. 2001-42466, 8-114884, 8-314051, 8-333325, 9-133983, 11-282117, 10-246931, 10-90819, 9-54384, 10-171060 and 7-77783. Phenols described in U.S. Pat. No. 6,054,260 are usable herein.

The compounds of formula (I) for use in the invention may have a ballast group or a polymer chain that is generally seen in passive photographic additives such as couplers. For the polymer, for example, referred to are those mentioned in JP-A No. 1-100530.

The compounds of formula (I) may be in any form of bis compounds or tris compounds. Preferably, the compounds of formula (I) have a molecular weight of from 100 to 10000, more preferably from 120 to 1000, even more preferably from 150 to 500.

Examples of the compounds of formula (I) are mentioned below, however, the invention is not limited thereto. In addition to these, the compounds described in JP-A Nos. 2000-330247 and 2001-42446 are also preferred for use in the invention.

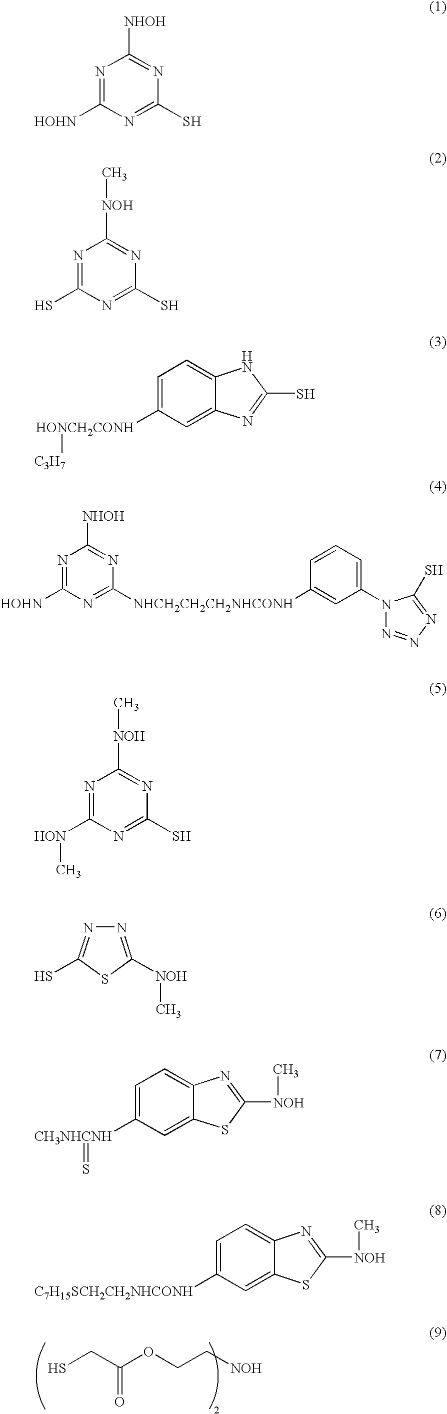

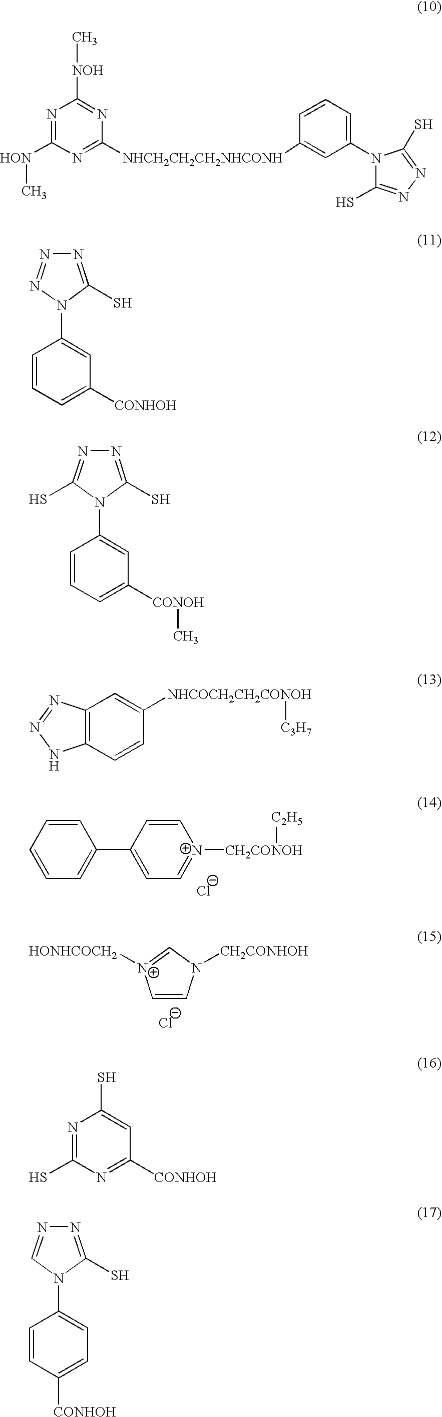

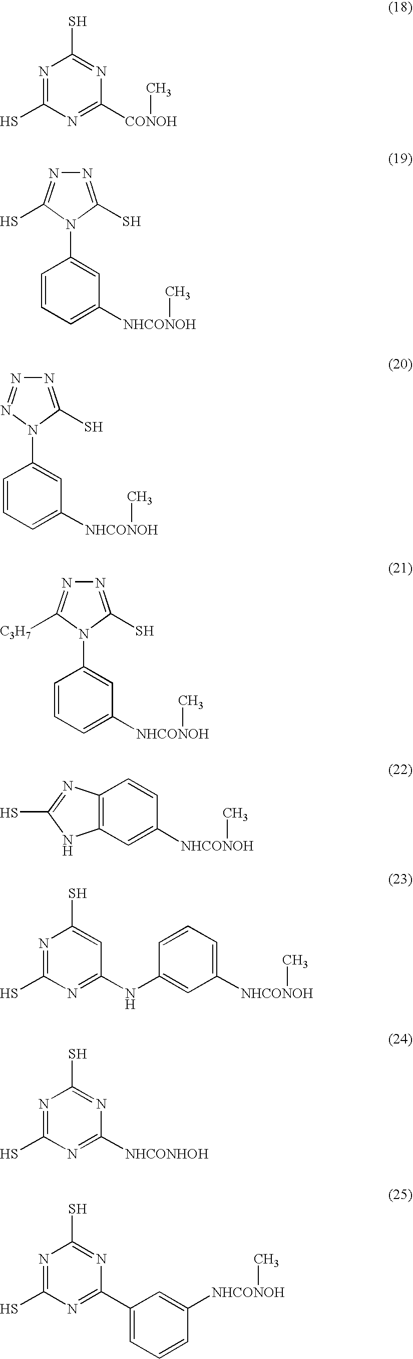

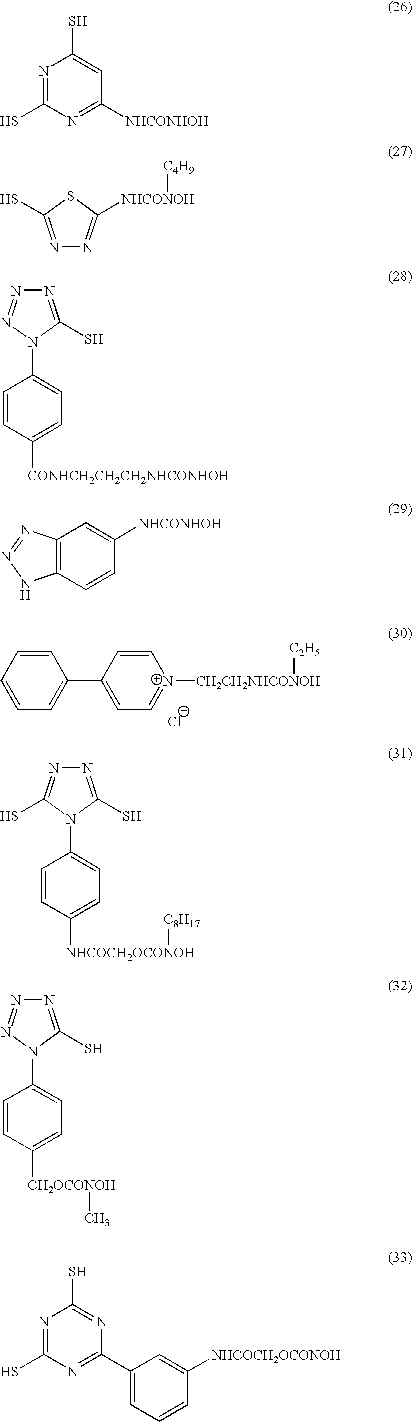

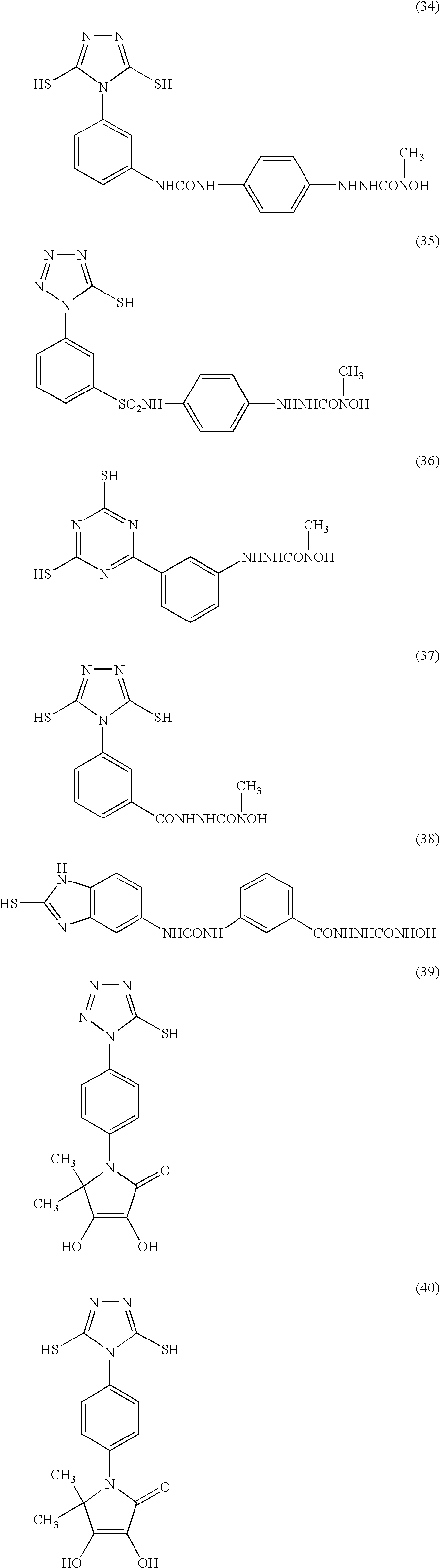

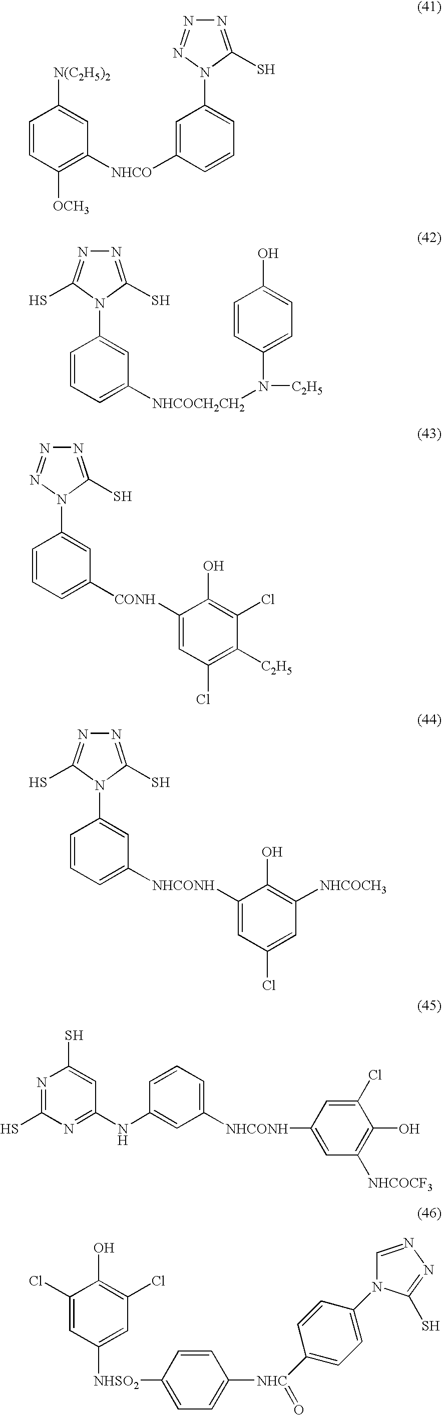

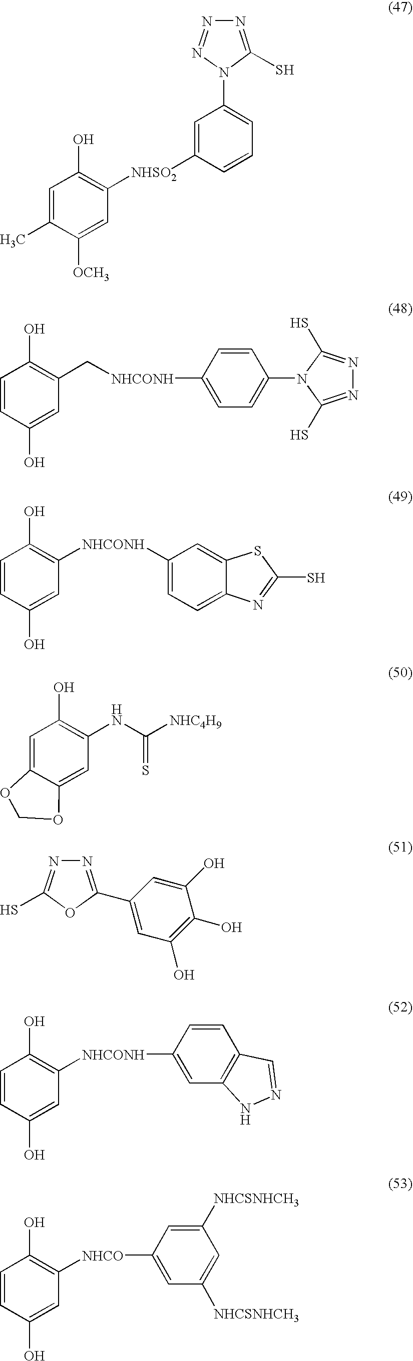

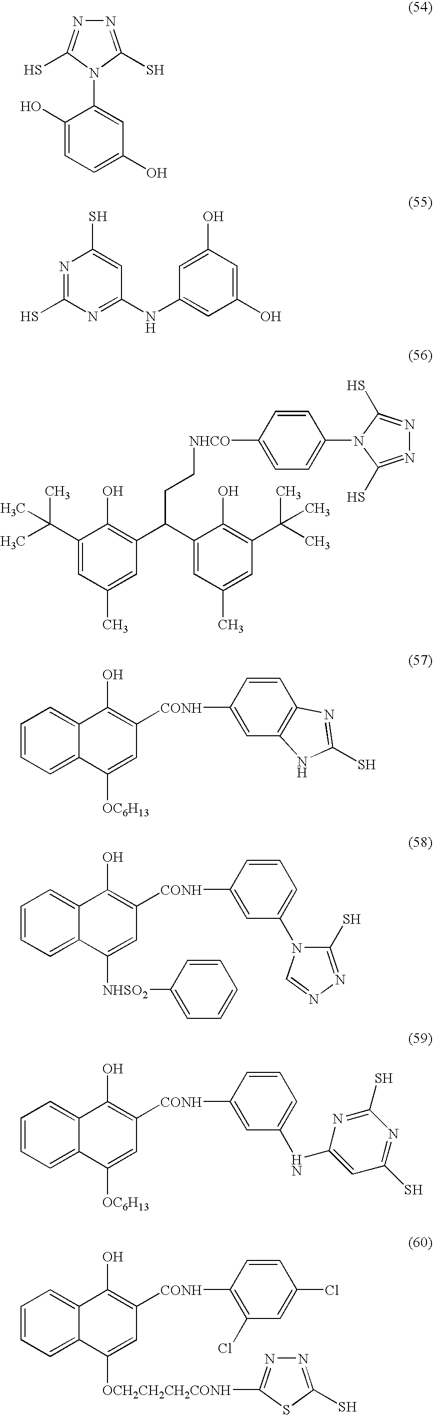

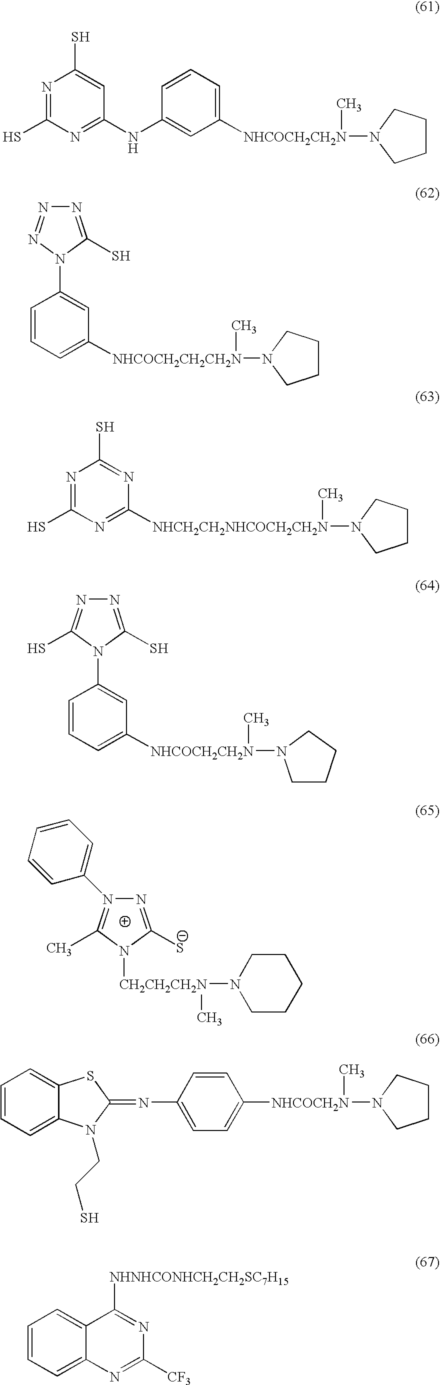

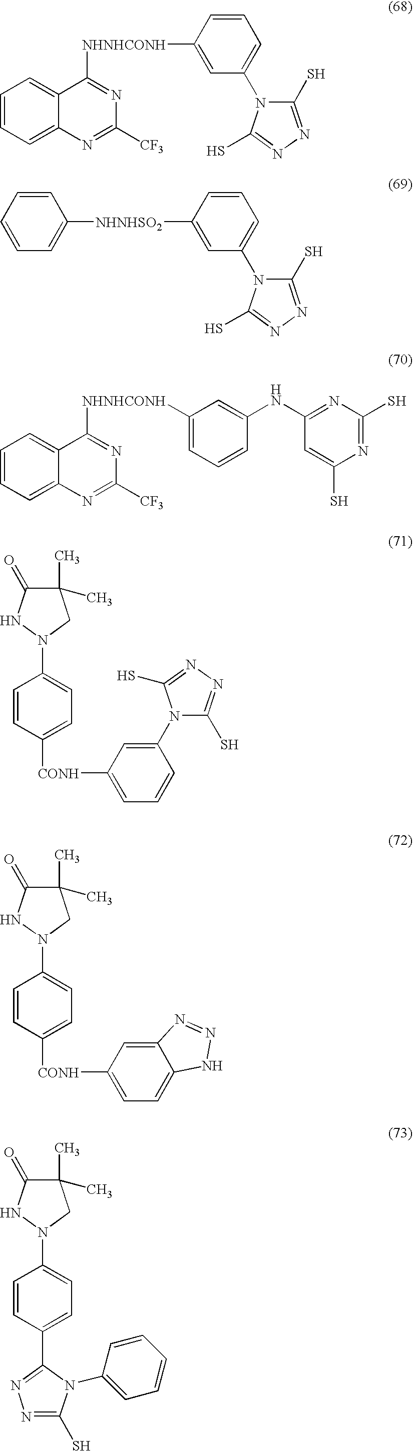

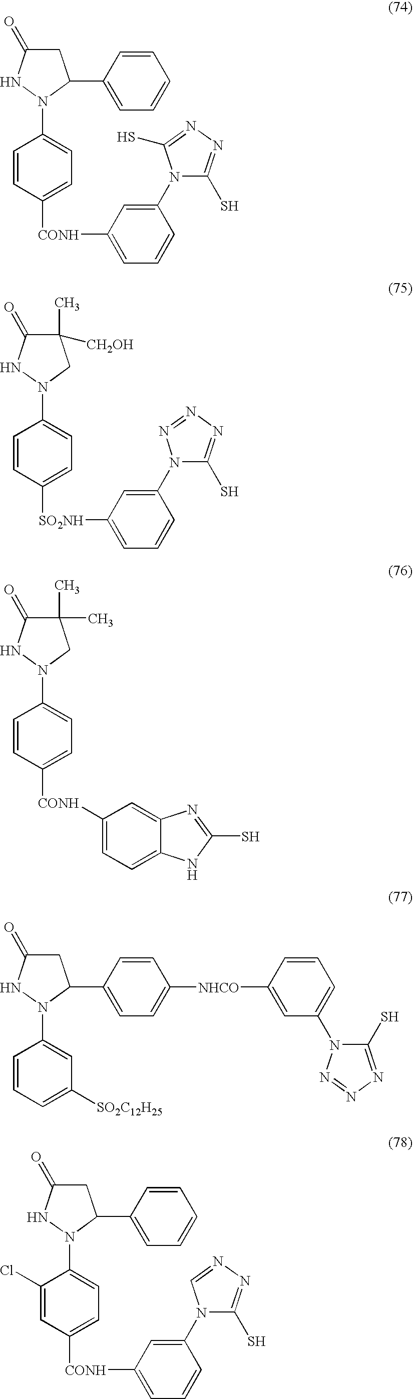

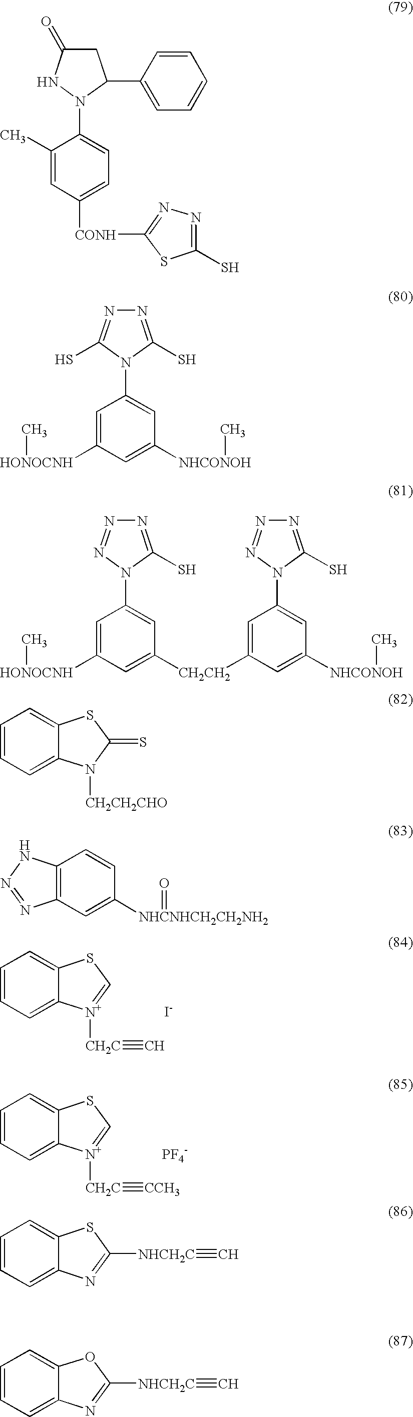

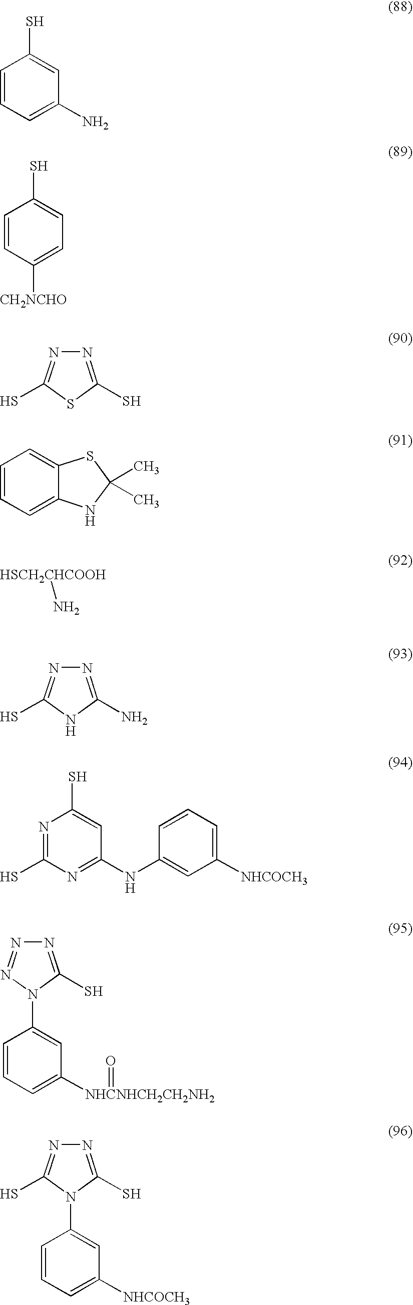

The compounds for use in the invention may be readily produced in any known manner.

One of the compounds of formula (I) may be used alone in the invention or at least two of the compounds of formula (I) may be used in combination. When two or more compounds are used together, they may be added to the same layer or may be separately added to different layers. They may be added in the same manner or in different methods.

Preferably, the compound of formula (I) is added to a silver halide emulsion layer, more preferably to such a layer during preparation of the emulsion. When the compound is added to the emulsion during preparation of the emulsion, it may be added thereto in any stage of emulsion production. For example, the compound may be added to the emulsion during preparation of silver halide grains, or may be added thereto before the start of desalting, during desalting, before the start of chemically ripening, during chemically ripening, or before formulation of the finished emulsion. If desired, the compound may be divided into some portions and they may be separately added to the emulsion in these steps. Preferably, the compound is added to an emulsion layer, but it may also be added to a protective layer or an interlayer that is adjacent to the emulsion layer so that it may diffuse into the adjacent emulsion layer.

The preferred amount of the compound to be added varies significantly depending on the method of the addition and on the type of the compound to be added, but in general, it may be from 1×10⁻⁶ to 1 mol, preferably from 1×10⁻⁵ to 5×10⁻¹ mols, even more preferably from 1×10⁻⁴ to 1×10⁻¹ mols, per mol of the photosensitive silver halide in the emulsion.

The compound of formula (I) to be added may be dissolved in water or in a water-soluble solvent such as methanol or ethanol, or in a mixed solvent of these. In this stage, the pH of the solution may be suitably controlled by an acid or a base, or a surfactant may be added to the solution. If desired, the compound to be added may be dispersed in a high-boiling-point organic solvent to form an emulsified dispersion. Also if desired, a solid dispersion of the compound may be added.

11) Combined Use of Silver Halides:

The heat-developable light-sensitive material of the invention may contain only one type or two or more different types of photosensitive silver halide grains (these differ in their mean grain size, halogen composition or crystal habit, or in conditions of their chemical sensitization). Combining two or more types of photosensitive silver halide grains differing in their sensitivity enables control of the gradation of the images to be formed in the heat-developable light-sensitive material. For the technique relating to it, referred to are JP-A Nos. 57-119341, 53-106125, 47-3929, 48-55730, 46-5187, 50-73627 and 57-150841. The sensitivity difference between the combined silver halide grains is preferably such that the diference between sensitivities of the respective emulsions is at least 0.2 log E.

12) Coating Amount:

The amount of the photosensitive silver halide grains to be in the heat-developable light-sensitive material is, in terms of the amount of silver per m² of the material, preferably from 0.03 to 0.6 g/m², more preferably from 0.05 to 0.4 g/m², most preferably from 0.07 to 0.3 g/m². Relative to one mol of the organic silver salt therein, the amount of the photosensitive silver halide grains to be in the material preferably falls between 0.01 mols and 0.5 mols, more preferably between 0.02 mols and 0.3 mols, even more preferably between 0.03 mols and 0.2 mols.

13) Mixing of Photosensitive Silver Halide and Organic Silver Salt:

Regarding a method and conditions for mixing the photosensitive silver halide and an organic silver salt prepared separately, for example, employable is a method of mixing them in a high-speed stirrer, a ball mill, a sand mill, a colloid mill, a vibration mill, a homogenizer or the like; or a method of adding the photosensitive silver halide grains prepared to the organic silver salt which is being prepared, in any desired timing to produce the organic silver salt mixed with the silver halide grains. However, the mixing method is not specifically defined so far as it ensures the advantages of the invention. Mixing two or more different types of aqueous, organic silver salt dispersions with two or more different types of aqueous, photosensitive silver salt dispersions is also preferred for suitably controlling the photographic properties of the heat-developable light-sensitive material of the invention.

14) Mixing of Silver Halide in Coating Liquid:

The preferred time at which the silver halide grains are added to the coating liquid for forming an image-forming layer of the heat-developable light-sensitive material of the invention may fall between 180 minutes before coating the liquid and a time just before the coating, preferably between 60 minutes before the coating and 10 seconds before it. However, there is no specific limitation thereon, so far as the method and the conditions employed to add the grains to the coating liquid ensure the advantages of the invention. Concretely for mixing them, employable is a method of adding the grains to the coating liquid in a tank in such a controlled manner that the mean residence time of the grains in the tank, as calculated from the amount of the grains added and the flow rate of the coating liquid to a coater, can be a predetermined period of time; or a method of mixing them with a static mixer, for example, as in N. Harnby, M. F. Edwards & A. W. Nienow's Liquid Mixing Technology, Chap. 8 (translated by Koji Takahasi, published by Nikkan Kogyo Shinbun, 1989).

Description of Binder:

The binder to be in the organic silver salt-containing layer in the invention may be polymer of any type, but is preferably transparent or semitransparent and is generally colorless. For it, for example, preferred are natural resins, polymers and copolymers; synthetic resins, polymers and copolymers; and other film-forming media. More concretely, they include, for example, gelatins, rubbers, poly(vinyl alcohols), hydroxyethyl celluloses, cellulose acetates, cellulose acetatebutyrates, poly(vinylpyrrolidones), casein, starch, poly(acrylic acids), poly(methylmethacrylic acids), poly(vinyl chlorides), poly(methacrylic acids), styrene-maleic anhydride copolymers, styrene-acrylonitrile copolymers, styrene-butadiene copolymers, poly(vinylacetals) (e.g., poly(vinylformal), poly(vinylbutyral)), poly(esters), poly(urethanes), phenoxy resins, poly(vinylidene chlorides), poly(epoxides), poly(carbonates), poly(vinyl acetates), poly(olefins), cellulose esters, and poly(amides). To prepare a coating liquid of the binder, water or an organic solvent or an emulsion may be used.

The glass transition point of the binder to be in the organic silver salt-containing layer in the invention preferably falls between 10° C. and 80° C. (the binder of the type will be hereinafter referred to as a high-Tg binder), more preferably between 10° C. and 70° C., even more preferably between 15° C. and 60° C.

In this specification, Tg is calculated according to the following equation:

1/Tg=Σ(Xi/Tgi)

The polymer whose glass transition point Tg is calculated as in the above comprises ns monomers copolymerized (i indicates the number of the monomers copolymerized, falling between 1 and n); Xi indicates the mass fraction of i′th monomer (ΣXi=1); Tgi indicates the glass transition point (in terms of the absolute temperature) of the homopolymer of i′th monomer alone; and Σ indicates the sum of i falling between 1 and n. For the glass transition point (Tgi) of the homopolymer of each monomer alone, referred to is the description in Polymer Handbook (3rd edition) (written by J. Brandrup, E. H. Immergut (Wiley-Interscience, 1989)).

If desired, two or more different types of binders may be combined and used herein. For example, a binder having a glass transition point of 20° C. or higher and a binder having a glass transition point of lower than 20° C. may be combined. When at least two polymers that differ in Tg are blended for use herein, it is desirable that the weight-average Tg of the resulting blend falls within the range defined as above.

In the invention, it is desirable that the organic silver salt-containing layer is formed by applying a coating liquid, in which at least 30% by mass of the solvent is water, onto a support, and drying the resultant coating.

When the organic silver salt-containing layer in the invention is formed by using such a coating liquid in which at least 30% by mass of the solvent is water and by drying the resultant coating, and when the binder in the organic silver salt-containing layer is soluble or dispersible in an aqueous solvent (watery solvent), especially when the binder in the organic silver salt-containing layer is a polymer latex that has an equilibrium moisture content at 25° C. and 60% RH of at most 2% by mass, the heat-developable light-sensitive material having such a layer has improved properties. Most preferably, the binder for use in the invention is so designed that its ionic conductivity is at most 2.5 mS/cm. In order to prepare such a binder, for example, employable is a method of purifying a prepared binder polymer through an advanced separation membrane.

The aqueous solvent in which the polymer binder is soluble or dispersible is water or a mixed solvent of water and at most 70% by mass of a water-miscible organic solvent. The water-miscible organic solvent includes, for example, alcohols such as methyl alcohol, ethyl alcohol, propyl alcohol; cellosolves such as methyl cellosolve, ethyl cellosolve, butyl cellosolve; ethyl acetate, and dimethylformamide.

The terminology “aqueous solvent” referred to herein can apply also to polymer systems in which the polymer is not thermodynamically dissolved but is dispersed.

The “equilibrium moisture content at 25° C. and 60% RH” referred to herein is represented by the following equation, in which W₁ indicates the weight of a polymer in humidity-conditioned equilibrium at 25° C. and 60% RH, and W₀ indicates the absolute dry weight of the polymer at 25° C.

Equilibrium moisture content at 25° C. and 60% RH=[(W₁−W₀)/W₀]×100 (mass %)

For the details of the definition of moisture content and the method for measuring it, for example, referred to is Polymer Engineering, Lecture 14, Test Methods of Polymer Materials (by the Polymer Society of Japan, Chijin Shokan Publishing).

Preferably, the equilibrium moisture content at 25° C. and 60% RH of the binder polymer for use in the invention is at most 2% by mass, more preferably from 0.01 to 1.5% by mass, even more preferably from 0.02 to 1% by mass.

Polymers that serve as the binder in the invention are preferably dispersible in aqueous solvents. Polymer dispersions include, for example, latex in which water-insoluble hydrophobic fine polymer particles are dispersed, and a dispersion in which polymer molecules or micelles are dispersed. Any of these are usable herein, but preferred is the latex. The particles in the polymer dispersions preferably have a mean particle size falling between 1 and 50000 nm, more preferably between 5 and 1000 nm, even more preferably between 10 and 500 nm, still more preferably between 50 and 200 nm. The particle size distribution of the dispersed polymer particles is not specifically defined. For example, the dispersed polymer particles may have a broad particle size distribution, or may have a particle size distribution of monodispersion. If desired, two or more different types of polymer particle monodispersions may be combined for use herein, and it is desirable for controlling the physical properties of coating liquids.

In preferred embodiments of the heat-developable light-sensitive material of the invention, favorably used are hydrophobic polymers that are dispersible in aqueous solvents. The hydrophobic polymers include, for example, acrylic polymers, poly(esters), rubbers (e.g., SBR resins), poly(urethanes), poly(vinyl chlorides), poly(vinyl acetates), poly(vinylidene chlorides), and poly(olefins). These polymers may be linear, branched or crosslinked ones. They may be homopolymers from one type of monomer, or copolymers from two or more different types of monomers. The copolymers may be random copolymers or block copolymers. The polymers for use herein preferably have a number-average molecular weight falling between 5000 and 1000000, more preferably between 10000 and 200000. Polymers whose molecular weight is too small are unfavorable to the invention, since the mechanical strength of the emulsion layer comprising such a polymer is low; but polymers whose molecular weight is too large are also unfavorable since their film forming properties are not good. Crosslinked polymer latex is especially preferred for use herein.

Examples of Latex:

Preferred examples of polymer latex for use herein are mentioned below. They are expressed by the constituent monomers, and each numeral parenthesized indicates the proportion, in terms of % by mass, of the monomer unit, and the molecular weight is the number-average molecular weight of the polymer. Polyfunctional monomers form a crosslinked structure, to which the concept of molecular weight cannot apply. That type of the polymer latex is referred to as “crosslinked”, and the molecular weight is omitted. Tg indicates the glass transition point of the polymer latex.

P-1: Latex of -MMA(70)-EA(27)-MAA(3)- (molecular weight: 37000, Tg: 61° C.)

P-2: Latex of -MMA(70)-2EHA(20)-St(5)-AA(5)- (molecular weight: 40000, Tg: 59° C.)

P-3: Latex of -St(50)-Bu(47)-MMA(3)- (crosslinked, Tg: −17° C.)

P-4: Latex of -St(68)-Bu(29)-AA(3)- (crosslinked, Tg: 17° C.)

P-5: Latex of -St(71)-Bu(26)-AA(3)- (crosslinked, Tg: 24° C.)

P-6: Latex of -St(70)-Bu(27)-IA(3)- (crosslinked)

P-7: Latex of -St(75)-Bu(24)-AA(1)- (crosslinked, Tg: 29° C.)

P-8: Latex of -St(60)-Bu(35)-DVB(3)-MAA(2)- (crosslinked)

P-9: Latex of -St(70)-Bu(25)-DVB(2)-AA(3)- (crosslinked)

P-10: Latex of -VC(50)-MMA(20)-EA(20)-AN-(5)-AA(5)-(molecular weight: 80000)

P-11: Latex of -VDC(85)-MMA(5)-EA(5)-MAA(5)- (molecular weight: 67000)

P-12: Latex of -Et(90)-MAA(10)- (molecular weight: 12000)

P-13: Latex of -St(70)-2EHA(27)-AA(3)- (molecular weigh: 130000, Tg: 43° C.)

P-14: Latex of -MMA(63)-EA(35)-AA(2)- (molecular weight: 33000, Tg: 47° C.)

P-15: Latex of -St(70.5)-Bu(26.5)-AA(3)- (crosslinked, Tg: 23° C.)

P-16: Latex of -St(69.5)-Bu(27.5)-AA(3)- (crosslinked, Tg: 20.5° C.)

Abbreviations of the constituent monomers are as follows:

MMA: methyl methacrylate

EA: ethyl acrylate

MAA: methacrylic acid

2EHA: 2-ethylhexyl acrylate

St: styrene

Bu: butadiene

AA: acrylic acid

DVB: divinylbenzene

VC: vinyl chloride

AN: acrylonitrile

VDC: vinylidene chloride

Et: ethylene

IA: itaconic acid

The polymer latexes mentioned above are commercially available. Some commercial products employable herein are mentioned below. Examples of acrylic polymers are CEBIAN A-4635, 4718, 4601 (all from Daicel Chemical Industries), and Nipol Lx811, 814, 821, 820, 857 (all from Nippon Zeon); examples of poly(esters) are FINETEX ES650, 611, 675, 850 (all from Dai-Nippon Ink & Chemicals), and WD-size, WMS (both from Eastman Chemical); examples of poly(urethanes) are HYDRAN AP10, 20, 30, 40 (all from Dai-Nippon Ink & Chemicals); examples of rubbers are LACSTAR 7310K, 3307B, 4700H, 7132C (all from Dai-Nippon Ink & Chemicals), and Nipol Lx416, 410, 438C, 2507 (all from Nippon Zeon); examples of poly (vinyl chlorides) are G351, G576 (both from Nippon Zeon); examples of poly(vinylidene chlorides) are L502, L513 (both from Asahi Kasei); and examples of poly(olefins) are CHEMIPEARL S120, SA100 (both from Mitsui Petrochemical).

These polymer latexes may be used either alone or in combination.

Preferred Latex:

For the polymer latex for use herein, especially preferred is styrene-butadiene copolymer latex. In the styrene-butadiene copolymer, the ratio of styrene monomer units to butadiene monomer units preferably falls between 40/60 and 95/5 by weight. Also preferably, the mass of the styrene monomer units and the butadiene monomer units account for from 60 to 99% of the total mass of the copolymer monomers. Still preferably, the polymer latex contains from 1 to 6% by mass, more preferably from 2 to 5% by mass of acrylic acid or methacrylic acid relative to the sum of styrene and butadiene. Even more preferably, the polymer latex contains acrylic acid.

Preferred examples of the styrene-butadiene copolymer latex for use in the invention are the above-mentioned P-3 to P-8 and P-15, and commercial products, LACSTAR-3307B, 7132C, and Nipol Lx416.

The organic silver salt-containing layer of the heat-developable light-sensitive material of the invention may optionally contain a hydrophilic polymer such as gelatin, polyvinyl alcohol, methyl cellulose, hydroxypropyl cellulose or carboxymethyl cellulose. The amount of the hydrophilic polymer that may be in the layer is preferably at most 30% by mass, more preferably at most 20% by mass of all the binder in the organic silver salt-containing layer.

Preferably, the polymer latex as above is used in forming the organic silver salt-containing layer (that is, the image-forming layer) of the heat-developable light-sensitive material of the invention. Concretely, the amount of the binder in the organic silver salt-containing layer is such that the ratio by weight of total binder/organic silver salt falls between 1/10 and 10/1, more preferably between 1/3 and 5/1, even more preferably between 1/1 and 3/1.

The organic silver salt-containing layer is a photosensitive layer (emulsion layer) generally containing a photosensitive silver salt, that is, a photosensitive silver halide. In the layer, the ratio by weight of total binder/silver halide preferably falls between 5 and 400, more preferably between 10 and 200.

The overall amount of the binder in the image-forming layer of the heat-developable light-sensitive material of the invention preferably falls between 0.2 and 30 g/m², more preferably between 1 and 15 g/m², even more preferably between 2 and 10 g/m². The image-forming layer may optionally contain a crosslinking agent, and a surfactant which is used to improve the coating properties of the coating liquid for the layer.

Preferred Solvent of Coating Liquid:

Preferably, the solvent of the coating liquid for the organic silver salt-containing layer of the heat-developable light-sensitive material of the invention is an aqueous solvent that contains at least 30% by mass of water. For simple explanation, the solvent referred to herein includes both a solvent and a dispersion medium. The components other than water of the aqueous solvent may be any organic solvent that is miscible with water, including, for example, methyl alcohol, ethyl alcohol, isopropyl alcohol, methyl cellosolve, ethyl cellosolve, dimethylformamide, and ethyl acetate. The water content of the solvent of the coating liquid is preferably at least 50% by mass, more preferably at least 70% by mass. Preferred examples of the solvent composition are water alone, a mixture of water and methyl alcohol at a mass ratio of 90/10, a mixture of water and methyl alcohol at a mass ratio of 70/30, a mixture of water, methyl alcohol and dimethylformamide at a mass ratio of 80/15/5, a mixture of water, methyl alcohol and ethyl cellosolve at a mass ratio of 85/10/5, a mixture of water, methyl alcohol and isopropyl alcohol at a mass ratio of 85/10/5.

Description of Antifoggant:

Antifoggants, stabilizers and stabilizer precursors usable in the invention are described, for example, in JP-A No. 10-62899, paragraph [0070]; EP-A No. 0803764A1, from page 20, line 57 to page 21, line 7; JP-A Nos. 9-281637 and 9-329864; U.S. Pat. No. 6,083,681; and EP No. 1,048,975. Antifoggants preferred for use in the invention are organic halides. These are described, for example, in JP-A No. 11-65021, paragraphs [0111] to [0112]. Especially preferred are organic halides of formula (P) in JP-A No. 2000-284399; organic polyhalogen compounds of formula (II) in JP-A No. 10-339934; and organic polyhalogen compounds in JP-A Nos. 2001-31644 and 2001-33911.

Description of Polyhalogen Compound:

Organic polyhalogen compounds preferred for use in the invention are described concretely. Preferably, the polyhalogen compounds for use in the invention are represented by the following formula (H):

Q-(Y)n-C(Z₁)(Z₂)X Formula (H)

wherein Q represents an alkyl, aryl or heterocyclic group; Y represents a divalent linking group; n indicates 0 or 1; Z₁ and Z₂ each represent a halogen atom; and X represents a hydrogen atom or an electron attractive group.

In formula (H), Q is preferably an aryl group or a heterocyclic group.

When Q in formula (H) is a heterocyclic group, it is preferably a nitrogen-containing heterocyclic group that contains one or two nitrogen atoms, more preferably a 2-pyridyl group or a 2-quinolyl group.

When Q in formula (H) is an aryl group, it is preferably a phenyl group substituted with an electron attractive group having a positive Hammett's substituent constant σₚ. For the Hammett's substituent constant, referred to is, for example, Journal of Medicinal Chemistry, 1973, Vol. 16, No. 11, 1207-1216. Preferred examples of the electron attractive group are a halogen atom (fluorine atom with σₚ of 0.06, chlorine atom with σₚ of 0.23, bromine atom with σₚ of 0.23, iodine atom with σₚ of 0.18), a trihalomethyl group (tribromomethyl with σₚ of 0.29, trichloromethyl with σₚ of 0.33, trifluoromethyl with σₚ of 0.54), a cyano group (with σₚ of 0.66), a nitro group (with σₚ of 0.78), an aliphatic, aryl or heterocyclic sulfonyl group (e.g., methanesulfonyl with σₚ of 0.72), an aliphatic, aryl or heterocyclic acyl group (e.g., acetyl with σₚ of 0.50, benzoyl with σₚ of 0.43), an alkynyl group (e.g., C≡CH with σₚ of 0.23), an aliphatic, aryl or heterocyclic oxycarbonyl group (e.g., methoxycarbonyl with σₚ of 0.45, phenoxycarbonyl with σₚ of 0.44), a carbamoyl group (with σₚ of 0.36), a sulfamoyl group (with σₚ of 0.57), a sulfoxide group, a heterocyclic group, and a phosphoryl group. The σₚ of the electron attractive group preferably falls between 0.2 and 2.0, more preferably between 0.4 and 1.0. Of the preferred examples of the electron attractive group mentioned above, more preferred are a carbamoyl group, an alkoxycarbonyl group, an alkylsulfonyl group and an alkylphosphoryl group, and most preferred is a carbamoyl group.

X is preferably an electron attractive group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group, or a sulfamoyl group. Even more preferably, it is a halogen atom. For the halogen atom for X, preferred are chlorine, bromine and iodine atoms, more preferred are chlorine and bromine atoms, and even more preferred is a bromine atom.

Y is preferably —C(═O)—, —SO— or —SO₂—, more preferably —C(═O)— or —SO₂—, even more preferably —SO₂—. n is 0 or 1, but preferably 1.

Specific examples of the compounds of formula (H) for use in the invention are mentioned below.

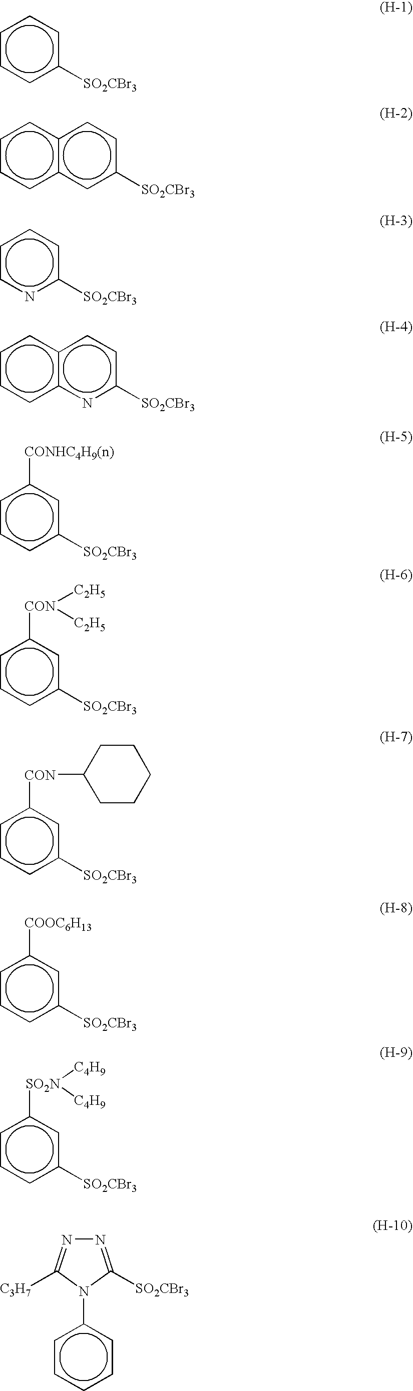

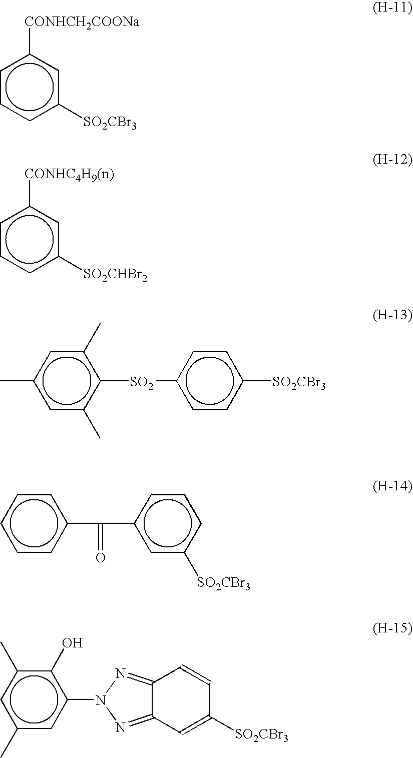

Preferred polyhalogen compounds usable herein other than the above are described in JP-A 2001-31644, 2001-56526 and 2001-209145.

Preferably, the amount of the compound of formula (H) to be in the heat-developable light-sensitive material of the invention falls between 10⁻⁴ and 1 mol, more preferably between 10⁻³ and 0.5 mols, even more preferably between 1×10⁻² and 0.2 mols per mol of the non-photosensitive silver salt in the image-forming layer of the material.

The antifoggant may be incorporated into the heat-developable light-sensitive material of the invention in the same manner as that mentioned hereinabove for incorporating the reducing agent thereinto. Preferably, the organic polyhalogen compound is in the form of a fine solid particle dispersion when it is incorporated into the material.

Other Antifoggants:

Other antifoggants usable herein are mercury(II) salts in JP-A No. 11-65021, paragraph [0113]; benzoic acids in JP-A No. 11-65021, paragraph [0114]; salicylic acid derivatives in JP-A No. 2000-206642; formalin scavenger compounds of formula (S) in JP-A No. 2000-221634; triazine compounds recited in claim 9 in JP-A No. 11-352624; compounds of formula (III) in JP-A No. 6-11791; and 4-hydroxy-6-methyl-1,3,3a,7-tetrazaindene.

The heat-developable light-sensitive material of the invention may also contain an azolium salt serving as an antifoggant. The azolium salt includes, for example, compounds of formula (XI) in JP-A No. 59-193447, compounds in JP-B No. 55-12581, and compounds of formula (II) in JP-A No. 60-153039. The azolium salt may be present in any site of the heat-developable light-sensitive material, but is preferably in a layer or layers on the surface of the material on which is present a photosensitive layer. More preferably, it is added to the organic silver salt-containing layer of the material. Regarding the time at which the azolium salt is added to the material, it may be added to the coating liquid at any stage of preparing the liquid. When it is to be present in the organic silver salt-containing layer, the azolium salt may be added to any of the reaction system to prepare the organic silver salt or the reaction system to prepare the coating liquid at any stage of preparing them. Preferably, however, it is added to the coating liquid after the stage of preparing the organic silver salt and just before the stage of coating with the liquid. The azolium salt to be added may be in any form of a powder, a solution or a fine particle dispersion. It may be added along with other additives such as a sensitizing dye, a reducing agent and a color toning agent, for example, in the form of their solution. The amount of the azolium salt to be added to the heat-developable light-sensitive material of the invention is not specifically defined, but preferably falls between 1×10⁻⁶ mols and 2 mols, more preferably between 1×10⁻3 mols and 0.5 mols, per mol of silver in the material.

Other Additives:

1) Mercapto Compounds, Disulfide Compounds and Thione Compounds:

The heat-developable light-sensitive material of the invention may optionally contain any of mercapto compounds, disulfide compounds and thione compounds in order to retard, promote or control development, or to enhance the spectral sensitivity efficiency of the material, or to improve the storability thereof before and after development. For the additive compounds, for example, referred to are JP-A No. 10-62899, paragraphs [0067] to [0069]; compounds of formula (I) in JP-A No. 10-186572, and their examples in paragraphs [0033] to [0052]; and EP-A No. 0803764A1, page 20, lines 36 to 56. Of those, especially preferred are the mercapto-substituted hetero-aromatic compounds described in JP-A Nos. 9-297367, 9-304875 and 2001-100358, and Japanese Patent Application Nos. 2001-104213 and 2001-104214.

2) Color Toning Agent:

Adding a color toning agent to the heat-developable light-sensitive material of the invention is preferred. Examples of the color toning agent usable herein are described in JP-A No. 10-62899, paragraphs [0054] to [0055], EP-A No. 0803764A1, page 21, lines 23 to 48; and JP-A Nos. 2000-356317 and 2000-187298. Preferred for use herein are phthalazinones (phthalazinone, phthalazinone derivatives and their metal salts, e.g., 4-(1-naphthyl)phthalazinone, 6-chlorophthalazinone, 5,7-dimethoxyphthalazinone, 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate, tetrachlorophthalic anhydride); phthalazines (phthalazine, phthalazine derivatives and their metal salts, e.g., 4-(1-naphthyl)phthalazine, 6-isopropylphthalazine, 6-tert-butylphthalazine, 6-chlorophthalazine, 5,7-dimethoxyphthalazine, 2,3-dihydrophthalazine); combinations of phthalazines and phthalic acids. More preferred are combinations of phthalazines and phthalic acids. Even more preferred is a combination of 6-isopropylphthalazine and phthalic acid or 4-methylphthalic acid.

3) Plasticizer and Lubricant:

A plasticizer and a lubricant that may be used in the photosensitive layer of the heat-developable light-sensitive material of the invention are described in, for example, JP-A No. 11-65021, paragraph [0117]. For super-high contrasting agents for forming super-high contrast images, methods of adding the same to a light-sensitive material, and its amount applicable to the invention, for example, referred to are JP-A No. 11-65021, paragraph [0118]; JP-A No. 11-223898, paragraphs [0136] to [0193]; compounds of formula (H), those of formulae (1) to (3) and those of formulae (A) and (B) in JP-A No. 2000-284399; and compounds of formulae (III) to (V) in Japanese Patent Application No. 11-91652, especially concrete compounds in [Formula 21] to [Formula 24] therein. For contrasting promoters also applicable to the invention, referred to are JP-A No. 11-65021, paragraph [0102]; and JP-A No. 11-223898, paragraphs [0194] to [0195].

4) Dye and Pigment:

The photosensitive layer of the heat-developable light-sensitive material of the invention may contain any dye and/or pigment (e.g., C.I. Pigment Blue 60, C.I. Pigment Blue 64, C.I. Pigment Blue 15:6) in order to improve the color image tone, prevent interference fringes during laser exposure, and prevent irradiation. The details of such dyes and pigments are described in, for example, WO98/36322, and JP-A Nos. 10-268465 and 11-338098.

5) Super-High Contrasting Agent:

In ordr to form super-high contrast images suitable to printing plates, it is desirable to add a super-high contrasting agent to the image-forming layer of the heat-developable light-sensitive material of the invention. For the super-high contrasting agent, the method of adding the same, and its amount applicable to the invention, for example, referred to are JP-A No. 11-65021, paragraph [0118]; JP-A No. 11-223898, paragraphs [0136] to [0193]; compounds of formula (H), those of formulae (1) to (3) and those of formulae (A) and (B) in Japanese Patent Application No. 11-87297; and compounds of formulae (III) to (V) in Japanese Patent Application No. 11-91652, especially concrete compounds in [Formula 21] to [Formula 24] therein. For contrasting promoters also applicable to the invention, referred to are JP-A No. 11-65021, paragraph [0102]; and JP-A No. 11-223898, paragraphs [0194] to [0195].

When formic acid or its salt is used as a strong foggant in the invention, it may be added to the side of the heat-developable light-sensitive material that has thereon a photosensitive silver halide-containing, image-forming layer, and its amount is preferably at most 5 mmols, more preferably at most 1 mmol per mol of silver in the layer.

When a super-high contrasting agent is used in the heat-developable light-sensitive material of the invention, it is preferably combined with an acid formed through hydration of diphosphorus pentoxide or its salt. The acid formed through hydration of diphosphorus pentoxide and its salts include, for example, metaphosphoric acid (and its salts), pyrophosphoric acid (and its salts), orthophosphoric acid (and its salts), triphosphoric acid (and its salts), tetraphosphoric acid (and its salts), and hexametaphosphoric acid (and its salts). For the acid formed through hydration of diphosphorus pentoxide and its salts, preferred for use herein are orthophosphoric acid (and its salts), and hexametaphosphoric acid (and its salts). Concretely, their salts are sodium orthophosphate, sodium dihydrogen-orthophosphate, sodium hexametaphosphate, and ammonium hexametaphosphate.

The amount of the acid formed through hydration of diphosphorus pentoxide or its salt to be used herein (that is, the amount thereof per m² of the heat-developable light-sensitive material) depends on the sensitivity, the fogging resistance and other properties of the material. Preferably, however, it falls between 0.1 and 500 mg/m², more preferably between 0.5 and 100 mg/m².

In the invention, the reducing agent, the hydrogen-bonding compound, the development promoter and the polyhalogen compounds are preferably in the form of their solid dispersions, and preferred production methods for these solid dispersions are descried in JP-A No. 2002-55405.

Preparation of Coating Liquid and Application Thereof:

The temperature at which the coating liquid for the image-forming layer is prepared preferably falls between 30° C. and 65° C., more preferably at least 35° C. but lower than 60° C., even more preferably between 35° C. and 55° C. Also preferably, the temperature of the coating liquid is kept between 30° C. and 65° C. immediately after a polymer latex is added thereto.

Layer Configuration and Constituent Components:

One or more image-forming layers are formed on one support to produce the heat-developable light-sensitive material of the invention. When the material has one image-forming layer, the layer comprises an organic silver salt, a photosensitive silver halide, a reducing agent and a binder, optionally containing any desired additives such as a color toning agent, a coating aid and other auxiliary agents. When the material has two or more image-forming layers, the first image-forming layer (in general, this is directly adjacent to the support) contains an organic silver salt and a photosensitive silver halide, and the second image-forming layer or the two layers must contain the other ingredients. The multi-color heat-developable light-sensitive material of the invention may have combinations of these two layers for the respective colors, or may contain all the necessary ingredients in a single layer, for example, as in U.S. Pat. No. 4,708,928. In the case of a multi-color heat-developable light-sensitive material containing multiple dyes, a functional or non-functional barrier layer is disposed between adjacent emulsion layers, for example, as in U.S. Pat. No. 4,460,681.

The heat-developable light-sensitive material of the invention may have at least one non-photosensitive layer in addition to an image-forming layer. Depending on their positions, the non-photosensitive layers are grouped into (a) a surface-protective layer to be disposed on an image-forming layer (a layer farther from the support than the image-forming layer); (b) an intermediate layer to be disposed between adjacent image-forming layers or between an image-forming layer and a protective layer; (c) a subbing layer to be disposed between an image-forming layer and a support; (d) a back layer to be disposed on a support opposite to an image-forming layer.

A layer that serves as an optical filter may be disposed in the material, and it may be the layer (a) or (b). An antihalation layer may be disposed in the material, and it may be the layer (c) or (d).

1) Surface-Protective Layer:

The heat-developable light-sensitive material of the invention may have a surface-protective layer for preventing adhesion of the image-forming layer thereof. The surface-protective layer may have a single-layered structure or a multi-layered structure. The details of the surface-protective layer are described, for example, in JP-A No. 11-65021, paragraphs [0119] to [0120], and JP-A No. 2000-171936.

Gelatin is preferred for the binder in the surface-protective layer, but polyvinyl alcohol (PVA) is also usable for it. Combining the two for the binder is also preferred in the invention. Gelatin for use herein may be inert gelatin (e.g., Nitta Gelatin 750), or gelatin phthalide (e.g., Nitta Gelatin 801) For PVA usable herein, referred to are those described in JP-A No. 2000-171936, paragraphs [0009] to [0020]. Preferred for PVA for use herein are, for example, completely saponified one, PVA-105; partially saponified one, PVA-205, PVA-335; and modified polyvinyl alcohol, MP-203 (all can be available from Kuraray). The polyvinyl alcohol content (per m² of the support) of one surface-protective layer preferably falls between 0.3 and 4.0 g/m², more preferably between 0.3 and 2.0 g/m².

The overall binder content (including water-soluble polymer and latex polymer) (per m² of the support) of one surface-protective layer preferably falls between 0.3 and 5.0 g/m², more preferably between 0.3 and 2.0 g/m².

2) Antihalation Layer:

In the heat-developable light-sensitive material of the invention, an antihalation layer may be disposed farther from the light source than the photosensitive layer.

The antihalation layer is described in, for example, JP-A No. 11-65021, paragraphs [0123] to [0124]; JP-A Nos. 11-223898, 9-230531, 10-36695, 10-104779, 11-231457, 11-352625 and 11-352626.

The antihalation layer contains an antihalation dye capable of absorbing the light to which the heat-developable light-sensitive material is exposed. When the heat-developable light-sensitive material is exposed to IR rays, IR-absorbing dyes may be used for antihalation. In that case, it is desirable that the dyes do not absorb visible light.

On the other hand, when visible light-absorbing dyes are used for antihalation, it is desirable that the dye used is substantially decolored after image formation on the material. For this, for example, usable is a decoloring means that decolors the dye when heated in the step of heat development. Preferably, a thermal decoloring dye and a base precursor are added to a non-photosensitive layer so that the layer containing them may function as an antihalation layer. The details of this technique are described in, for example, JP-A No. 11-231457.

The amount of the decoloring dye depends on the use of the dye. In general, its amount is so determined that the dye added could ensure an optical density (absorbance), measured at an intended wavelength, of larger than 0.1. The optical density preferably falls between 0.15 and 2, more preferably between 0.2 and 1. The amount of the dye capable of ensuring the optical density falling within the range may be generally from 0.001 to 1 g/m².

Decoloring the dye in the heat-developable light-sensitive material in that manner can lower the optical density of the material to 0.1 or less after heat development. Two or more different types of decoloring dyes may be in the thermodecoloring recording material or the heat-developable light-sensitive material. Similarly, two or more different types of base precursors may be in the material.

In the thermodecoloring material that contains such a decoloring dye and a base precursor, it is desirable, in view of the thermodecoloring ability of the material, that the base precursor therein is combined with a substance which, when mixed with the base precursor, can lower the melting point of the mixture by at least 3° C. (e.g., diphenyl sulfone, 4-chlorophenyl(phenyl) sulfone, 2-naphthyl benzoate), for example, as in JP-A No. 11-352626.

3) Back Layer:

For the back layer applicable to the invention, referred to is the description in JP-A No. 11-65021, paragraphs [0128] to [0130].

In the invention, a coloring agent having an absorption maximum in the range falling between 300 and 450 nm may be added to the heat-developable light-sensitive material in order to improve the silver tone and reduce change of image over time of the material. The coloring agent is described in, for example, JP-A Nos. 62-210458, 63-104046, 63-103235, 63-208846, 63-306436, 63-314535, 01-61745, and 2001-100363.

In general, the amount of the coloring agent to be added to the material falls between 0.1 mg/m² and 1 g/m². Preferably, it is added to the back layer that is opposite to the photosensitive layer of the material.

Also preferably, the heat-developable light-sensitive material of the invention contains a dye that has an absorption maximum within a range of from 580 to 680 nm in order to control the base color tone of the material. For the dye for that purpose, preferred are those having a low absorption intensity in the short wavelength side, more specifically, oil-soluble azomethine dyes in JP-A Nos. 4-359967 and 4-359968; and water-soluble phthalocyanine dyes in Japanese Patent Application No. 2002-96797. The dye may be added to any layer of the material, but preferably to the non-photosensitive layer on the side coated with emulsion layers or to the side of back face.

Preferably, the heat-developable light-sensitive material of the invention has, on one surface of its support, at least one photosensitive layer that contains a photosensitive silver halide emulsion, and has a back layer on the other surface thereof. This is referred to as a single-sided heat-developable light-sensitive material.

4) Matting Agent:

Preferably, the heat-developable light-sensitive material of the invention contains a matting agent in order to improve the transferring properties of the material. Matting agents are described in JP-A No. 11-65021, paragraphs [0126] to [0127]. The amount of the matting agent to be added to the heat-developable light-sensitive material of the invention preferably falls between 1 and 400 mg/m², more preferably between 5 and 300 mg/m² of the material.

Regarding its shape, the matting agent for use in the invention may have any form including regular or irregular form, but preferred are regular particles, and more preferred are spherical particles. The mean particle size of the particles preferably falls between 0.5 and 10 μm, more preferably between 1.0 and 8.0 μm, still more preferably between 2.0 and 6.0 μm. The fluctuation coefficient of the particle size distribution of the particles is preferably at most 50%, more preferably at most 40%, even more preferably at most 30%. The particle size fluctuation coefficient is represented by (standard deviation of particle size)/(mean value of particle size)×100. Also preferably, two different types of matting agents are combined for use herein, both having a small fluctuation coefficient but differing from each other in the ratio of the mean particle size of the two by at least 3.

The degree to which the surface of the emulsion layer of the heat-developable light-sensitive material of the invention is matted is not specifically defined, so far as the matted layer surface is free from star dust trouble, but is preferably such that the Beck's smoothness of the matted surface can fall between 30 seconds and 2000 seconds, more preferably between 40 seconds and 1500 seconds. The Beck's smoothness is readily obtained according to JIS P8119 (method of testing surface smoothness of paper and paperboard with Beck tester), and to TAPPI Standard T479.

Regarding the matting degree of the back layer of the heat-developable light-sensitive material of the invention, the Beck's smoothness of the matted back layer preferably falls between 10 seconds and 1200 seconds, more preferably between 20 seconds and 800 seconds, even more preferably between 40 seconds and 500 seconds.

Preferably, the heat-developable light-sensitive material of the invention contains a matting agent in the outermost surface layer, or in a layer functioning as an outermost surface layer, or in a layer near the outermost surface of the material. Also preferably, it may contain a matting agent in a layer of the material that functions as a protective layer.

5) Polymer Latex:

When the heat-developable light-sensitive material of the invention is used in the field of printing that requires high-level dimensional stability, it is desirable to use a polymer latex in the surface protective layer or the back layer of the material. The polymer latex for that purpose is described in, for example, Synthetic Resin Emulsions (edited by Taira Okuda & Hiroshi Inagaki, the Polymer Publishing Association of Japan, 1978); Applications of Synthetic Latexes (by Takaaki Sugimura, Yasuo Kataoka, Sohichi Suzuki & Keiji Kasahara, the Polymer Publishing Association of Japan, 1993); and Chemistry of Synthetic Latexes (by Sohichi Muroi, the Polymer Publishing Association of Japan, 1970). Concretely, it includes, for example, a methyl methacrylate (33.5 mass %)/ethyl acrylate (50 mass %)/methacrylic acid (16.5 mass %) copolymer latex; a methyl methacrylate (47.5 mass %)/butadiene (47.5 mass %)/itaconic acid (5 mass %) copolymer latex; an ethyl acrylate/methacrylic acid copolymer latex; a methyl methacrylate (58.9 mass %)/2-ethylhexyl acrylate (25.4 mass %)/styrene (8.6 mass %)/2-hydroxyethyl methacrylate (5.1 mass %)/acrylic acid (2.0 mass %) copolymer latex; and a methyl methacrylate (64.0 mass %)/styrene (9.0 mass %)/butyl acrylate (20.0 mass.%)/2-hydroxyethyl methacrylate (5.0 mass %)/acrylic acid (2.0 mass %) copolymer latex. For the binder for the surface-protective layer in the invention, for example, referred to are the polymer latex combinations in Japanese Patent Application No. 11-6872; the techniques in JP-A No. 2000-267226, paragraphs [0021] to [0025]; the techniques in Japanese Patent Application No. 11-6872, paragraphs [0027] to [0028]; and the techniques in JP-A No. 2000-19678, paragraphs [0023] to [0041]. The proportion of the polymer latex in the surface-protective layer preferably falls between 10% by mass and 90% by mass, more preferably between 20% by mass and 80% by mass of all the binder in the layer.

6) pH of Film Surface:

Preferably, the heat-developable light-sensitive material of the invention has the pH of a film surface of at most 7.0, more preferably at most 6.6, before heat development. The lowermost limit of the pH is not specifically defined, but may be about 3. Most preferably, the pH range falls between 4 and 6.2. In order to control the film surface pH of the heat-developable light-sensitive material, employable are nonvolatile acids, for example, organic acids such as phthalic acid derivatives or sulfuric acid, or volatile bases such as ammonia. These are preferred as effective for reducing the film surface pH of the material. Especially preferred for the film surface pH-lowering agent is ammonia, as it is highly volatile, and therefore can be readily removed during coating or before heat development.

Also preferred is combining ammonia with a nonvolatile base such as sodium hydroxide, potassium hydroxide or lithium hydroxide. In order to measure the film surface pH of the heat-developable light-sensitive material, referred to is the description in JP-A No. 2000-284399, paragraph [0123].

7) Hardening Agent:

A hardening agent may be added to the photosensitive layer, the protective layer, the back layer and other layers of the heat-developable light-sensitive material of the invention. The details of the hardening agent applicable to the invention are described in T. H. James' The Theory of the Photographic Process, 4th Ed. (Macmillan Publishing Co., Inc., 1977), pp. 77-87. For example, preferred for use herein are chromium alum, 2,4-dichloro-6-hydroxy-s-triazine sodium salt, N,N-ethylenebis(vinylsulfonacetamide), N,N-propylenebis(vinylsulfonacetamide); polyvalent metal ions described on page 78 of that reference; polyisocyanates described in U.S. Pat. No. 4,281,060 and JP-A No. 6-208193; epoxy compounds described in U.S. Pat. No. 4,791,042; and vinylsulfone compounds described in JP-A No. 62-89048.

The hardening agent is added to the coating liquids in the form of its solution. The time at which the solution is added to the coating liquid for the protective layer may fall between 180 minutes before coating the liquid and a time just before the coating, preferably between 60 minutes before the coating and 10 seconds before it. There is no specific limitation on a method and conditions of adding the hardening agent to the coating liquid so long as they ensure the advantages of the invention. For concrete adding methods, employable is a method of mixing a hardening agent with a coating liquid in a tank in such a controlled manner that the mean residence time of the agent as calculated from the amount of the agent added and the flow rate of the coating liquid to a coater can be a predetermined period of time; or a method of mixing them with a static mixer, for example, as in N. Harnby, M. F. Edwards & A. W. Nienow's Liquid Mixing Technology, Chap. 8 (translated by Koji Takahasi, published by Nikkan Kogyo Shinbun, 1989).

8) Surfactant:

Surfactants applicable to the heat-developable light-sensitive material of the invention are described in JP-A No. 11-65021, paragraph [0132]; solvents applicable thereto are in the same but in paragraph [0133]; supports applicable thereto are in the same but in paragraph [0134]; antistatic and electroconductive layers applicable thereto are in the same but in paragraph [0135]; methods of forming color images applicable thereto are in the same but in paragraph [0136]; lubricants applicable thereto are in JP-A No. 11-84573, paragraphs [0061] to [0064] and Japanese Patent Application No. 11-106881, paragraphs [0049] to [0062].

The heat-developable light-sensitive material of the invention preferably contains a fluorine-containing surfactant. Examples of fluorine-containing surfactants that are preferred for use herein are disclosed, for example, in JP-A Nos. 10-197985, 2000-19680 and 2000-214554. Also preferred for use herein are fluorine-containing polymer surfactants such as those in JP-A No. 9-281636. In the invention, especially preferred are the fluorine-containing surfactants described in JP-A No. 2002-82411, and Japanese Patent Application Nos. 2001-242357 and 2001-264110. In particular, the fluorine-containing surfactants described in Japanese Patent Application Nos. 2001-242357 and 2001-264110 are especially preferred in preparing aqueous coating liquids and in coating with them, since their ability to control the charging level, to stabilize the coated surface and to improve the slipping properties of the coated surface is good. Most preferred are the fluorine-containing surfactants described in Japanese Patent Application No. 2001-264110, as their ability to control the charging level is excellent and their amount to be used may be small.

The fluorine-containing surfactant may be used in any of the emulsion-coated surface and the back surface of the heat-developable light-sensitive material of the invention, but is preferably used in both surfaces of the material. More preferably, the surfactant is combined with the above-mentioned metal oxide-containing conductive layer. In this case, even when the amount of the fluorine-containing layer in the conductive layer side is reduced or removed, the heat-developable light-sensitive material of the invention still has good properties.

Preferably, the amount of the fluorine-containing surfactant is from 0.1 mg/m² to 100 mg/m², more preferably from 0.3 mg/m² to 30 mg/m², even more preferably from 1 mg/m² to 10 mg/m² in each of the emulsion-coated face and the back face of the material. In particular, the fluorine-containing surfactants described in Japanese Patent Application No. 2001-264111 are significantly effective, and the amount of the surfactant is preferably from 0.01 mg/m² to 10 mg/m², more preferably from 0.1 mg/m² to 5 mg/m².

9) Antistatic Agent:

The heat-developable light-sensitive material of the invention preferably has as an antistatic layer an electroconductive layer that contains a metal oxide or an electroconductive polymer. The antistatic layer may also serve as a subbing layer or a back surface-protective layer, but may be provided separately from them. The electroconductive material of the antistatic layer is preferably a metal oxide having increased electroconductivity by introducing an oxygen defect or a different metal atom into the metal oxide. Preferred examples of the metal oxide include ZnO, TiO₂ and SnO₂. It is preferred to add Al or In to ZnO, add Sb, Nb, P or a halogen element to SnO₂, and add Nb or Ta to TiO₂. In particular, SnO₂ with Sb added thereto is preferred. The amount of the different metal atom added is preferably from 0.01 to 30 mol %, more preferably from 0.1 to 10 mol %. The shape of the metal oxide may be any one of spherical form, needle-like form and plate-like form but in view of its electroconductivity, a needle-like particle having a long axis/short axis ratio of 2.0 or more, preferably from 3.0 to 50 is preferred. The amount of the metal oxide used is preferably from 1 to 1000 mg/m², more preferably from 10 to 500 mg/m², even more preferably from 20 to 200 mg/m². In the heat-developable light-sensitive material of the invention, the antistatic layer may be either on the emulsion surface side or on the back surface side but is preferably between the support and the back layer. Specific examples of the antistatic layer that may be used in the heat-developable light-sensitive material of the invention are described in JP-A No. 11-65021, paragraph [0135]; JP-A Nos. 56-143430,56-143431, 58-62646 and 56-120519; JP-A No. 11-84573, paragraphs [0040] to [0051]; U.S. Pat. No. 5,575,957; and JP-A No. 11-223898, paragraphs [0078] to [0084].

10) Support:

The support of the heat-developable light-sensitive material of the invention may be a transparent support. For the transparent support, preferred are biaxially-oriented polyester films (especially polyethylene terephthalate) which have been heated at a temperature falling between 130 and 185° C. The heat treatment is conducteed to remove the internal strain that may remain in the biaxially-oriented films and to prevent the film supports from thermally shrinking during heat development of the material. When the heat-developable light-sensitive material is one for medical treatment, the transparent support thereof may be colored with a blue dye (for example, with Dye-1 used in the examples in JP-A No. 8-240877), or may not be colored. Preferably, the support of the heat-developable light-sensitive material of the invention is undercoated, for example, with a water-soluble polyester of JP-A No. 11-84574; a styrene-butadiene copolymer of JP-A No. 10-186565; or a vinylidene chloride copolymer of JP-A No. 2000-39684 or Japanese Patent Application No. 11-106881, paragraphs [0063] to [0080]. When the support is coated with an emulsion layer or a back layer, its water content is preferably at most 0.5% by weight.

11) Other Additives:

The heat-developable light-sensitive material of the invention may optionally contain an antioxidant, a stabilizer, a plasticizer, a UV absorbent or a coating aid. Such additives may be contained in any of the photosensitive layers or the non-photosensitive layers of the material. For the additives, for example, referred to are WO 98/36322, EP-A No. 803764A1, and JP-A Nos. 10-186567 and 10-18568.

12) Coating Method:

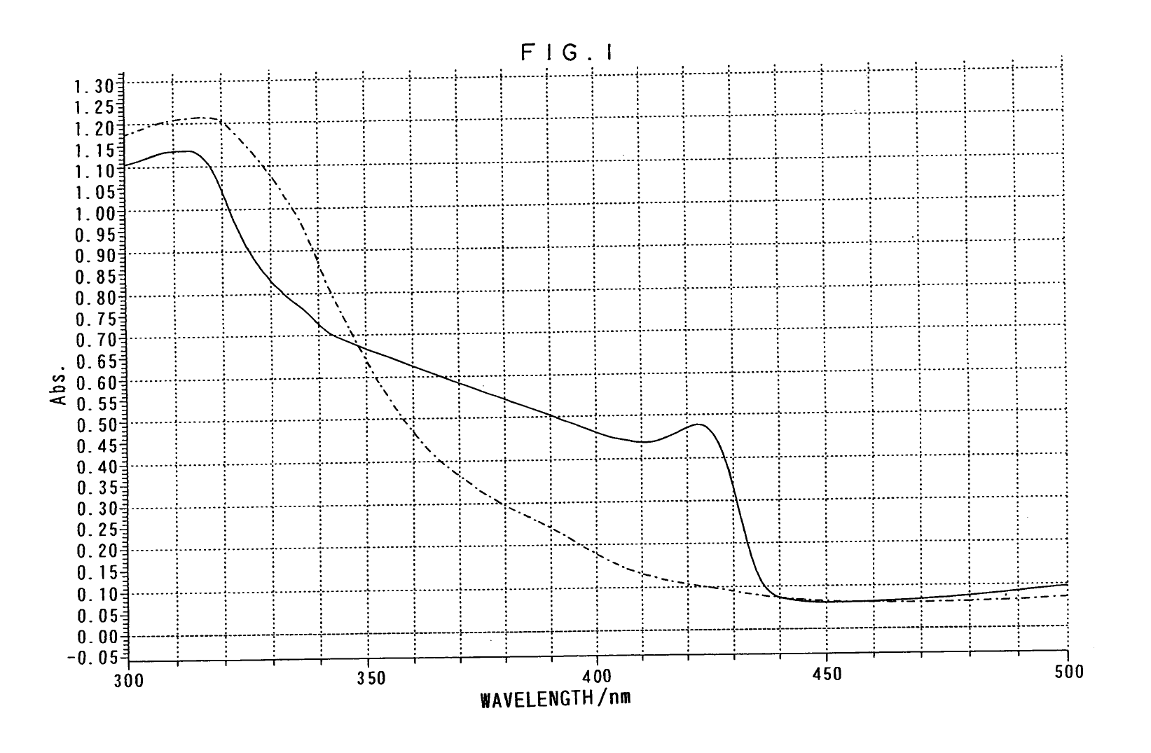

To fabricate the heat-developable light-sensitive material of the invention, the coating liquids may be applied onto the support in any desired manner. Concretely, various types of coating techniques are employable herein, including, for example, extrusion coating, slide coating, curtain coating, dipping, knife coating, and flow coating. Various types of hoppers for extrusion coating employable herein are described in U.S. Pat. No. 2,681,294. Preferred for the heat-developable light-sensitive material of the invention is extrusion coating or slide coating described in Stephen F. Kistler & Petert M. Schweizer's Liquid Film Coating (Chapman & Hall, 1997), pp. 399-536. More preferred is slide coating. One example of the shape of a slide coater for slide coating is shown in FIG. 11b-1, on page 427 of that reference. If desired, two or more layers may be formed at the same time, for example, according to the methods described from page 399 to page 536 of that reference, or to the methods described in U.S. Pat. No. 2,761,791 and British Patent No. 837,095. Coating methods preferred for the invention are described in, for example, JP-A Nos. 2001-194748, 2002-153808, 2002-153803 and 2002-182333.

Preferably, the coating liquid for the organic silver salt-containing layer of the heat-developable light-sensitive material of the invention is a thixotropic fluid. For it, referred to is the technique described in JP-A No. 11-52509. Preferably, the coating liquid for the organic silver salt-containing layer in the invention has a viscosity falling between 400 mPa·s and 100,000 mPa·s, more preferably between 500 mPa·s and 20,000 mPa·s, at a shear rate of 0.1 sec⁻¹. Also preferably, the viscosity falls between 1 mPa·s and 200 mPa·s, more preferably between 5 mPa·s and 80 mPa·s, at a shear rate of 1000 sec⁻¹.

When two liquids are mixed to prepare the coating liquid of the invention, preferably used is a known in-line mixer or in-plant mixer. In-line mixer preferred for the invention is described in JP-A No. 2002-85948; and in-plant mixer also preferred for the invention is in JP-A 2002-90940.

The coating liquid is preferably defoamed to improve the state of the surface coated with it. For example, the defoaming method described in JP-A 2002-66431 is preferred for the invention.

It is also desirable that the support is, before it is coated with coating liquids, discharged to prevent it from charging and attracting dust and others. For example, the discharging method preferred for the invention is described in JP-A No. 2002-143747.

In the invention, it is important to accurately control the drying air and the drying temperature in drying the coating liquid for non-setting image-forming layer. The drying method preferred for the invention is described in detail in JP-A Nos. 2001-194749 and 2002-139814.

In fabricating the heat-developable light-sensitive material of the invention, it is desirable that, after the coating liquids have been applied to the support to form the layers thereon and dried, the thus-fabricated material is heated to improve the film-forming properties of the coating liquids. The heating temperature is preferably from 60° C. to 100° C. measured on the film surface, and the heating time is preferably from 1 second to 60 seconds. More preferably, the heating temperature is from 70 to 90° C. and the heating time is from 2 to 10 seconds. The heating method preferred for the invention is described in JP-A No. 2002-107872.

For stable and continuous fabrication of the heat-developable light-sensitive material of the invention, preferred are the fabrication methods described in JP-A Nos. 2002-156728 and 2002-182333.

Preferably, the heat-developable light-sensitive material of the invention is monosheet type one. The monosheet type material does not require any additional sheet such as an image-receiving material, and may directly form images on itself.

13) Packaging Material:

Preferably, the photographic material of the invention is packaged with a material having low oxygen and/or moisture permeability to prevent its photographic properties from varying and to prevent it from curling or from having a curling habit while stored as unprocessed stocks. Preferably, the oxygen permeability at 25° C. of the packaging material for use herein is at most 50 ml/atm·m²·day, more preferably at most 10 ml/atm·m² day, even more preferably at most 1.0 ml/atm·m² day. Also preferably, the moisture permeability thereof is at most 10 g/atm·m²·day, more preferably at most 5 g/atm·m²·day, even more preferably at most 1 g/atm·m²·day.

Preferred examples of the packaging material having low oxygen and/or moisture permeability for use herein are described, for example, in JP-A Nos. 8-254793 and 2000-206653.

14) Other Employable Techniques:

Other techniques applicable to the heat-developable light-sensitive material of the invention are, for example, in EP-A Nos. 803764A1 and 883022A1, WO98/36322; JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076,11-338096, 11-338098, 11-338099, 11-343420, 2000-187298, 2000-10229, 2000-47345, 2000-206642,2000-98530, 2000-98531,2000-112059, 2000-112060, 2000-112104, 2000-112064 and 2000-171936.

When the heat-developable light-sensitive material of the invention is a multi-color heat-developable light-sensitive material, a functional or non-functional barrier layer is disposed between adjacent emulsion layers, for example, as in U.S. Pat. No. 4,460,681.

Regarding its configuration, the multi-color heat-developable light-sensitive material may have combinations of two layers for each color, or may contain all the necessary ingredients in a single layer, for example, as in U.S. Pat. No. 4,708,928.

Image-Forming Method:

1) Exposure:

The photographic material of the invention may be exposed in any manner, but is preferably exposed to scanning laser rays. For the laser rays, usable are red to IR light-emitting He—Ne lasers, red light-emitting semiconductor lasers, blue to green light-emitting Ar⁺, He—Ne or He—Cd lasers, or blue light-emitting semiconductor lasers. Preferred are red to IR light-emitting semiconductor lasers. The peak wavelength of the laser rays may fall between 600 nm and 900 nm, preferably between 620 nm and 850 nm. On the other hand, modules of SHG (secondary harmonics generator) element integrated with a semiconductor laser, and blue light-emitting semiconductor lasers have been developed recently, and short wavelength laser output devices have become much highlighted in the art. Blue light-emitting semiconductor lasers enable high-precision image recording, further having the advantages of increased recoding density and stable long-life output. Therefore, it is expected that the demand for them will much increase in future. The peak wavelength of blue laser rays may fall between 300 nm and 500 nm, preferably between 390 nm and 430 nm.

In addition, laser rays that oscillate in longitudinal multi mode through high-frequency superimposition are also preferred for use in the invention.

2) Heat Development:

The heat-developable light-sensitive material of the invention may be developed in any manner. In general, after imagewise exposure, it is developed with heat. Preferably, the temperature of the heat development falls between 80 and 250° C., more preferably between 100 and 140° C., even more preferably between 110 and 130° C. The development time preferably falls between 1 and 60 seconds, more preferably between 3 and 30 seconds, even more preferably between 5 and 25 seconds, still more preferably between 7 and 15 seconds.

For heat development of the heat-developable light-sensitive material, employable is any of a drum heater system or a plate heater system, but preferred is a plate heater system. For heat development with the plate heater system, preferred is the method described in JP-A No. 11-133572. In the plate heater system described therein, a heat-developable light-sensitive material which has been exposed to form a latent image thereon is brought into contact with a heating unit in a heat development zone to thereby convert the latent image into a visible image. In this, the heating unit comprises a plate heater, and multiple press rolls are disposed facing one surface of the plate heater. The exposed heat-developable light-sensitive material is heated and developed while it is passing between the multiple press rolls and the plate heater. The plate heater is sectioned into 2 to 6 stages, and it is desirable that the temperature of the top stage is kept lower by 1 to 10° C. than that of the others. For example, four plate heaters whose temperatures are independently controllable may be used, and the temperatures thereof are set at 112° C., 119° C., 121° C. and 120° C. Such a system is described in JP-A No. 54-30032. In the plate heater system, water and the organic solvent that remain in the heat-developable light-sensitive material can be removed out of the material. In addition, deformation of the support caused by rapid heating thereof can be prevented.

For the miniaturization of a heat-developing device and for shortening of heat development time, it is desirable that the heaters used can be controlled more stably. In addition, it is also desirable that heat development of the exposed front portion of a sheet type material is started before exposure of the rear portion of the material has been finished. Imagers that enable rapid processing favorably for the invention are described in, for example, Japanese Patent Application Nos. 2001-088832 and 2001-091114. The imagers enable heat development with three-stage plate heaters kept, for example, at 107° C., 121° C. and 121° C., respectively within a period of 14 seconds, and the output time of the first sheet may be shortened to about 60 seconds. For such rapid development, it is desirable to combine and use the heat-developable light-sensitive material-2 of the invention that has high sensitivity and is hardly influenced by the ambient temperature.

3) System:

One example of laser imagers for medical treatment equipped with an exposure unit and a heat development unit is Fuji Medical Dry Laser Imager FM-DP L. The system FM-DP L is described in Fuji Medical Review No. 8, pp. 39-55. The technique disclosed therein is applicable to laser imagers for the heat-developable light-sensitive material of the invention. In addition, the heat-developable light-sensitive material of the invention can be processed with the laser imager in the AD Network which Fuji Film Medical has proposed as a network system adapted to DICOM Standards.

Applications of the Invention:

The heat-developable light-sensitive material of the invention forms a monochromatic image based on a silver image, and is favorable for use in medical diagnosis, industrial photography, printing, and COM.

### EXAMPLES

The present invention is described in more detail with reference to the following Examples, which are not intended to restrict the scope of the invention.

### Example 1

Formation of PET Support:

1) Formation of Base:

PET was made of terephthalic acid and ethylene glycol in an ordinary manner, having an intrinsic viscosity, IV of 0.66 (measured in a mixture of phenol and tetrachloroethane at an weight ratio of 6/4 at 25° C.). This was pelletized, and the resultant was dried at 130° C. for 4 hours, and melted at 300° C. The PET melt was extruded out from a T-die, and rapidly cooled. Thus, a non-oriented film whose thickness was so controlled that the thickness after thermal fixation was 175 μm was prepared.

The film was longitudinally oriented by rolls rotating at different circumferencial speeds at 110° C. so that the longitudinal length thereof after the orientation was 3.3 times as long as the original longitudinal length thereof. Next, the film was laterally oriented by a tenter at 130° C. so that the lateral length thereof after the orientation was 4.5 times as long as the original lateral length thereof. Next, the oriented film was thermally fixed at 240° C. for 20 seconds, and then laterally relaxed by 4% at the same temperature. Next, the chuck of the tenter was slitted, the both edges of the film were knurled, and the film was rolled up at 4 kg/cm². The rolled film had a thickness of 175 μm.

2) Surface Corona Discharge Treatment:

Both surfaces of the support were subjected to corona treatment at room temperature at a speed of 20 m/min with a Pillar's solid-state corona processor, Model 6 KVA. From the data of the current and the voltage read, it was seen that the support had been processed at 0.375 kV·A·min/m². The frequency for the treatment was 9.6 kHz, and the gap clearance between the electrode and the dielectric roll was 1.6 mm.

3) Subbing Treatment:

Preparation of Coating Liquid for Subbing Layer:

Formulation <1> (for Subbing Layer Below Image-Forming Layer)

| | | |
|---|---|---|
| Takamatsu Yushi's PESURESIN A-520 (30 mass % solution) | 59 | g |
| Polyethylene glycol monononylphenyl ether (mean number of | 5.4 | g |
| ethylene oxides: 8.5, 10 mass % solution) | | |
| Soken Chemical's MP-1000 (polymer particles having a mean | 0.91 | g |
| particle size of 0.4 μm) | | |
| Distilled water | 935 | ml |

Formulation <2> (for First Layer on Back Surface):

| | | |
|---|---|---|
| Styrene-butadiene copolymer latex (solid content: 40 mass %, | 158 | g |
| weight ratio of styrene and butadiene: 68/32) | | |
| 2,4-Dichloro-6-hydroxy-S-triazine sodium salt (8 mass % | 20 | g |
| aqueous solution) | | |
| Sodium laurylbenzenesulfonate (1 mass % aqueous solution) | 10 | ml |
| Distilled water | 854 | ml |

Formulation <3> (for Second Layer on Back Surface):

| | | |
|---|---|---|
| SnO₂/SbO (mass ratio: 9/1, mean particle size: 0.038 μm, | 84 | g |
| 17 mass % dispersion) | | |
| Gelatin (10 mass % aqueous solution) | 89.2 | g |
| Shin-etsu Chemical's METOLOSE TC-5 (2 mass % aqueous | 8.6 | g |
| solution) | | |
| Soken Chemical's MP-1000 | 0.01 | g |
| Sodium dodecylbenzenesulfonate (1 mass % aqueous solution) | 10 | ml |
| NaOH (1 mass %) | 6 | ml |
| PROXEL (from ICI) | 1 | ml |
| Distilled water | 805 | ml |

Subbing Treatment:

Both surfaces of the biaxially oriented polyethylene terephthalate support (thickness: 175 μm) were subjected to corona discharge treatment in the above manner. One surface (to have a photosensitive layer thereon) of the support was coated with the coating liquid of subbing layer formulation <1> by the use of a wire bar so that the wet application amount of the coating liquid was 6.6 ml/m² (one surface), and then dried at 180° C. for 5 minutes. Next, the other surface (back surface) of the support was coated with the coating liquid of subbing layer formulation <2> by the use of a wire bar so that the wet application amount of the coating liquid was 5.7 ml/m², and then dried at 180° C. for 5 minutes. The back surface thus coated was further coated with the coating liquid of subbing layer formulation <3> by the use of a wire bar so that the wet application amount of the coating liquid was 7.7 ml/m², and then dried at 180° C. for 6 minutes. In that manner, the support was undercoated.

2) Back Layer:

Preparation of Coating Liquid for Antihalation Layer:

60 g of gelatin, 24.5 g of polyacrylamide, 2.2 g of sodium hydroxide (1 mol/liter), 2.4 g of monodispersed polymethyl methacrylate particles (mean particle size: 8 μm, standard deviation of particle size: 0.4), 0.08 g of benzoisothiazolinone, 0.3 g of sodium polystyrenesulfonate, 0.21 g of blue dye compound 1, 0.15 g of yellow dye compound 1, and 8.3 g of acrylic acid/ethyl acrylate copolymer latex (copolymerization ratio of 5/95) were mixed. Water was added to the resulting mixture so that the total amount of the resultant was 818 ml. Thus, a coating solution for antihalation layer was prepared.

Preparation of Coating Liquid for Back Surface-Protective Layer:

In a reactor kept at 40° C., 40 g of gelatin, 1.5 g of liquid paraffin in the form of a liquid paraffin emulsion, 35 mg of benzoisothiazolinone, 6.8 g of caustic compound (1 mol/liter), 0.5 g of sodium t-octylphenoxyethoxyethanesulfonate, 0.27 g of sodium polystyrenesulfonate, 5.4 m of aqueous 2% solution of fluorine-containing surfactant (F-1), 6.0 g of an acrylic acid/ethyl acrylate copolymer (copolymerization weight ratio: 5/95), and 2.0 g of N,N-ethylenebis(vinylsulfonacetamide) were mixed. Water was added to the resultant mixture so that the total amount of the mixutre became 1000 ml. Thus, a coating liquid for back surface protective layer was prepared.

Formation of Back Layer:

The coating liquid for antihalation layer was applied to the back face of the undercoated substrate. The amount thereof was such that the amount of gelatin of the antihalation layer was 0.52 g/m². At the same time, the coating liquid for back surface-protective layer was applied thereto and dried to form a back layer on the antihalation layer. The amount thereof was such that the amount of gelatin of the surface-protective layer was 1.7 g/m².

Image-Forming Layer, Intermediate Layer, and Surface-Protective Layer:

1. Preparation of Coating Materials:

1) Silver Halide Emulsions:

Preparation of Silver Halide Emulsion A:

3.1 ml of aqueous 1 mass % potassium bromide solution, 3.5 ml of sulfuric acid (0.5 mol/liter) and 31.7 g of phthalated gelatin were added to 1421 ml of distilled water. The resulting solution was kept at 30° C. in a stainless reactor while it was being stirred. 95.4 ml of a solution A containing 22.22 g of silver nitrate diluted with distilled water, and 97. 4 ml of a solution B containing 15.3 g of potassium bromide and 0.8 g of potassium iodide diluted with distilled water were added to the above solution at constant flow rates over 45 seconds. Next, 10 ml of aqueous 3.5 mass % solution of hydrogen peroxide and 10.8 ml of aqueous 10 mass % solution of benzimidazole were added to the resultant solution. Next, 317.5 ml of a solution C containing 51.86 g of silver nitrate diluted with distilled water, and 400 ml of a solution D containing 44.2 g of potassium bromide and 2.2 g of potassium iodide diluted with distilled water were added to the resultant by a controlled double jet method. At this time, the solution C was added thereto over 20 minutes at a constant flow rate. Meanwhile, the solution D was added thereto so that pAg of the system was kept at 8.1. When 10 minutes lapsed from the start of the addition of the solutions C and D to the system, 1×10⁻⁴ mols, per mol of silver in the system, of potassium hexachloroiridate(III) was added to the system. When five seconds lapsed from the end of the addition of the solution C, 3×10⁻⁴ mols, per mol of silver in the system, of aqueous iron (II) potassium hexacyanide solution was added to the system. Sulfuric acid (0.5 mol/liter) was added to the system to adjust the pH of the system at 3.8. Then, stirring the system was stopped, and steps of precipitating, desalting and washing with water were conducted. Sodium hydroxide (1 mol/liter) was added to the system to adjust the pH of the system at 5.9. A silver halide dispersion having pAg of 8.0 was thus prepared.

While stirring the silver halide dispersion at 38° C., 5 ml of a 0.34 mass % methanol solution of 1,2-benzoisothiazolin-3-one was added thereto. 40 minutes later, the resultant was heated to 47° C. When 20 minutes lapsed from the system temperature reaching 47° C., a methanol solution containing 7.6×10⁻⁵ mols, per mol of silver in the system, of sodium benzenethiosulfonate was added to the system. Five minutes later, a methanol solution containing 2.9×10⁻⁴ mols, per mol of silver of the system, of tellurium sensitizer C was added to the system. Then, the system was ripened for 91 minutes. Thereafter, a methanol solution including spectral sensitizing dye A and spectral sensitizing dye B at a mole ratio of 3/1 was added to the system. The total amount of the spectral sensitizing dyes A and B added thereto was 1.2×10⁻³ mols per mol of silver in the system. One minute later, 1.3 ml of a 0.8 mass % methanol solution of N,N′-dihydroxy-N″-diethylmelamine was added to the system. Four minutes later, a methanol solution including 4.8×10⁻³ mols, per mol of silver, of 5-methyl-2-mercaptobenzimidazole, a methanol solution including 5.4×10⁻³ mols, per mol of silver in the system, of 1-phenyl-2-heptyl-5-mercapto-1,3,4-triazole, and an aqueous solution including 8.5×10⁻³ mols, per mol of silver, of 1-(3-methylureidophenyl)-5-mercaptotetrazole sodium salt were added to the system. Thus, a silver halide emulsion A was prepared.

The grains in the silver halide emulsion thus prepared were silver iodobromide grains and the mean diameter and fluctuation coefficient of spheres having the same volumes as those of the grains were 0.04 μm and 20%, respectively. The iodide content of the grains was 3.5 mol %, and the iodide was uniformly dispersed in the grains. To obtain the grain size, 1000 grains were analyzed with an electronic microscope, and their data were averaged.

Preparation of Silver Halide Emulsion B:

A silver halide emulsion B was prepared in the same manner as the preparation of the emulsion A, except that potassium iodide was not added to the system. The grains in the silver halide emulsion thus prepared were silver bromide grains and the mean diameter and fluctuation coefficient of spheres having the same volumes as those of the grains were 0.04 μm and 15%, respectively.

Preparation of Silver Halide Emulsion 1:

A silver iodobromide emulsion 1 having a silver iodide content of 90 mol % was prepared in the same manner as the preparation of the emulsion A, except that the amounts of potassium iodide and potassium bromide added were varied. The mean diameter and fluctuation coefficient of spheres having the same volumes as those of the grains were 0.04 μm and 15%, respectively.

Preparation of Silver Halide Emulsion 2:

4.3 ml of 1 mass % potassium iodide solution was added to 1420 ml of distilled water, and 3.5 ml of sulfuric acid (0.5 mol/liter) and 36.7 g of phthalated gelatin were added to the resultant mixture. The resulting solution was stirred at 42° C. in a stainless reactor, and 195.6 ml of a solution A containing 22.22 g of silver nitrate diluted with distilled water, and 218 ml of a solution B containing 21.8 g of potassium iodide diluted with distilled water were added to the solution at constant flow rates over 9 minutes. Next, 10 ml of aqueous 3.5 mass % solution of hydrogen peroxide and 10.8 ml of aqueous 10 mass % solution of benzimidazole were added to the resultant solution.

Next, 317.5 ml of a solution C containing 51.86 g of silver nitrate diluted with distilled water, and 600 ml of a solution D containing 60 g of potassium iodide diluted with distilled water were added to the resultant solution by a controlled double jet method. At this time, the solution C was added thereto over 120 minutes at a constant flow. Meanwhile, the solution D was added thereto so that pAg of the system was kept at 8.1. When 10 minutes lapsed from the start of the addition of the solutions C and D to the system, 1×10⁻⁴ mols, per mol of silver in the system, of potassium hexachloroiridate(III) was added to the system. When five seconds lapsed from the end of the addition of the solution C, 3×10⁻⁴ mols, per mol of silver in the system, of aqueous iron (II) potassium hexacyanide solution was added to the system. Sulfuric acid (0.5 mol/liter) was added to the system to adjust the pH of the system at 3.8. Then, stirring the system was stopped, and steps of precipitating, desalting and washing with water were conducted. Sodium hydroxide (1 mol/liter) was added to the system to adjust the pH of the system at 5.9. A silver halide dispersion having pAg of 8.0 was thus prepared.

While stirring the silver halide dispersion at 38° C., 5 ml of a 0.34 mass % methanol solution of 1,2-benzoisothiazolin-3-one was added thereto. The resultant was heated to 47° C. When 20 minutes lapsed from the system temperature reaching 47° C., a methanol solution containing 7.6×10⁻⁵ mols, per mol of silver in the system, of sodium benzenethiosulfonate was added to the system. Five minutes later, a methanol solution containing 2.9×10⁻⁴ mols, per mol of silver of the system, of tellurium sensitizer B was added to the system. Then, the system was ripened for 91 minutes.

1.3 ml of a 0.8 mass % methanol solution of N,N′-dihydroxy-N″-diethylmelamine was added to the system. Four minutes later, a methanol solution including 4.8×10⁻³ mols, per mol of silver, of 5-methyl-2-mercaptobenzimidazole, and a methanol solution including 5.4×10⁻³ mols, per mol of silver in the system, of 1-phenyl-2-heptyl-5-mercapto-1,3,4-triazole were added to the system. Thus, a silver halide emulsion 2 was prepared.

The grains in the silver halide emulsion thus prepared were pure silver iodide grains and the mean diameter and fluctuation coefficient of spheres having the same volumes as those of the grains were 0.04 μm and 18%, respectively. To obtain the grain size, 1000 grains were analyzed with an electronic microscope, and their data were averaged. Based on the formulation for the silver halide emulsion 1, other silver halide emulsions having different grain sizes (their grain sizes are given in Table 1) were prepared in the same manner as the preparation of the emulsion 1. Here, the system temperature that was 42° C. in the preparation of the emulsion 1 was changed to control the mean diameter of spheres having the same volumes as those of the grains.

Preparation of Diluted Emulsions for Coating Liquids:

A 1 mass % aqueous solution containing 7×10⁻³ mols, per mol of silver in the system, of benzothiazolium iodide was added to each of the silver halide emulsions. Water was added to the resultant so that the silver content of silver halides contained in the diluted emulsion was 38.2 g per kg of the emulsion.

2) Fatty Acid Silver Salt Dispersion:

87.6 kg of behenic acid (Henkel's EDENOR C22-85R), 423 liters of distilled water, 49.2 liters of aqueous NaOH solution (5 mol/liter), and 120 liters of t-butyl alcohol were mixed and reacted at 75° C. for 1 hour while stirring this system to prepare a sodium behenate solution A. Apart from this, 206.2 liters of an aqueous solution (pH 4.0) containing 40.4 kg of silver nitrate was prepared, and kept at 10° C. 635 liters of distilled water and 30 liters of t-butyl alcohol were put into a reactor, and kept at 30° C. While sufficient stirring the resultant, the whole amounts of the sodium behenate solution A and the aqueous silver nitrate solution were fed into the reactor at constant flow rates over 93 minutes and 15 seconds, and 90 minutes, respectively. Feeding them into the reactor was so controlled that, for 11 minutes after the start of feeding the aqueous silver nitrate solution, only the aqueous silver nitrate solution was fed into the reactor, that feeding the sodium behenate solution A was started thereafter, and that for 14 minutes and 15 seconds after feeding the aqueous silver nitrate had been finished, only the sodium benenate solution A was fed into the reactor. In this stage, the internal temperature of the reactor was 30° C., and the external temperature of the reactor was so controlled that the temperature of the reaction system in the reactor could be kept constant. The pipe line for the sodium behenate solution A was a double-walled pipe and thermally insulated by circulating hot water through the interspace of the double-walled pipe, and the temperature of the solution at the outlet of the nozzle tip was adjusted at 75° C. The pipe line for the aqueous silver nitrate solution was also a double-walled pipe and thermally insulated by circulating cold water through the interspace of the double-walled pipe. Regarding the position at which the sodium behenate solution A was added to the reaction system and that at which the aqueous silver nitrate solution was added thereto, the two were disposed symmetrically to each other relative to the shaft of the stirrer disposed in the reactor, and the nozzle tips of the pipes were spaced apart from the reaction solution level in the reactor.

After adding the sodium behenate solution A was finished, the reaction system was stirred for 20 minutes at that temperature, and then heated to 35° C. over 30 minutes. Thereafter, the system was ripened for 210 minutes. Immediately after the completion of the ripening, the system was centrifuged to take out a solid component, which was washed with water until the conductivity of the washing waste reached 30 μS/cm. The solid thus obtained was a silver salt of the fatty acid and was stored as wet cake without drying it.

The shapes of the silver behenate grains obtained herein were analyzed on the basis of their images taken through electron microscopic photography. Average values of a, b, and c were 0.14 μm, 0.4 μm and 0.6 μm, respectively (a, b and c are defined hereinabove). The mean aspect ratio was 5.2. The mean diameter and fluctuation coefficient of spheres having the same volumes as those of the grains were 0.52 μm and 15%, respectively. The grains were scaly crystals.

19.3 kg of polyvinyl alcohol (trade name, PVA-217) and water were added to the wet cake whose amount corresponded to 260 kg of the dry weight thereof so that the total amount of the resultant became 1000 kg. The resultant was formed into slurry with a dissolver wing, and then pre-dispersed with a pipe-line mixer (Model PM-10 available from Mizuho Industry).

Next, the pre-dispersed stock slurry was processed three times in a disperser (MICROFLUIDIZER M-610 obtained from Microfluidex International Corporation, and equipped with a Z-type interaction chamber) at a controlled pressure of 1260 kg/cm². A silver behenate dispersion was thus prepared. To cool it, corrugated tube type heat exchangers were disposed before and after the interaction chamber. The temperature of the coolant in these heat exchangers was so controlled that the system could be processed at a dispersion temperature of 18° C.

3) Reducing Agent Dispersion:

Preparation of Reducing Agent-1 Dispersion:

10 kg of a reducing agent 1 (2,2′-methylenebis-(4-ethyl-6-tert-butylphenol)), 16 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) including zirconia beads having a mean diameter of 0.5 mm, and dispersed therewith for 3 hours. Then, 0.2 g of benzoisothiazolinone sodium salt and water were added thereto to adjust the reducing agent concentration of the resultant at 25% by mass. The dispersion was heated at 60° C. for 5 hours. A reducing agent-1 dispersion was thus prepared. The reducing agent grains in the dispersion had a median diameter of 0.40 μm, and a maximum grain size of at most 1.4 μm. The reducing agent dispersion was filtered through a polypropylene filter having a pore size of 3.0 μm to remove foreign objects such as dirt from it, and then stored.

Preparation of Reducing Agent-2 Dispersion:

10 kg of a reducing agent 2 (6,6′-di-t-butyl-4,4′-dimethyl-2,2′-butylidenediphenol), 16 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) including zirconia beads having a mean diameter of 0.5 mm, and dispersed therewith for 3 hours and 30 minutes. Then, 0.2 g of benzoisothiazolinone sodium salt and water were added thereto to adjust the reducing agent concentration of the resultant at 25% by mass. The dispersion was then heated at 40° C. for 1 hour, and then at 80° C. for 1 hour. A reducing agent-2 dispersion was thus prepared. The reducing agent grains in the dispersion had a median diameter of 0.50 μm, and a maximum grain size of at most 1.6 μm. The reducing agent dispersion was filtered through a polypropylene filter having a pore size of 3.0 μm to remove foreign objects such as dirt from it, and then stored.

4) Preparation of Hydrogen-Bonding Compound-1 Dispersion:

10 kg of a hydrogen-bonding compound 1 (tri(4-t-butylphenyl)phosphine oxide), 16 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) containing zirconia beads having a mean diameter of 0.5 mm, and dispersed therewith for 4 hours. Then, 0.2 g of benzoisothiazolinone sodium salt and water were added thereto to adjust the hydrogen-bonding compound concentration of the resultant at 25% by mass. The dispersion was heated at 40° C. for 1 hour and then at 80° C. for 1 hour. A hydrogen-bonding compound-1 dispersion was thus prepared. The hydrogen-bonding compound grains in the dispersion had a median diameter of 0.45 μm, and a maximum grain size of at most 1.3 μm. The hydrogen-bonding compound dispersion was filtered through a polypropylene filter having a pore size of 3.0 μm to remove foreign objects such as dirt from it, and then stored.

5) Development Promoter-1 Dispersion:

Preparation of Development Promoter-1 Dispersion:

10 kg of a development promoter 1, 20 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) containing zirconia beads having a mean diameter of 0.5 mm, and dispersed therewith for 3 hours and 30 minutes. Then, 0.2 g of benzoisothiazolinone sodium salt and water were added thereto to prepare a development promoter-1 dispersion having a development promoter concentration of 20% by mass. The development promoter grains in the dispersion had a median diameter of 0.48 μm, and a maximum grain size of at most 1.4 μm. The development promoter dispersion was filtered through a polypropylene filter having a pore size of 3.0 μm to remove foreign objects such as dirt from it, and then stored.

Preparation of Development Promoter-2 and Color Toning Agent-1 Solid Dispersions:

Development promoter-2 and color toning agent-1 solid dispersions having the respective concentrations of 20% by mass and 15% by mass were prepared in the same manner as the preparation of the development promoter-1 dispersion.

6) Polyhalogen Compound:

Preparation of Organic Polyhalogen Compound-1 Dispersion:

10 kg of an organic polyhalogen compound-1 (tribromomethanesulfonylbenzene), 10 kg of aqueous 20 mass % solution of modified polyvinyl alcohol (Kuraray's POVAL MP203), 0.4 kg of aqueous 20 mass % solution of sodium triisopropylnaphthalenesulfonate, and 14 kg of water were sufficiently mixed to prepare slurry. Via a diaphragm pump, the slurry was fed into a horizontal sand mill (Imex's UVM-2) including zirconia beads having a mean diameter of 0.5 mm, and dispersed therewith for 5 hours. Then, 0.2 g of benzoisothiazolinone sodium salt and water were added thereto to prepare an organic polyhalogen compound-1 dispersion having an ogranic polyhalogen content of 30 mass %. The organic polyhalogen compound grains in the dispersion had a median diameter of 0.41 μm, and a maximum grain size of at most 2.0 μm. The organic polyhalogen compound dispersion was filtered through a polypropylene filter having a pore size of 10.0 μm to remove foreign objects such as dirt from it, and then stored.

Preparation of Organic Polyhalogen Compound-2 Dispersion:

10 kg of an organic polyhalogen compound-2 (N-butyl-3-tribromomethanesulfonylbenzamide), 20 kg of aqueous 10 mass % solution of modified polyvinyl alcohol (Kuraray's POVAL MP203), and 0.4 kg of aqueous 20 mass % solution of sodium triisopropylnaphthalenesulfonate were sufficiently mixed to prepare slurry. Via a diaphragm pump, the slurry was fed into a horizontal sand mill (Imex's UVM-2) including zirconia beads having a mean diameter of 0.5 mm, and dispersed therewith for 5 hours. Then, 0.2 g of benzoisothiazolinone sodium salt and water were added thereto to adjust the organic polyhalogen content of the resultant at 30 mass %. The dispersion was heated at 40° C. for 5 hours. An organic polyhalogen compound-2 dispersion was thus obtained. The organic polyhalogen compound grains in the dispersion had a median diameter of 0.40 μm, and a maximum grain size of at most 1.3 μm. The organic polyhalogen compound dispersion was filtered through a polypropylene filter having a pore size of 3.0 μm to remove foreign objects such as dirt from it, and then stored.

7) Dispersion of Compound of Formula (1) or (2):

One kg of a compound of formula (1) or (2) (types used thereof were described in Table 1), 2 kg of aqueous 10 mass % solution of modified polyvinyl alcohol (Kuraray's POVAL MP203), and 0.04 kg of aqueous 20 mass % solution of sodium triisopropylnaphthalenesulfonate were sufficiently mixed to prepare slurry. Via a diaphragm pump, the slurry was fed into a horizontal sand mill (Imex's UVM-2) including zirconia beads having a mean diameter of 0.5 mm, and dispersed therewith while the dispersion time was so controlled that the dispersed grains could have a median diameter mentioned below. Then, 0.02 g of benzoisothiazolinone sodium salt and water were added thereto to adjust the content of compound of fomula (1) or (2) in the resultant at 20 mass %. The dispersion was heated at 40° C. for 5 hours. A dispersion of the compound of formula (1) or (2) was thus prepared. The compound grains in the dispersion had a median diameter of 0.40 μm, and a maximum grain size of at most 1.3 μm. The dispersion was filtered through a polypropylene filter having a pore size of 3.0 μm to remove foreign objects such as dirt from it, and then stored.

8) Color Toning Agent Dispersion:

Preparation of Phthalazine Compound Solution (Types Used Thereof Were Described in Table 1):

8 kg of Kuraray's modified polyvinyl alcohol MP203 was dissolved in 174.57 kg of water, and 3.15 kg of aqueous 20 mass % solution of sodium triisopropylnaphthalenesulfonate and 6 kg of a phthalazine compound were added to the resultant solution to prepare an aqueous 5 mass % solution of phthalazine compound.

Preparation of Phthalazone Compound Dispersion:

One kg of a phthalazone compound, 2 kg of aqueous 10 mass % solution of modified polyvinyl alcohol (Kuraray's POVAL MP203), and 0.04 kg of aqueous 20 mass % solution of sodium triisopropylnaphthalenesulfonate were sufficiently mixed to prepare slurry. Via a diaphragm pump, the slurry was fed into a horizontal sand mill (Imex's UVM-2) including zirconia beads having a mean diameter of 0.5 mm, and dispersed therewith for 45 minutes. Then, 0.02 g of benzoisothiazolinone sodium salt and water were added thereto to adjust the phthalazone compound content of the resultant at 20 mass %. The dispersion was heated at 40° C. for 5 hours. A phthalazone compound dispersion was thus prepared. The dispersion was filtered through a polypropylene filter having a pore size of 3.0 μm to remove foreign objects such as dirt from it, and then stored.

9) Preparation of Mercapto Compound:

Preparation of Aqueous Mercapto Compound-1 Solution:

7 g of a mercapto compound-1 (1-(3-sulfophenyl)-5-mercaptotetrazole sodium salt) was dissolved in 993 g of water to prepare an aqueous 0.7 mass % solution of the mercapto compound.

Preparation of Aqueous Mercapto Compound-2 Solution:

20 g of a mercapto compound-2 (1-(3-methylureidophenyl)-5-mercaptotetrazole sodium salt) was dissolved in 980 g of water to prepare an aqueous 2.0 mass % solution of the mercapto compound.

10) Preparation of Pigment-1 Dispersion:

64 g of C.I. Pigment Blue 60, 6.4 g of Kao's DEMOLE N and 250 g of water were sufficiently mixed to prepare slurry. 800 g of zirconia beads having a mean diameter of 0.5 mm were prepared and put into a vessel along with the slurry. The slurry in the vessel was dispersed by the use of a disperser (Imex's 1/4G Sand Grinder Mill) for 25 hours, and water was added to the slurry to prepare a pigment-1 dispersion having a pigment concentration of 5% by mass. The pigment grains in the dispersion thus prepared had a mean grain size of 0.21 μm.

11) Preparation of SBR Latex:

SBR Latex Was Prepared as Follows:

287 g of distilled water, 7.73 g of surfactant (Takemoto Yushi's PIONIN A-43-S, having a solid content of 48.5%), 14.06 ml of NaOH (1 mol/liter), 0.15 g of tetrasodium ethylenediaminetetraacetate, 255 g of styrene, 11.25 g of acrylic acid, and 3.0 g of tert-dodecylmercaptan were put into the polymerization reactor of a gas monomer reaction apparatus (Pressure Glass Industry's TAS-2J Model). The reactor was sealed, and the content therein was stirred at 200 rpm. The internal air was exhausted via a vacuum pump, and purged a few times repeatedly with nitrogen. Then, 108.75 g of 1,3-butadiene was introduced into the reactor under pressure, and the internal temperature of the reactor was heated to 60° C. A solution in which 1.875 g of ammonium persulfate was dissolved in 50 ml of water was added to the system, and the system was stirred for 5 hour. It was further heated to 90° C. and stirred for 3 hours. After the reaction was completed, the internal temperature was cooled to room temperature. Then, NaOH and NH₄OH (both 1 mol/liter) were added to the system at a molar ratio of Na and NH₄ of 1/5.3 so as to adjust the pH of the system at 8.4. Next, the system was filtered through a polypropylene filter having a pore size of 1.0 μm to remove foreign objects such as dirt from it, and then stored. 774.7 g of SBR latex was thus obtained. Its halide ion content was measured through ion chromatography, and the chloride ion concentration of the latex was 3 ppm. The chelating agent concentration thereof was measured through high-performance liquid chromatography, and was 145 ppm.

The mean grain size of the latex was 90 nm, Tg thereof was 17° C., the solid content thereof was 44% by mass, the equilibrium moisture content thereof at 25° C. and 60% RH was 0.6% by mass, and the ion conductivity thereof was 4.80 mS/cm. To measure the ion conductivity, a To a Denpa Kogyo's conductometer CM-30S was used. In the device, the 44 mass % latex was measured at 25° C. Its pH was 8.4.

2. Preparation of Coating Liquids:

Preparation of Coating Liquids 1 to 20 for Image-Forming Layer:

The pigment-1 dispersion, the organic polyhalogen compound-1 dispersion, the organic polyhalogen compound-2 dispersion, the phthalazine or phthalazone compound solution, the compound of formula (1) or (2), the SBR latex (Tg: 17° C.), the reducing agent-1 dispersion, the hydrogen-bonding compound-1 dispersion, the development promoter-1 dispersion, the development promoter-2 dispersion, the color toning agent-1 dispersion, the aqueous mercapto compound-1 solution, the aqueous mercapto compound-2 solution, an aqueous additive S-1 solution and an aqueous additive S-2 solution were successively added to 1000 g of the fatty acid silver salt dispersion A and 276 ml of water in accordance with formulations of Table 1. Just before applition, the resulting mixture was sufficiently mixed with any of the diluted emulsions-A, -B, -1 or -2 to prepare coating liquids 1 to 20 for an image-forming layer.

The zirconium content of the coating liquid was 0.52 mg per gram of Ag.

Preparation of Coating Liquid for Intermediate Layer:

27 ml of aqueous 5 mass % solution of AEROSOL OT (from American Cyanamid), 135 ml of aqueous 20 mass % solution of diammonium phthalate and water were added to 1000 g of a polyvinyl alcohol, Kuraray's PVA-205, 272 g of the pigment-1 dispersion, and 4200 ml of 19 mass % latex of methyl methacrylate/styrene/butyl acrylate/hydroxyethyl methacrylate/acrylic acid copolymer (copolymerization ratio: 64/9/20/5/2 by weight) so that the total amount of the resultant mixture became 10000 g. The pH of the mixture was adjusted at 7.5 with the addition of NaOH. A coating liquid for an intermediate layer was thus obtained. This was fed into a coating die, with its flow rate so controlled that its coating amount could be 9.1 ml/m².

The viscosity of the coating liquid used in heat-developable light-sensitive material 1, measured with a B-type viscometer (with No. 1 rotor at 60 rpm), was 58 [mPa·s] at 40° C.

Preparation of Coating Liquid for First Surface-Protective Layer:

64 g of inert gelatin was dissolved in water, and 112 g of 19.0 mass % latex of methyl methacrylate/styrene/butyl acrylate/hydroxyethyl methacrylate/acrylic acid copolymer (copolymerization ratio: 64/9/20/5/2 by weight), 30 ml of 15 mass % methanol solution of phthalic acid, 23 ml of aqueous 10 mass % solution of 4-methylphthalic acid, 28 ml of sulfuric acid (0.5 mol/liter), 5 ml of aqueous 5 mass % solution of AEROSOL OT (from American Cyanamid), 0.5 g of phenoxyethanol, 0.1 g of benzoisothiazolinone, and water were added to the resultant solution so that the total amount of the resultant mixture became 750 g. Just before application thereof, 26 ml of 4 mass % chromium alum was added to the mixture, and the resultant was stirred with a static mixer. The resultant coating liquid was fed into a coating die so that the amount of the resultant coating was 18.6 ml/m².

The viscosity of the coating liquid, measured with a B-type viscometer (with No. 1 rotor at 60 rpm), was 20 [mPa·s] at 40° C.

Preparation of Coating Liquid for Second Surface-Protective Layer:

80 g of inert gelatin was dissolved in water, and 102 g of 27.5 mass % latex of methyl methacrylate/styrene/butyl acrylate/hydroxyethyl methacrylate/acrylic acid copolymer (copolymerization ratio: 64/9/20/5/2 by weight), 5.4 ml of 2 mass % solution of a fluorine-containing surfactant (F-1), 5.4 ml of aqueous 2 mass % solution of a fluorine-containing surfactant (F-2), 23 ml of 5 mass % solution of AEROSOL OT (from American Cyanamid), 4 g of fine polymethyl methacrylate grains (mean grain size: 0.7 μm), 21 g of fine polymethyl methacrylate grains (mean grain size: 4.5 μm), 1.6 g of 4-methylphthalic acid, 4.8 g of phthalic acid, 44 ml of sulfuric acid (0.5 mol/liter), 10 mg of benzoisothiazolinone, and water were added to the resultant solution so that the total amount of the resultant mixture became 650 g. Just before application thereof, 445 ml of aqueous solution containing 4 mass % of chromium alum and 0.67 mass % of phthalic acid was added to the mixture, and the resultant was stirred with a static mixer. A coating liquid for surface-protective layer was thus obtained. The coating liquid was fed into a coating die, with its flow rate so controlled that its coating amount could be 8.3 ml/m².

The viscosity of the coating liquid, measured with a B-type viscometer (with No. 1 rotor at 60 rpm), was 19 [mPa·s] at 40° C.

3. Preparation of Heat-Developable Light-Sensitive Materials 1 to 20:

The coating liquid for an image-forming layer, that for an intermediate layer, that for a first surface-protective layer and that for a second surface-protective layer were simultaneously applied onto the undercoated surface opposite to the back of the support in that order according to a slide bead coating method to preapare heat-developable light-sensitive materials. At this time, the temperatures of the coating liquid for an emulsion layer and the coating liquid for an intermediate layer were adjusted at 31° C., that of the coating liquid for a first surface-protective layer was adjusted at 36° C. and that of the coating liquid for a second surface-protective layer was adjusted at 37° C.

The coating amounts (g/m²) of the constitutive components of the emulsion layer are mentioned below.

| | |
|---|---|
| Silver behenate | 5.27 |
| Pigment (C.I. Pigment Blue 60) | 0.036 |
| Polyhalogen compound 1 | 0.09 |
| Polyhalogen compound 2 | 0.14 |
| Phthalazine or phthalazone compound (shown in Table 1) | 0.18 |
| Compound of formula (1) or (2) (shown in Table 1) | 0.15 |
| SBR latex | 9.43 |
| Reducing agent 1 | 0.55 |
| Reducing agent 2 | 0.22 |
| Hydrogen-bonding compound 1 | 0.28 |
| Development promoter 1 | 0.025 |
| Development promoter 2 | 0.020 |
| Color toning agent 1 | 0.008 |
| Mercapto compound 1 | 0.002 |
| Mercapto compound 2 | 0.006 |
| Additive S-1 | 0.001 |
| Additive S-2 | 0.002 |

Silver of Silver Halide (Its Grain Size is Shown in Table 1) 0.046

The coating and drying conditions are mentioned below.

Before coating, the static electricity of the support was eliminated by blowing an ion blow to the support. The coating speed was 160 m/min. The coating and drying conditions for each sample were controlled within the range mentioned below so that the coated surface could be stabilized to the best.

The distance between the coating die tip and the support fell between 0.10 and 0.30 mm. The pressure in the decompression chamber was lower by 196 to 882 Pa than the atmospheric pressure. In the subsequent chilling zone, the coated support was chilled with an air blow (its dry-bulb temperature fell between 10 and 20° C.). In the next helix type contactless drying zone, the support was dried with a dry air blow (its dry-bulb temperature fell between 23 and 45° C., and its wet-bulb temperature fell between 15 and 21° C.). In this zone, the coated support to be dried was kept not in contact with the drier. After the drying, the support was conditioned at 25° C. and 40 to 60% RH, and then heated so that the surface temperature was between 70 and 90° C. After thr heating, the support was cooled to have a surface temperature of 25° C.

The degree of matting, in terms of the Beck's smoothness, of the heat-developable light-sensitive material 1 thus prepared was 550 seconds on the photosensitive layer-coated surface thereof and 130 seconds on the back surface thereof. The pH of the photosensitive layer-coated surface of the sample was measured and was 6.0.

Chemical structures of the compounds used in this Example are shown below.

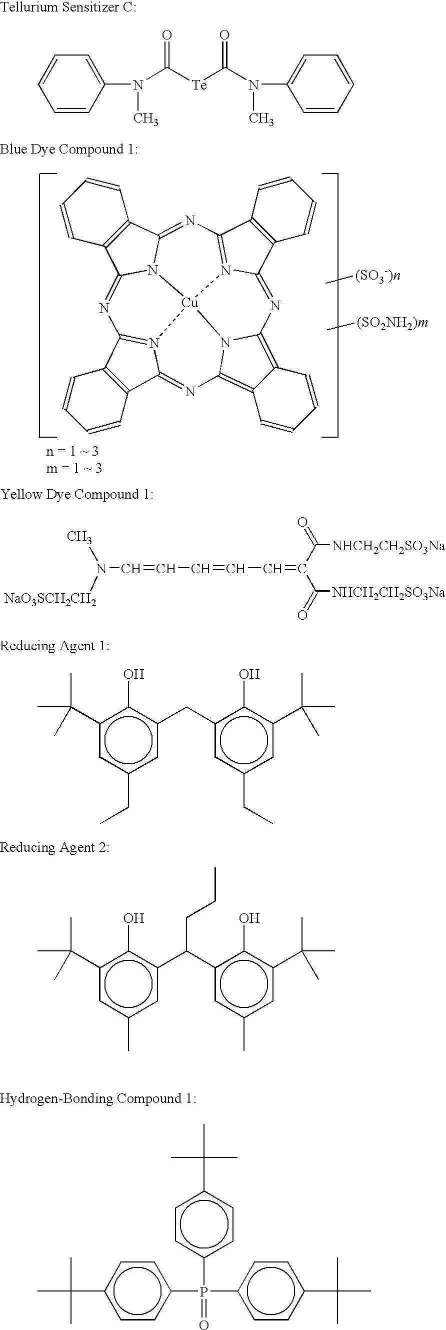

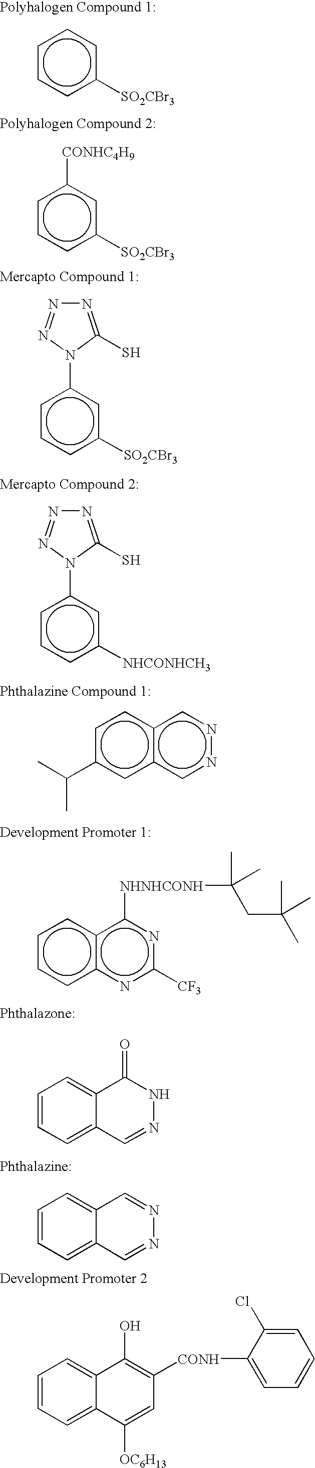

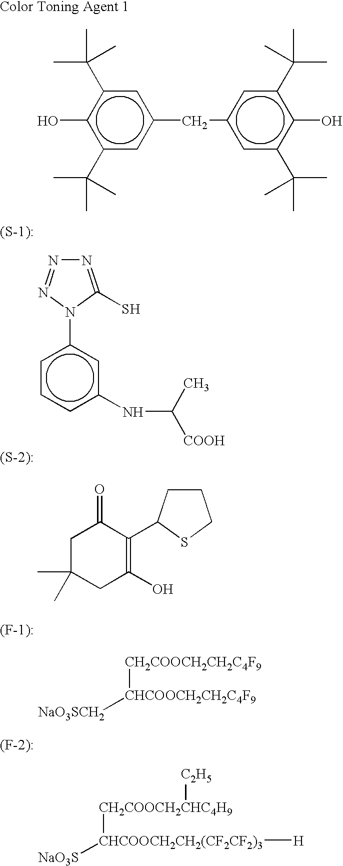

4. Evaluation of Photographic Properties: Heat Development:

Each sample was thermally developed with Fuji Medical Dry Laser Imager FM-DPL Model in which the temperatures of four panel heaters were set at 112° C., 118° C., 120° C. and 120° C., respectively and which the overall development time was set at 24 seconds.

Difference Between Light Absorption Intensity Before Heat Development and that After Heat Development:

Using a spectral photometer U-4100 (manufactured by Hitachi) equipped with an integrating sphere, the spectral absorbance of each sample was measured. The samples with a silver iodide-rich emulsion had an absorption maximum at 415 nm as shown in FIG. 1. However, the samples 1 to 10 did not have the absorption maximum. The change rate of the absorbance at 415 nm of each of samples 11 to 20 before heat development and that after heat development was measured. Apart from the above samples, silver iodide-free sample was prepared, and the absorbance thereof at 415 nm was used as a base standard. The absorbance reduction rate of each sample was computed according to the formula mentioned below. The results obtained are given in Table 1.

Absorbance reduction rate (%)=A/B×100

A=(absorbance of a sample after heat development)−(absorbance of a silver iodide-free sample after heat development)

B=(absorbance of the sample before heat development)−(absorbance of a silver iodide-free sample before heat development)

TABLE 1

| | Silver Halide | | | | | | |
|---|---|---|---|---|---|---|---|
| | | Silver | | | | | |
| | | Iodide | | Compound of Formula | | Absorbance | |
| | | Content | | (1) or (2) | | Change | |
| Sample No. | Emulsion No. | (mol %) | Color Toning Agent | No. | pKa | Rate (%) | Remarks |
| 1 | A | 3.5 | — | — | — | — | comparative |
| | | | | | | | sample |
| 2 | A | 3.5 | 6- | — | — | — | comparative |
| | | | isopropylphthalazine | | | | sample |
| 3 | A | 3.5 | 6- | F-325 | 4.2 | — | comparative |
| | | | isopropylphthalazine | | | | sample |
| 4 | A | 3.5 | phthalazone | — | — | — | comparative |
| | | | | | | | sample |
| 5 | A | 3.5 | phthalazone | F-325 | 4.2 | — | comparative |
| | | | | | | | sample |
| 6 | B | 0 | — | — | — | — | comparative |
| | | | | | | | sample |
| 7 | B | 0 | 6- | — | — | — | comparative |
| | | | isopropylphthalazine | | | | sample |
| 8 | B | 0 | 6- | F-325 | 4.2 | — | comparative |
| | | | isopropylphthalazine | | | | sample |
| 9 | B | 0 | phthalazone | — | — | — | comparative |
| | | | | | | | sample |
| 10 | B | 0 | phthalazone | F-325 | 4.2 | — | comparative |
| | | | | | | | sample |
| 11 | 1 | 90 | — | — | — | 52 | comparative |
| | | | | | | | sample |
| 12 | 1 | 90 | 6- | — | — | 7 | sample of |
| | | | isopropylphthalazine | | | | the |
| | | | | | | | invention |
| 13 | 1 | 90 | 6- | F-325 | 4.2 | 0 | sample of |
| | | | isopropylphthalazine | | | | the |
| | | | | | | | invention |
| 14 | 1 | 90 | phthalazone | — | — | 53 | comparative |
| | | | | | | | sample |
| 15 | 1 | 90 | phthalazone | F-325 | 4.2 | 18 | sample of |
| | | | | | | | the |
| | | | | | | | invention |
| 16 | 2 | 100 | — | — | — | 44 | comparative |
| | | | | | | | sample |
| 17 | 2 | 100 | 6- | — | — | 4 | sample of |
| | | | isopropylphthalazine | | | | the |
| | | | | | | | invention |
| 18 | 2 | 100 | 6- | F-325 | 4.2 | 0 | sample of |
| | | | isopropylphthalazine | | | | the |
| | | | | | | | invention |
| 19 | 2 | 100 | phthalazone | — | — | 44 | comparative |
| | | | | | | | sample |
| 20 | 2 | 100 | phthalazone | F-325 | 4.2 | 15 | sample of |
| | | | | | | | the |
| | | | | | | | invention |

In the Table, 6-isopropylphthalazine and compound F-325 correspond to the silver iodide complex forming agent in the invention. It is obvious that the combination of the silver iodide-rich emulsion and the silver iodide complex-forming agent in the invention specifically lowers the absorption intensity of the samples.

Samples 1 to 10 did not have the absorption maximum, and no absorption intensity reduction was found at all in them.

From the data in Table 1, it is understood that the color toning agent, 6-isopropylphthalazine, may lower the absorption intensity even though the compound of formula (1) or (2) is not used along with it, but it is seen that the combination of the color toning agent with the compound of formula (1) or (2) brings about better results.

### Example 2

1) Fabrication of Samples 21 to 35:

Preparation of Photosensitive Silver Halide Emulsion:

Silver halide emulsions having different mean grain sizes were prepared in the same manner as the preparation of the silver halide emulsion 2 in Example 1 except that the grain-forming temperature was varied. The grain size of each emulsion thus prepared is given in Table 2.

Preparation of Coated Samples:

Samples 21 to 35 were prepared in the same manner as in Example 1 except that the silver halide emulsions prepared in the above were used and the color toning agent and the compound of formula (1) or (2) were added in accordance with Table 2.

2) Evaluation of Photographic Properties:

Each sample thus prepared was cut into pieces of a half-size, packaged with a packaging material mentioned below at 25° C. and 50% RH, then stored for 2 weeks at room temperature, and tested according to the test methods mentioned below.

Packaging Material:

The packaging material used herein was a film comprising a PET film having a thickness of 10 μm, a PE film having a thickness of 12 μm, an aluminium foil having a thickness of 9 μm, a nylone film having a thickness of 15 μm, and a 3% carbon-containing polyethylene having a thickness of 50 μm, and having an oxygen transmittance of 0.02 ml/atm·m²·25° C.·day and a moisture transmittance of 0.10 g/atm·m²·25° C.·day.

Photographic Properties:

A laser source, Nichia Chemical Industry's semiconductor laser NLHV3000E was set in the exposure zone of Fuji Medical Dry Laser Imager FM-DPL, and its beam diameter was narrowed down to 100 μm. With the intensity of laser light on the surface of the heat-developable light-sensitive material sample controlled to be 0 or within a range of from 1 mW/mm² to 1000 mW/mm², the sample was exposed to the laser light for 10⁻⁶ seconds. The laser light oscillation wavelength was 405 nm. For the heat development, the temperatures of four panel heaters were set at 112° C., 118° C., 120° C. and 120° C., respectively and the development time was set at 12 seconds by accelerating the conveying speed. The density of the image formed was measured with a densitometer.

Fog (Dmin): This is the concentration of the non-exposed area.

Maximum density (Dmax): This is the density at exposure saturation.

Evaluation of Image Storability:

The thermally developed samples were left under a fluorescent lamp (intensity of illumination: 6000 luxes) in a room (30° C., 70% RH) for 3 days, and the fog density change thereof was measured. The smaller fog density increase, the better the image storability.

Measurement of Acid Dissociation Constant, pKa:

Using an automatic potentiometric titration meter, Kyoto Electronic Industry's AT-420, the acid dissociation constant (pKa) of the conjugate acid of the compound of formula (1) in a mixed solution of tetrahydrofuran and water (3/2) was measured at 25° C.

TABLE 2

| | | | | | | | Change | | |
|---|---|---|---|---|---|---|---|---|---|
| | | | | | | | Rate (%) of | | |
| | | | | | | | absorbance | | |
| | | | | | | | at 415 nm | | |
| | | | Compound | | | | before heat | | |
| | | | of | | | | development | | |
| | Grain | | Formula | pKa of | Photographic | | and that | Image | |
| Sample | Size | Phthalazine or | (1) or | Conjugate | Properties | | after heat | Storability | |
| No. | (μm) | Phthalazone | (2) | Acid | Dmin | Dmax | development | Δfog | Remarks |
| 21 | 0.04 | 6-isopropylphthalazine | — | | 0.18 | 3.8 | 3 | 0.02 | sample of |
| | | | | | | | | | the |
| | | | | | | | | | invention |
| 22 | 0.06 | 6-isopropylphthalazine | — | | 0.18 | 3.8 | 8 | 0.05 | sample of |
| | | | | | | | | | the |
| | | | | | | | | | invention |
| 23 | 0.09 | 6-isopropylphthalazine | — | | 0.18 | 3.8 | 15 | 0.11 | comparative |
| | | | | | | | | | sample |
| 24 | 0.04 | — | — | | 0.14 | 0.18 | 43 | 0.15 | comparative |
| | | | | | | | | | sample |
| 25 | 0.04 | phthalazone | — | | 0.17 | 3.6 | 43 | 0.12 | comparative |
| | | | | | | | | | sample |
| 26 | 0.04 | phthalazone | F-325 | 4.2 | 0.17 | 3.5 | 15 | 0.03 | sample of |
| | | | | | | | | | the |
| | | | | | | | | | invention |
| 27 | 0.09 | phthalazone | F-325 | 4.2 | 0.17 | 3.6 | 32 | 0.14 | comparative |
| | | | | | | | | | sample |
| 28 | 0.04 | phthalazone | F-421 | 4.2 | 0.17 | 3.5 | 14 | 0.03 | sample of |
| | | | | | | | | | the |
| | | | | | | | | | invention |
| 29 | 0.04 | phthalazone | F-405 | 3.6 | 0.17 | 3.5 | 19 | 0.04 | sample of |
| | | | | | | | | | the |
| | | | | | | | | | invention |
| 30 | 0.04 | phthalazone | F-404 | 5.4 | 0.17 | 3.5 | 13 | 0.04 | sample of |
| | | | | | | | | | the |
| | | | | | | | | | invention |
| 31 | 0.04 | phthalazone | F-515 | | 0.17 | 3.5 | 16 | 0.03 | sample of |
| | | | | | | | | | the |
| | | | | | | | | | invention |
| 32 | 0.04 | phthalazone | F-814 | | 0.17 | 3.5 | 14 | 0.04 | sample of |
| | | | | | | | | | the |
| | | | | | | | | | invention |
| 33 | 0.02 | phthalazone | F-325 | | 0.17 | 3.5 | 8 | 0.01 | sample of |
| | | | | | | | | | the |
| | | | | | | | | | invention |
| 34 | 0.04 | phthalazone | F-325 | 4.2 | 0.17 | 3.6 | 3 | 0.02 | sample of |
| | | | | | | | | | the |
| | | | | | | | | | invention |
| 35 | 0.04 | phthalazone | — | | 0.17 | 3.6 | 6 | 0.03 | sample of |
| | | | | | | | | | the |
| | | | | | | | | | invention |

From the data in Table 2, it is understood that the samples of the invention give high-quality images having high image density and low fog and have good image storability. From their absorption intensity change rate, it is also understood that the samples of the invention give clear and good images as their turbidity after heat development is reduced.

As in the above, when a silver iodide-rich photosensitive silver halide is used in a heat-developable light-sensitive material and the material is exposed to blue-violet laser light, the image formed on the material has a satisfactory density enough for practical use. In addition, when the specific compound in the invention is added to the material, the material may form a better and clearer image having good storability since the silver iodide crystal-derived absorption of the material lowers before and after heat development.

### Example 3

Formation of PET Support:

1) Formation of Base:

PET was made of terephthalic acid and ethylene glycol in an ordinary manner, having an intrinsic viscosity, IV of 0.66 (measured in a mixture of phenol and tetrachloroethane at an weight ratio of 6/4 at 25° C.). This was pelletized, and the resultant was dried at 130° C. for 4 hours, and melted at 300° C. The PET melt was extruded out from a T-die, and rapidly cooled. Thus, a non-oriented film whose thickness was so controlled that the thickness after thermal fixation was 175 μm was prepared.

The film was longitudinally oriented by rolls rotating at different circumferencial speeds at 110° C. so that the longitudinal length thereof after the orientation was 3.3 times as long as the original longitudinal length thereof. Next, the film was laterally oriented by a tenter at 130° C. so that the lateral length thereof after the orientation was 4.5 times as long as the original lateral length thereof. Next, the oriented film was thermally fixed at 240° C. for 20 seconds, and then laterally relaxed by 4% at the same temperature. Next, the chuck of the tenter was slitted, the both edges of the film were knurled, and the film was rolled up at 4 kg/cm². The rolled film had a thickness of 175 μm.

2) Surface Corona Discharge Treatment:

Both surfaces of the support were subjected to corona treatment at room temperature at a speed of 20 m/min with a Pillar's solid-state corona processor, Model 6 KVA. From the data of the current and the voltage read, it was seen that the support had been processed at 0.375 kV·A·min/m². The frequency for the treatment was 9.6 kHz, and the gap clearance between the electrode and the dielectric roll was 1.6 mm.

3) Subbing Treatment:

Preparation of Coating Liquid for Subbing Layer:

Formulation<1> (for Subbing Layer Below Image-Forming Layer):

| | | |
|---|---|---|
| Takamatsu Yushi's PESURESIN A-520 (30 mass % solution) | 59 | g |
| Polyethylene glycol monononylphenyl ether (mean number of | 5.4 | g |
| ethylene oxides: 8.5, 10 mass % solution) | | |
| Soken Chemical's MP-1000 (polymer particles having a mean | 0.91 | g |
| particle size of 0.4 μm) | | |
| Distilled water | 935 | ml |

Formulation <2> (for First Layer on Back Surface):

| | | |
|---|---|---|
| Styrene-butadiene copolymer latex (solid content: 40 mass %, | 158 | g |
| weight ratio of styrene and butadiene: 68/32) | | |
| 2,4-Dichloro-6-hydroxy-S-triazine sodium salt (8 mass % | 20 | g |
| aqueous solution) | | |
| Sodium laurylbenzenesulfonate (1 mass % aqueous solution) | 10 | ml |
| Distilled water | 854 | ml |

Formulation <3> (for Second Layer on Back Surface):

| | | |
|---|---|---|
| SnO₂/SbO (mass ratio: 9/1, mean particle size: 0.038 μm, 17 | 84 | g |
| mass % dispersion) | | |
| Gelatin (10 mass % aqueous solution) | 89.2 | g |
| Shin-etsu Chemical's METOLOSE TC-5 (2 mass % aqueous | 8.6 | g |
| solution) | | |
| Soken Chemical's MP-1000 | 0.01 | g |
| Sodium dodecylbenzenesulfonate (1 mass % aqueous solution) | 10 | ml |
| NaOH (1 mass %) | 6 | ml |
| PROXEL (from ICI) | 1 | ml |
| Distilled water | 805 | ml |

Subbing Treatment:

Both surfaces of the biaxially oriented polyethylene terephthalate support (thickness: 175 μm) were subjected to corona discharge treatment in the above manner. One surface (to have a photosensitive layer thereon) of the support was coated with the coating liquid of subbing layer formulation <1> by the use of a wire bar so that the wet application amount of the coating liquid was 6.6 ml/m² (one surface), and then dried at 180° C. for 5 minutes. Next, the other surface (back surface) of the support was coated with the coating liquid of subbing layer formulation <2> by the use of a wire bar so that the wet application amount of the coating liquid was 5.7 ml/m², and then dried at 180° C. for 5 minutes. The back surface thus coated was further coated with the coating liquid of subbing layer formulation <3> by the use of a wire bar so that the wet application amount of the coating liquid was 7.7 ml/m², and then dried at 180° C. for 6 minutes. In that manner, the support was undercoated.

2) Back Layer:

Preparation of Coating Liquid for Antihalation Layer:

60 g of gelatin, 24.5 g of polyacrylamide, 2.2 g of sodium hydroxide (1 mol/liter), 2.4 g of monodispersed polymethyl methacrylate particles (mean particle size: 8 μm, standard deviation of particle size: 0.4), 0.08 g of benzoisothiazolinone, 0.3 g of sodium polystyrenesulfonate, 0.21 g of blue dye compound 1, 0.15 g of yellow dye compound 1, and 8.3 g of acrylic acid/ethyl acrylate copolymer latex (copolymerization ratio of 5/95) were mixed. Water was added to the resulting mixture so that the total amount of the resultant was 818 ml. Thus, a coating solution for antihalation layer was prepared.

Preparation of Coating Liquid for Back Surface-Protective Layer:

Ina reactor kept at 40° C., 40 g of gelatin, 1.5 g of liquid paraffin in the form of a liquid paraffin emulsion, 35 mg of benzoisothiazolinone, 6.8 g of caustic compound (1 mol/liter), 0.5 g of sodium t-octylphenoxyethoxyethanesulfonate, 0.27 g of sodium polystyrenesulfonate, 5.4 m of aqueous 2% solution of fluorine-containing surfactant (F-1), 6.0 g of an acrylic acid/ethyl acrylate copolymer (copolymerization weight ratio: 5/95), and 2.0 g of N,N-ethylenebis(vinylsulfonacetamide) were mixed. Water was added to the resultant mixture so that the total amount of the mixutre became 1000 ml. Thus, a coating liquid for back surface protective layer was prepared.

Formation of Back Layer:

The coating liquid for antihalation layer was applied to the back face of the undercoated substrate. The amount thereof was such that the amount of gelatin of the antihalation layer was 0.52 g/m². At the same time, the coating liquid for back surface-protective layer was applied thereto and dried to form a back layer on the antihalation layer. The amount thereof was such that the amount of gelatin of the surface-protective layer was 1.7 g/m².

Image-Forming Layer, Intermediate Layer, and Surface-Protective Layer:

1. Preparation of Coating Materials:

1) Silver Halide Emulsions:

Preparation of Silver Halide Emulsion A:

3.1 ml of aqueous 1 mass % potassium bromide solution, 3.5 ml of sulfuric acid (0.5 mol/liter) and 31.7 g of phthalated gelatin were added to 1421 ml of distilled water. The resulting solution was kept at 15° C. in a stainless reactor while it was being stirred. 95.4 ml of a solution A containing 22.22 g of silver nitrate diluted with distilled water, and 97. 4 ml of a solution B containing 15.3 g of potassium bromide and 0.8 g of potassium iodide diluted with distilled water were added to the above solution at constant flow rates over 90 seconds. Next, 10 ml of aqueous 3.5 mass % solution of hydrogen peroxide and 10.8 ml of aqueous 10 mass % solution of benzimidazole were added to the resultant solution. Next, 317.5 ml of a solution C containing 51.86 g of silver nitrate diluted with distilled water, and 400 ml of a solution D containing 44.2 g of potassium bromide and 2.2 g of potassium iodide diluted with distilled water were added to the resultant by a controlled double jet method. At this time, the solution C was added thereto over 20 minutes at a constant flow rate. Meanwhile, the solution D was added thereto so that pAg of the system was kept at 8.1. When 10 minutes lapsed from the start of the addition of the solutions C and D to the system, 1×10⁻⁴ mols, per mol of silver in the system, of potassium hexachloroiridate(III) was added to the system. When five seconds lapsed from the end of the addition of the solution C, 3×10⁻⁴ mols, per mol of silver in the system, of aqueous iron (II) potassium hexacyanide solution was added to the system. Sulfuric acid (0.5 mol/liter) was added to the system to adjust the pH of the system at 3.8. Then, stirring the system was stopped, and steps of precipitating, desalting and washing with water were conducted. Sodium hydroxide (1 mol/liter) was added to the system to adjust the pH of the system at 5.9. A silver halide dispersion having pAg of 8.0 was thus prepared.

While stirring the silver halide dispersion at 38° C., 5 ml of a 0.34 mass % methanol solution of 1,2-benzoisothiazolin-3-one was added thereto. 40 minutes later, the resultant was heated to 47° C. When 20 minutes lapsed from the system temperature reaching 47° C., a methanol solution containing 7.6×10⁻⁵ mols, per mol of silver in the system, of sodium benzenethiosulfonate was added to the system. Five minutes later, a methanol solution containing 2.9×10⁻⁴ mols, per mol of silver of the system, of tellurium sensitizer C was added to the system. Then, the system was ripened for 91 minutes. Thereafter, 1.3 ml of a 0.8 mass % methanol solution of N,N′-dihydroxy-N″-diethylmelamine was added to the system. Four minutes later, a methanol solution including 4.8×10⁻³ mols, per mol of silver, of 5-methyl-2-mercaptobenzimidazole, a methanol solution including 5.4×10⁻³ mols, per mol of silver in the system, of 1-phenyl-2-heptyl-5-mercapto-1,3,4-triazole, and an aqueous solution including 8.5×10⁻³ mols, per mol of silver, of 1-(3-methylureidophenyl)-5-mercaptotetrazole sodium salt were added to the system. Thus, a silver halide emulsion A was prepared.

The grains in the silver halide emulsion thus prepared were silver iodobromide grains and the mean diameter and fluctuation coefficient of spheres having the same volumes as those of the grains were 0.12 μm and 20%, respectively. The iodide content of the grains was 3.5 mol %, and the iodide was uniformly dispersed in the grains. To obtain the grain size, 1000 grains were analyzed with an electronic microscope, and their data were averaged.

Preparation of Silver Halide Emulsion B:

A silver halide emulsion B was prepared in the same manner as the preparation of the emulsion A, except that potassium iodide was not added to the system. The grains in the silver halide emulsion thus prepared were silver bromide grains and the mean diameter and fluctuation coefficient of spheres having the same volumes as those of the grains were 0.12 μm and 15%, respectively.

Preparation of Silver Halide Emulsion 1:

A silver iodobromide emulsion 1 having a silver iodide content of 90 mol % was prepared in the same manner as the preparation of the emulsion A, except that the amounts of potassium iodide and potassium bromide added were varied. The mean diameter and fluctuation coefficient of spheres having the same volumes as those of the grains were 0.12 μm and 15%, respectively.

Preparation of Silver Halide Emulsion 2: 4.3 ml of 1 mass % potassium iodide solution was added to 1420 ml of distilled water, and 3.5 ml of sulfuric acid (0.5 mol/liter) and 36.7 g of phthalated gelatin were added to the resultant mixture. The resulting solution was stirred at 42° C. in a stainless reactor, and 195.6 ml of a solution A containing 22.22 g of silver nitrate diluted with distilled water, and 218 ml of a solution B containing 21.8 g of potassium iodide diluted with distilled water were added to the solution at constant flow rates over 9 minutes. Next, 10 ml of aqueous 3.5 mass % solution of hydrogen peroxide and 10.8 ml of aqueous 10 mass % solution of benzimidazole were added to the resultant solution.

Next, 317.5 ml of a solution C containing 51.86 g of silver nitrate diluted with distilled water, and 600 ml of a solution D containing 60 g of potassium iodide diluted with distilled water were added to the resultant solution by a controlled double jet method. At this time, the solution C was added thereto over 120 minutes at a constant flow. Meanwhile, the solution D was added thereto so that pAg of the system was kept at 8.1. When 10 minutes lapsed from the start of the addition of the solutions C and D to the system, 1×10⁻⁴ mols, per mol of silver in the system, of potassium hexachloroiridate(III) was added to the system. When five seconds lapsed from the end of the addition of the solution C, 3×10⁻⁴ mols, per mol of silver in the system, of aqueous iron (II) potassium hexacyanide solution was added to the system. Sulfuric acid (0.5 mol/liter) was added to the system to adjust the pH of the system at 3.8. Then, stirring the system was stopped, and steps of precipitating, desalting and washing with water were conducted. Sodium hydroxide (1 mol/liter) was added to the system to adjust the pH of the system at 5.9. A silver halide dispersion having pAg of 8.0 was thus prepared.

While stirring the silver halide dispersion at 38° C., 5 ml of a 0.34 mass % methanol solution of 1,2-benzoisothiazolin-3-one was added thereto. The resultant was heated to 47° C. When 20 minutes lapsed from the system temperature reaching 47° C., a methanol solution containing 7.6×10⁻⁵ mols, per mol of silver in the system, of sodium benzenethiosulfonate was added to the system. Five minutes later, a methanol solution containing 2.9×10⁻⁴ mols, per mol of silver of the system, of tellurium sensitizer B was added to the system. Then, the system was ripened for 91 minutes.

1.3 ml of a 0.8 mass % methanol solution of N,N′-dihydroxy-N″-diethylmelamine was added to the system. Four minutes later, a methanol solution including 4.8×10⁻³ mols, per mol of silver, of 5-methyl-2-mercaptobenzimidazole, and a methanol solution including 5.4×10⁻³ mols, per mol of silver in the system, of 1-phenyl-2-heptyl-5-mercapto-1,3,4-triazole were added to the system. Thus, a silver halide emulsion 2 was prepared.

The grains in the silver halide emulsion thus prepared were pure silver iodide grains and the mean diameter and fluctuation coefficient of spheres having the same volumes as those of the grains were 0.12 μm and 18%, respectively. To obtain the grain size, 1000 grains were analyzed with an electronic microscope, and their data were averaged. Based on the formulation for the silver halide emulsion 1, other silver halide emulsions having different grain sizes (their grain sizes are given in Table 3) were prepared in the same manner as the preparation of the emulsion 1. Here, the system temperature that was 42° C. in the preparation of the emulsion 1 was changed to control the mean diameter of spheres having the same volumes as those of the grains.

Preparation of Diluted Emulsions for Coating Liquids:

A 1 mass % aqueous solution containing 7×10⁻³ mols, per mol of silver in the system, of benzothiazolium iodide was added to each of the silver halide emulsions. Water was added to the resultant so that the silver content of silver halides contained in the diluted emulsion was 38.2 g per kg of the emulsion.

2) Fatty Acid Silver Salt Dispersion:

87.6 kg of behenic acid (Henkel's EDENOR C22-85R), 423 liters of distilled water, 49.2 liters of aqueous NaOH solution (5 mol/liter), and 120 liters of t-butyl alcohol were mixed and reacted at 75° C. for 1 hour while stirring this system to prepare a sodium behenate solution A. Apart from this, 206.2 liters of an aqueous solution (pH 4.0) containing 40.4 kg of silver nitrate was prepared, and kept at 10° C. 635 liters of distilled water and 30 liters of t-butyl alcohol were put into a reactor, and kept at 30° C. While sufficient stirring the resultant, the whole amounts of the sodium behenate solution A and the aqueous silver nitrate solution were fed into the reactor at constant flow rates over 93 minutes and 15 seconds, and 90 minutes, respectively. Feeding them into the reactor was so controlled that, for 11 minutes after the start of feeding the aqueous silver nitrate solution, only the aqueous silver nitrate solution was fed into the reactor, that feeding the sodium behenate solution A was started thereafter, and that for 14 minutes and 15 seconds after feeding the aqueous silver nitrate had been finished, only the sodium benenate solution A was fed into the reactor. In this stage, the internal temperature of the reactor was 30° C., and the external temperature of the reactor was so controlled that the temperature of the reaction system in the reactor could be kept constant. The pipe line for the sodium behenate solution A was a double-walled pipe and thermally insulated by circulating hot water through the interspace of the double-walled pipe, and the temperature of the solution at the outlet of the nozzle tip was adjusted at 75° C. The pipe line for the aqueous silver nitrate solution was also a double-walled pipe and thermally insulated by circulating cold water through the interspace of the double-walled pipe. Regarding the position at which the sodium behenate solution A was added to the reaction system and that at which the aqueous silver nitrate solution was added thereto, the two were disposed symmetrically to each other relative to the shaft of the stirrer disposed in the reactor, and the nozzle tips of the pipes were spaced apart from the reaction solution level in the reactor.

After adding the sodium behenate solution A was finished, the reaction system was stirred for 20 minutes at that temperature, and then heated to 35° C. over 30 minutes. Thereafter, the system was ripened for 210 minutes. Immediately after the completion of the ripening, the system was centrifuged to take out a solid component, which was washed with water until the conductivity of the washing waste reached 30 μS/cm. The solid thus obtained was a silver salt of the fatty acid and was stored as wet cake without drying it.

The shapes of the silver behenate grains obtained herein were analyzed on the basis of their images taken through electron microscopic photography. Average values of a, b, and c were 0.14 μm, 0.4 μm and 0.6 μm, respectively (a, b and c are defined hereinabove). The mean aspect ratio was 5.2. The mean diameter and fluctuation coefficient of spheres having the same volumes as those of the grains were 0.52 μm and 15%, respectively. The grains were scaly crystals.

19.3 kg of polyvinyl alcohol (trade name, PVA-217) and water were added to the wet cake whose amount corresponded to 260 kg of the dry weight thereof so that the total amount of the resultant became 1000 kg. The resultant was formed into slurry with a dissolver wing, and then pre-dispersed with a pipe-line mixer (Model PM-10 available from Mizuho Industry).

Next, the pre-dispersed stock slurry was processed three times in a disperser (MICROFLUIDIZER M-610 obtained from Microfluidex International Corporation, and equipped with a Z-type interaction chamber) at a controlled pressure of 1260 kg/cm². A silver behenate dispersion was thus prepared. To cool it, corrugated tube type heat exchangers were disposed before and after the interaction chamber. The temperature of the coolant in these heat exchangers was so controlled that the system could be processed at a dispersion temperature of 18° C.

3) Reducing Agent Dispersion:

Preparation of Reducing Agent-1 Dispersion:

10 kg of a reducing agent 1 (2,2′-methylenebis-(4-ethyl-6-tert-butylphenol)), 16 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) including zirconia beads having a mean diameter of 0.5 mm, and dispersed therewith for 3 hours. Then, 0.2 g of benzoisothiazolinone sodium salt and water were added thereto to adjust the reducing agent concentration of the resultant at 25% by mass. The dispersion was heated at 60° C. for 5 hours. A reducing agent-1 dispersion was thus prepared. The reducing agent grains in the dispersion had a median diameter of 0.40 μm, and a maximum grain size of at most 1.4 μm. The reducing agent dispersion was filtered through a polypropylene filter having a pore size of 3.0 μm to remove foreign objects such as dirt from it, and then stored.

Preparation of Reducing Agent-2 Dispersion:

10 kg of a reducing agent 2 (6,6′-di-t-butyl-4,4′-dimethyl-2,2′-butylidenediphenol), 16 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) including zirconia beads having a mean diameter of 0.5 mm, and dispersed therewith for 3 hours and 30 minutes. Then, 0.2 g of benzoisothiazolinone sodium salt and water were added thereto to adjust the reducing agent concentration of the resultant at 25% by mass. The dispersion was then heated at 40° C. for 1 hour, and then at 80° C. for 1 hour. A reducing agent-2 dispersion was thus prepared. The reducing agent grains in the dispersion had a median diameter of 0.50 μm, and a maximum grain size of at most 1.6 μm. The reducing agent dispersion was filtered through a polypropylene filter having a pore size of 3.0 μm to remove foreign objects such as dirt from it, and then stored.

4) Preparation of Hydrogen-Bonding Compound-1 Dispersion:

10 kg of a hydrogen-bonding compound 1 (tri(4-t-butylphenyl)phosphine oxide), 16 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) containing zirconia beads having a mean diameter of 0.5 mm, and dispersed therewith for 4 hours. Then, 0.2 g of benzoisothiazolinone sodium salt and water were added thereto to adjust the hydrogen-bonding compound concentration of the resultant at 25% by mass. The dispersion was heated at 40° C. for 1 hour and then at 80° C. for 1 hour. A hydrogen-bonding compound-1 dispersion was thus prepared. The hydrogen-bonding compound grains in the dispersion had a median diameter of 0.45 μm, and a maximum grain size of at most 1.3 μm. The hydrogen-bonding compound dispersion was filtered through a polypropylene filter having a pore size of 3.0 μm to remove foreign objects such as dirt from it, and then stored.

5) Development Promoter-1 Dispersion:

Preparation of Development Promoter-1 Dispersion:

10 kg of a development promoter 1, 20 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) containing zirconia beads having a mean diameter of 0.5 mm, and dispersed therewith for 3 hours and 30 minutes. Then, 0.2 g of benzoisothiazolinone sodium salt and water were added thereto to prepare a development promoter-1 dispersion having a development promoter concentration of 20% by mass. The development promoter grains in the dispersion had a median diameter of 0.48 μm, and a maximum grain size of at most 1.4 μm. The development promoter dispersion was filtered through a polypropylene filter having a pore size of 3.0 μm to remove foreign objects such as dirt from it, and then stored.

Preparation of Development Promoter-2 and Color Toning Agent-1 Solid Dispersions:

Development promoter-2 and color toning agent-1 solid dispersions having the respective concentrations of 20% by mass and 15% by mass were prepared in the same manner as the preparation of the development promoter-1 dispersion.

6) Polyhalogen Compound:

Preparation of Organic Polyhalogen Compound-1 Dispersion:

10 kg of an organic polyhalogen compound-1 (tribromomethanesulfonylbenzene), 10 kg of aqueous 20 mass % solution of modified polyvinyl alcohol (Kuraray's POVAL MP203), 0.4 kg of aqueous 20 mass % solution of sodium triisopropylnaphthalenesulfonate, and 14 kg of water were sufficiently mixed to prepare slurry. Via a diaphragm pump, the slurry was fed into a horizontal sand mill (Imex's UVM-2) including zirconia beads having a mean diameter of 0.5 mm, and dispersed therewith for 5 hours. Then, 0.2 g of benzoisothiazolinone sodium salt and water were added thereto to prepare an organic polyhalogen compound-1 dispersion having an ogranic polyhalogen content of 30 mass %. The organic polyhalogen compound grains in the dispersion had a median diameter of 0.41 μm, and a maximum grain size of at most 2.0 μm. The organic polyhalogen compound dispersion was filtered through a polypropylene filter having a pore size of 10.0 μm to remove foreign objects such as dirt from it, and then stored.

Preparation of Organic Polyhalogen Compound-2 Dispersion:

10 kg of an organic polyhalogen compound-2 (N-butyl-3-tribromomethanesulfonylbenzamide), 20 kg of aqueous 10 mass % solution of modified polyvinyl alcohol (Kuraray's POVAL MP203), and 0.4 kg of aqueous 20 mass % solution of sodium triisopropylnaphthalenesulfonate were sufficiently mixed to prepare slurry. Via a diaphragm pump, the slurry was fed into a horizontal sand mill (Imex's UVM-2) including zirconia beads having a mean diameter of 0.5 mm, and dispersed therewith for 5 hours. Then, 0.2 g of benzoisothiazolinone sodium salt and water were added thereto to adjust the organic polyhalogen content of the resultant at 30 mass %. The dispersion was heated at 40° C. for 5 hours. An organic polyhalogen compound-2 dispersion was thus obtained. The organic polyhalogen compound grains in the dispersion had a median diameter of 0.40 μm, and a maximum grain size of at most 1.3 μm. The organic polyhalogen compound dispersion was filtered through a polypropylene filter having a pore size of 3.0 μm to remove foreign objects such as dirt from it, and then stored.

7) Dispersion of Silver Iodide Complex-Forming Agent in the Invention:

One kg of a silver iodide complex-forming agent in the invention (types used thereof are described in Table 3), 2 kg of aqueous 10 mass % solution of modified polyvinyl alcohol (Kuraray's POVAL MP203), and 0.04 kg of aqueous 20 mass % solution of sodium triisopropylnaphthalenesulfonate were sufficiently mixed to prepare slurry. Via a diaphragm pump, the slurry was fed into a horizontal sand mill (Imex's UVM-2) including zirconia beads having a mean diameter of 0.5 mm, and dispersed therewith while the dispersion time was so controlled that the dispersed grains could have a median diameter mentioned below. Then, 0.02 g of benzoisothiazolinone sodium salt and water were added thereto to adjust the content of compound of fomula (10) or (11) in the resultant at 20 mass %. The dispersion was heated at 40° C. for 5 hours. A dispersion of the compound of formula (10) or (11) was thus prepared. The compound grains in the dispersion had a median diameter of 0.40 μm, and a maximum grain size of at most 1.3 μm. The dispersion was filtered through a polypropylene filter having a pore size of 3.0 μm to remove foreign objects such as dirt from it, and then stored.

8) Color Toning Agent Dispersion:

Preparation of Phthalazine Compound Solution (Types Used Thereof are Described in Table 3):

8 kg of Kuraray's modified polyvinyl alcohol MP203 was dissolved in 174.57 kg of water, and 3.15 kg of aqueous 20 mass % solution of sodium triisopropylnaphthalenesulfonate and 6 kg of a phthalazine compound were added to the resultant solution to prepare an aqueous 5 mass % solution of phthalazine compound.

Preparation of Phthalazone Compound Dispersion:

One kg of a phthalazone compound, 2 kg of aqueous 10 mass % solution of modified polyvinyl alcohol (Kuraray's POVAL MP203), and 0.04 kg of aqueous 20 mass % solution of sodium triisopropylnaphthalenesulfonate were sufficiently mixed to prepare slurry. Via a diaphragm pump, the slurry was fed into a horizontal sand mill (Imex's UVM-2) including zirconia beads having a mean diameter of 0.5 mm, and dispersed therewith for 45 minutes. Then, 0.02 g of benzoisothiazolinone sodium salt and water were added thereto to adjust the phthalazone compound content of the resultant at 20 mass %. The dispersion was heated at 40° C. for 5 hours. A phthalazone compound dispersion was thus prepared. The dispersion was filtered through a polypropylene filter having a pore size of 3.0 μm to remove foreign objects such as dirt from it, and then stored.

9) Preparation of Mercapto Compound:

Preparation of Aqueous Mercapto Compound-1 Solution:

7 g of a mercapto compound-1 (1-(3-sulfophenyl)-5-mercaptotetrazole sodium salt) was dissolved in 993 g of water to prepare an aqueous 0.7 mass % solution of the mercapto compound.

Preparation of Aqueous Mercapto Compound-2 Solution:

20 g of a mercapto compound-2 (1-(3-methylureidophenyl)-5-mercaptotetrazole sodium salt) was dissolved in 980 g of water to prepare an aqueous 2.0 mass % solution of the mercapto compound.

10) Preparation of Pigment-1 Dispersion:

64 g of C.I. Pigment Blue 60, 6.4 g of Kao's DEMOLE N and 250 g of water were sufficiently mixed to prepare slurry. 800 g of zirconia beads having a mean diameter of 0.5 mm were prepared and put into a vessel along with the slurry. The slurry in the vessel was dispersed by the use of a disperser (Imex's 1/4G Sand Grinder Mill) for 25 hours, and water was added to the slurry to prepare a pigment-1 dispersion having a pigment concentration of 5% by mass. The pigment grains in the dispersion thus prepared had a mean grain size of 0.21 μm.

11) Preparation of SBR Latex:

SBR latex was prepared as follows:

287 g of distilled water, 7.73 g of surfactant (Takemoto Yushi's PIONINA-43-S, having a solid content of 48.5%), 14.06 ml of NaOH (1 mol/liter), 0.15 g of tetrasodium ethylenediaminetetraacetate, 255 g of styrene, 11.25 g of acrylic acid, and 3.0 g of tert-dodecylmercaptan were put into the polymerization reactor of a gas monomer reaction apparatus (Pressure Glass Industry's TAS-2J Model). The reactor was sealed, and the content therein was stirred at 200 rpm. The internal air was exhausted via a vacuum pump, and purged a few times repeatedly with nitrogen. Then, 108.75 g of 1,3-butadiene was introduced into the reactor under pressure, and the internal temperature of the reactor was heated to 60° C. A solution in which 1.875 g of ammonium persulfate was dissolved in 50 ml of water was added to the system, and the system was stirred for 5 hour. It was further heated to 90° C. and stirred for 3 hours. After the reaction was completed, the internal temperature was cooled to room temperature. Then, NaOH and NH₄OH (both 1 mol/liter) were added to the system at a molar ratio of Na⁺ and NH₄⁺ of 1/5.3 so as to adjust the pH of the system at 8.4. Next, the system was filtered through a polypropylene filter having a pore size of 1.0 μm to remove foreign objects such as dirt from it, and then stored. 774.7 g of SBR latex was thus obtained. Its halide ion content was measured through ion chromatography, and the chloride ion concentration of the latex was 3 ppm. The chelating agent concentration thereof was measured through high-performance liquid chromatography, and was 145 ppm.

The mean grain size of the latex was 90 nm, Tg thereof was 17° C., the solid content thereof was 44% by mass, the equilibrium moisture content thereof at 25° C. and 60% RH was 0.6% by mass, and the ion conductivity thereof was 4.80 mS/cm. To measure the ion conductivity, a To a Denpa Kogyo's conductometer CM-30S was used. In the device, the 44 mass % latex was measured at 25° C. Its pH was 8.4.

Preparation of Coating Liquids:

Preparation of Coating Liquids 1 to 24 for image-forming layer:

The pigment-1 dispersion, the organic polyhalogen compound-1 dispersion, the organic polyhalogen compound-2 dispersion, the phthalazine or phthalazone compound solution, the silver iodide complex-forming agent in the invention, the SBR latex (Tg: 17° C.), the reducing agent-1 dispersion, the hydrogen-bonding compound-1 dispersion, the development promoter-1 dispersion, the development promoter-2 dispersion, the color toning agent-1 dispersion, the aqueous mercapto compound-1 solution, the aqueous mercapto compound-2 solution, an aqueous additive S-1 solution and an aqueous additive S-2 solution were successively added to 1000 g of the fatty acid silver salt dispersion A and 276 ml of water in accordance with formulations of Table 3. Just before applition, the resulting mixture was sufficiently mixed with any of the diluted emulsions-A, -B, -1 or -2 to prepare coating liquids 1 to 24 for an image-forming layer.

The zirconium content of the coating liquid was 0.52 mg per gram of Ag.

Preparation of Coating Liquid for Intermediate Layer:

27 ml of aqueous 5 mass % solution of AEROSOL OT (from American Cyanamid), 135 ml of aqueous 20 mass % solution of diammonium phthalate and water were added to 1000 g of a polyvinyl alcohol, Kuraray's PVA-205, 272 g of the pigment-1 dispersion, and 4200 ml of 19 mass % latex of methyl methacrylate/styrene/butyl acrylate/hydroxyethyl methacrylate/acrylic acid copolymer (copolymerization ratio: 64/9/20/5/2 by weight) so that the total amount of the resultant mixture became 10000 g. The pH of the mixture was adjusted at 7.5 with the addition of NaOH. A coating liquid for an intermediate layer was thus obtained. This was fed into a coating die, with its flow rate so controlled that its coating amount could be 9.1 ml/m².

The viscosity of the coating liquid used in heat-developable light-sensitive material 1, measured with a B-type viscometer (with No. 1 rotor at 60 rpm), was 58 [mPa·s] at 40° C.

Preparation of Coating Liquid for First Surface-Protective Layer:

64 g of inert gelatin was dissolved in water, and 112 g of 19.0 mass % latex of methyl methacrylate/styrene/butyl acrylate/hydroxyethyl methacrylate/acrylic acid copolymer (copolymerization ratio: 64/9/20/5/2 by weight), 30 ml of 15 mass % methanol solution of phthalic acid, 23 ml of aqueous 10 mass % solution of 4-methylphthalic acid, 28 ml of sulfuric acid (0.5 mol/liter), 5 ml of aqueous 5 mass % solution of AEROSOL OT (from American Cyanamid), 0.5 g of phenoxyethanol, 0.1 g of benzoisothiazolinone, and water were added to the resultant solution so that the total amount of the resultant mixture became 750 g. Just before application thereof, 26 ml of 4 mass % chromium alum was added to the mixture, and the resultant was stirred with a static mixer. The resultant coating liquid was fed into a coating die so that the amount of the resultant coating was 18.6 ml/m².

The viscosity of the coating liquid, measured with a B-type viscometer (with No. 1 rotor at 60 rpm), was 20 [mPa·s] at 40° C.

Preparation of Coating Liquid for Second Surface-Protective Layer:

80 g of inert gelatin was dissolved in water, and 102 g of 27.5 mass % latex of methyl methacrylate/styrene/butyl acrylate/hydroxyethyl methacrylate/acrylic acid copolymer (copolymerization ratio: 64/9/20/5/2 by weight), 5.4 ml of 2 mass % solution of a fluorine-containing surfactant (F-1), 5.4 ml of aqueous 2 mass % solution of a fluorine-containing surfactant (F-2), 23 ml of 5 mass % solution of AEROSOL OT (from American Cyanamid), 4 g of fine polymethyl methacrylate grains (mean grain size: 0.7 μm), 21 g of fine polymethyl methacrylate grains (mean grain size: 4.5 μm), 1.6 g of 4-methylphthalic acid, 4.8 g of phthalic acid, 44 ml of sulfuric acid (0.5 mol/liter), 10 mg of benzoisothiazolinone, and water were added to the resultant solution so that the total amount of the resultant mixture became 650 g. Just before application thereof, 445 ml of aqueous solution containing 4 mass % of chromium alum and 0.67 mass % of phthalic acid was added to the mixture, and the resultant was stirred with a static mixer. A coating liquid for surface-protective layer was thus obtained. The coating liquid was fed into a coating die, with its flow rate so controlled that its coating amount could be 8.3 ml/m².

The viscosity of the coating liquid, measured with a B-type viscometer (with No. 1 rotor at 60 rpm), was 19 [mPa·s] at 40° C.

3. Preparation of Heat-Developable Light-Sensitive Materials 1 to 24:

The coating liquid for an image-forming layer, that for an intermediate layer, that for a first surface-protective layer and that for a second surface-protective layer were simultaneously applied onto the undercoated surface opposite to the back of the support in that order according to a slide bead coating method to preapare heat-developable light-sensitive materials. At this time, the temperatures of the coating liquid for an emulsion layer and the coating liquid for an intermediate layer were adjusted at 31° C., that of the coating liquid for a first surface-protective layer was adjusted at 36° C. and that of the coating liquid for a second surface-protective layer was adjusted at 37° C.

The coating amounts (g/m²) of the constitutive components of the emulsion layer are mentioned below.

| | |
|---|---|
| Silver behenate | 5.27 |
| Pigment (C.I. Pigment Blue 60) | 0.036 |
| Polyhalogen compound 1 | 0.09 |
| Polyhalogen compound 2 | 0.14 |
| Phthalazine or phthalazone compound (shown in Table 3) | 0.18 |
| Silver Iodide Complex-Forming Agent in the invention (shown | 0.15 |
| in Table 3) | |
| SBR latex | 9.43 |
| Reducing agent 1 | 0.55 |
| Reducing agent 2 | 0.22 |
| Hydrogen-bonding compound 1 | 0.28 |
| Development promoter 1 | 0.025 |
| Development promoter 2 | 0.020 |
| Color toning agent 1 | 0.008 |
| Mercapto compound 1 | 0.002 |
| Mercapto compound 2 | 0.006 |
| Additive S-1 | 0.001 |
| Additive S-2 | 0.002 |
| Silver of silver halide (its grain size is shown in Table | 0.046 |
| 3) | |

The coating and drying conditions are mentioned below.

Before coating, the static electricity of the support was eliminated by blowing an ion blow to the support. The coating speed was 160 m/min. The coating and drying conditions for each sample were controlled within the range mentioned below so that the coated surface could be stabilized to the best.

The distance between the coating die tip and the support fell between 0.10 and 0.30 mm. The pressure in the decompression chamber was lower by 196 to 882 Pa than the atmospheric pressure. In the subsequent chilling zone, the coated support was chilled with an air blow (its dry-bulb temperature fell between 10 and 20° C.). In the next helix type contactless drying zone, the support was dried with a dry air blow (its dry-bulb temperature fell between 23 and 45° C., and its wet-bulb temperature fell between 15 and 21° C.) In this zone, the coated support to be dried was kept not in contact with the drier. After the drying, the support was conditioned at 25° C. and 40 to 60% RH, and then heated so that the surface temperature was between 70 and 90° C. After thr heating, the support was cooled to have a surface temperature of 25° C.

The degree of matting, in terms of the Beck's smoothness, of the heat-developable light-sensitive material 1 thus prepared was 550 seconds on the photosensitive layer-coated surface thereof and 130 seconds on the back surface thereof. The pH of the photosensitive layer-coated surface of the sample was measured and was 6.0.

Chemical structures of the compounds used in this Example are shown below.

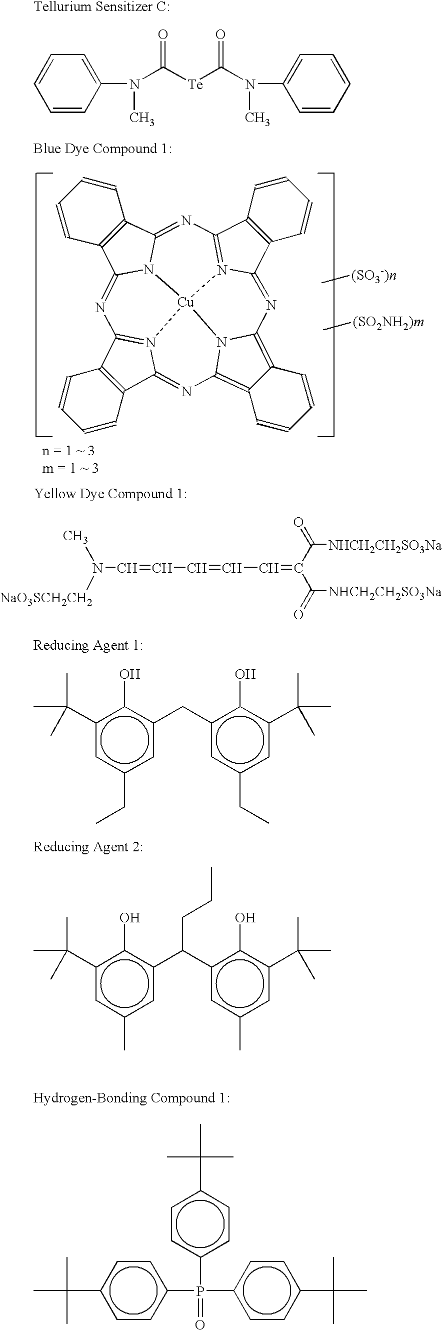

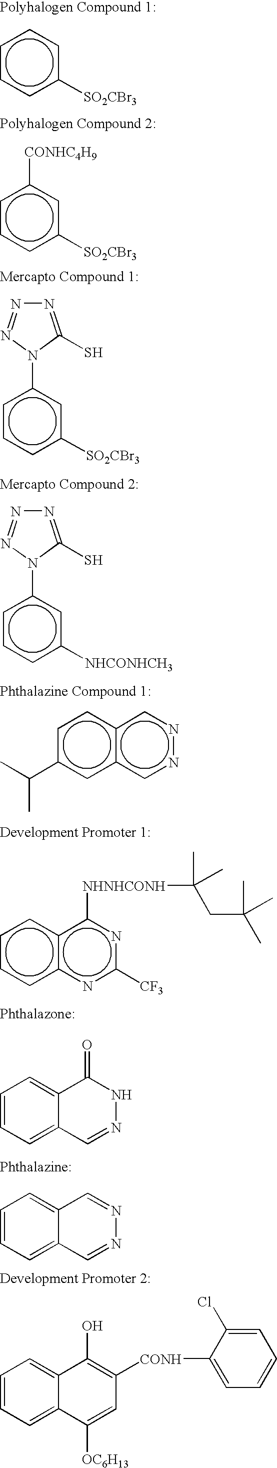

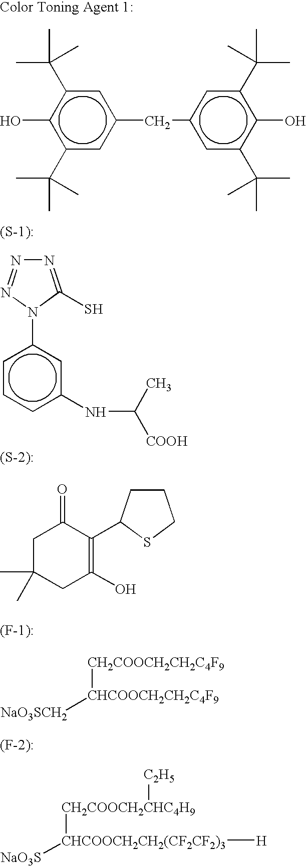

4. Evaluation of Photographic Properties:

Heat Development:

Each sample was thermally developed with Fuji Medical Dry Laser Imager FM-DPL Model in which the temperatures of four panel heaters were set at 112° C., 118° C., 120° C. and 120° C., respectively and which the overall development time was set at 24 seconds.

Difference Between Light Absorption Intensity Before Heat Development and that After Heat Development:

Using a spectral photometer U-4100 (manufactured by Hitachi) equipped with an integrating sphere, the spectral absorbance of each sample was measured. The samples with a silver iodide-rich emulsion had an absorption maximum at 415 nm as shown in FIG. 1. The change rate of the absorbance at 415 nm of each sample before heat development and that after heat development was measured. Apart from the above samples, silver iodide-free sample was prepared, and the absorbance thereof at 415 nm was used as a base standard. The retention of absorbance of each sample was computed according to the formula mentioned below. The smaller the retention, the larger the reduction in absorption, which is preferable.

Retention of Absorbance (%)=A/B×100

A=(absorbance of a sample after heat development)−(absorbance of a silver iodide-free sample after heat development)

B=(absorbance of the sample before heat development)−(absorbance of a silver iodide-free sample before heat development)

The results obtained are given in Table 3.

TABLE 3

| | Silver Halide | | | | | Silver | |
|---|---|---|---|---|---|---|---|
| | | Silver | | Silver Iodide | | Iodide | |
| | | Iodide | | Complex-forming | | Absorption | |
| | | Content | | Agent | | Retention | |
| Sample No. | Emulsion No. | (mol %) | Color Toning Agent | No. | pKa | (%) | Remarks |
| 1 | A | 3.5 | — | — | — | 100 | comparative |
| | | | | | | | sample |
| 2 | A | 3.5 | phthalazine | — | — | 100 | comparative |
| | | | | | | | sample |
| 3 | A | 3.5 | 6- | — | — | 100 | comparative |
| | | | isopropylphthalazine | | | | sample |
| 4 | A | 3.5 | 6- | F-325 | 4.2 | 100 | comparative |
| | | | isopropylphthalazine | | | | sample |
| 5 | A | 3.5 | phthalazone | — | — | 100 | comparative |
| | | | | | | | sample |
| 6 | A | 3.5 | phthalazone | F-325 | 4.2 | 100 | comparative |
| | | | | | | | sample |
| 7 | B | 0 | — | — | — | 100 | comparative |
| | | | | | | | sample |
| 8 | B | 0 | phthalazine | — | — | 100 | comparative |
| | | | | | | | sample |
| 9 | B | 0 | 6- | — | — | 100 | comparative |
| | | | isopropylphthalazine | | | | sample |
| 10 | B | 0 | 6- | F-325 | 4.2 | 100 | comparative |
| | | | isopropylphthalazine | | | | sample |
| 11 | B | 0 | phthalazone | — | — | 100 | comparative |
| | | | | | | | sample |
| 12 | B | 0 | phthalazone | F-325 | 4.2 | 100 | comparative |
| | | | | | | | sample |
| 13 | 1 | 90 | — | — | — | 43 | comparative |
| | | | | | | | sample |
| 14 | 1 | 90 | phthalazine | — | — | 8 | sample of |
| | | | | | | | the |
| | | | | | | | invention |
| 15 | 1 | 90 | 6- | — | — | 5 | sample of |
| | | | isopropylphthalazine | | | | the |
| | | | | | | | invention |
| 16 | 1 | 90 | 6- | F-325 | 4.2 | 0 | sample of |
| | | | isopropylphthalazine | | | | the |
| | | | | | | | invention |
| 17 | 1 | 90 | phthalazone | — | — | 43 | comparative |
| | | | | | | | sample |
| 18 | 1 | 90 | phthalazone | F-325 | 4.2 | 15 | sample of |
| | | | | | | | the |
| | | | | | | | invention |
| 19 | 2 | 100 | — | — | — | 40 | comparative |
| | | | | | | | sample |
| 20 | 2 | 100 | phthalazine | — | — | 6 | sample of |
| | | | | | | | the |
| | | | | | | | invention |
| 21 | 2 | 100 | 6- | — | — | 4 | sample of |
| | | | isopropylphthalazine | | | | the |
| | | | | | | | invention |
| 22 | 2 | 100 | 6- | F-325 | 4.2 | 0 | sample of |
| | | | isopropylphthalazine | | | | the |
| | | | | | | | invention |
| 23 | 2 | 100 | phthalazone | — | — | 40 | comparative |
| | | | | | | | sample |
| 24 | 2 | 100 | phthalazone | F-325 | 4.2 | 15 | sample of |
| | | | | | | | the |
| | | | | | | | invention |

In Table 3, phtalazine, 6-isopropylphthalazine and compound F-325 correspond to the silver iodide complex-forming agent in the invention. It is obvious that the combination of the silver iodide-rich emulsion and the silver iodide complex-forming agent in the invention specifically lowers the absorption intensity of the samples. 6-isopropylphthalazine was more effective than phthalazine.

From the data in Table 3, it is understood that, when phthalazine is used as a color toning agent, it is effective for reducing the absorption intensity even when any additional compound of formula (10) or (11) is not used. However, when the silver iodide complex-forming agent of the invention is additionally used, this brings about better results.

Photographic Properties:

A laser source, Nichia Chemical Industry's semiconductor laser NLHV3000E was set in the exposure zone of Fuji Medical Dry Laser Imager FM-DPL, and its beam diameter was narrowed down to 100 μm. With the intensity of laser light on the surface of the heat-developable light-sensitive material sample controlled to be 0 or within a range of from 1 mW/mm² to 1000 mW/mm², the sample was exposed to the laser light for 1106 seconds. The laser light oscillation wavelength was 405 nm. For the heat development, the temperatures of four panel heaters were set at 112° C., 118° C., 120° C. and 120° C., respectively and the development time was set at 12 seconds by accelerating the conveying speed. The density of the image formed was measured with a densitometer.

Fog (Dmin): This is the concentration of the non-exposed area.

Maximum density (Dmax): This is the density at exposure saturation.

Evaluation of Image Storability:

The thermally developed samples were left under a fluorescent lamp (intensity of illumination: 6000 luxes) in a room (30° C., 70% RH) for 3 days, and the fog density change thereof was measured. The smaller fog density increase, the better the image storability.

Measurement of Acid Dissociation Constant, pKa:

Using an automatic potentiometric titration meter, Kyoto Electronic Industry's AT-420, the acid dissociation constant (pKa) of the conjugate acid of the silver iodide complex-forming agent in a mixed solution of tetrahydrofuran and water (3/2) was measured at 25° C.

TABLE 4

| | | | Image | |
|---|---|---|---|---|
| | Photographic Properties | | Storability | |
| Sample No. | Dmin | Dmax | Δfog | Remarks |
| 1 | 0.14 | 0.17 | 0.28 | comparative |
| | | | | sample |
| 2 | 0.17 | 3.04 | 0.14 | comparative |
| | | | | sample |
| 3 | 0.17 | 3.6 | 0.12 | comparative |
| | | | | sample |
| 4 | 0.17 | 3.6 | 0.11 | comparative |
| | | | | sample |
| 5 | 0.17 | 3.4 | 0.27 | comparative |
| | | | | sample |
| 6 | 0.17 | 3.4 | 0.16 | comparative |
| | | | | sample |
| 7 | 0.14 | 0.17 | 0.3 | comparative |
| | | | | sample |
| 8 | 0.17 | 3.4 | 0.16 | comparative |
| | | | | sample |
| 9 | 0.17 | 3.6 | 0.14 | comparative |
| | | | | sample |
| 10 | 0.17 | 3.6 | 0.12 | comparative |
| | | | | sample |
| 11 | 0.17 | 3.4 | 0.3 | comparative |
| | | | | sample |
| 12 | 0.17 | 3.4 | 0.18 | comparative |
| | | | | sample |
| 13 | 0.14 | 0.18 | 0.14 | comparative |
| | | | | sample |
| 14 | 0.17 | 3.6 | 0.03 | sample of the |
| | | | | invention |
| 15 | 0.18 | 3.08 | 0.03 | sample of the |
| | | | | invention |
| 16 | 0.18 | 3.07 | 0.02 | sample of the |
| | | | | invention |
| 17 | 0.17 | 3.5 | 0.14 | comparative |
| | | | | sample |
| 18 | 0.17 | 3.5 | 0.04 | sample of the |
| | | | | invention |
| 19 | 0.14 | 0.18 | 0.12 | comparative |
| | | | | sample |
| 20 | 0.17 | 3.6 | 0.02 | sample of the |
| | | | | invention |
| 21 | 0.18 | 3.8 | 0.02 | sample of the |
| | | | | invention |
| 22 | 0.18 | 3.7 | 0.01 | sample of the |
| | | | | invention |
| 23 | 0.17 | 3.5 | 0.12 | comparative |
| | | | | sample |
| 24 | 0.17 | 3.5 | 0.03 | sample of the |
| | | | | invention |

From the data in Table 4, it is understood that the samples of the invention give high-quality images having high image density and low fog, and that their image storability is good. In addition, from the data of absorption intensity change thereof, it is also understood that the samples of the invention give clear and good images with reduced turbidity after heat development.

### Example 4

Samples 101 to 116 were prepared in the same manner as in sample 19 of Example 3 except that the color toning agent and the silver iodide complex-forming agent were changed in accordance with Table 5. These were evaluated in the same manner as in Example 3.

Results are shown in Table 5. From the data in Table 5, it is understood that the samples of the invention give high-quality images having high image density and low fog, and that their image storability is good. In addition, from the data of absorption intensity change thereof, it is also understood that the samples of the invention give clear and good images with reduced turbidity after heat development.

TABLE 5

| | | | | | | Retention | | |
|---|---|---|---|---|---|---|---|---|
| | | | | | | of Silver | | |
| | | | | | | Iodide | | |
| | | | | | | Absorption | | |
| | | | | | | after heat | | |
| | | Silver Iodide | | | | development | | |
| | | Complex-Forming | | | | to that | | |
| | | Agent | | Photographic | | before heat | Image | |
| | | Compound | | Properties | | development | Storability | |
| No. | Color Toning Agent | No. | pKa | Dmin | Dmax | (%) | (Δfog) | Remarks |
| 101 | 6-isopropylphthalazine | — | | 0.18 | 3.8 | 4 | 0.02 | sample of |
| | | | | | | | | the |
| | | | | | | | | invention |
| 102 | 6-isopropylphthalazine | F-325 | 4.2 | 0.18 | 3.7 | 0 | 0.01 | sample of |
| | | | | | | | | the |
| | | | | | | | | invention |
| 103 | — | — | | 0.14 | 0.18 | 40 | 0.12 | comparative |
| | | | | | | | | sample |
| 104 | phthalazone | — | | 0.17 | 3.5 | 40 | 0.12 | comparative |
| | | | | | | | | sample |
| 105 | phthalazone | F-325 | 4.2 | 0.17 | 3.5 | 15 | 0.03 | sample of |
| | | | | | | | | the |
| | | | | | | | | invention |
| 106 | phthalazine | — | | 0.17 | 3.6 | 6 | 0.02 | sample of |
| | | | | | | | | the |
| | | | | | | | | invention |
| 107 | phthalazone | F-421 | 4.2 | 0.17 | 3.5 | 15 | 0.04 | sample of |
| | | | | | | | | the |
| | | | | | | | | invention |
| 108 | phthalazone | F-405 | 3.6 | 0.17 | 3.5 | 20 | 0.06 | sample of |
| | | | | | | | | the |
| | | | | | | | | invention |
| 109 | phthalazone | F-404 | 5.4 | 0.17 | 3.5 | 14 | 0.03 | sample of |
| | | | | | | | | the |
| | | | | | | | | invention |
| 110 | phthalazone | F-515 | | 0.17 | 3.5 | 15 | 0.04 | sample of |
| | | | | | | | | the |
| | | | | | | | | invention |
| 111 | phthalazone | F-814 | | 0.17 | 3.5 | 15 | 0.04 | sample of |
| | | | | | | | | the |
| | | | | | | | | invention |
| 112 | phthalazone | F-909 | | 0.17 | 3.5 | 15 | 0.04 | sample of |
| | | | | | | | | the |
| | | | | | | | | invention |
| 113 | phthalazone | F-418 | | 0.17 | 3.5 | 14 | 0.04 | sample of |
| | | | | | | | | the |
| | | | | | | | | invention |
| 114 | phthalazone | F-706 | | 0.17 | 3.5 | 14 | 0.04 | sample of |
| | | | | | | | | the |
| | | | | | | | | invention |
| 115 | phthalazone | F-805 | | 0.17 | 3.5 | 14 | 0.04 | sample of |
| | | | | | | | | the |
| | | | | | | | | invention |
| 116 | phthalazone | F-916 | | 0.17 | 3.5 | 14 | 0.04 | sample of |
| | | | | | | | | the |
| | | | | | | | | invention |

### Example 5

Formation of PET Support:

1) Formation of Base:

PET was made of terephthalic acid and ethylene glycol in an ordinary manner, having an intrinsic viscosity, IV of 0.66 (measured in a mixture of phenol and tetrachloroethane at an weight ratio of 6/4 at 25° C.). This was pelletized, and the resultant was dried at 130° C. for 4 hours, and melted at 300° C. The PET melt was extruded out from a T-die, and rapidly cooled. Thus, a non-oriented film whose thickness was so controlled that the thickness after thermal fixation was 175 μm was prepared.

The film was longitudinally oriented by rolls rotating at different circumferencial speeds at 110° C. so that the longitudinal length thereof after the orientation was 3.3 times as long as the original longitudinal length thereof. Next, the film was laterally oriented by a tenter at 130° C. so that the lateral length thereof after the orientation was 4.5 times as long as the original lateral length thereof. Next, the oriented film was thermally fixed at 240° C. for 20 seconds, and then laterally relaxed by 4% at the same temperature. Next, the chuck of the tenter was slitted, the both edges of the film were knurled, and the film was rolled up at 4 kg/cm². The rolled film had a thickness of 175 μm.

2) Surface Corona Discharge Treatment:

Both surfaces of the support were subjected to corona treatment at room temperature at a speed of 20 m/min with a Pillar's solid-state corona processor, Model 6 KVA. From the data of the current and the voltage read, it was seen that the support had been processed at 0.375 kV·A·min/m². The frequency for the treatment was 9.6 kHz, and the gap clearance between the electrode and the dielectric roll was 1.6 mm.

3) Subbing Treatment:

Preparation of Coating Liquid for Subbing Layer:

Formulation <1> (for subbing layer below image-forming layer):

| Formulation <1> (for subbing | | |
|---|---|---|
| layer below image - forming layer): | | |
| Takamatsu Yushi's PESURESIN A-520 (30 mass % solution) | 59 | g |
| Polyethylene glycol monononylphenyl ether (mean number of | 5.4 | g |
| ethylene oxides: 8.5, 10 mass % solution) | | |
| Soken Chemical's MP-1000 (polymer particles having a mean | 0.91 | g |
| particle size of 0.4 μm) | | |
| Distilled water | 935 | ml |
| Formulation <2> (for first layer on back surface): | | |
| Styrene-butadiene copolymer latex (solid content: 40 mass %, | 158 | g |
| weight ratio of styrene and butadiene: 68/32) | | |
| 2,4-Dichloro-6-hydroxy-S-triazine sodium salt (8 mass % | 20 | g |
| aqueous solution) | | |
| Sodium laurylbenzenesulfonate (1 mass % aqueous solution) | 10 | ml |
| Distilled water | 854 | ml |

Formulation <3> (for second layer on back surface):

| Formulation <1> (for subbing layer below image- | | |
|---|---|---|
| forming layer): | | |
| SnO₂/SbO (mass ratio: 9/1, mean particle size: 0.038 μm, | 84 | g |
| 17 mass % dispersion) | | |
| Gelatin (10 mass % aqueous solution) | 89.2 | g |
| Shin-etsu Chemical's METOLOSE TC-5 (2 mass % aqueous | 8.6 | g |
| solution) | | |
| Soken Chemical's MP-1000 | 0.01 | g |
| Sodium dodecylbenzenesulfonate (1 mass % aqueous solution) | 10 | ml |
| NaOH (1 mass %) | 6 | ml |
| PROXEL (from ICI) | 1 | ml |
| Distilled water | 805 | ml |

Subbing Treatment:

Both surfaces of the biaxially oriented polyethylene terephthalate support (thickness: 175 μm) were subjected to corona discharge treatment in the above manner. One surface (to have a photosensitive layer thereon) of the support was coated with the coating liquid of subbing layer formulation <1> by the use of a wire bar so that the wet application amount of the coating liquid was 6.6 ml/m² (one surface), and then dried at 180° C. for 5 minutes. Next, the other surface (back surface) of the support was coated with the coating liquid of subbing layer formulation <2> by the use of a wire bar so that the wet application amount of the coating liquid was 5.7 ml/m², and then dried at 180° C. for 5 minutes. The back surface thus coated was further coated with the coating liquid of subbing layer formulation <3> by the use of a wire bar so that the wet application amount of the coating liquid was 7.7 ml/m², and then dried at 180° C. for 6 minutes. In that manner, the support was undercoated.

2) Back Layer:

Preparation of Coating Liquid for Antihalation Layer:

60 g of gelatin, 24.5 g of polyacrylamide, 2.2 g of sodium hydroxide (1 mol/liter), 2.4 g of monodispersed polymethyl methacrylate particles (mean particle size: 8 μm, standard deviation of particle size: 0.4), 0.08 g of benzoisothiazolinone, 0.3 g of sodium polystyrenesulfonate, 0.21 g of blue dye compound 1, 6.8 g of UV absorbent 1, and 8.3 g of acrylic acid/ethyl acrylate copolymer latex (copolymerization ratio of 5/95) were mixed. Water was added to the resulting mixture so that the total amount of the resultant was 818 ml. Thus, a coating solution for antihalation layer was prepared.

Preparation of Coating Liquid for Back Surface-Protective Layer:

In a reactor kept at 40° C., 40 g of gelatin, 1.5 g of liquid paraffin in the form of a liquid paraffin emulsion, 35 mg of benzoisothiazolinone, 6.8 g of caustic compound (1 mol/liter), 0.5 g of sodium t-octylphenoxyethoxyethanesulfonate, 0.27 g of sodium polystyrenesulfonate, 5.4 m of aqueous 2% solution of fluorine-containing surfactant (F-1), 6.0 g of an acrylic acid/ethyl acrylate copolymer (copolymerization weight ratio: 5/95), and 2.0 g of N,N-ethylenebis(vinylsulfonacetamide) were mixed. Water was added to the resultant mixture so that the total amount of the mixutre became 1000 ml. Thus, a coating liquid for back surface protective layer was prepared.

Formation of Back Layer:

The coating liquid for antihalation layer was applied to the back face of the undercoated substrate. The amount thereof was such that the amount of gelatin of the antihalation layer was 0.52 g/m². At the same time, the coating liquid for back surface-protective layer was applied thereto and dried to form a back layer on the antihalation layer. The amount thereof was such that the amount of gelatin of the surface-protective layer was 1.7 g/m².

Image-Forming Layer, Intermediate Layer, and Surface-Protective Layer:

1. Preparation of Coating Materials:

1) Silver Halide Emulsions:

Preparation of Silver Halide Emulsion A:

3.1 ml of aqueous 1 mass % potassium bromide solution, 3.5 ml of sulfuric acid (0.5 mol/liter) and 31.7 g of phthalated gelatin were added to 1421 ml of distilled water. The resulting solution was kept at 30° C. in a stainless reactor while it was being stirred. 95.4 ml of a solution A containing 22.22 g of silver nitrate diluted with distilled water, and 97. 4 ml of a solution B containing 15.3 g of potassium bromide and 0.8 g of potassium iodide diluted with distilled water were added to the above solution at constant flow rates over 45 seconds. Next, 10 ml of aqueous 3.5 mass % solution of hydrogen peroxide and 10.8 ml of aqueous 10 mass % solution of benzimidazole were added to the resultant solution. Next, 317.5 ml of a solution C containing 51.86 g of silver nitrate diluted with distilled water, and 400 ml of a solution D containing 44.2 g of potassium bromide and 2.2 g of potassium iodide diluted with distilled water were added to the resultant by a controlled double jet method. At this time, the solution C was added thereto over 20 minutes at a constant flow rate. Meanwhile, the solution D was added thereto so that pAg of the system was kept at 8.1. When 10 minutes lapsed from the start of the addition of the solutions C and D to the system, 1×10⁻⁴ mols, per mol of silver in the system, of potassium hexachloroiridate(III) was added to the system. When five seconds lapsed from the end of the addition of the solution C, 3×10⁻⁴ mols, per mol of silver in the system, of aqueous iron (II) potassium hexacyanide solution was added to the system. Sulfuric acid (0.5 mol/liter) was added to the system to adjust the pH of the system at 3.8. Then, stirring the system was stopped, and steps of precipitating, desalting and washing with water were conducted. Sodium hydroxide (1 mol/liter) was added to the system to adjust the pH of the system at 5.9. A silver halide dispersion having pAg of 8.0 was thus prepared.

While stirring the silver halide dispersion at 38° C., 5 ml of a 0.34 mass % methanol solution of 1,2-benzoisothiazolin-3-one was added thereto. 40 minutes later, the resultant was heated to 47° C. When 20 minutes lapsed from the system temperature reaching 47° C., a methanol solution containing 7.6×10⁻⁵ mols, per mol of silver in the system, of sodium benzenethiosulfonate was added to the system. Five minutes later, a methanol solution containing 2.9×10⁻⁴ mols, per mol of silver of the system, of tellurium sensitizer C was added to the system. Then, the system was ripened for 91 minutes. Thereafter, 1.3 ml of a 0.8 mass % methanol solution of N,N′-dihydroxy-N″-diethylmelamine was added to the system. Four minutes later, a methanol solution including 4.8×10⁻³ mols, per mol of silver, of 5-methyl-2-mercaptobenzimidazole, a methanol solution including 5.4×10⁻³ mols, per mol of silver in the system, of 1-phenyl-2-heptyl-5-mercapto-1,3,4-triazole, and an aqueous solution including 8.5×10⁻³ mols, per mol of silver, of 1-(3-methylureidophenyl)-5-mercaptotetrazole sodium salt were added to the system. Thus, a silver halide emulsion A was prepared.

The grains in the silver halide emulsion thus prepared were silver iodobromide grains and the mean diameter and fluctuation coefficient of spheres having the same volumes as those of the grains were 0.04 μm and 20%, respectively. The iodide content of the grains was 3.5 mol %, and the iodide was uniformly dispersed in the grains. To obtain the grain size, 1000 grains were analyzed with an electronic microscope, and their data were averaged.

Preparation of Silver Halide Emulsion B:

A silver halide emulsion B was prepared in the same manner as the preparation of the emulsion A, except that potassium iodide was not added to the system. The grains in the silver halide emulsion thus prepared were silver bromide grains and the mean diameter and fluctuation coefficient of spheres having the same volumes as those of the grains were 0.04 μm and 15%, respectively.

Preparation of Silver Halide Emulsion 1:

A silver iodobromide emulsion 1 having a silver iodide content of 90 mol % was prepared in the same manner as the preparation of the emulsion A, except that the amounts of potassium iodide and potassium bromide added were varied. The mean diameter and fluctuation coefficient of spheres having the same volumes as those of the grains were 0.04 μm and 15%, respectively.

Preparation of Silver Halide Emulsion 2:

4.3 ml of 1 mass % potassium iodide solution was added to 1420 ml of distilled water, and 3.5 ml of sulfuric acid (0.5 mol/liter) and 36.7 g of phthalated gelatin were added to the resultant mixture. The resulting solution was stirred at 42° C. in a stainless reactor, and 195.6 ml of a solution A containing 22.22 g of silver nitrate diluted with distilled water, and 218 ml of a solution B containing 21.8 g of potassium iodide diluted with distilled water were added to the solution at constant flow rates over 9 minutes. Next, 10 ml of aqueous 3.5 mass % solution of hydrogen peroxide and 10.8 ml of aqueous 10 mass % solution of benzimidazole were added to the resultant solution.

Next, 317.5 ml of a solution C containing 51.86 g of silver nitrate diluted with distilled water, and 600 ml of a solution D containing 60 g of potassium iodide diluted with distilled water were added to the resultant solution by a controlled double jet method. At this time, the solution C was added thereto over 120 minutes at a constant flow. Meanwhile, the solution D was added thereto so that pAg of the system was kept at 8.1. When 10 minutes lapsed from the start of the addition of the solutions C and D to the system, 1×10⁻⁴ mols, per mol of silver in the system, of potassium hexachloroiridate(III) was added to the system. When five seconds lapsed from the end of the addition of the solution C, 3×10⁻⁴ mols, per mol of silver in the system, of aqueous iron (II) potassium hexacyanide solution was added to the system. Sulfuric acid (0.5 mol/liter) was added to the system to adjust the pH of the system at 3.8. Then, stirring the system was stopped, and steps of precipitating, desalting and washing with water were conducted. Sodium hydroxide (1 mol/liter) was added to the system to adjust the pH of the system at 5.9. A silver halide dispersion having pAg of 8.0 was thus prepared.

While stirring the silver halide dispersion at 38° C., 5 ml of a 0.34 mass % methanol solution of 1,2-benzoisothiazolin-3-one was added thereto. The resultant was heated to 47° C. When 20 minutes lapsed from the system temperature reaching 47° C., a methanol solution containing 7.6×10⁻⁵ mols, per mol of silver in the system, of sodium benzenethiosulfonate was added to the system. Five minutes later, a methanol solution containing 2.9×10⁻⁴ mols, per mol of silver of the system, of tellurium sensitizer B was added to the system. Then, the system was ripened for 91 minutes.

1.3 ml of a 0.8 mass % methanol solution of N,N′-dihydroxy-N″-diethylmelamine was added to the system. Four minutes later, a methanol solution including 4.8×10⁻³ mols, per mol of silver, of 5-methyl-2-mercaptobenzimidazole, and a methanol solution including 5.4×10⁻³ mols, per mol of silver in the system, of 1-phenyl-2-heptyl-5-mercapto-1,3,4-triazole were added to the system. Thus, a silver halide emulsion 2 was prepared.

The grains in the silver halide emulsion thus prepared were pure silver iodide grains and the mean diameter and fluctuation coefficient of spheres having the same volumes as those of the grains were 0.04 μm and 18%, respectively. To obtain the grain size, 1000 grains were analyzed with an electronic microscope, and their data were averaged. Based on the formulation for the silver halide emulsion 1, other silver halide emulsions having different grain sizes (their grain sizes are given in Table 6) were prepared in the same manner as the preparation of the emulsion 1. Here, the system temperature that was 42° C. in the preparation of the emulsion 1 was changed to control the mean diameter of spheres having the same volumes as those of the grains.

Preparation of Diluted Emulsions for Coating Liquids:

A 1 mass % aqueous solution containing 7×10⁻³ mols, per mol of silver in the system, of benzothiazolium iodide was added to each of the silver halide emulsions. Water was added to the resultant so that the silver content of silver halides contained in the diluted emulsion was 38.2 g per kg of the emulsion.

2) Fatty Acid Silver Salt Dispersion:

87.6 kg of behenic acid (Henkel's EDENOR C22-85R), 423 liters of distilled water, 49.2 liters of aqueous NaOH solution (5 mol/liter), and 120 liters of t-butyl alcohol were mixed and reacted at 75° C. for 1 hour while stirring this system to prepare a sodium behenate solution A. Apart from this, 206.2 liters of an aqueous solution (pH 4.0) containing 40.4 kg of silver nitrate was prepared, and kept at 10° C. 635 liters of distilled water and 30 liters of t-butyl alcohol were put into a reactor, and kept at 30° C. While sufficient stirring the resultant, the whole amounts of the sodium behenate solution A and the aqueous silver nitrate solution were fed into the reactor at constant flow rates over 93 minutes and 15 seconds, and 90 minutes, respectively. Feeding them into the reactor was so controlled that, for 11 minutes after the start of feeding the aqueous silver nitrate solution, only the aqueous silver nitrate solution was fed into the reactor, that feeding the sodium behenate solution A was started thereafter, and that for 14 minutes and 15 seconds after feeding the aqueous silver nitrate had been finished, only the sodium benenate solution A was fed into the reactor. In this stage, the internal temperature of the reactor was 30° C., and the external temperature of the reactor was so controlled that the temperature of the reaction system in the reactor could be kept constant. The pipe line for the sodium behenate solution A was a double-walled pipe and thermally insulated by circulating hot water through the interspace of the double-walled pipe, and the temperature of the solution at the outlet of the nozzle tip was adjusted at 75° C. The pipe line for the aqueous silver nitrate solution was also a double-walled pipe and thermally insulated by circulating cold water through the interspace of the double-walled pipe. Regarding the position at which the sodium behenate solution A was added to the reaction system and that at which the aqueous silver nitrate solution was added thereto, the two were disposed symmetrically to each other relative to the shaft of the stirrer disposed in the reactor, and the nozzle tips of the pipes were spaced apart from the reaction solution level in the reactor.

After adding the sodium behenate solution A was finished, the reaction system was stirred for 20 minutes at that temperature, and then heated to 35° C. over 30 minutes. Thereafter, the system was ripened for 210 minutes. Immediately after the completion of the ripening, the system was centrifuged to take out a solid component, which was washed with water until the conductivity of the washing waste reached 30 μS/cm. The solid thus obtained was a silver salt of the fatty acid and was stored as wet cake without drying it.

The shapes of the silver behenate grains obtained herein were analyzed on the basis of their images taken through electronmicroscopic photography. Average values of a, b, and c were 0.14 μm, 0.4 μm and 0.6 μm, respectively (a, b and c are defined hereinabove). The mean aspect ratio was 5.2. The mean diameter and fluctuation coefficient of spheres having the same volumes as those of the grains were 0.52 μm and 15%, respectively. The grains were scaly crystals.

19.3 kg of polyvinyl alcohol (trade name, PVA-217) and water were added to the wet cake whose amount corresponded to 260 kg of the dry weight thereof so that the total amount of the resultant became 1000 kg. The resultant was formed into slurry with a dissolver wing, and then pre-dispersed with a pipe-line mixer (Model PM-10 available from Mizuho Industry).

Next, the pre-dispersed stock slurry was processed three times in a disperser (MICROFLUIDIZER M-610 obtained from Microfluidex International Corporation, and equipped with a Z-type interaction chamber) at a controlled pressure of 1260 kg/cm². A silver behenate dispersion was thus prepared. To cool it, corrugated tube type heat exchangers were disposed before and after the interaction chamber. The temperature of the coolant in these heat exchangers was so controlled that the system could be processed at a dispersion temperature of 18° C.

3) Reducing Agent Dispersion:

Preparation of Reducing Agent-1 Dispersion:

10 kg of a reducing agent 1 (2,2′-methylenebis-(4-ethyl-6-tert-butylphenol)), 16 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) including zirconia beads having a mean diameter of 0.5 mm, and dispersed therewith for 3 hours. Then, 0.2 g of benzoisothiazolinone sodium salt and water were added thereto to adjust the reducing agent concentration of the resultant at 25% by mass. The dispersion was heated at 60° C. for 5 hours. A reducing agent-1 dispersion was thus prepared. The reducing agent grains in the dispersion had a median diameter of 0.40 μm, and a maximum grain size of at most 1.4 μm. The reducing agent dispersion was filtered through a polypropylene filter having a pore size of 3.0 μm to remove foreign objects such as dirt from it, and then stored.

Preparation of reducing agent-2 dispersion:

10 kg of a reducing agent 2 (6,6′-di-t-butyl-4,4′-dimethyl-2,2′-butylidenediphenol), 16 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) including zirconia beads having a mean diameter of 0.5 mm, and dispersed therewith for 3 hours and 30 minutes. Then, 0.2 g of benzoisothiazolinone sodium salt and water were added thereto to adjust the reducing agent concentration of the resultant at 25% by mass. The dispersion was then heated at 40° C. for 1 hour, and then at 80° C. for 1 hour. A reducing agent-2 dispersion was thus prepared. The reducing agent grains in the dispersion had a median diameter of 0.50 μm, and a maximum grain size of at most 1.6 μm. The reducing agent dispersion was filtered through a polypropylene filter having a pore size of 3.0 μm to remove foreign objects such as dirt from it, and then stored.

4) Preparation of Hydrogen-Bonding Compound-1 Dispersion:

10 kg of a hydrogen-bonding compound 1 (tri(4-t-butylphenyl)phosphine oxide), 16 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) containing zirconia beads having a mean diameter of 0.5 mm, and dispersed therewith for 4 hours. Then, 0.2 g of benzoisothiazolinone sodium salt and water were added thereto to adjust the hydrogen-bonding compound concentration of the resultant at 25% by mass. The dispersion was heated at 40° C. for 1 hour and then at 80° C. for 1 hour. A hydrogen-bonding compound-1 dispersion was thus prepared. The hydrogen-bonding compound grains in the dispersion had a median diameter of 0.45 μm, and a maximum grain size of at most 1.3 μm. The hydrogen-bonding compound dispersion was filtered through a polypropylene filter having a pore size of 3.0 μm to remove foreign objects such as dirt from it, and then stored.

5) Development Promoter-1 Dispersion:

Preparation of Development Promoter-1 Dispersion:

10 kg of a development promoter 1, 20 kg of aqueous 10 mass % solution of modified polyvinyl alcohol (Kuraray's POVAL MP203) and 10 kg of water were sufficiently mixed to form slurry. Via a diaphragm pump, the slurry was fed into a horizontal sand mill (Imex's UVM-2) containing zirconia beads having a mean diameter of 0.5 mm, and dispersed therewith for 3 hours and 30 minutes. Then, 0.2 g of benzoisothiazolinone sodium salt and water were added thereto to prepare a development promoter-1 dispersion having a development promoter concentration of 20% by mass. The development promoter grains in the dispersion had a median diameter of 0.48 μm, and a maximum grain size of at most 1.4 μm. The development promoter dispersion was filtered through a polypropylene filter having a pore size of 3.0 μm to remove foreign objects such as dirt from it, and then stored.

Preparation of Development Promoter-2 and Color Toning Agent-1 Solid dispersions:

Development promoter-2 and color toning agent-1 solid dispersions having the respective concentrations of 20% by mass and 15% by mass were prepared in the same manner as the preparation of the development promoter-1 dispersion.

6) Polyhalogen Compound:

Preparation of Organic Polyhalogen Compound-1 Dispersion:

10 kg of an organic polyhalogen compound-i (tribromomethanesulfonylbenzene), 10 kg of aqueous 20 mass % solution of modified polyvinyl alcohol (Kuraray's POVAL MP203) 0.4 kg of aqueous 20 mass % solution of sodium triisopropylnaphthalenesulfonate, and 14 kg of water were sufficiently mixed to prepare slurry. Via a diaphragm pump, the slurry was fed into a horizontal sand mill (Imex's UVM-2) including zirconia beads having a mean diameter of 0.5 mm, and dispersed therewith for 5 hours. Then, 0.2 g of benzoisothiazolinone sodium salt and water were added thereto to prepare an organic polyhalogen compound-1 dispersion having an ogranic polyhalogen content of 30 mass %. The organic polyhalogen compound grains in the dispersion had a median diameter of 0.41 μm, and a maximum grain size of at most 2.0 μm. The organic polyhalogen compound dispersion was filtered through a polypropylene filter having a pore size of 10.0 μm to remove foreign objects such as dirt from it, and then stored.

Preparation of Organic Polyhalogen Compound-2 Dispersion:

10 kg of an organic polyhalogen compound-2 (N-butyl-3-tribromomethanesulfonylbenzamide), 20 kg of aqueous 10 mass % solution of modified polyvinyl alcohol (Kuraray's POVAL MP203), and 0.4 kg of aqueous 20 mass % solution of sodium triisopropylnaphthalenesulfonate were sufficiently mixed to prepare slurry. Via a diaphragm pump, the slurry was fed into a horizontal sand mill (Imex's UVM-2) including zirconia beads having a mean diameter of 0.5 mm, and dispersed therewith for 5 hours. Then, 0.2 g of benzoisothiazolinone sodium salt and water were added thereto to adjust the organic polyhalogen content of the resultant at 30 mass %. The dispersion was heated at 40° C. for 5 hours. An organic polyhalogen compound-2 dispersion was thus obtained. The organic polyhalogen compound grains in the dispersion had a median diameter of 0.40 μm, and a maximum grain size of at most 1.3 μm. The organic polyhalogen compound dispersion was filtered through a polypropylene filter having a pore size of 3.0 μm to remove foreign objects such as dirt from it, and then stored.

7) Dispersion of Silver Iodide Complex-Forming Agent in the Invention:

One kg of a silver iodide complex-forming agent in the invention (types used thereof are described in Table 6), 2 kg of aqueous 10 mass % solution of modified polyvinyl alcohol (Kuraray's POVAL MP203), and 0.04 kg of aqueous 20 mass % solution of sodium triisopropylnaphthalenesulfonate were sufficiently mixed to prepare slurry. Via a diaphragm pump, the slurry was fed into a horizontal sand mill (Imex's UVM-2) including zirconia beads having a mean diameter of 0.5 mm, and dispersed therewith while the dispersion time was so controlled that the dispersed grains could have a median diameter mentioned below. Then, 0.02 g of benzoisothiazolinone sodium salt and water were added thereto to adjust the content of compound of fomula (14) or (3) in the resultant at 20 mass %. The dispersion was heated at 40° C. for 5 hours. A dispersion of the compound of formula (14) or (3) was thus prepared. The compound grains in the dispersion had a median diameter of 0.40 μm, and a maximum grain size of at most 1.3 μm. The dispersion was filtered through a polypropylene filter having a pore size of 3.0 μm to remove foreign objects such as dirt from it, and then stored.

8) Preparation of Dispersion of Compound of Formula (14) in the Invention, and Comparative Compound Solution:

Preparation of Dispersion of Compound of Formula (14) of the Invention:

A dispersion of compound of formula (14) of the invention (types thereof used are shown in Table 6) was prepared as follows:

One kg of a compound of formula (14) in the invention, 2 kg of aqueous 10 mass % solution of modified polyvinyl alcohol (Kuraray's POVAL MP203), and 0.04 kg of aqueous 20 mass % solution of sodium triisopropylnaphthalenesulfonate were sufficiently mixed to prepare slurry. Via a diaphragm pump, the slurry was fed into a horizontal sand mill (Imex's UVM-2) including zirconia beads having a mean diameter of 0.5 mm, and dispersed therewith for 45 minutes. Then, 0.02 g of benzoisothiazolinone sodium salt and water were added thereto to adjust the content of compound of fomula (14) in the resultant at 20 mass %. The dispersion was heated at 40° C. for 5 hours. A dispersion of the compound of formula (14) was thus prepared. The dispersion was filtered through a polypropylene filter having a pore size of 3.0 μm to remove foreign objects such as dirt from it, and then stored.

Preparation of Comparative Compound Dispersion 1:

A dispersion of phthalazone serving as a comparative compound was prepared in the same manner as that of compound of formula (14).

Phthalazone:

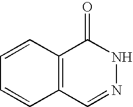

Preparation of Comparative Compound Solution 2:

A solution of a comparative compound, phthalazine, was prepared as follows.

Phthalazine:

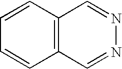

8 kg of modified polyvinyl alcohol, Kuraray's MP203, was dissolved in 174.57 kg of water, and then 3.15 kg of aqueous 20 mass % solution of sodium triisopropylnaphthalenesulfonate and 6 kg of the phthalazine compound were added to the resultant solution to prepare a 5 mass % solution of the phthalazine compound.

9) Preparation of Mercapto Compound:

Preparation of Aqueous Mercapto Compound-1 Solution:

7 g of a mercapto compound-1 (1-(3-sulfophenyl)-5-mercaptotetrazole sodium salt) was dissolved in 993 g of water to prepare an aqueous 0.7 mass % solution of the mercapto compound.

Preparation of Aqueous Mercapto Compound-2 Solution:

20 g of a mercapto compound-2 (1-(3-methylureidophenyl)-5-mercaptotetrazole) was dissolved in 980 g of water to prepare an aqueous 2.0 mass % solution of the mercapto compound.

10) Preparation of Pigment-1 Dispersion:

64 g of C.I. Pigment Blue 60, 6.4 g of Kao's DEMOLE N and 250 g of water were sufficiently mixed to prepare slurry. 800 g of zirconia beads having a mean diameter of 0.5 mm were prepared and put into a vessel along with the slurry. The slurry in the vessel was dispersed by the use of a disperser (Imex's 1/4G Sand Grinder Mill) for 25 hours, and water was added to the slurry to prepare a pigment-1 dispersion having a pigment concentration of 5% by mass. The pigment grains in the dispersion thus prepared had a mean grain size of 0.21 μm.

11) Preparation of Dispersion of Adsorptive Redox Compound and Dispersion of Compound Capable of Releasing Electron Through Oxidation:

Methanol solutions of additive S-1 and additive S-2 were separately prepared.

12) Preparation of SBR Latex:

SBR latex was prepared as follows:

287 g of distilled water, 7.73 g of surfactant (Takemoto Yushi's PIONIN A-43-S, having a solid content of 48.5%), 14.06 ml of NaOH (1 mol/liter), 0.15 g of tetrasodium ethylenediaminetetraacetate, 255 g of styrene, 11.25 g of acrylic acid, and 3.0 g of tert-dodecylmercaptan were put into the polymerization reactor of a gas monomer reaction apparatus (Pressure Glass Industry's TAS-2J Model). The reactor was sealed, and the content therein was stirred at 200 rpm. The internal air was exhausted via a vacuum pump, and purged a few times repeatedly with nitrogen. Then, 108.75 g of 1,3-butadiene was introduced into the reactor under pressure, and the internal temperature of the reactor was heated to 60° C. A solution in which 1.875 g of ammonium persulfate was dissolved in 50 ml of water was added to the system, and the system was stirred for 5 hour. It was further heated to 90° C. and stirred for 3 hours. After the reaction was completed, the internal temperature was cooled to room temperature. Then, NaOH and NH₄OH (both 1 mol/liter) were added to the system at a molar ratio of Na and NH₄ of 1/5.3 so as to adjust the pH of the system at 8.4. Next, the system was filtered through a polypropylene filter having a pore size of 1.0 μm to remove foreign objects such as dirt from it, and then stored. 774.7 g of SBR latex was thus obtained. Its halide ion content was measured through ion chromatography, and the chloride ion concentration of the latex was 3 ppm. The chelating agent concentration thereof was measured through high-performance liquid chromatography, and was 145 ppm.

The mean grain size of the latex was 90 nm, Tg thereof was 17° C., the solid content thereof was 44% by mass, the equilibrium moisture content thereof at 25° C. and 60% RH was 0.6% by mass, and the ion conductivity thereof was 4.80 mS/cm. To measure the ion conductivity, a To a Denpa Kogyo's conductometer CM-30S was used. In the device, the 44 mass % latex was measured at 25° C. Its pH was 8.4.

2. Preparation of Coating Liquids:

Preparation of Coating Liquids 1 to 16 for Image-Forming Layer:

The pigment-1 dispersion, the organic polyhalogen compound-1 dispersion, the organic polyhalogen compound-2 dispersion, the dispersion of compound of formula (14) of the invention or the comparative compound solution (shown in Table 6), the silver iodide complex-forming agent in the invention, the SBR latex (Tg: 17° C.), the reducing agent-1 dispersion, the hydrogen-bonding compound-1 dispersion, the development promoter-1 dispersion, the development promoter-2 dispersion, the color toning agent-1 dispersion, the aqueous mercapto compound-1 solution, the aqueous mercapto compound-2 solution, the additive S-1 dispersion and the additive S-2 dispersion were successively added to 1000 g of the fatty acid silver salt dispersion A and 276 ml of water in accordance with formulations of Table 6. Just before applition, the resulting mixture was sufficiently mixed with a diluted emulsion to prepare coating liquids 1 to 16 for an image-forming layer.

Compounds I-27 and I-40 of formula (14) of the invention had an overall Hammett's substituent constant σₚ of −0.27 and −0.54, respectively.

The zirconium content of the coating liquid was 0.34 mg per gram of Ag.

Preparation of Coating Liquid for Intermediate Layer:

27 ml of aqueous 5 mass % solution of AEROSOL OT (from American Cyanamid), 135 ml of aqueous 20 mass % solution of diammonium phthalate and water were added to 1000 g of a polyvinyl alcohol, Kuraray's PVA-205, 272 g of the pigment-1 dispersion, and 4200 ml of 19 mass % latex of methyl methacrylate/styrene/butyl acrylate/hydroxyethyl methacrylate/acrylic acid copolymer (copolymerization ratio: 64/9/20/5/2 by weight) so that the total amount of the resultant mixture became 10000 g. The pH of the mixture was adjusted at 7.5 with the addition of NaOH. A coating liquid for an intermediate layer was thus obtained. This was fed into a coating die, with its flow rate so controlled that its coating amount could be 9.1 ml/m².

The viscosity of the coating liquid used in heat-developable light-sensitive material 1, measured with a B-type viscometer (with No. 1 rotor at 60 rpm), was 58 [mPa·s] at 40° C.

Preparation of Coating Liquid for First Surface-Protective Layer:

64 g of inert gelatin was dissolved in water, and 112 g of 19.0 mass % latex of methyl methacrylate/styrene/butyl acrylate/hydroxyethyl methacrylate/acrylic acid copolymer (copolymerization ratio: 64/9/20/5/2 by weight), 30 ml of 15 mass % methanol solution of phthalic acid, 23 ml of aqueous 10 mass % solution of 4-methylphthalic acid, 28 ml of sulfuric acid (0.5 mol/liter), 5 ml of aqueous 5 mass % solution of AEROSOL OT (from American Cyanamid), 0.5 g of phenoxyethanol, 0.1 g of benzoisothiazolinone, and water were added to the resultant solution so that the total amount of the resultant mixture became 750 g. Just before application thereof, 26 ml of 4 mass % chromium alum was added to the mixture, and the resultant was stirred with a static mixer. The resultant coating liquid was fed into a coating die so that the amount of the resultant coating was 18.6 ml/m².

The viscosity of the coating liquid, measured with a B-type viscometer (with No. 1 rotor at 60 rpm), was 20 [mPa·s] at 40° C.

Preparation of Coating Liquid for Second Surface-Protective Layer:

80 g of inert gelatin was dissolved in water, and 102 g of 27.5 mass % latex of methyl methacrylate/styrene/butyl acrylate/hydroxyethyl methacrylate/acrylic acid copolymer (copolymerization ratio: 64/9/20/5/2 by weight), 5.4 ml of 2 mass % solution of a fluorine-containing surfactant (F-1), 5.4 ml of aqueous 2 mass % solution of a fluorine-containing surfactant (F-2), 23 ml of 5 mass % solution of AEROSOL OT (from American Cyanamid), 4 g of fine polymethyl methacrylate grains (mean grain size: 0.7 μm), 21 g of fine polymethyl methacrylate grains (mean grain size: 4.5 μm), 1.6 g of 4-methylphthalic acid, 4.8 g of phthalic acid, 44 ml of sulfuric acid (0.5 mol/liter), 10 mg of benzoisothiazolinone, and water were added to the resultant solution so that the total amount of the resultant mixture became 650 g. Just before application thereof, 445 ml of aqueous solution containing 4 mass % of chromium alum and 0.67 mass % of phthalic acid was added to the mixture, and the resultant was stirred with a static mixer. A coating liquid for surface-protective layer was thus obtained. The coating liquid was fed into a coating die, with its flow rate so controlled that its coating amount could be 8.3 ml/m².

The viscosity of the coating liquid, measured with a B-type viscometer (with No. 1 rotor at 60 rpm), was 19 [mPa·s] at 40° C.

3. Preparation of Heat-Developable Light-Sensitive Materials 1 to 16:

The coating liquid for an image-forming layer, that for an intermediate layer, that for a first surface-protective layer and that for a second surface-protective layer were simultaneously applied onto the undercoated surface opposite to the back of the support in that order according to a slide bead coating method to preapare heat-developable light-sensitive materials. At this time, the temperatures of the coating liquid for an image-forming layer and the coating liquid for an intermediate layer were adjusted at 31° C., that of the coating liquid for a first surface-protective layer was adjusted at 36° C. and that of the coating liquid for a second surface-protective layer was adjusted at 37° C.

The coating amounts (g/m²) of the constitutive components of the image-forming layer are mentioned below.

| | |
|---|---|
| Silver behenate | 5.27 |
| Pigment (C.I. Pigment Blue 60) | 0.036 |
| Polyhalogen compound 1 | 0.09 |
| Polyhalogen compound 2 | 0.14 |
| Compound of formula (14) in the invention or Comparative | 0.18 |
| Compound (shown in Table 6) | |
| Silver Iodide Complex-Forming Agent in the invention (shown | 0.15 |
| in Table 6) | |
| SBR latex | 9.43 |
| Reducing agent 1 | 0.55 |
| Reducing agent 2 | 0.22 |
| Hydrogen-bonding compound 1 | 0.28 |
| Development promoter 1 | 0.025 |
| Development promoter 2 | 0.020 |
| Color toning agent 1 | 0.008 |
| Additive S-1 | 0.001 |
| Additive S-2 | 0.002 |
| Silver of silver halide (its grain size is shown in Table 6) | 0.046 |

The coating and drying conditions are mentioned below.

Before coating, the static electricity of the support was eliminated by blowing an ion blow to the support. The coating speed was 170 m/min. The coating and drying conditions for each sample were controlled within the range mentioned below so that the coated surface could be stabilized to the best.

The distance between the coating die tip and the support fell between 0.10 and 0.30 mm. The pressure in the decompression chamber was lower by 196 to 882 Pa than the atmospheric pressure. In the subsequent chilling zone, the coated support was chilled with an air blow (its dry-bulb temperature fell between 10 and 20° C.). In the next helix type contactless drying zone, the support was dried with a dry air blow (its dry-bulb temperature fell between 23 and 45° C., and its wet-bulb temperature fell between 15 and 21° C.). In this zone, the coated support to be dried was kept not in contact with the drier. After the drying, the support was conditioned at 25° C. and 40 to 60% RH, and then heated so that the surface temperature was between 70 and 90° C. After thr heating, the support was cooled to have a surface temperature of 25° C.

The degree of matting, in terms of the Beck's smoothness, of the heat-developable light-sensitive material 1 thus prepared was 550 seconds on the photosensitive layer-coated surface thereof and 130 seconds on the back surface thereof. The pH of the photosensitive layer-coated surface of the sample was measured and was 6.0.

Chemical structures of the compounds used in this Example are shown below.

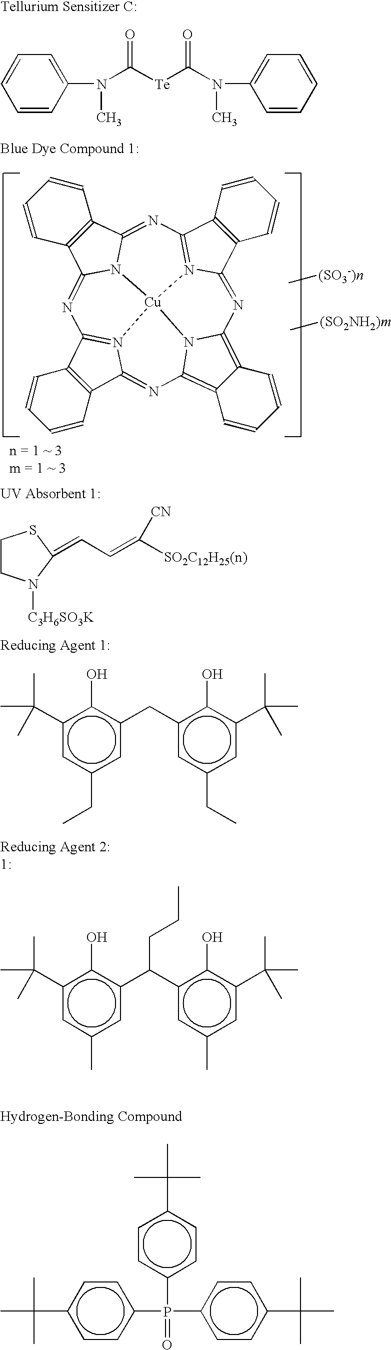

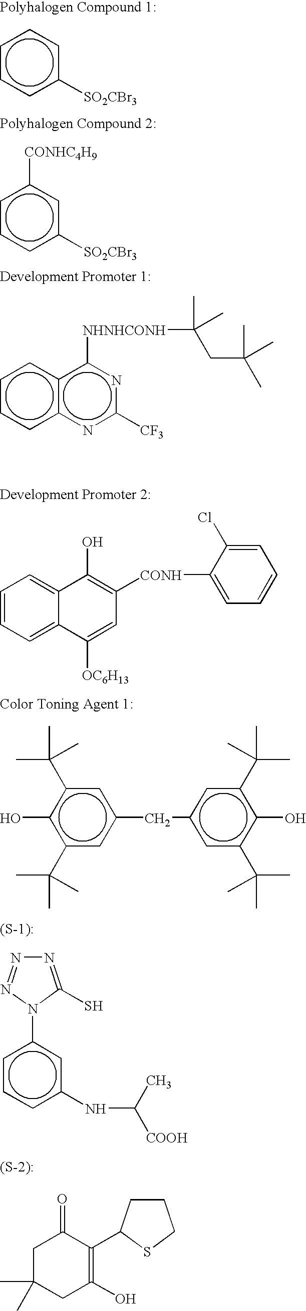

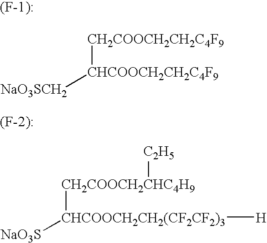

4. Evaluation of Photographic Properties:

Sensitivity Change During Unprocessed Stock

Each sample thus prepared was cut into pieces of a half-size, packaged with a packaging material mentioned below at 25° C. and 50% RH, then stored for 30 days at 40° C., and tested according to the test methods mentioned below.

Packaging Material:

The packaging material used herein was a film comprising a PET film having a thickness of 10 μm, a PE film having a thickness of 12 μm, an aluminium foil having a thickness of 9 μm, a nylone film having a thickness of 15 μm, and a 3% carbon-containing polyethylene having a thickness of 50 μm, and having an oxygen transmittance of 0.02 ml/atm·m²25° C.·day and a moisture transmittance of 0.10 g/atm·m²25° C.·day.

Photographic Properties:

A laser source, Nichia Chemical Industry's semiconductor laser NLHV3000E was set in the exposure zone of Fuji Medical Dry Laser Imager FM-DPL, and its beam diameter was narrowed down to 100 μm. With the intensity of laser light on the surface of the heat-developable light-sensitive material sample controlled to be 0 or within a range of from 1 mW/mm² to 1000 mW/mm², the sample was exposed to the laser light for 106 seconds. The laser light oscillation wavelength was 405 nm. For the heat development, the temperatures of four panel heaters were set at 112° C., 118° C., 121° C. and 121° C., respectively and the development time was set at 10 seconds by accelerating the conveying speed. The density of the image formed was measured with a densitometer.

The exposure amount at which a density of 1.2 could be obtained on a sample that had been exposed to light and thermally developed without being stored at 40° C. is referred to as A. The density of a sample that had been stored at 40° C. for 30 days, exposed to light at the exposure amount A and thermally developed was measured. The density change of the latter sample with respect to the former sample density of 1.2 is referred to as ΔD1.2. Smaller value ΔD1.2 indicates smaller sensitivity change during unprocessed stock which is preferable.

Difference Between Light Absorption Intensity Before Heat Development and that After Heat Development:

Using Fuji Medical Dry Laser Imager FM-DPL with four panel heaters thereof set at 112° C., 118° C., 121° C., and 121° C., respectively, unexposed samples were thermally developed for an overall development time of 14 seconds.

Using a spectral photometer U-4100 (manufactured by Hitachi) equipped with an integrating sphere, the spectral absorbance of each sample was measured. The samples with a silver iodide-rich emulsion had an absorption maximum at 415 nm as shown in FIG. 1. The change rate of the absorbance at 415 nm of each sample before heat development and that after heat development was measured. Apart from the above samples, silver halide-free sample was prepared, and the absorbance thereof at 415 nm was used as a base standard. The absorbance reduction rate of each sample was computed according to the formula mentioned below. The results obtained are given in Table 6.

Absorbance reduction rate (%)=A/B×100

A=(absorbance of a sample after heat development)−(absorbance of a silver halide-free sample after heat development)

B=(absorbance of the sample before heat development)−(absorbance of a silver halide-free sample before heat development)

TABLE 6

| | Silver Halide | | Compound | Silver Iodide | | Sensitivity | | |
|---|---|---|---|---|---|---|---|---|
| | | Silver | of formula | Complex- | | Change | | |
| | | Iodide | (14) or | Forming | | during | | |
| | Emulsion | Content | Comparative | Agent | | Unprocessed | Absorbance | |
| Sample No. | No. | (mol %) | Compound | No. | pKa | Stock | Change (%) | Remarks |
| 1 | A | 3.5 | I-27 | — | — | 0.03 | 100 | comparative sample |
| 2 | B | 0 | I-27 | — | — | 0.03 | 100 | comparative sample |
| 3 | B | 0 | phthalazone | — | — | 0.05 | 100 | comparative sample |
| 4 | B | 0 | phthalazine | — | — | 0.04 | 100 | comparative sample |
| 5 | 1 | 90 | phthalazone | — | — | 0.45 | 40 | comparative sample |
| 6 | 1 | 90 | phthalazine | — | — | 0.31 | 18 | comparative sample |
| 7 | 1 | 90 | I-27 | — | — | 0.03 | 38 | sample of the |
| | | | | | | | | invention |
| 8 | 1 | 90 | I-40 | — | — | 0.02 | 37 | sample of the |
| | | | | | | | | invention |
| 9 | 1 | 90 | I-27 | F-325 | 4.2 | 0.03 | 3 | sample of the |
| | | | | | | | | invention |
| 10 | 1 | 90 | I-40 | F-325 | 4.2 | 0.03 | 4 | sample of the |
| | | | | | | | | invention |
| 11 | 2 | 100 | phthalazone | — | — | 0.38 | 37 | comparative sample |
| 12 | 2 | 100 | phthalazine | — | — | 0.33 | 15 | comparative sample |
| 13 | 2 | 100 | I-27 | — | — | 0.03 | 35 | sample of the |
| | | | | | | | | invention |
| 14 | 2 | 100 | I-40 | — | — | 0.02 | 34 | sample of the |
| | | | | | | | | invention |
| 15 | 2 | 100 | I-27 | F-325 | 4.2 | 0.03 | 2 | sample of the |
| | | | | | | | | invention |
| 16 | 2 | 100 | I-40 | F-325 | 4.2 | 0.02 | 1 | sample of the |
| | | | | | | | | invention |

Table 6 shows the following:

1) Effect of Compound of Formula (14) of the Invention for Silver Iodide Emulsion:

Samples 1 to 4 are heat-developable light-sensitive materials in which the silver iodide content of the silver halide is outside the scope of the invention. Samples 5 to 16 are heat-developable light-sensitive materials in which the silver iodide content of the silver halide is within the scope of the invention. When comparative samples 3 and 4 containing phthalazone or phthalazine that is generally used as a color toning agent in heat-developable light-sensitive materials and having a low silver iodide content are compared with comparative samples 5, 6, 11 and 12 containing phthalazone or phthalazine having a high silver iodide content, it is understood that the sensitivity change during unprocessed stock of the samples with a silver iodide-rich emulsion is large.

As opposed to these, the sensitivity change during unprocessed stock of samples 7, 8, 13 and 14 that contain a compound of formula (14) in the invention and whose silver-iodide content is high are smaller than those of comparative samples 5, 6, 11 and 12.

2) Effect of Silver Iodide Complex-Forming Agent in Silver Iodide Emulsion:

When compound F-325 is used as the silver iodide complex-forming agent in the invention, the absorption intensity of the heat-developable light-sensitive material lowers after heat development and the material provides a clear image of little turbidity. The advantage results from the specific effect of the combination of the silver iodide-rich emulsion and the silver iodide complex-forming agent in the material.

From Table 6, the sensitivity change during unprocessed stock of the heat-developable light-sensitive material that comprises a combination of the compound of formula (14) and the silver iodide complex-forming agent in the invention is small.

Evaluation of Image Storability:

The thermally developed samples were left under a fluorescent lamp (intensity of illumination: 6000 luxes) in a room (30° C., 70% RH) for 3 days, and the fog density change thereof was measured. The smaller fog density increase, the better the image storability.

Measurement of Acid Dissociation Constant, pKa:

Using an automatic potentiometric titration meter, Kyoto Electronic Industry's AT-420, the acid dissociation constant (pKa) of the conjugate acid of the silver iodide complex-forming agent in a mixed solution of tetrahydrofuran and water (3/2) was measured at 25° C.

TABLE 7

| | | | Image | |
|---|---|---|---|---|
| | Photographic Properties | | Storability | |
| Sample No. | Dmin | Dmax | Δfog | Remarks |
| 1 | 0.15 | 3.8 | 0.13 | comparative |
| | | | | sample |
| 2 | 0.15 | 3.8 | 0.13 | comparative |
| | | | | sample |
| 3 | 0.15 | 3.8 | 0.14 | comparative |
| | | | | sample |
| 4 | 0.15 | 3.8 | 0.09 | comparative |
| | | | | sample |
| 5 | 0.15 | 3.8 | 0.04 | comparative |
| | | | | sample |
| 6 | 0.15 | 3.8 | 0.03 | comparative |
| | | | | sample |
| 7 | 0.15 | 3.8 | 0.02 | sample of the |
| | | | | invention |
| 8 | 0.15 | 3.8 | 0.02 | sample of the |
| | | | | invention |
| 9 | 0.15 | 3.8 | 0 | sample of the |
| | | | | invention |
| 10 | 0.15 | 3.8 | 0 | sample of the |
| | | | | invention |
| 11 | 0.15 | 3.8 | 0.04 | comparative |
| | | | | sample |
| 12 | 0.15 | 3.8 | 0.03 | comparative |
| | | | | sample |
| 13 | 0.15 | 3.8 | 0.02 | sample of the |
| | | | | invention |
| 14 | 0.15 | 3.8 | 0.02 | sample of the |
| | | | | invention |
| 15 | 0.15 | 3.8 | 0 | sample of the |
| | | | | invention |
| 16 | 0.15 | 3.8 | 0 | sample of the |
| | | | | invention |

From the data in Table 7, it is understood that the samples of the invention give high-quality images having high image density and low fog, and their image storability is good. In addition, from the data of absorption intensity change Thereof, it is also understood that the samples of the invention Give clear and good images with reduced turbidity after heat development.

### Example 6

Samples 101 to 115 were prepared in the same manner as the preparation of sample 16 in Example 5 except that the compound of formula (14) in the invention and the silver iodide complex-forming agent were changed in accordance with Table 8. These were evaluated in the same manner as in Example 5.

From the data in Table 8, it is understood that the samples of the invention give high-quality images having high image density and low fog, and their image storability is good. In addition, from the data of absorption intensity change thereof, it is also understood that the samples of the invention give clear and good images with reduced turbidity after heat development.

TABLE 8

| | | | | | | Change Rate | | |
|---|---|---|---|---|---|---|---|---|
| | | | | | | of | | |
| | | | | | | Absorption | | |
| | | | | | | before heat | | |
| | | Silver Iodide | | | | development | | |
| | | Complex-Forming | | | | and that | | |
| | Compound of formula | Agent | | Photographic | | after heat | Image | |
| | (14) or Comparative | Compound | | Properties | | development | Storability | |
| No. | Compound | No. | pKa | Dmin | Dmax | (%) | (Δfog) | Remarks |
| 101 | phthalazone | — | | 0.15 | 3.8 | 37 | 0.04 | comparative |
| | | | | | | | | sample |
| 102 | I-27 | F-325 | 4.2 | 0.15 | 3.8 | 2 | 0.00 | sample of the |
| | | | | | | | | invention |
| 103 | I-40 | F-325 | 4.2 | 0.15 | 3.8 | 1 | 0.00 | sample of the |
| | | | | | | | | invention |
| 104 | I-35 | F-325 | 4.2 | 0.15 | 3.8 | 1 | 0.00 | sample of the |
| | | | | | | | | invention |
| 105 | I-13 | F-325 | 4.2 | 0.15 | 3.8 | 2 | 0.00 | sample of the |
| | | | | | | | | invention |
| 106 | I-27 | F-421 | 4.2 | 0.15 | 3.8 | 1 | 0.00 | sample of the |
| | | | | | | | | invention |
| 107 | I-27 | F-405 | 3.6 | 0.15 | 3.8 | 1 | 0.00 | sample of the |
| | | | | | | | | invention |
| 108 | I-27 | F-404 | 5.4 | 0.15 | 3.8 | 2 | 0.00 | sample of the |
| | | | | | | | | invention |
| 109 | I-27 | F-515 | | 0.15 | 3.8 | 1 | 0.00 | sample of the |
| | | | | | | | | invention |
| 110 | I-27 | F-814 | | 0.15 | 3.8 | 2 | 0.00 | sample of the |
| | | | | | | | | invention |
| 111 | I-27 | F-909 | | 0.15 | 3.8 | 1 | 0.00 | sample of the |
| | | | | | | | | invention |
| 112 | I-27 | F-418 | | 0.15 | 3.8 | 2 | 0.00 | sample of the |
| | | | | | | | | invention |
| 113 | I-27 | F-706 | | 0.15 | 3.8 | 1 | 0.00 | sample of the |
| | | | | | | | | invention |
| 114 | I-27 | F-805 | | 0.15 | 3.8 | 1 | 0.00 | sample of the |
| | | | | | | | | invention |
| 115 | I-27 | F-916 | | 0.15 | 3.8 | 1 | 0.00 | sample of the |
| | | | | | | | | invention |

What is claimed is:

1. A heat-developable light-sensitive material comprising, on a face of a support thereof, a photosensitive silver halide, a non-photosensitive organic silver salt, a reducing agent and a binder, wherein (a) the silver iodide content of the photosensitive silver halide is from 5 mol % to 100 mol %, (b) the photosensitive silver halide is photosensitive silver halide grains having a mean diameter of 0.001 μm to 0.08 μm, and (c) the material contains a silver iodide complex-forming agent capable of substantially lowering through heat development a spectral absorption intensity derived from the photosensitive silver halide in visible and ultraviolet ranges.

2. The heat-developable light-sensitive material as claimed in claim 1, wherein the silver iodide content of the photosensitive silver halide is from 40% to 100%.

3. The heat-developable light-sensitive material as claimed in claim 1, wherein the silver iodide complex-forming agent is a compound of at least one of the following two formulae (1) and (2): 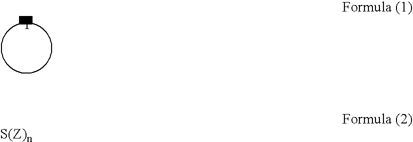
in formula (1), Y represents a non-metallic atomic group necessary for forming a 5- to 7-membered heterocyclic ring that contains at least one of a nitrogen and sulfur atom, the heterocyclic ring which Y forms may be saturated or unsaturated, and may be substituted, and substituents for the heterocyclic ring which Y forms may bond to each other to form a ring; and
in formula (2), Z represents a hydrogen atom or a substituent; n indicates an integer of 1 or 2, and when n is 1, S bonds to Z via a double bond, when n is 2, S bonds to the two Zs each via a single bond, when n is 1, Z cannot represent a hydrogen atom, when n is 2, the two Zs may be either the same or different, but the two Zs must not both represent hydrogen atoms.

4. The heat-developable light-sensitive material as claimed in claim 3, wherein the compound of formula (1) is a pyridine derivative of the following formula (3): 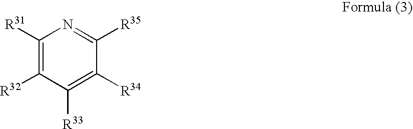
wherein R³¹ to R³⁵ each independently represent a hydrogen atom or a substituent, and R³¹ to R³⁵ may bond to each other to form a saturated or unsaturated ring.

5. The heat-developable light-sensitive material as claimed in claim 3, wherein the compound of formula (1) is a pyridazine derivative of the following formula (4): 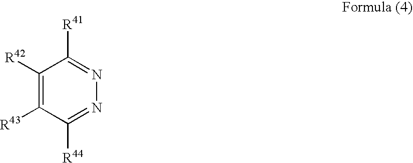
wherein R⁴¹ to R⁴⁴ each independently represent a hydrogen atom or a substituent; and R⁴¹ to R⁴⁴ may bond to each other to form a saturated or unsaturated ring.

6. The heat-developable light-sensitive material as claimed in claim 3, wherein the compound of formula (1) is a 5- to 7-membered heterocyclic ring that has at least one mercapto substituent and contains at least one of a nitrogen and sulfur atom.

7. The heat-developable light-sensitive material as claimed in claim 3, wherein the compound of formula (1) is a compound of any one of the following formulae (5) to (7): 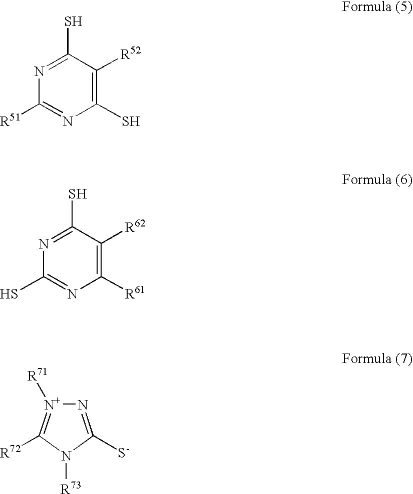
wherein R⁵¹ and R⁵², R⁶¹ and R⁶² and R⁷¹ to R⁷³ each independently represent a hydrogen atom or a substituent.

8. The heat-developable light-sensitive material as claimed in claim 3, wherein the compound of formula (2) is a compound of at least one of the following two formulae (8) and (9): 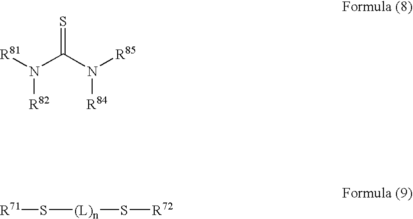
wherein R⁸¹ to R⁸⁵ and R⁷¹ and R⁷² each independently represent a hydrogen atom or a substituent; L represents a divalent linking group; and m is 0 or 1.

9. The heat-developable light-sensitive material as claimed in claim 3, wherein the compound of formula (1) is a nitrogen-containing heterocyclic compound, and the acid dissociation constant (pKa) of a conjugate acid thereof in a mixed solution of tetrahydrofuran/water (3/2) at 25° C. is from 3 to 8.

10. The heat-developable light-sensitive material as claimed in claim 4, wherein the compound of formula (1) is a pyridine derivative of formula (3), and the acid dissociation constant (pKa) of a conjugate acid thereof in a mixed solution of tetrahydrofuran/water (3/2) at 25° C. is from 3 to 8.

11. The heat-developable light-sensitive material as claimed in claim 1, for which laser light is used as a source of exposure light.

12. The heat-developable light-sensitive material as claimed in claim 11, for which the emission peak wavelength of the laser light is from 390 to 430 nm.

13. The heat-developable light-sensitive material as claimed in claim 1, wherein the reducing agent is at least one of bisphenols.

14. The heat-developable light-sensitive material as claimed in claim 1, further comprising an organic polyhalogen compound serving as an antifoggant.

15. A heat-developable light-sensitive material comprising, on a face of a support thereof, a photosensitive silver halide, a non-photosensitive organic silver salt, a reducing agent and a binder, wherein (a) the silver iodide content of the photosensitive silver halide is from 5 mol % to 100 mol %, (b) the material contains a compound capable of substantially lowering through heat development a spectral absorption intensity derived from the photosensitive silver halide in visible and ultraviolet ranges, and (c) the material is exposed to light shorter than 700 nm.

16. The heat-developable light-sensitive material as claimed in claim 15, wherein the compound capable of substantially lowering through heat development a spectral absorption intensity derived from the photosensitive silver halide in visible and ultraviolet ranges is a silver iodide complex-forming agent.

17. The heat-developable light-sensitive material as claimed in claim 15, wherein the silver iodide content of the photosensitive silver halide is from 40 mol % to 100 mol %.

18. The heat-developable light-sensitive material as claimed in claim 16, wherein the silver iodide complex-forming agent is a 5- to 7-membered heterocyclic compound that contains at least one nitrogen atom.

19. The heat-developable light-sensitive material as claimed in claim 18, wherein the heterocyclic compound is a pyridine, imidazole, pyrazole, pyrazine, pyrimidine, pyridazine, phthalazine, triazine, triazole, naphthyridine or phenanthroline derivative.

20. The heat-developable light-sensitive material as claimed in claim 16, wherein the silver iodide complex-forming agent is a compound of at least one of the following formulae (10) and (11): 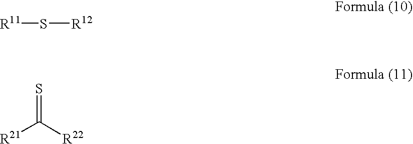
wherein R¹¹ and R¹² each represent a hydrogen atom or a substituent; R²¹ and R²² each represent a hydrogen atom or a substituent; but R¹¹ and R¹² are both not hydrogen atoms, and R²¹ and R²² are both not hydrogen atoms.

21. The heat-developable light-sensitive material as claimed in claim 18, wherein the heterocyclic compound is a pyridine derivative of the following formula (3): 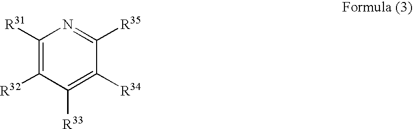
wherein R³¹ to R³⁵ each independently represent a hydrogen atom or a substituent, and R³¹ to R³⁵ may bond to each other to form a saturated or unsaturated ring.

22. The heat-developable light-sensitive material as claimed in claim 18, wherein the heterocyclic compound is a pyridazine derivative of the following formula (4): 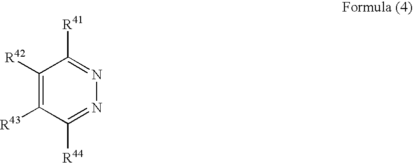
wherein R⁴¹ to R⁴⁴ each independently represent a hydrogen atom or a substituent, and R⁴¹ to R⁴⁴ may bond to each other to form a saturated or unsaturated ring.

23. The heat-developable light-sensitive material as claimed in claim 18, wherein the heterocyclic compound is a phthalazine derivative of the following formula (12): 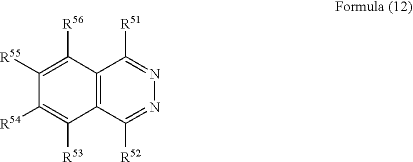
wherein R⁵¹ to R⁵⁶ each independently represent a hydrogen atom or a substituent, and R⁵¹ to R⁵⁶ may bond to each other to form a saturated or unsaturated ring.

24. The heat-developable light-sensitive material as claimed in claim 18, wherein the heterocyclic compound is a compound of the following formula (13): 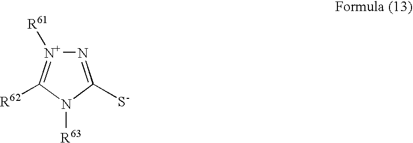
wherein R⁶¹ to R³ each independently represent a hydrogen atom or a substituent.

25. The heat-developable light-sensitive material as claimed in claim 18, wherein the heterocyclic compound is a nitrogen-containing, 5- to 7-membered heterocyclic compound that has at least one mercapto substituent.

26. The heat-developable light-sensitive material as claimed in claim 25, wherein the heterocyclic compound is pyridine, thiazole, isothiazole, oxazole, isoxazole, imidazole, pyrazole, pyrazine, pyrimidine, pyridazine, triazine, triazole, thiadiazole or oxadiazole.

27. The heat-developable light-sensitive material as claimed in claim 20, wherein the compound of formula (10) is represented by the following formula (9):
R⁷¹—S-(L)ₙ-S—R⁷² Formula (9)
wherein R⁷¹ and R⁷² each independently represent a hydrogen atom or a substituent; L represents a divalent linking group; and
n is 0 or 1.

28. The heat-developable light-sensitive material as claimed in claim 20, wherein the compound of formula (11) is represented by the following formula (8): 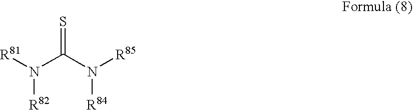
wherein R⁸¹ to R⁸⁵ each independently represent a hydrogen atom or a substituent; and L represents a divalent linking group.

29. The heat-developable light-sensitive material as claimed in claim 18, wherein the acid dissociation constant (pKa) of a conjugate acid in relation to the nitrogen atom in the heterocyclic compound, measured in a mixed solution of tetrahydrofuran/water (3/2) at 25° C., is from 3 to 8.

30. The heat-developable light-sensitive material as claimed in claim 21, wherein the heterocyclic compound is a pyridine derivative of formula (3), and the acid dissociation constant (pKa) of a conjugate acid thereof in a mixed solution of tetrahydrofuran/water (3/2) at 25° C. is from 3 to 8.

31. The heat-developable light-sensitive material as claimed in claim 15, wherein the heat-developable light-sensitive material is to be exposed to a laser light source.

32. The heat-developable light-sensitive material as claimed in claim 31, for which the laser light source emits laser light of not longer than 450 nm.

33. A heat-developable light-sensitive material comprising, on a face of a support thereof, a photosensitive silver halide, a non-photosensitive organic silver salt, a reducing agent and a binder, wherein (a) the silver iodide content of the photosensitive silver halide is from 40 mol % to 100 mol %, and (b) the material contains a compound of the following formula (14): 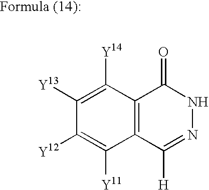
wherein Y¹ to Y¹⁴ each independently represent a hydrogen atom, or a substituent which can bond to the benzene ring; at least one of Y¹¹ to Y¹⁴ is a substituent; and Y¹¹ to Y¹⁴ may bond to each other to form a saturated or unsaturated ring.

34. The heat-developable light-sensitive material as claimed in claim 33, wherein in formula (14) the total sum of Hammett's substituent constants σₚ of substituents represented by Y¹¹ to Y¹⁴ is from −5 to 0.

35. The heat-developable light-sensitive material as claimed in claim 33, wherein the substituents represented by Y¹¹ to Y¹⁴ in formula (14) are any of an alkyl group, an alkenyl group, an alkynyl group, an aryl group, an alkoxy group, an alkenyloxy group, an acylamino group, a sulfonamino group, an acyloxy group, a heterocyclic group, an aryloxy group, and an amino group.

36. The heat-developable light-sensitive material as claimed in claim 33, further comprising a silver iodide complex-forming agent.

37. The heat-developable light-sensitive material as claimed in claim 36, wherein the silver iodide complex-forming agent is a 5- to 7-membered heterocyclic compound that contains at least one nitrogen atom.

38. The heat-developable light-sensitive material as claimed in claim 37, wherein the heterocyclic compound is a pyridine, imidazole, pyrazole, pyrazine, pyrimidine, pyridazine, phthalazine, triazine, triazole, naphthyridine or phenanthroline ring.

39. The heat-developable light-sensitive material as claimed in claim 37, wherein the heterocyclic compound is a pyridine derivative of the following formula (3): 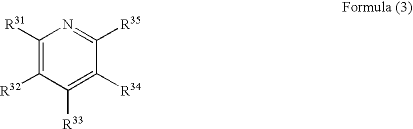
wherein R³¹ to R³⁵ each independently represent a hydrogen atom or a substituent which can bond to the pyridine ring, and R³¹ to R³⁵ may bond to each other to form a saturated or unsaturated ring.

40. The heat-developable light-sensitive material as claimed in claim 37, wherein the heterocyclic compound is a pyridazine derivative of the following formula (4): 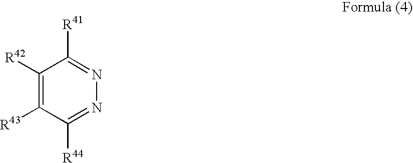
wherein R⁴¹ to R⁴⁴ each independently represent a hydrogen atom or a substituent which can bond to the pyridazine ring, and R⁴¹ to R⁴⁴ may bond to each other to form a saturated or unsaturated ring.

41. The heat-developable light-sensitive material as claimed in claim 37, wherein the heterocyclic compound is a phthalazine derivative of the following formula (12): 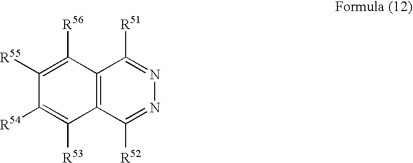
wherein R⁵¹ to R⁵⁶ each independently represent a hydrogen atom or a substituent which can bond to the phthalazine ring, and R⁵¹ to R⁵⁶ may bond to each other to form a saturated or unsaturated ring.

42. The heat-developable light-sensitive material as claimed in claim 37, wherein the heterocyclic compound is a compound of the following formula (13): 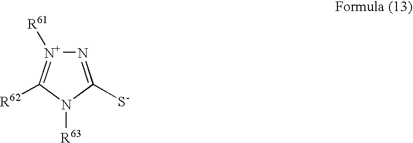
wherein R⁶¹ to R⁶³ each independently represent a hydrogen atom or a substitutable substituent.

43. The heat-developable light-sensitive material as claimed in claim 37, wherein the heterocyclic compound is a nitrogen-containing, 5- to 7-membered heterocyclic compound that has at least one mercapto substituent.

44. The heat-developable light-sensitive material as claimed in claim 43, wherein the heterocyclic compound is a compound having a pyridine, thiazole, isothiazole, oxazole, isoxazole, imidazole, pyrazole, pyrazine, pyrimidine, pyridazine, triazine, triazole, thiadiazole or oxadiazole ring.

45. The heat-developable light-sensitive material as claimed in claim 36, wherein the silver iodide complex-forming agent is a compound of at least one of the following two formulae (9) and (8):
R⁷¹—S(L)ₙ-S—R⁷² Formula (9)
wherein R⁷¹ and R⁷² each independently represent a substituent;
L represents a divalent linking group; and n represents 0 or 1; 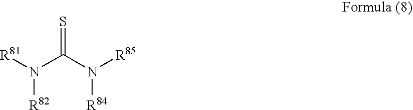
wherein R⁸¹ to R⁸⁴ each independently represent a hydrogen atom or a substituent, and both a combination of R⁸¹ and R⁸² and a combination of R⁸³ and R⁸⁴ may independently bond to each other to form saturated or unsaturated rings.

46. The heat-developable light-sensitive material as claimed in claim 33, wherein the heat-developable light-sensitive material is to be exposed to a laser light source.

47. The heat-developable light-sensitive material as claimed in claim 46, for which the laser light source emits laser light of not longer than 450 nm.
